(19) United States
(12) Patent Application Publication
(10) Pub. No.: US 2013/0054695 A1
(43) Pub. Date: Feb. 28, 2013

(54) Social network reporting system and method for ingestible material preparation system and method

(71) Applicants: Paul Holman, Seattle, WA (US); Royce A. Levien, Lexington, MA (US); Mark A. Malamud, Seattle, WA (US); Neal Stephenson, Seattle, WA (US); Christopher Charles Young, Seattle, WA (US)

(72) Inventors: Paul Holman, Seattle, WA (US); Royce A. Levien, Lexington, MA (US); Mark A. Malamud, Seattle, WA (US); Neal Stephenson, Seattle, WA (US); Christopher Charles Young, Seattle, WA (US)

(73) Assignee: Elwha LLC, a limited liability company of the State of Delaware

(21) Appl. No.: 13/385,690

(22) Filed: Feb. 29, 2012

Related U.S. Application Data
(63) Continuation-in-part of application No. 13/199,361, filed on Aug. 26, 2011.
Application No. 13/199,361 is a continuation-in-part of application No. 13/199,481, filed on Aug. 30, 2011.
Application No. 13/199,481 is a continuation-in-part of application No. 13/199,544, filed on Aug. 31, 2011.
Application No. 13/199,544 is a continuation-in-part of application No. 13/199,545, filed on Aug. 31, 2011.
Application No. 13/199,545 is a continuation-in-part of application No. 13/200,106, filed on Sep. 16, 2011.
Application No. 13/200,106 is a continuation-in-part of application No. 13/200,113, filed on Sep. 16, 2011.
Application No. 13/200,113 is a continuation-in-part of application No. 13/200,829, filed on Sep. 30, 2011.
Application No. 13/200,829 is a continuation-in-part of application No. 13/200,830, filed on Sep. 30, 2011.
Application No. 13/200,830 is a continuation-in-part of application No. 13/200,906, filed on Oct. 3, 2011.
Application No. 13/200,906 is a continuation-in-part of application No. 13/200,907, filed on Oct. 3, 2011.
Application No. 13/200,907 is a continuation-in-part of application No. 13/317,545, filed on Oct. 19, 2011.
Application No. 13/317,545 is a continuation-in-part of application No. 13/317,546, filed on Oct. 19, 2011.
Application No. 13/317,546 is a continuation-in-part of application No. 13/317,978, filed on Oct. 31, 2011.
Application No. 13/317,978 is a continuation-in-part of application No. 13/317,979, filed on Oct. 31, 2011.
Application No. 13/317,979 is a continuation-in-part of application No. 13/373,674, filed on Nov. 22, 2011.
Application No. 13/373,674 is a continuation-in-part of application No. 13/373,675, filed on Nov. 22, 2011.
Application No. 13/373,675 is a continuation-in-part of application No. 13/373,846, filed on Nov. 30, 2011.
Application No. 13/373,846 is a continuation-in-part of application No. 13/373,847, filed on Nov. 30, 2011.
Application No. 13/373,847 is a continuation-in-part of application No. 13/385,128, filed on Feb. 1, 2012.
Application No. 13/385,128 is a continuation-in-part of application No. 13/385,129, filed on Feb. 1, 2012.
Application No. 13/385,129 is a continuation of application No. 13/385,687, filed on Feb. 29, 2012.

(51) Int. Cl. G06F 15/16

(52) U.S. Cl. 709/204

(57) ABSTRACT

A computationally implemented system and method that is designed to, but is not limited to: electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus. In addition to the foregoing, other method aspects are described in the claims, drawings, and text forming a part of the present disclosure.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

### RELATED APPLICATIONS

For purposes of the USPTO extra-statutory requirements, the present application constitutes a continuation of U.S. patent application Ser. No. 13/199,361, entitled CONTROLLED SUBSTANCE AUTHORIZATION SYSTEM AND METHOD FOR INGESTIBLE PRODUCT PREPARATION SYSTEM AND METHOD, naming Paul Holman, Royce A. Levien, Mark A. Malamud, Neal Stephenson, and Christopher Charles Young as inventors, filed 26 Aug. 2011, which is currently co-pending or is an application of which a currently co-pending application is entitled to the benefit of the filing date.

For purposes of the USPTO extra-statutory requirements, the present application constitutes a continuation of U.S. patent application Ser. No. 13/199,481, entitled CONTROLLED SUBSTANCE AUTHORIZATION SYSTEM AND METHOD FOR INGESTIBLE PRODUCT PREPARATION SYSTEM AND METHOD, naming Paul Holman, Royce A. Levien, Mark A. Malamud, Neal Stephenson, and Christopher Charles Young as inventors, filed 30 Aug. 2011, which is currently co-pending or is an application of which a currently co-pending application is entitled to the benefit of the filing date.

For purposes of the USPTO extra-statutory requirements, the present application constitutes a continuation of U.S. patent application Ser. No. 13/199,544, entitled REPORTING SYSTEM AND METHOD FOR INGESTIBLE PRODUCT PREPARATION SYSTEM AND METHOD, naming Paul Holman, Royce A. Levien, Mark A. Malamud, Neal Stephenson, and Christopher Charles Young as inventors, filed 31 Aug. 2011, which is currently co-pending or is an application of which a currently co-pending application is entitled to the benefit of the filing date.

For purposes of the USPTO extra-statutory requirements, the present application constitutes a continuation of U.S. patent application Ser. No. 13/199,545, entitled REPORTING SYSTEM AND METHOD FOR INGESTIBLE PRODUCT PREPARATION SYSTEM AND METHOD, naming Paul Holman, Royce A. Levien, Mark A. Malamud, Neal Stephenson, and Christopher Charles Young as inventors, filed 31 Aug. 2011, which is currently co-pending or is an application of which a currently co-pending application is entitled to the benefit of the filing date.

For purposes of the USPTO extra-statutory requirements, the present application constitutes a continuation of U.S. patent application Ser. No. 13/200,106, entitled SUBSTANCE CONTROL SYSTEM AND METHOD FOR DISPENSING SYSTEMS, naming Paul Holman, Royce A. Levien, Mark A. Malamud, Neal Stephenson, and Christopher Charles Young as inventors, filed 16 Sep. 2011, which is currently co-pending or is an application of which a currently co-pending application is entitled to the benefit of the filing date.

For purposes of the USPTO extra-statutory requirements, the present application constitutes a continuation of U.S. patent application Ser. No. 13/200,113, entitled SUBSTANCE CONTROL SYSTEM AND METHOD FOR DISPENSING SYSTEMS, naming Paul Holman, Royce A. Levien, Mark A. Malamud, Neal Stephenson, and Christopher Charles Young as inventors, filed 16 Sep. 2011, which is currently co-pending or is an application of which a currently co-pending application is entitled to the benefit of the filing date.

For purposes of the USPTO extra-statutory requirements, the present application constitutes a continuation of U.S. patent application Ser. No. 13/200,829, entitled CLEANING SYSTEM AND METHOD FOR INGESTIBLE PRODUCT PREPARATION SYSTEM AND METHOD, naming Paul Holman, Royce A. Levien, Mark A. Malamud, Neal Stephenson, and Christopher Charles Young as inventors, filed 30 Sep. 2011, which is currently co-pending or is an application of which a currently co-pending application is entitled to the benefit of the filing date.

For purposes of the USPTO extra-statutory requirements, the present application constitutes a continuation of U.S. patent application Ser. No. 13/200,830, entitled CLEANING SYSTEM AND METHOD FOR INGESTIBLE PRODUCT PREPARATION SYSTEM AND METHOD, naming Paul Holman, Royce A. Levien, Mark A. Malamud, Neal Stephenson, and Christopher Charles Young as inventors, filed 30 Sep. 2011, which is currently co-pending or is an application of which a currently co-pending application is entitled to the benefit of the filing date.

For purposes of the USPTO extra-statutory requirements, the present application constitutes a continuation of U.S. patent application Ser. No. 13/200,906, entitled TREATMENT SYSTEM AND METHOD FOR INGESTIBLE PRODUCT DISPENSING SYSTEM AND METHOD, naming Paul Holman, Royce A. Levien, Mark A. Malamud, Neal Stephenson, and Christopher Charles Young as inventors, filed 3 Oct. 2011, which is currently co-pending or is an application of which a currently co-pending application is entitled to the benefit of the filing date.

For purposes of the USPTO extra-statutory requirements, the present application constitutes a continuation of U.S. patent application Ser. No. 13/200,907, entitled TREATMENT SYSTEM AND METHOD FOR INGESTIBLE PRODUCT DISPENSING SYSTEM AND METHOD, naming Paul Holman, Royce A. Levien, Mark A. Malamud, Neal Stephenson, and Christopher Charles Young as inventors, filed 3 Oct. 2011, which is currently co-pending or is an application of which a currently co-pending application is entitled to the benefit of the filing date.

For purposes of the USPTO extra-statutory requirements, the present application constitutes a continuation of U.S. patent application Ser. No. 13/317,545, entitled SUBSTANCE ALLOCATION SYSTEM AND METHOD FOR INGESTIBLE PRODUCT PREPARATION SYSTEM AND METHOD, naming Paul Holman, Royce A. Levien, Mark A. Malamud, Neal Stephenson, and Christopher Charles Young as inventors, filed 19 Oct. 2011, which is currently co-pending or is an application of which a currently co-pending application is entitled to the benefit of the filing date.

For purposes of the USPTO extra-statutory requirements, the present application constitutes a continuation of U.S. patent application Ser. No. 13/317,546, entitled SUBSTANCE ALLOCATION SYSTEM AND METHOD FOR INGESTIBLE PRODUCT PREPARATION SYSTEM AND METHOD, naming Paul Holman, Royce A. Levien, Mark A. Malamud, Neal Stephenson, and Christopher Charles Young as inventors, filed 19 Oct. 2011, which is currently co-pending or is an application of which a currently co-pending application is entitled to the benefit of the filing date.

For purposes of the USPTO extra-statutory requirements, the present application constitutes a continuation of U.S. patent application Ser. No. 13/317,978, entitled SELECTION INFORMATION SYSTEM AND METHOD FOR INGESTIBLE PRODUCT PREPARATION SYSTEM AND METHOD, naming Paul Holman, Royce A. Levien, Mark A. Malamud, Neal Stephenson, and Christopher Charles Young as inventors, filed 31 Oct. 2011, which is currently co-pending or is an application of which a currently co-pending application is entitled to the benefit of the filing date.

For purposes of the USPTO extra-statutory requirements, the present application constitutes a continuation of U.S. patent application Ser. No. 13/317,979, entitled SELECTION INFORMATION SYSTEM AND METHOD FOR INGESTIBLE PRODUCT PREPARATION SYSTEM AND METHOD, naming Paul Holman, Royce A. Levien, Mark A. Malamud, Neal Stephenson, and Christopher Charles Young as inventors, filed 31 Oct. 2011, which is currently co-pending or is an application of which a currently co-pending application is entitled to the benefit of the filing date.

For purposes of the USPTO extra-statutory requirements, the present application constitutes a continuation of U.S. patent application Ser. No. 13/373,674, entitled INGESTION INTELLIGENCE ACQUISITION SYSTEM AND METHOD FOR INGESTIBLE MATERIAL PREPARATION SYSTEM AND METHOD, naming Paul Holman, Royce A. Levien, Mark A. Malamud, Neal Stephenson, and Christopher Charles Young as inventors, filed 22 Nov. 2011, which is currently co-pending or is an application of which a currently co-pending application is entitled to the benefit of the filing date.

For purposes of the USPTO extra-statutory requirements, the present application constitutes a continuation of U.S. patent application Ser. No. 13/373,675, entitled INGESTION INTELLIGENCE ACQUISITION SYSTEM AND METHOD FOR INGESTIBLE MATERIAL PREPARATION SYSTEM AND METHOD, naming Paul Holman, Royce A. Levien, Mark A. Malamud, Neal Stephenson, and Christopher Charles Young as inventors, filed 22 Nov. 2011, which is currently co-pending or is an application of which a currently co-pending application is entitled to the benefit of the filing date.

For purposes of the USPTO extra-statutory requirements, the present application constitutes a continuation of U.S. patent application Ser. No. 13/373,846, entitled REFUSE INTELLIGENCE ACQUISITION SYSTEM AND METHOD FOR INGESTIBLE PRODUCT PREPARATION SYSTEM AND METHOD, naming Paul Holman, Royce A. Levien, Mark A. Malamud, Neal Stephenson, and Christopher Charles Young as inventors, filed 30 Nov. 2011, which is currently co-pending or is an application of which a currently co-pending application is entitled to the benefit of the filing date.

For purposes of the USPTO extra-statutory requirements, the present application constitutes a continuation of U.S. patent application Ser. No. 13/373,847, entitled REFUSE INTELLIGENCE ACQUISITION SYSTEM AND METHOD FOR INGESTIBLE PRODUCT PREPARATION SYSTEM AND METHOD, naming Paul Holman, Royce A. Levien, Mark A. Malamud, Neal Stephenson, and Christopher Charles Young as inventors, filed 30 Nov. 2011, which is currently co-pending or is an application of which a currently co-pending application is entitled to the benefit of the filing date.

For purposes of the USPTO extra-statutory requirements, the present application constitutes a continuation of U.S. patent application Ser. No. 13/385,128, entitled ITINERARY INTEGRATION SYSTEM AND METHOD FOR VENDING NETWORK SYSTEMS, naming Paul Holman, Royce A. Levien, Mark A. Malamud, Neal Stephenson, and Christopher Charles Young as inventors, filed 1 Feb. 2012, which is currently co-pending or is an application of which a currently co-pending application is entitled to the benefit of the filing date.

For purposes of the USPTO extra-statutory requirements, the present application constitutes a continuation of U.S. patent application Ser. No. 13/385,129, entitled ITINERARY INTEGRATION SYSTEM AND METHOD FOR VENDING NETWORK SYSTEMS, naming Paul Holman, Royce A. Levien, Mark A. Malamud, Neal Stephenson, and Christopher Charles Young as inventors, filed 1 Feb. 2012, which is currently co-pending or is an application of which a currently co-pending application is entitled to the benefit of the filing date.

For purposes of the USPTO extra-statutory requirements, the present application constitutes a continuation of United States Patent Application No. To Be Assigned, entitled SOCIAL NETWORK REPORTING SYSTEM AND METHOD FOR INGESTIBLE MATERIAL PREPARATION SYSTEM AND METHOD, naming Paul Holman, Royce A. Levien, Mark A. Malamud, Neal Stephenson, and Christopher Charles Young as inventors, filed 29 Feb. 2012, which is currently co-pending or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

### SUMMARY

A method includes, but is not limited to electronically receiving user status information regarding a particular individual living being including computer based social network service identification associated with the particular individual living being and electronically receiving selection information of one or more computer based social network service options via electronically enabled input in response to electronically outputted one or more selection menus prior to dispensing of one or more ingestible products for ingestion by the particular individual living being to electronically direct control of collection of preparation information regarding at least partial preparation of the one or more ingestible products, the at least partial preparation of the one or more ingestible products occurring within a first vicinity of the electronically outputting of the electronically outputted one or more selection menus; and electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus.

In one or more various aspects, related machines, compositions of matter, or manufactures of systems may include, but are not limited to, virtually any combination of hardware, software, and/or firmware configured to effect the herein-referenced method aspects depending upon the design choices of the system designer (limited to patentable subject matter under 35 USC 101).

A system includes, but is not limited to: means for electronically receiving user status information regarding a particular individual living being including computer based social network service identification associated with the particular individual living being and electronically receiving selection information of one or more computer based social network service options via electronically enabled input in response to electronically outputted one or more selection menus prior to dispensing of one or more ingestible products for ingestion by the particular individual living being to electronically direct control of collection of preparation information regarding at least partial preparation of the one or more ingestible products, the at least partial preparation of the one or more ingestible products occurring within a first vicinity of the electronically outputting of the electronically outputted one or more selection menus; and means for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus. In addition to the foregoing, other system aspects are described in the claims, drawings, and text forming a part of the present disclosure.

A system includes, but is not limited to a receiving information electrical circuitry arrangement for electronically receiving user status information regarding a particular individual living being including computer based social network service identification associated with the particular individual living being and electronically receiving selection information of one or more computer based social network service options via electronically enabled input in response to electronically outputted one or more selection menus prior to dispensing of one or more ingestible products for ingestion by the particular individual living being to electronically direct control of collection of preparation information regarding at least partial preparation of the one or more ingestible products, the at least partial preparation of the one or more ingestible products occurring within a first vicinity of the electronically outputting of the electronically outputted one or more selection menus; and a controlling transmission electrical circuitry arrangement for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus. In addition to the foregoing, other system aspects are described in the claims, drawings, and text forming a part of the present disclosure.

An article of manufacture including a non-transitory signal-bearing storage medium bearing one or more instructions for electronically receiving user status information regarding a particular individual living being including computer based social network service identification associated with the particular individual living being and electronically receiving selection information of one or more computer based social network service options via electronically enabled input in response to electronically outputted one or more selection menus prior to dispensing of one or more ingestible products for ingestion by the particular individual living being to electronically direct control of collection of preparation information regarding at least partial preparation of the one or more ingestible products, the at least partial preparation of the one or more ingestible products occurring within a first vicinity of the electronically outputting of the electronically outputted one or more selection menus; and one or more instructions for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus. In addition to the foregoing, other computer program product aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a perspective view depicting a first application of a first exemplary implementation of a social network reporting system including an ingestible material preparation system.

FIG. 1A is a fragmentary view depicting a second application of the first exemplary implementation of the ingestible preparation system of the social network reporting system of FIG. 1.

FIG. 1B is a fragmentary view depicting a third application of the first exemplary implementation of the ingestible preparation system of the social network reporting system of FIG. 1.

FIG. 1C is a fragmentary view depicting a fourth application of the first exemplary implementation of the ingestible preparation system for the social network reporting system of FIG. 1.

FIG. 2 is a perspective view depicting a first application of a second exemplary implementation of the social network reporting system of FIG. 1 including the ingestible preparation system.

FIG. 3 is a perspective view depicting a second application of the second exemplary implementation of the social network reporting system of FIG. 1 including the ingestible preparation system.

FIG. 4 is a perspective view depicting first implementations of collection of ingestion intelligence related to the social network reporting system in FIG. 1.

FIG. 5 is a perspective view depicting a second implementation of collection of ingestion intelligence related to the social network reporting system in FIG. 1.

FIG. 6 is a schematic view depicting reporting of collected ingestion intelligence information to a computer based social networking service by the social network reporting system in FIG. 1.

FIG. 7 is a schematic diagram depicting another implementation of the social network reporting system in FIG. 1.

FIG. 8 is a schematic diagram depicting a computer based social network service as related to the social network reporting system in FIG. 1.

FIG. 9 is a schematic diagram of a user interface for an exemplary computer based social network service as related to the social network reporting system in FIG. 1.

FIG. 10 is a block diagram depicting an exemplary implementation of the social network reporting system 10 of FIG. 1 including exemplary subsystems.

FIG. 11 is a block diagram depicting a control and information processing subsystem s100 of an exemplary implementation of the social network reporting system 10 of FIG. 1.

FIG. 12 is a block diagram depicting an information storage subsystem s200 of an exemplary implementation of the social network reporting system 10 of FIG. 1.

FIG. 13 is a block diagram depicting an information user interface subsystem s300 of an exemplary implementation of the social network reporting system 10 of FIG. 1.

FIG. 14 is a block diagram depicting a sensing subsystem s400 of an exemplary implementation of the social network reporting system 10 of FIG. 1.

FIG. 15 is a block diagram depicting an electronic communication subsystem s500 of an exemplary implementation of the social network reporting system 10 of FIG. 1.

FIG. 16 is a block diagram depicting a power subsystem s600 of an exemplary implementation of the social network reporting system 10 of FIG. 1.

FIG. 17 is a block diagram depicting a material processing subsystem s700 of an exemplary implementation of the social network reporting system 10 of FIG. 1.

FIG. 18 is a block diagram depicting a preparation subsystem s800 of an exemplary implementation of the social network reporting system 10 of FIG. 1.

FIG. 19 is a block diagram depicting one or more exemplary electrical circuitry arrangements of the social network reporting system 10 of FIG. 1.

FIG. 20 is a block diagram depicting one or more exemplary electrical circuitry arrangements of the social network reporting system 10 of FIG. 1.

FIG. 21 is a block diagram depicting one or more exemplary electrical circuitry arrangements of the social network reporting system 10 of FIG. 1.

FIG. 22 is a block diagram depicting one or more exemplary electrical circuitry arrangements of the social network reporting system 10 of FIG. 1.

FIG. 23 is a block diagram depicting one or more exemplary electrical circuitry arrangements of the social network reporting system 10 of FIG. 1.

FIG. 24 is a block diagram depicting one or more exemplary electrical circuitry arrangements of the social network reporting system 10 of FIG. 1.

FIG. 25 is a block diagram depicting one or more exemplary electrical circuitry arrangements of the social network reporting system 10 of FIG. 1.

FIG. 26 is a block diagram depicting one or more exemplary electrical circuitry arrangements of the social network reporting system 10 of FIG. 1.

FIG. 27 is a block diagram depicting one or more exemplary electrical circuitry arrangements of the social network reporting system 10 of FIG. 1.

FIG. 28 is a block diagram depicting one or more exemplary instructions of the information storage subsystem s200 of the social network reporting system 10 of FIG. 1.

FIG. 29 is a block diagram depicting one or more exemplary instructions of the information storage subsystem s200 of the social network reporting system 10 of FIG. 1.

FIG. 30 is a block diagram depicting one or more exemplary instructions of the information storage subsystem s200 of the social network reporting system 10 of FIG. 1.

FIG. 31 is a block diagram depicting one or more exemplary instructions of the information storage subsystem s200 of the social network reporting system 10 of FIG. 1.

FIG. 32 is a block diagram depicting one or more exemplary instructions of the information storage subsystem s200 of the social network reporting system 10 of FIG. 1.

FIG. 33 is a block diagram depicting one or more exemplary instructions of the information storage subsystem s200 of the social network reporting system 10 of FIG. 1.

FIG. 34 is a block diagram depicting one or more exemplary instructions of the information storage subsystem s200 of the social network reporting system 10 of FIG. 1.

FIG. 35 is a block diagram depicting one or more exemplary instructions of the information storage subsystem s200 of the social network reporting system 10 of FIG. 1.

FIG. 36 is a block diagram depicting one or more exemplary instructions of the information storage subsystem s200 of the social network reporting system 10 of FIG. 1.

FIG. 37 is a high-level flowchart illustrating an operational flow o10 representing exemplary operations related to electronically receiving user status information regarding a particular individual living being including computer based social network service identification associated with the particular individual living being and electronically receiving selection information of one or more computer based social network service options via electronically enabled input in response to electronically outputted one or more selection menus prior to dispensing of one or more ingestible products for ingestion by the particular individual living being to electronically direct control of collection of preparation information regarding at least partial preparation of the one or more ingestible products, the at least partial preparation of the one or more ingestible products occurring within a first vicinity of the electronically outputting of the electronically outputted one or more selection menus, and electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus at least associated with the depicted exemplary implementations of the system.

FIG. 38 is a high-level flowchart including exemplary implementations of operation O11 of FIG. 37.

FIG. 39 is a high-level flowchart including exemplary implementations of operation O11 of FIG. 37.

FIG. 40 is a high-level flowchart including exemplary implementations of operation O11 of FIG. 37.

FIG. 41 is a high-level flowchart including exemplary implementations of operation O11 of FIG. 37.

FIG. 42 is a high-level flowchart including exemplary implementations of operation O11 of FIG. 37.

FIG. 43 is a high-level flowchart including exemplary implementations of operation O11 of FIG. 37.

FIG. 44 is a high-level flowchart including exemplary implementations of operation O11 of FIG. 37.

FIG. 45 is a high-level flowchart including exemplary implementations of operation O11 of FIG. 37.

FIG. 46 is a high-level flowchart including exemplary implementations of operation O11 of FIG. 37.

FIG. 47 is a high-level flowchart including exemplary implementations of operation O11 of FIG. 37.

FIG. 48 is a high-level flowchart including exemplary implementations of operation O11 of FIG. 37.

FIG. 49 is a high-level flowchart including exemplary implementations of operation O11 of FIG. 37.

FIG. 50 is a high-level flowchart including exemplary implementations of operation O11 of FIG. 37.

FIG. 51 is a high-level flowchart including exemplary implementations of operation O11 of FIG. 37.

FIG. 52 is a high-level flowchart including exemplary implementations of operation O11 of FIG. 37.

FIG. 53 is a high-level flowchart including exemplary implementations of operation O11 of FIG. 37.

FIG. 54 is a high-level flowchart including exemplary implementations of operation O11 of FIG. 37.

FIG. 55 is a high-level flowchart including exemplary implementations of operation O11 of FIG. 37.

FIG. 56 is a high-level flowchart including exemplary implementations of operation O11 of FIG. 37.

FIG. 57 is a high-level flowchart including exemplary implementations of operation O11 of FIG. 37.

FIG. 58 is a high-level flowchart including exemplary implementations of operation O11 of FIG. 37.

FIG. 59 is a high-level flowchart including exemplary implementations of operation O11 of FIG. 37.

FIG. 60 is a high-level flowchart including exemplary implementations of operation O11 of FIG. 37.

FIG. 61 is a high-level flowchart including exemplary implementations of operation O11 of FIG. 37.

FIG. 62 is a high-level flowchart including exemplary implementations of operation O11 of FIG. 37.

FIG. 63 is a high-level flowchart including exemplary implementations of operation O11 of FIG. 37.

FIG. 64 is a high-level flowchart including exemplary implementations of operation O11 of FIG. 37.

FIG. 65 is a high-level flowchart including exemplary implementations of operation O11 of FIG. 37.

FIG. 66 is a high-level flowchart including exemplary implementations of operation O11 of FIG. 37.

FIG. 67 is a high-level flowchart including exemplary implementations of operation O11 of FIG. 37.

FIG. 68 is a high-level flowchart including exemplary implementations of operation O11 of FIG. 37.

FIG. 69 is a high-level flowchart including exemplary implementations of operation O11 of FIG. 37.

FIG. 70 is a high-level flowchart including exemplary implementations of operation O11 of FIG. 37.

FIG. 71 is a high-level flowchart including exemplary implementations of operation O11 of FIG. 37.

FIG. 72 is a high-level flowchart including exemplary implementations of operation O11 of FIG. 37.

FIG. 73 is a high-level flowchart including exemplary implementations of operation O12 of FIG. 37.

FIG. 74 is a high-level flowchart including exemplary implementations of operation O12 of FIG. 37.

FIG. 75 is a high-level flowchart including exemplary implementations of operation O12 of FIG. 37.

FIG. 76 is a high-level flowchart including exemplary implementations of operation O12 of FIG. 37.

FIG. 77 is a high-level flowchart including exemplary implementations of operation O12 of FIG. 37.

FIG. 78 is a high-level flowchart including exemplary implementations of operation O12 of FIG. 37.

FIG. 79 is a high-level flowchart including exemplary implementations of operation O12 of FIG. 37.

FIG. 80 is a high-level flowchart including exemplary implementations of operation O12 of FIG. 37.

FIG. 81 is a high-level flowchart including exemplary implementations of operation O12 of FIG. 37.

FIG. 82 is a high-level flowchart including exemplary implementations of operation O12 of FIG. 37.

FIG. 83 is a high-level flowchart including exemplary implementations of operation O12 of FIG. 37.

FIG. 84 is a high-level flowchart including exemplary implementations of operation O12 of FIG. 37.

FIG. 85 is a high-level flowchart including exemplary implementations of operation O12 of FIG. 37.

FIG. 86 is a high-level flowchart including exemplary implementations of operation O12 of FIG. 37.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Generally, automated and semi-automated machines to make, manufacture, fabricate, or otherwise prepare and/or dispense ingestible products to be ingested by living beings such as humans, animals, plants, etc. are known to a degree with interest existing for future development as well. Automated and semi-automated preparation of the ingestible products can incorporate all known forms of preparation of food and other ingestible products including but not limited to all known forms of energy addition to one or more ingredients of the ingestible products (such as through various forms of thermal heating or adding microwave, infrared, or ultrasonic energy), extracting energy from one or more ingredients of the ingestible products (such as through thermodynamic-cycle based cooling or peltier cooling), deposition methods (including deposition by layering or at the pixel level), and combinational methods (such as blending, mixing, ingredient injection, kneading, stirring, ultrasonic agitation, other agitational methods, etc.), etc.

Although ingestible products made, fabricated, or otherwise prepared and/or dispensed by semi-automated and automated machines are presently limited in scope to a degree, it is envisioned that with future development, this will change. Ingestible products can take many forms including, but not limited to, solids, semi-solids, liquids, gases, dispersions (such as true solutions, colloid dispersions, emulsions, foams, and gels) and vast combinations thereof. Ingestion by the living beings can occur through many pathways including, but not limited to, oral ingestion, transdermal ingestion, peg-tube ingestion, nasal ingestion, anal ingestion, injectable ingestion, tear-duct ingestion, and respiratory ingestion.

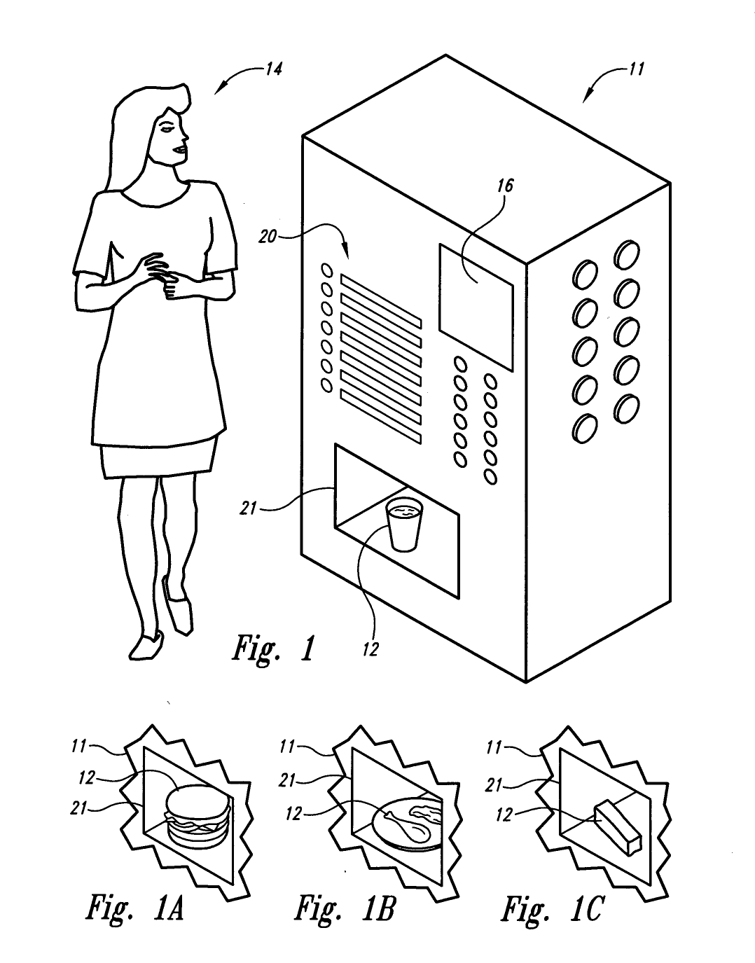

As depicted in FIGS. 1-3, exemplary implementations of an social network reporting system 10 including an ingestible material preparation system 11 associated therewith are shown to prepare and dispense ingestible products 12 such as a liquid drink, hamburger, chicken dinner, or a snack bar (shown in dispensing area 21) to be consumed by a particular individual living being, such as a human being 14 (such as a user, etc.) shown. Exemplary implementations determine selection menus to be generated and outputted, for instance, on display 16 and selections or other information can be inputted through user interfaces, for instance, user input 20 or other types of user input. For instance, input may be collected through active user input (e.g. keyboard, textual, audio, graphical user interface, etc.) or passive user input (e.g. image recognition of user behavior, refuse analysis of past dispensing such as quantity of wrappers, leftovers, audio analysis of collected unsolicited user comments, etc.). Selection menus can be generated that are unique to a particular individual living being, such as the human being 14, based upon such information as but not limited to identification of the individual and other information such as past selections, allergies, preferences, specials, holidays, location of preparation, location of dispensing, time of day, dislikes, recent ingestion, health goals, present illness, past illness, sports requirements, injuries, fads, hobbies, associated social organizations, etc. Other sorts of ingestible products can include but are not limited to sandwiches (FIG. 1A), full meals (FIG. 1B), food bars (FIG. 1C), meal replacements, snacks, plant and/or animal based products, nutraceuticals, pharmaceuticals, smoothies, etc. The selection menus can also provide options for reporting to various computer based social networking services regarding use of the ingestible products including associates venues, parties, types of products involved, etc.

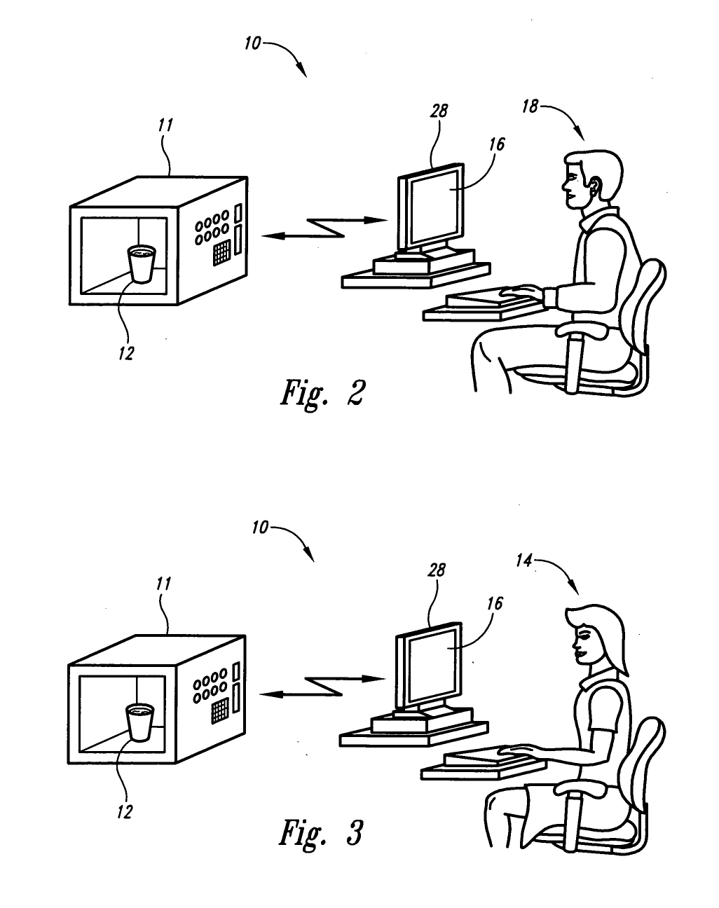

The social network reporting system 10 is further depicted in FIGS. 2 and 3 as communicating with the human being 14 an exemplary remotely located user or an exemplary advisor 18 (e.g. physician, nurse, nutritionist, health expert, sports coach, etc.) via a communication link (e.g. wireless or wired network or direct electronic communication, etc.) and display screen 28. The display screen 28 can include selection indicators configured to provide information described above by the users and advisors. The display screen 28 can also output generated selection menus based upon identification of the particular individual living being and other information including that described above. The social network reporting system 10 provides various reporting to selected computer based social network services regarding activities involved associated ingestible material preparation systems 11 so that menus 16 and 20 can provide selection regarding choices related to such reporting. Selection menus can also be furnished to suggest candidate ingestible products that once selected as selected ingestible products can be prepared and dispensed (in some implementations prepared such as from ingredient containers) and to provide other sorts of information discussed herein. The display screen 28 can display textual and graphic information such as including but not limited to menu screens allowing users to select various dispensing (including in some implementations preparation) options and information requests. Other implementations can include other devices and methods for information input and output including those further discussed below.

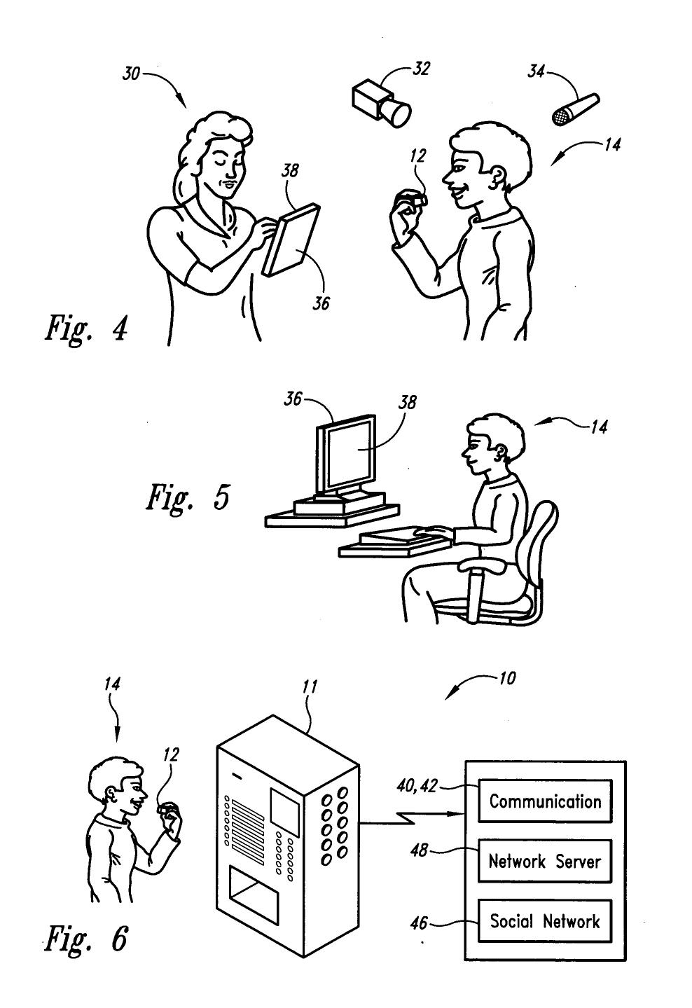

Exemplary collection of ingestion intelligence information is depicted in FIG. 4 involving waitress 30 using electronic tablet 36 with interface screen 38, video camera 32, microphone 34 to collect information such as regarding topics of conversation, digestion rates, arrangement of tables, chairs, types of furnishings, types of clothing worn, types of tips left, etc. FIG. 5 depicts user 14 with monitor 36 and display screen 38 inputting other ingestion intelligence information such how the user feels about themselves and/or how the user feels about the ingested material such as a smoothie.

FIG. 6 depicts reporting communication 40, 42 of collected ingestion intelligence information to a computer based social networking service 46 hosted on a network server 48 as performed by the social network reporting system 10 directly through and/or associated with the ingestible material preparation system 11.

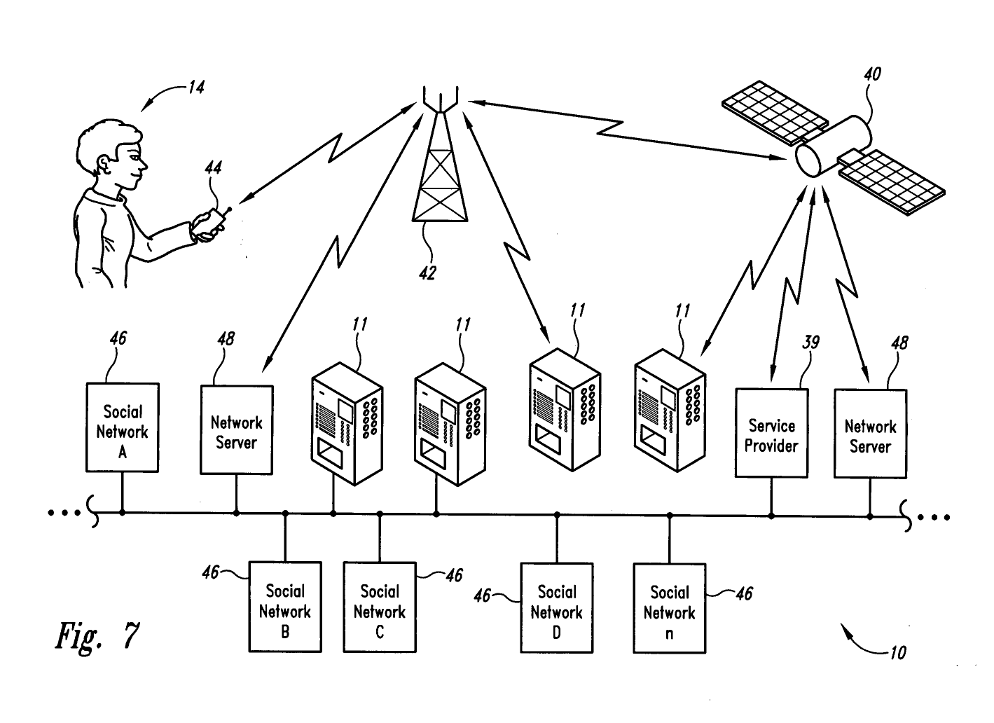

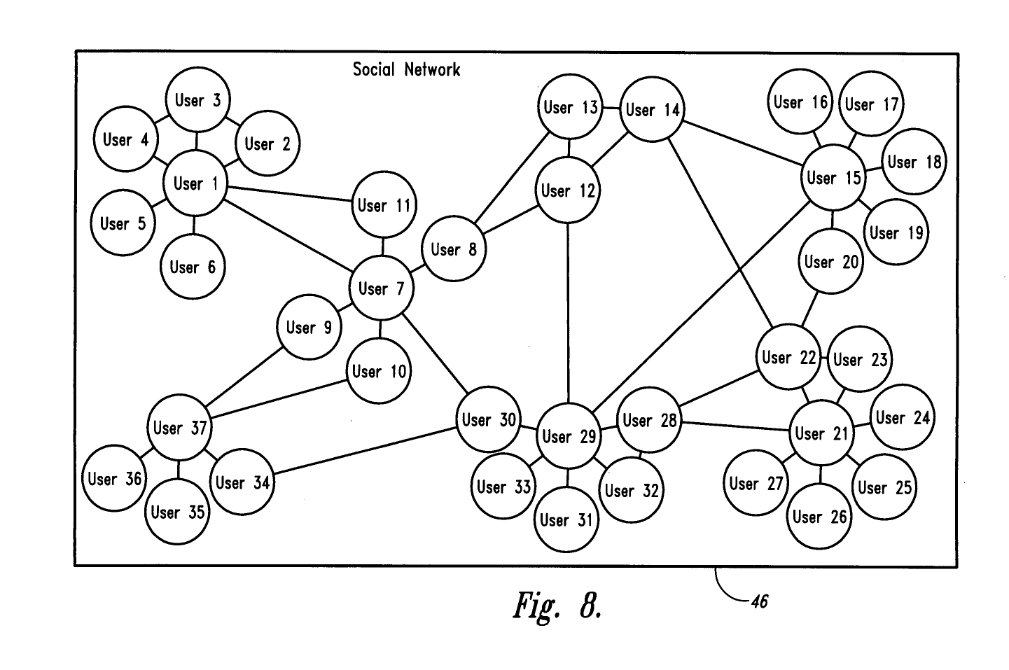

FIG. 7 is a schematic diagram depicting another implementation of the social network reporting system in FIG. 1 involving extensive networking of computer based social network services 46 along with supporting service providers 39 and network servers 48 through various wired and wireless 40, 42, 44 communication media.

FIG. 8 is a schematic diagram depicting a computer based social network service as related to the social network reporting system in FIG. 1.

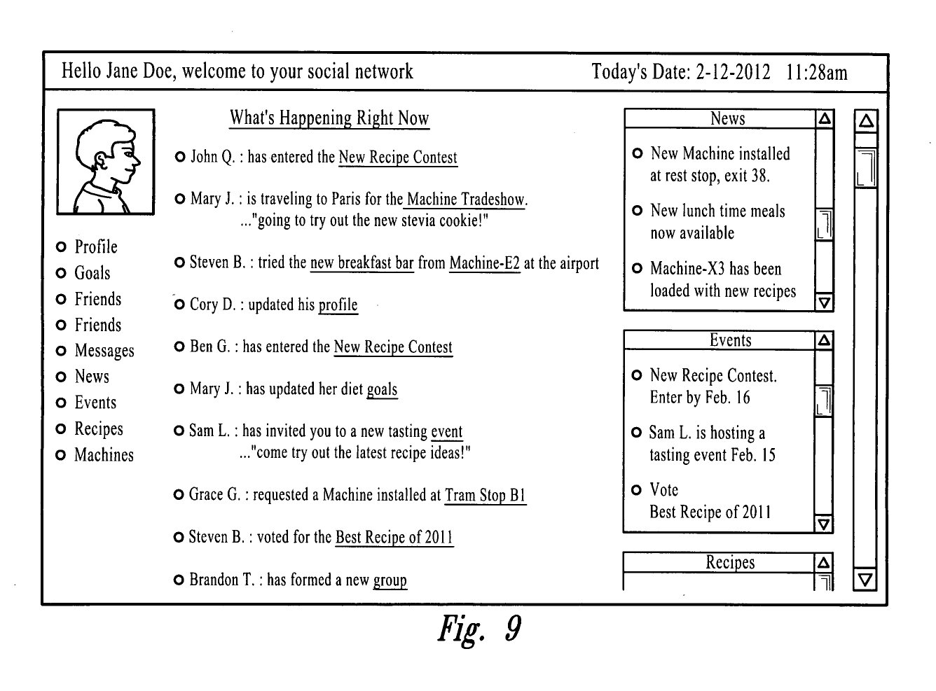

FIG. 9 is a schematic diagram of a user interface for an exemplary computer based social network service as related to the social network reporting system in FIG. 1. Computer based social network services 46 can include one or more online groups or communities of people who typically share something such as one or more interests, activities, goals, uses, ownership, etc. Implementations of the one or more computer based social network services 46 can include one or more web based services such as Facebook, Twitter, LinkedIn, MySpace, Nexopia, Friendster, Multiply, etc. Implementations of the one or more social networking services 18 can provide facilities for users to create profiles for themselves. Implementations of the one or more computer based social network services 46 can have various classifications such as for internal social networking or for external social networking. Implementations of the one or more computer based social network services 46 as internal social networking services can be closed, private groups of people within associations, companies, educational institutions, societies, or organizations such as those formed through invitation only arrangements. Implementations of the one or more computer based social network services 46 as external social networking services can include those open to the public such as most or all users of the internet and includes an advertising model to help support operations. The one or more computer based social network services 46 can include members and others with one or more interests such as environmental issues, for instance, climate change, preservation of species, forests, wildernesses, pollution control, waste management, recycling, energy conservation, sustainable energy sources, sustainable agriculture, and/or can specialize in one or more particular interests, etc.

Some intrinsic environmental factors that can be part of the ingestion intelligence information collected can include such as occupant density, noise level, artwork, furnishings, olfactory factors such as odors, etc., dining party factors such as type, mood, size, etc., temperature and/or humidity level such as that of the air in contact with the particular individual living being, lighting factors such as intensity and/or spectrum, etc., ergonomics such as that of chairs, tables, arrangements of furniture involved, colors and/or music as associated with ingestion by a particular individual living being all reported by the social network reporting system 10 to the computer based social network service 46.

User feedback factors can be part of the ingestion intelligence information collected such as taste opinion, texture opinion, feeling of physical health, feeling of mental health, financial considerations, and opinion on presentation of ingestible material, etc. as associated with ingestion by a particular individual living being as reported by the social network reporting system 10 to the computer based social network service 46.

Ingestion intelligence information reported to the computer based social network service 46 by the social network reporting system 10 can include information about some user (e.g. the particular individual living being) and/or dining party factors that can be part of the ingestion intelligence information acquired such as consumption rate that the user ingests the ingestible material, subject context of ingestion such as a special occasion or routine meal, other consumption or ingestion factors such as physical health of the user, conversation detail associated with discussion among members of a dining party including the user, material combinations that the ingestible product was combined with during ingestion, gratuity execution such as the amount of the tip left for the wait staff, participant apparel such as clothing worn by the user or other members of the dining party including the user, participant demographics of the user and/or others in the user's dining party, financial status of user and/or others in user's dining party, how animated the user or others in the user's dining party is, refuse status regarding what and how much of the ingestible material was not ingested by the user and/or the other members of the user's dining party, or time dynamics including amount of time taken to wait for a table, wait for the menus, wait for the order to be taken, wait for the food to be prepared and served, wait for the bill to delivered, wait for the bill to be paid, and amount of time taken to continue to occupy the dining space after the bill was paid as associated with ingestion by a user (e.g. particular individual living being) of ingestible material prepared by the ingestible material product preparation system 11.

Various methods of ingestion by the user can include consumption methods and delivery methods such as dermal, intranasal, transmucosal, perioral, buccal, sublingual, ocular, rectal, injection, and inhalation, etc. as associated with ingestion by a particular individual living being of ingestible material reported to the computer based social network service 46 by the social network reporting system 10. Main modes and types of acquisition of ingestion intelligence can include methods of consumption and/or delivery, intrinsic environmental factors, extrinsic environmental factors, acquired data of user and/or party, and user feedback, etc. as associated with ingestion by a particular individual living being of ingestible material reported by the social network reporting system 10.

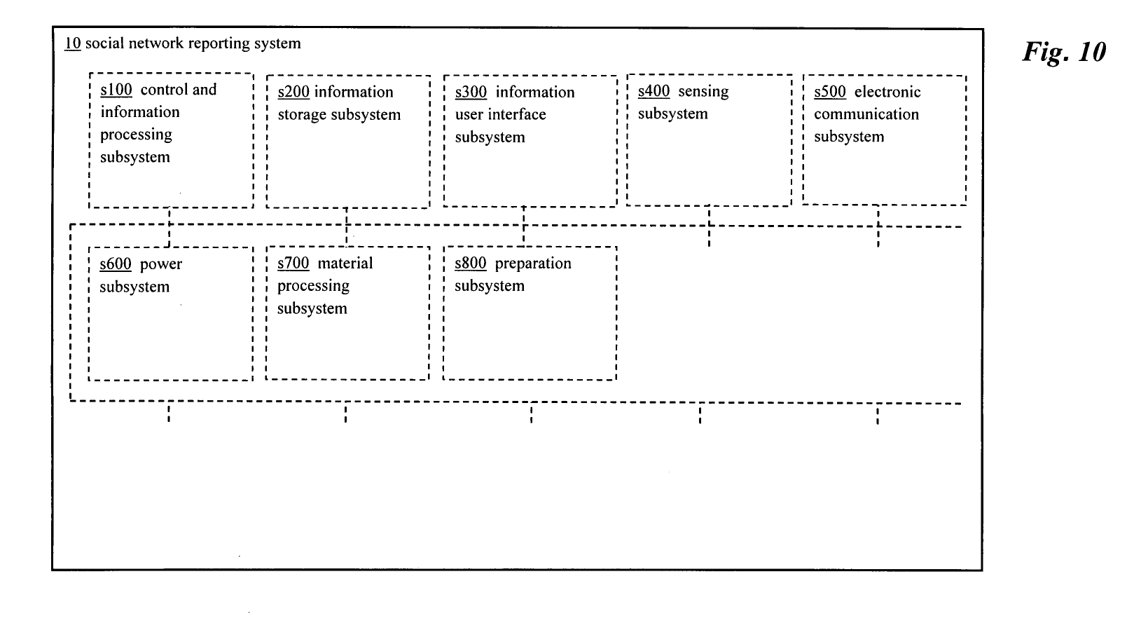

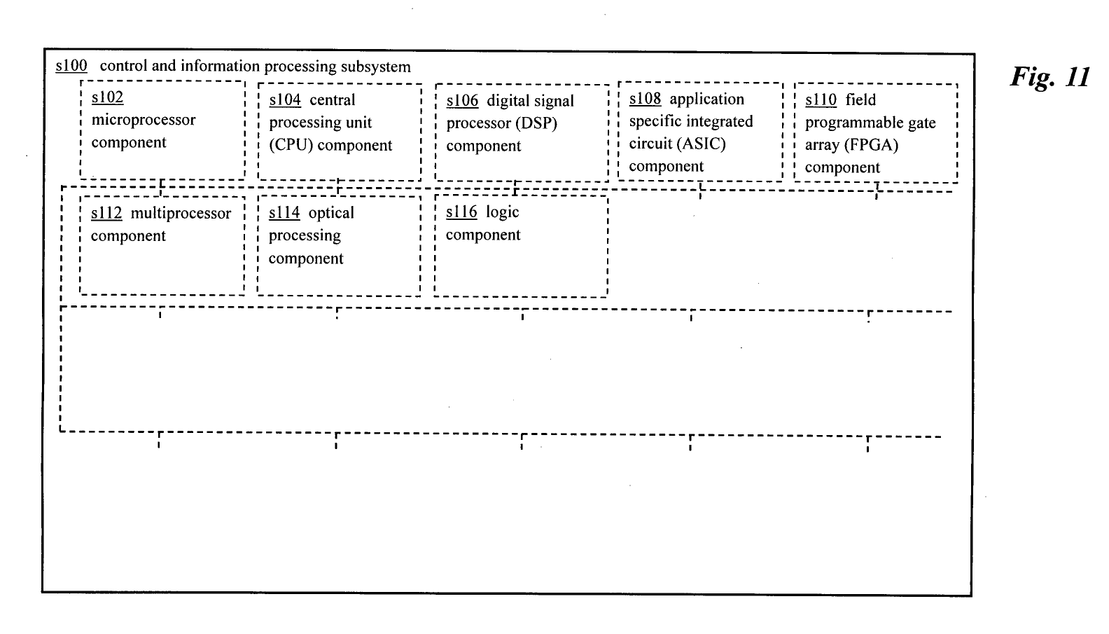

An exemplary version of the social network reporting system 10 is shown in FIG. 10 to optionally include various subsystems such as control and information processing subsystem s100, information storage subsystem s200, information user interface subsystem s300, sensing subsystem s400, electronic communication subsystem s500, power subsystem s600, material processing subsystem s700, and preparation subsystem s800.

An exemplary implementation of the control and information processing subsystem s100 is shown in FIG. 11 to optionally include various components such as microprocessor component s102, central processing unit (CPU) component s104, digital signal processor (DSP) component s106, application specific integrated circuit (ASIC) component s108, field programmable gate array (FPGA) component s110, multiprocessor component s112, optical processing component s114, and logic component s116.

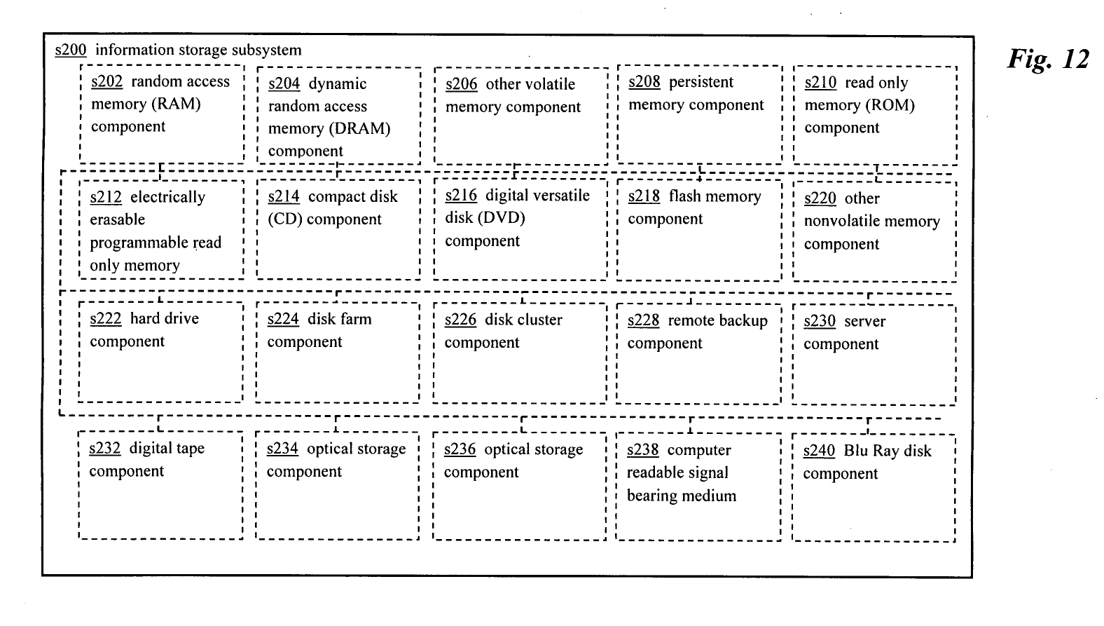

An exemplary implementation of the information storage subsystem s200 is shown in FIG. 12 to optionally include various components such as random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, and Blu Ray disk component s240.

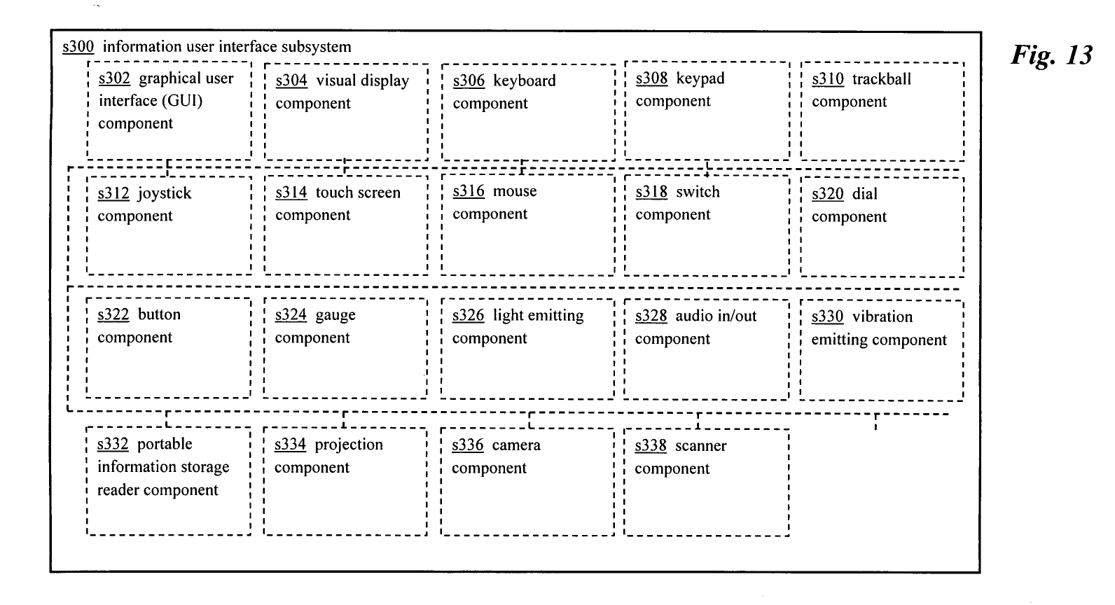

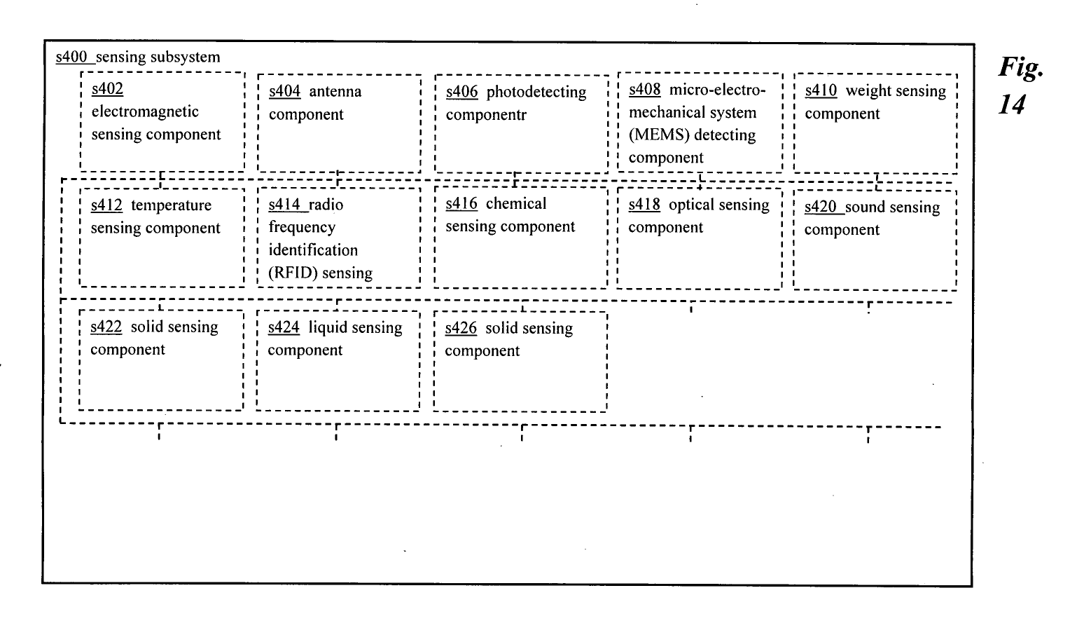

An exemplary implementation of the information user interface subsystem s300 is shown in FIG. 13 to optionally include various components such as graphical user interface (GUI) component s302, visual display component s304, keyboard component s306, keypad component s308, trackball component s310, joystick component s312, touch screen component s314, mouse component s316, switch component s318, dial component s320, button component s322, gauge component s324, light emitting component s326, audio in/out component s328, vibration emitting component s330, portable information storage reader component s332, projection component s334, camera component s336, and scanner component s338.

An exemplary implementation of the sensing subsystem s400 is shown in FIG. 14 to optionally include various components such as electromagnetic sensing component s402, antenna component s404, photodetecting component s406, micro-electro-mechanical system (MEMS) detecting component s408, weight sensing component s410, temperature sensing component s412, radio frequency identification (RFID) sensing component s414, chemical sensing component s416, optical sensing component s418, sound sensing component s420, solid sensing component s422, liquid sensing component s424, and solid sensing component s426.

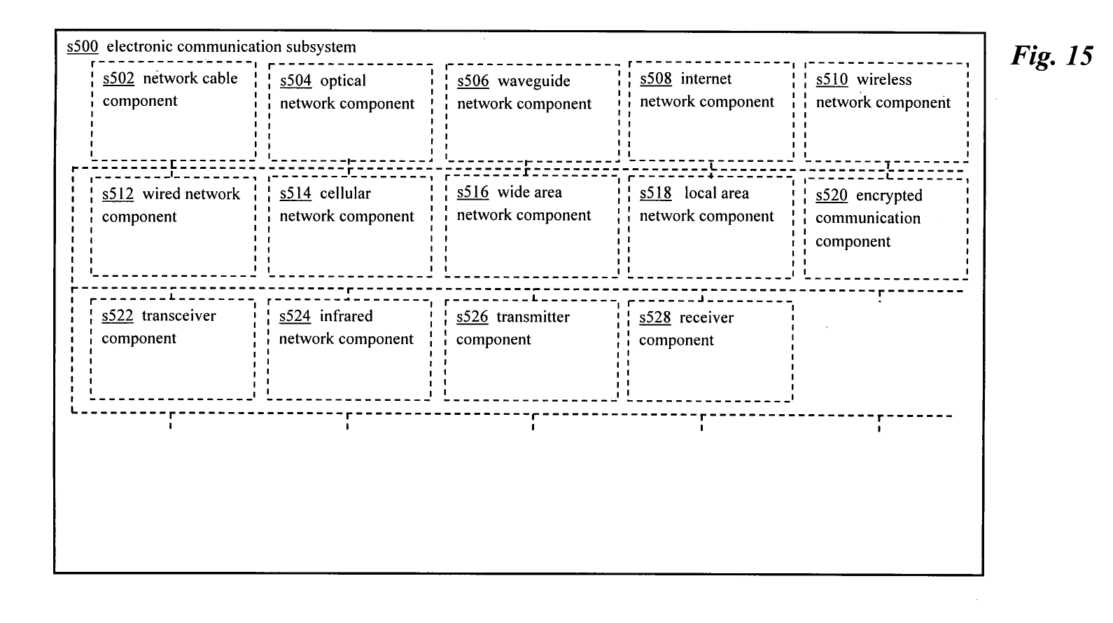

An exemplary implementation of the electronic communication subsystem s500 is shown in FIG. 15 to optionally include various components such as network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, and receiver component s528.

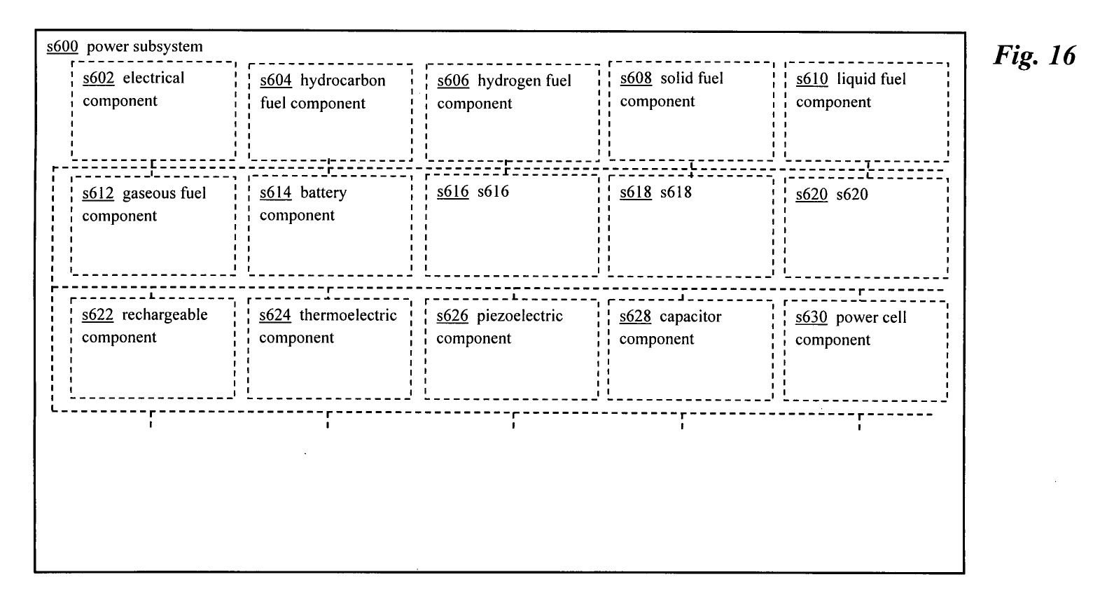

An exemplary implementation of the power subsystem s600 is shown in FIG. 16 to optionally include various components such as electrical component s602, hydrocarbon fuel component s604, hydrogen fuel component s606, solid fuel component s608, liquid fuel component s610, gaseous fuel component s612, battery component s614, battery component s622, battery component s624, battery component s626, battery component s628, and power cell component s630.

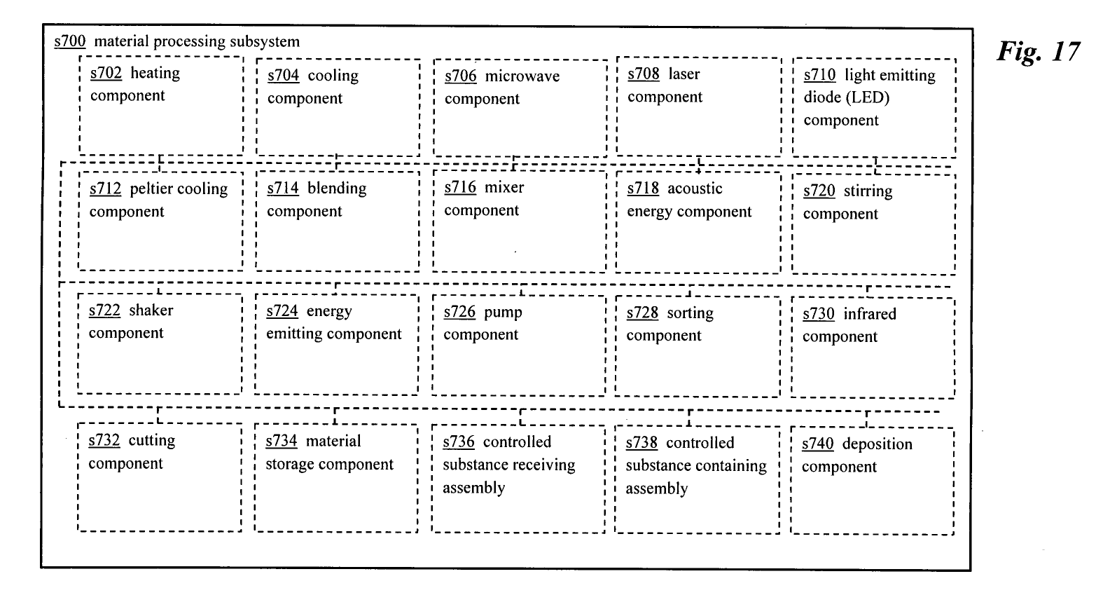

An exemplary implementation of the material processing subsystem s700 is shown in FIG. 17 to optionally include various components such as heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740.

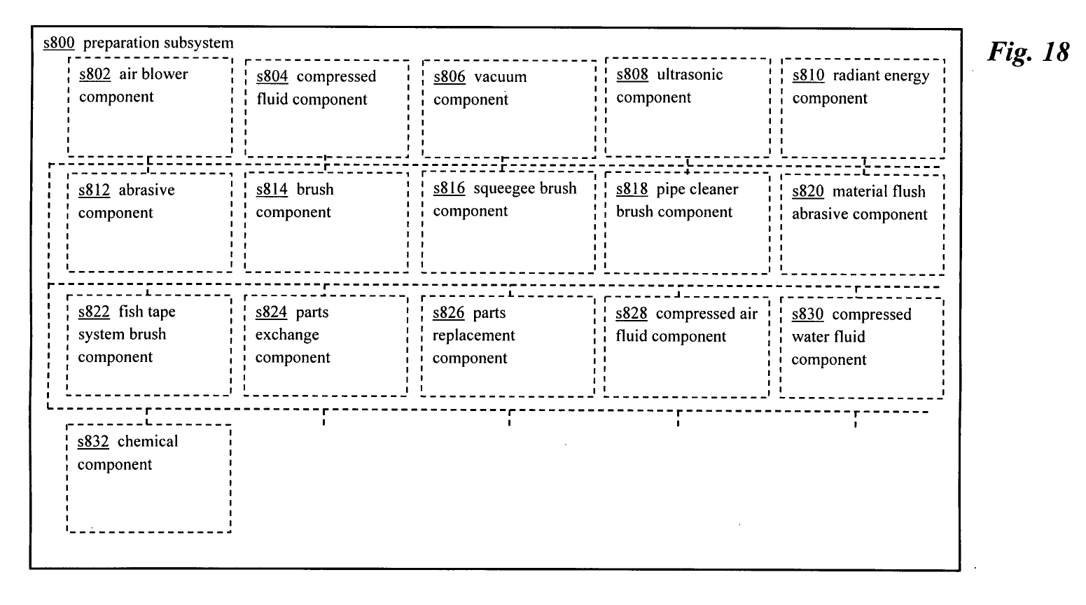

An exemplary implementation of the preparation subsystem s800 is shown in FIG. 18 to optionally include various components such as air blower component s802, compressed fluid component s804, vacuum component s806, ultrasonic component s808, radiant energy component s810, abrasive component s812, brush component s814, squeegee brush component s816, pipe cleaner brush component s818, material flush abrasive component s820, fish tape system brush component s822, parts exchange component s824, parts replacement component s826, compressed air fluid component s828, compressed water fluid component s830, and chemical component s832.

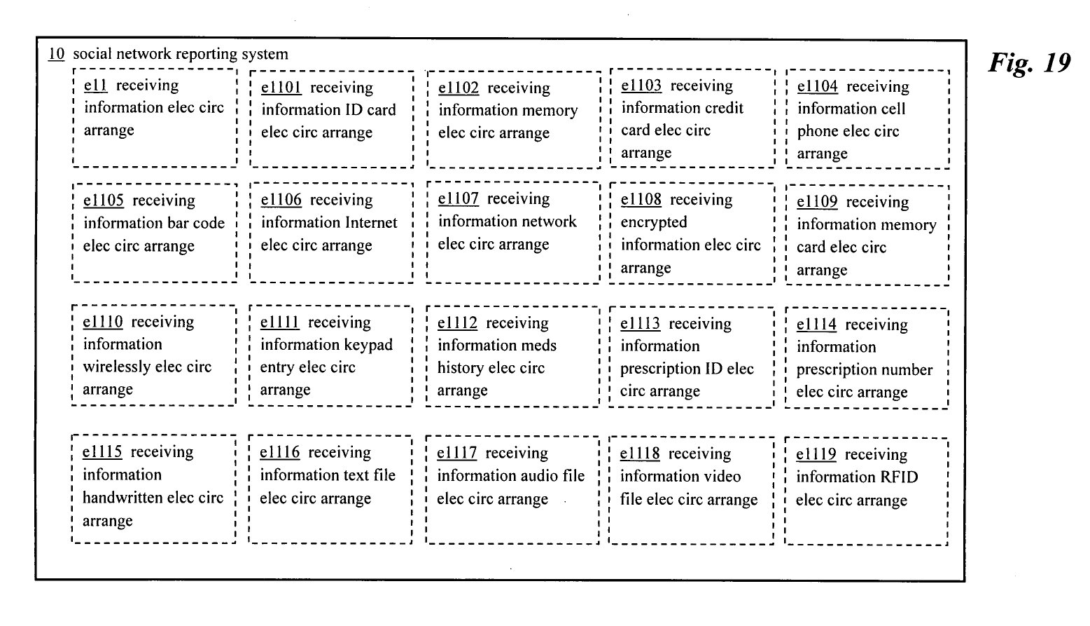

Implementations involve different combinations (otherwise known as “electrical circuitry arrangements”) of components from the subsystems of the social network reporting system 10. Exemplary depictions of some of these electrical circuitry arrangements are shown in FIG. 19 to include receiving information electrical circuitry arrangement ell, receiving information ID card electrical circuitry arrangement e1101, receiving information memory electrical circuitry arrangement e1102, receiving information credit card electrical circuitry arrangement e1103, receiving information cell phone electrical circuitry arrangement e1104, receiving information bar code electrical circuitry arrangement e1105, receiving information Internet electrical circuitry arrangement e1106, receiving information network electrical circuitry arrangement e1107, receiving encrypted information electrical circuitry arrangement e1108, receiving information memory card electrical circuitry arrangement e1109, receiving information wirelessly electrical circuitry arrangement e1110, receiving information keypad entry electrical circuitry arrangement e1111, receiving information meds history electrical circuitry arrangement e1112, receiving information prescription ID electrical circuitry arrangement e1113, receiving information prescription number electrical circuitry arrangement e1114, receiving information handwritten electrical circuitry arrangement e1115, receiving information text file electrical circuitry arrangement e1116, receiving information audio file electrical circuitry arrangement e1117, receiving information video file electrical circuitry arrangement e1118, and receiving information RFID electrical circuitry arrangement e1119.

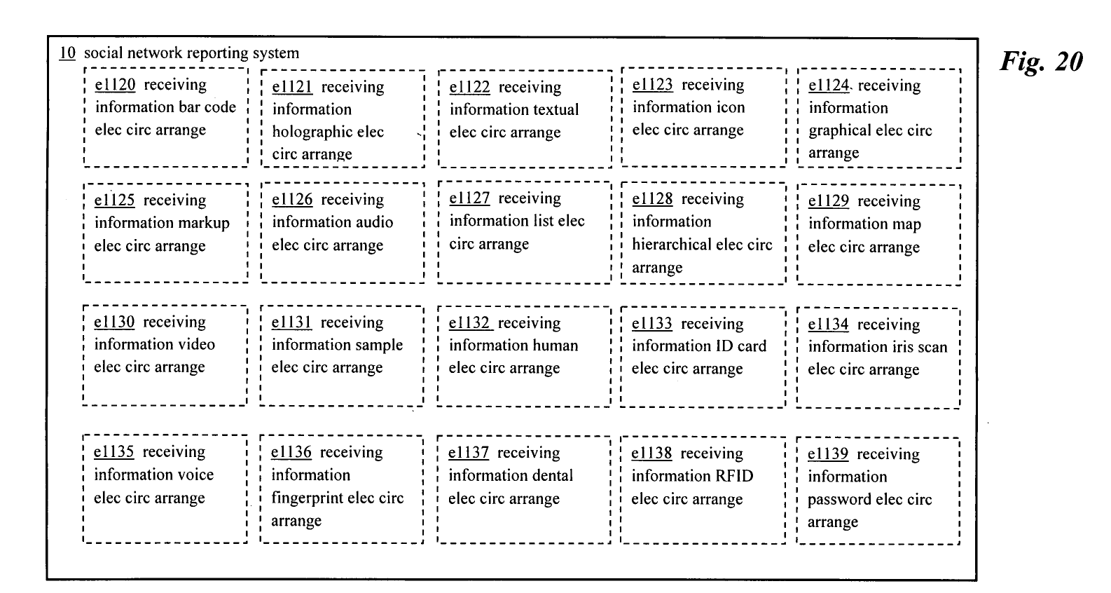

Some of these electrical circuitry arrangements are depicted in FIG. 20 to include receiving information bar code electrical circuitry arrangement e1120, receiving information holographic electrical circuitry arrangement e1121, receiving information textual electrical circuitry arrangement e1122, receiving information icon electrical circuitry arrangement e1123, receiving information graphical electrical circuitry arrangement e1124, receiving information markup electrical circuitry arrangement e1125, receiving information audio electrical circuitry arrangement e1126, receiving information list electrical circuitry arrangement e1127, receiving information hierarchical electrical circuitry arrangement e1128, receiving information map electrical circuitry arrangement e1129, receiving information video electrical circuitry arrangement e1130, receiving information sample electrical circuitry arrangement e113, receiving information human electrical circuitry arrangement e1132, receiving information ID card electrical circuitry arrangement e1133, receiving information iris scan electrical circuitry arrangement e1134, receiving information voice electrical circuitry arrangement e1135, receiving information fingerprint electrical circuitry arrangement e1136, receiving information dental electrical circuitry arrangement e1137, receiving information RFID electrical circuitry arrangement e1138, and receiving information password electrical circuitry arrangement e1139.

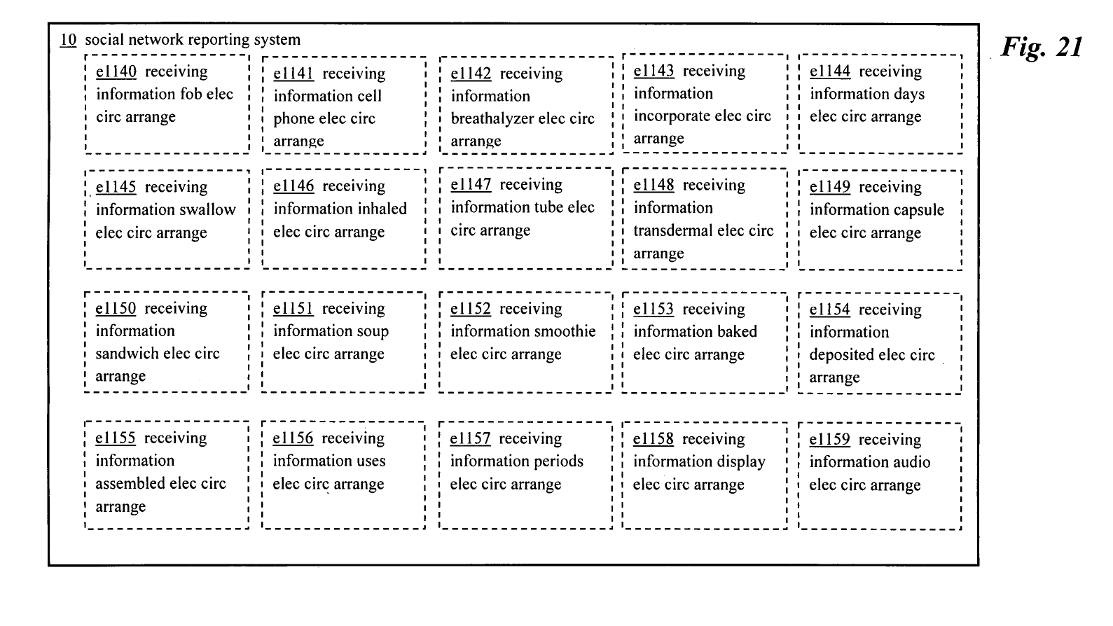

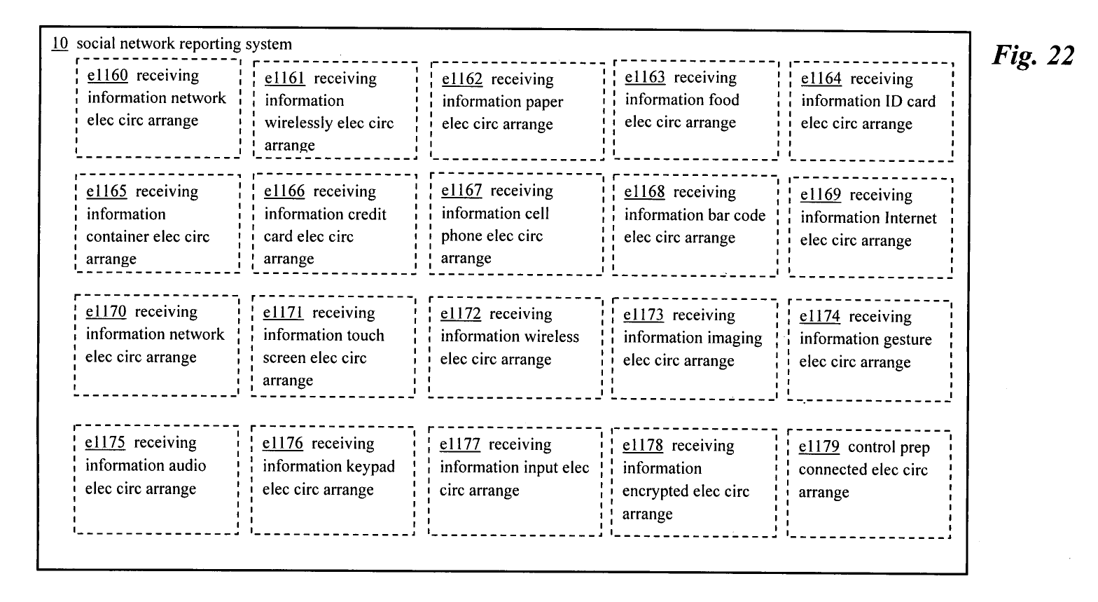

Some of these electrical circuitry arrangements are depicted in FIG. 21 to include receiving information fob electrical circuitry arrangement e1140, receiving information cell phone electrical circuitry arrangement e1141, receiving information breathalyzer electrical circuitry arrangement e1142, receiving information incorporate electrical circuitry arrangement e1143, receiving information days electrical circuitry arrangement e1144, receiving information swallow electrical circuitry arrangement e1145, receiving information inhaled electrical circuitry arrangement e1146, receiving information tube electrical circuitry arrangement e1147, receiving information transdermal electrical circuitry arrangement e1148, receiving information capsule electrical circuitry arrangement e1149, receiving information sandwich electrical circuitry arrangement e1150, receiving information soup electrical circuitry arrangement e1151, receiving information smoothie electrical circuitry arrangement e1152, receiving information baked electrical circuitry arrangement e1153, receiving information deposited electrical circuitry arrangement e1154, receiving information assembled electrical circuitry arrangement e1155, receiving information uses electrical circuitry arrangement e1156, receiving information periods electrical circuitry arrangement e1157, receiving information display electrical circuitry arrangement e1158, and receiving information audio electrical circuitry arrangement e1159.

Some of these electrical circuitry arrangements are depicted in FIG. 22 to include receiving information network electrical circuitry arrangement e1160, receiving information wirelessly electrical circuitry arrangement e1161, receiving information paper electrical circuitry arrangement e1162, receiving information food electrical circuitry arrangement e1163, receiving information ID card electrical circuitry arrangement e1164, receiving information container electrical circuitry arrangement e1165, and receiving information credit card electrical circuitry arrangement e1166, receiving information cell phone electrical circuitry arrangement e1167, receiving information bar code electrical circuitry arrangement e1168, receiving information Internet electrical circuitry arrangement e1169, receiving information network electrical circuitry arrangement e1170, receiving information touch screen electrical circuitry arrangement e1171, receiving information wireless electrical circuitry arrangement e1172, receiving information imaging electrical circuitry arrangement e1173, receiving information gesture electrical circuitry arrangement e1174, receiving information audio electrical circuitry arrangement e1175, receiving information keypad electrical circuitry arrangement e1176, receiving information input electrical circuitry arrangement e1177, receiving information encrypted electrical circuitry arrangement e1178, and control prep connected electrical circuitry arrangement e1179.

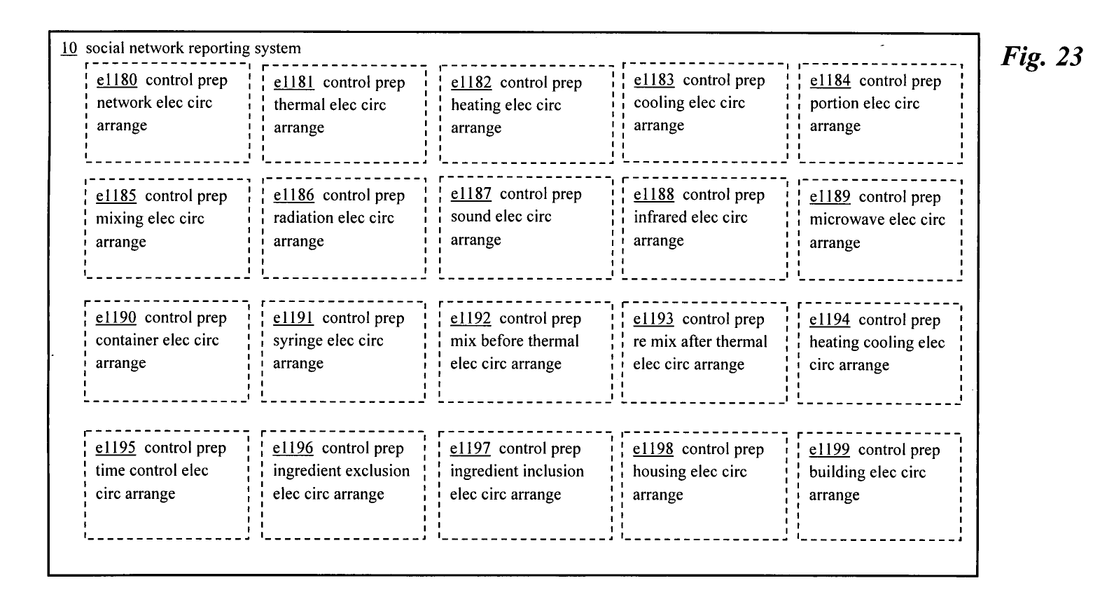

Some of these electrical circuitry arrangements are depicted in FIG. 23 to include control prep network electrical circuitry arrangement e1180, control prep thermal electrical circuitry arrangement e1181, control prep heating electrical circuitry arrangement e1182, control prep cooling electrical circuitry arrangement e1183, control prep portion electrical circuitry arrangement e1184, control prep mixing electrical circuitry arrangement e1185, and control prep radiation electrical circuitry arrangement e1186, control prep sound electrical circuitry arrangement e1187, control prep infrared electrical circuitry arrangement e1188, control prep microwave electrical circuitry arrangement e1189, control prep container electrical circuitry arrangement e1190, control prep syringe electrical circuitry arrangement e1191, control prep mix before thermal electrical circuitry arrangement e1192, control prep re mix after thermal electrical circuitry arrangement e1193, control prep heating cooling electrical circuitry arrangement e1194, control prep time control electrical circuitry arrangement e1195, control prep ingredient exclusion electrical circuitry arrangement e1196, control prep ingredient inclusion electrical circuitry arrangement e1197, control prep housing electrical circuitry arrangement e1198, and control prep building electrical circuitry arrangement e1199.

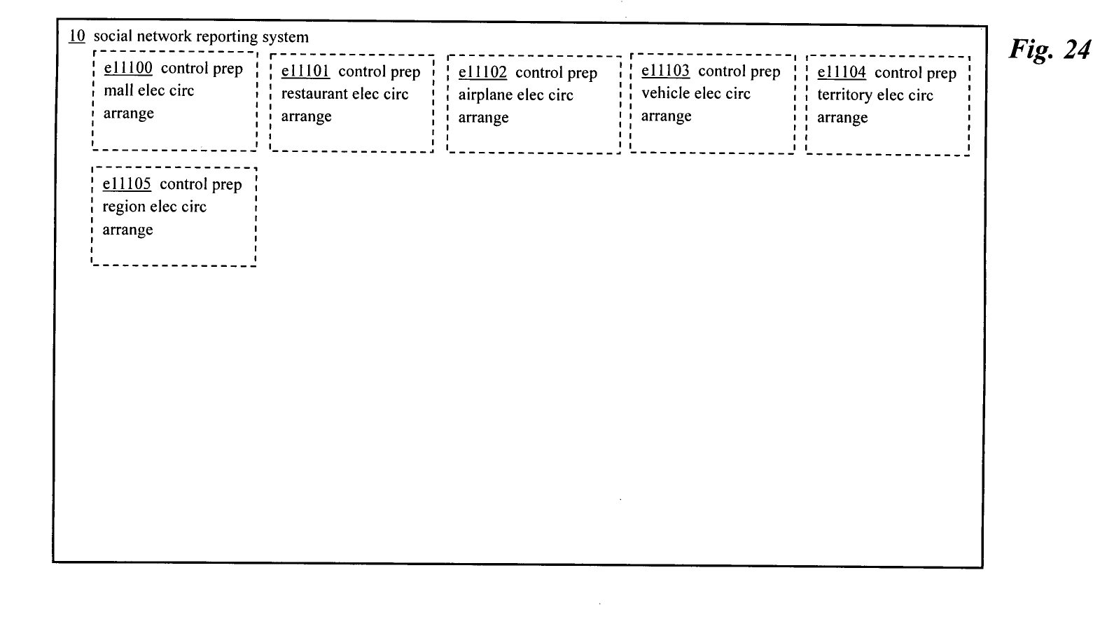

Some of these electrical circuitry arrangements are depicted in FIG. 24 to include control prep mall electrical circuitry arrangement e11100, control prep restaurant electrical circuitry arrangement e11101, control prep airplane electrical circuitry arrangement e11102, control prep vehicle electrical circuitry arrangement e11103, control prep territory electrical circuitry arrangement e11104, and control prep region electrical circuitry arrangement e11105.

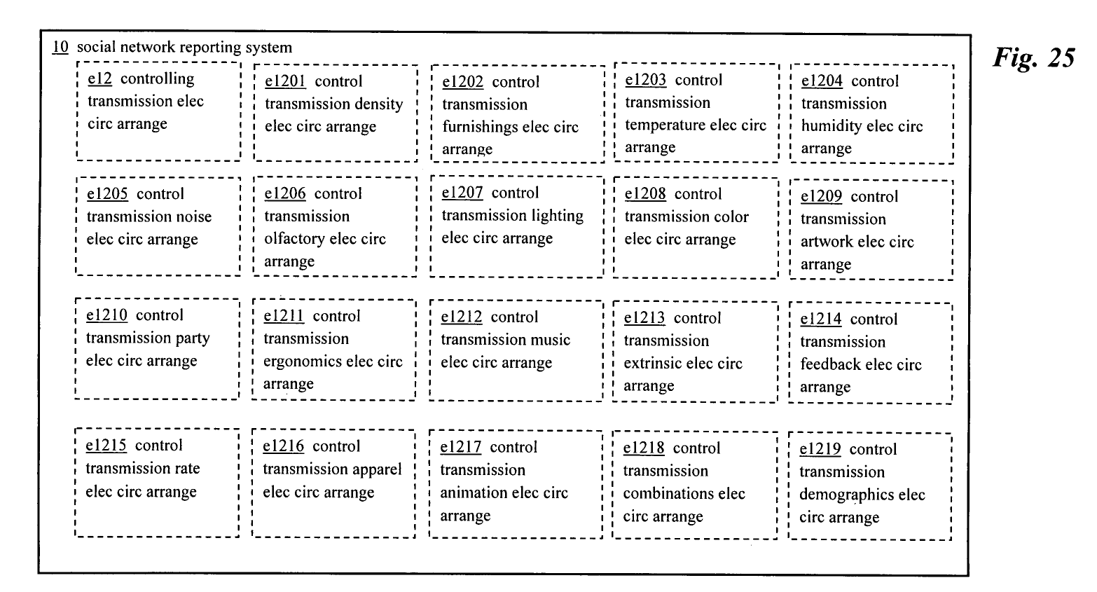

Some of these electrical circuitry arrangements are depicted in FIG. 25 to include controlling transmission electrical circuitry arrangement e12, control transmission density electrical circuitry arrangement e1201, control transmission furnishings electrical circuitry arrangement e1202, control transmission temperature electrical circuitry arrangement e1203, control transmission humidity electrical circuitry arrangement e1204, control transmission noise electrical circuitry arrangement e1205, control transmission olfactory electrical circuitry arrangement e1206, control transmission lighting electrical circuitry arrangement e1207, control transmission color electrical circuitry arrangement e1208, control transmission artwork electrical circuitry arrangement e1209, control transmission party electrical circuitry arrangement e1210, control transmission ergonomics electrical circuitry arrangement e1211, and control transmission music electrical circuitry arrangement e1212, control transmission extrinsic electrical circuitry arrangement e1213, control transmission feedback electrical circuitry arrangement e1214, control transmission rate electrical circuitry arrangement e1215, control transmission apparel electrical circuitry arrangement e1216, control transmission animation electrical circuitry arrangement e1217, control transmission combinations electrical circuitry arrangement e1218, and control transmission demographics electrical circuitry arrangement e1219.

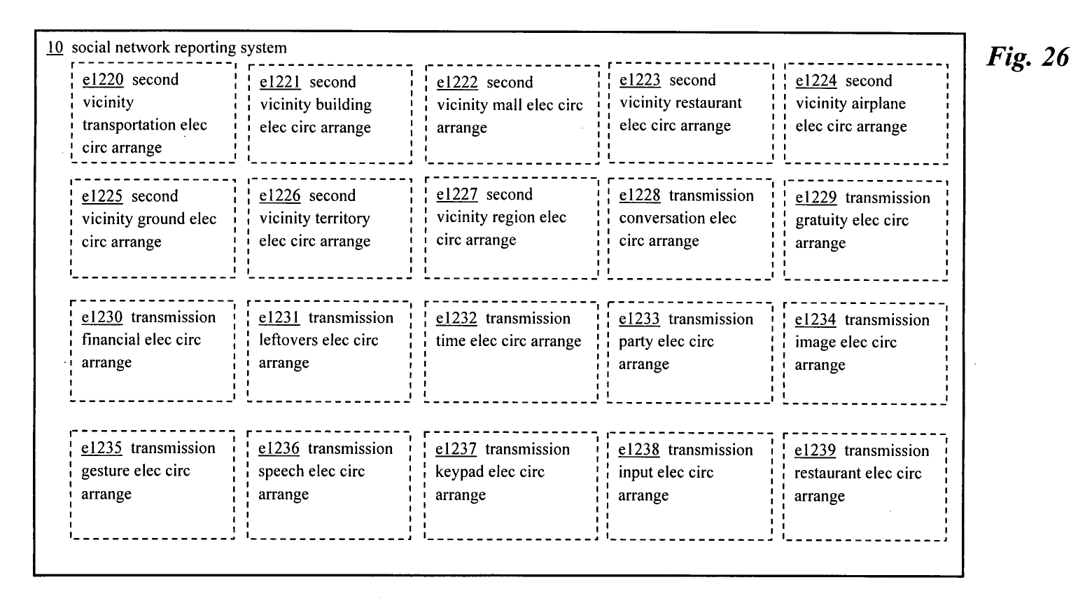

Some of these electrical circuitry arrangements are depicted in FIG. 26 to include second vicinity transportation electrical circuitry arrangement e12, second vicinity building electrical circuitry arrangement e1221, second vicinity mall electrical circuitry arrangement e1222, second vicinity restaurant electrical circuitry arrangement e1223, second vicinity airplane electrical circuitry arrangement e1224, second vicinity ground electrical circuitry arrangement e1225, second vicinity territory electrical circuitry arrangement e1226, second vicinity region electrical circuitry arrangement e1227, transmission conversation electrical circuitry arrangement e1228, transmission gratuity electrical circuitry arrangement e1229, transmission financial electrical circuitry arrangement e1230, transmission leftovers electrical circuitry arrangement e1231, and transmission time electrical circuitry arrangement e1232, transmission party electrical circuitry arrangement e1233, transmission image electrical circuitry arrangement e1234, transmission gesture electrical circuitry arrangement e1235, transmission speech electrical circuitry arrangement e1236, transmission keypad electrical circuitry arrangement e1237, transmission input electrical circuitry arrangement e1238, and transmission restaurant electrical circuitry arrangement e1239.

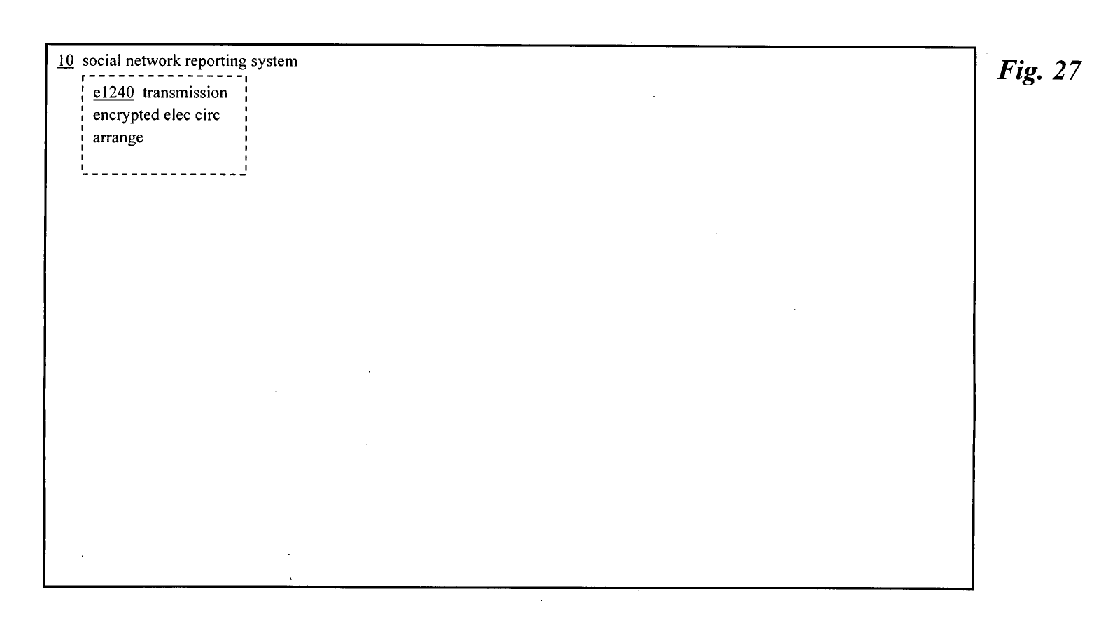

Some of these electrical circuitry arrangements are depicted in FIG. 27 to include transmission encrypted electrical circuitry arrangement e1240.

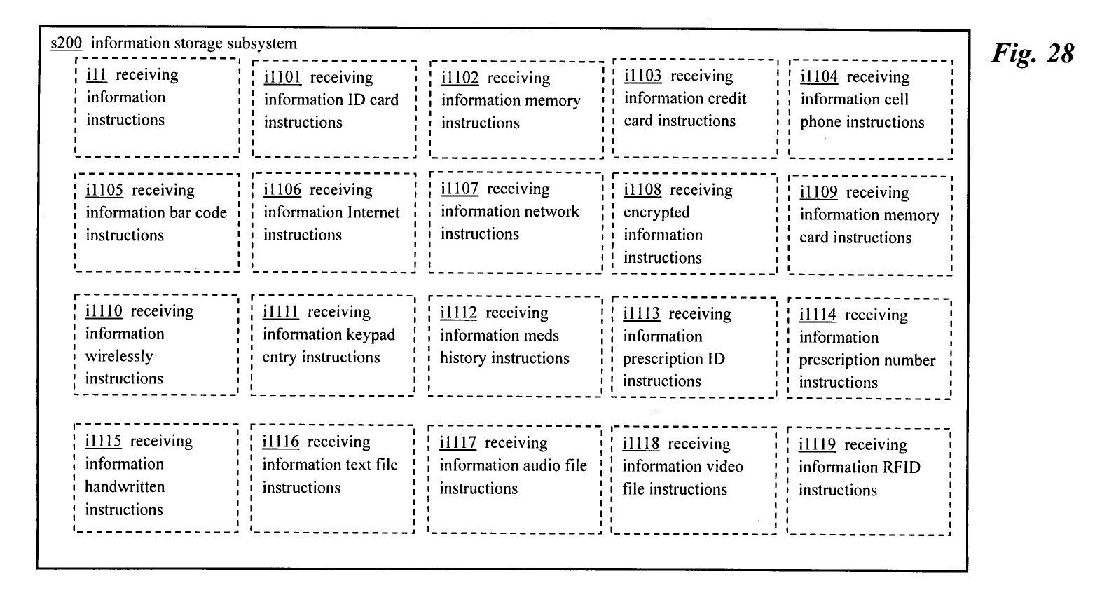

In implementations one or more instructions are stored and/or otherwise borne in various subsystems, components, and/or accessories of the social network reporting system 10 such as being borne in a non-transitory signal bearing medium of information storage subsystem s200. One or more exemplary instructions depicted in FIG. 28 as being borne in an exemplary version of a non-transitory signal bearing medium of information storage subsystem s200 include one or more receiving information instructions i11, one or more receiving information ID card instructions i1101, one or more receiving information memory instructions i1102, one or more receiving information credit card instructions i1103, one or more receiving information cell phone instructions i1104, one or more receiving information bar code instructions i1105, one or more receiving information Internet instructions i1106, one or more receiving information network instructions i1107, one or more receiving encrypted information instructions i1108, one or more receiving information memory card instructions i1109, one or more receiving information wirelessly instructions i1110, one or more receiving information keypad entry instructions i1111, one or more receiving information meds history instructions i1112, one or more receiving information prescription ID instructions i1113, one or more receiving information prescription number instructions i1114, one or more receiving information handwritten instructions i1115, one or more receiving information text file instructions i1116, one or more receiving information audio file instructions i1117, one or more receiving information video file instructions i1118, and one or more receiving information RFID instructions i1119.

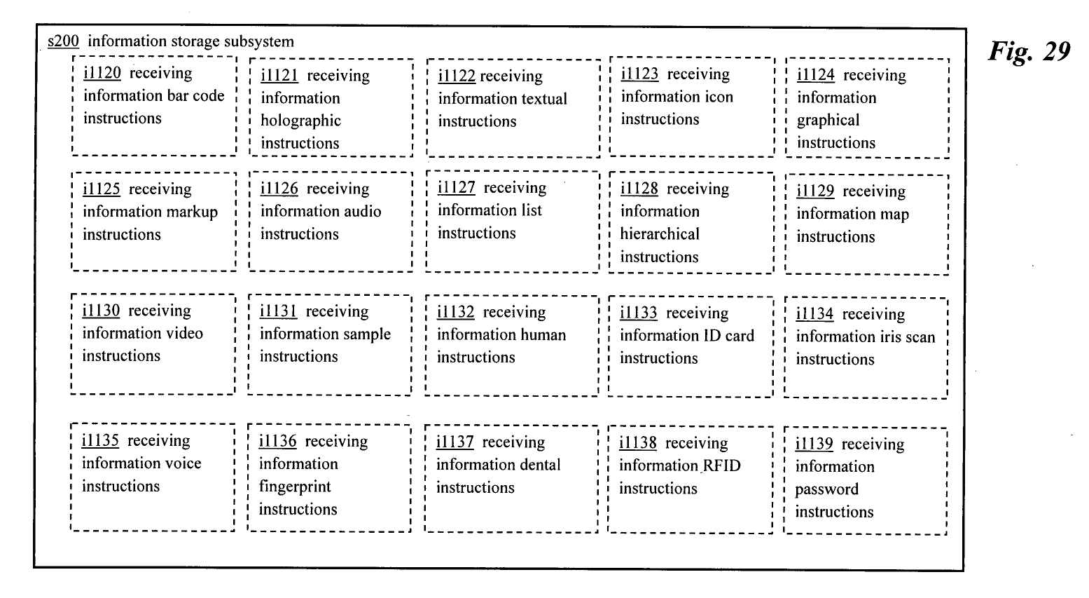

One or more exemplary instructions depicted in FIG. 29 as being borne in an exemplary version of a non-transitory signal bearing medium of information storage subsystem s200 include one or more receiving information bar code instructions i1120, one or more receiving information holographic instructions i1121, one or more receiving information textual instructions i1122, one or more receiving information icon instructions i1123, one or more receiving information graphical instructions i1124, one or more receiving information markup instructions i1125, one or more receiving information audio instructions i1126, one or more receiving information list instructions i1127, one or more receiving information hierarchical instructions i1128, one or more receiving information map instructions i1129, one or more receiving information video instructions i1130, one or more receiving information sample instructions i1131, one or more receiving information human instructions i1132, one or more receiving information ID card instructions i1133, one or more receiving information iris scan instructions i1134, one or more receiving information voice instructions i1135, one or more receiving information fingerprint instructions i1136, one or more receiving information dental instructions i1137, one or more receiving information RFID instructions i1138, and one or more receiving information password instructions i1139.

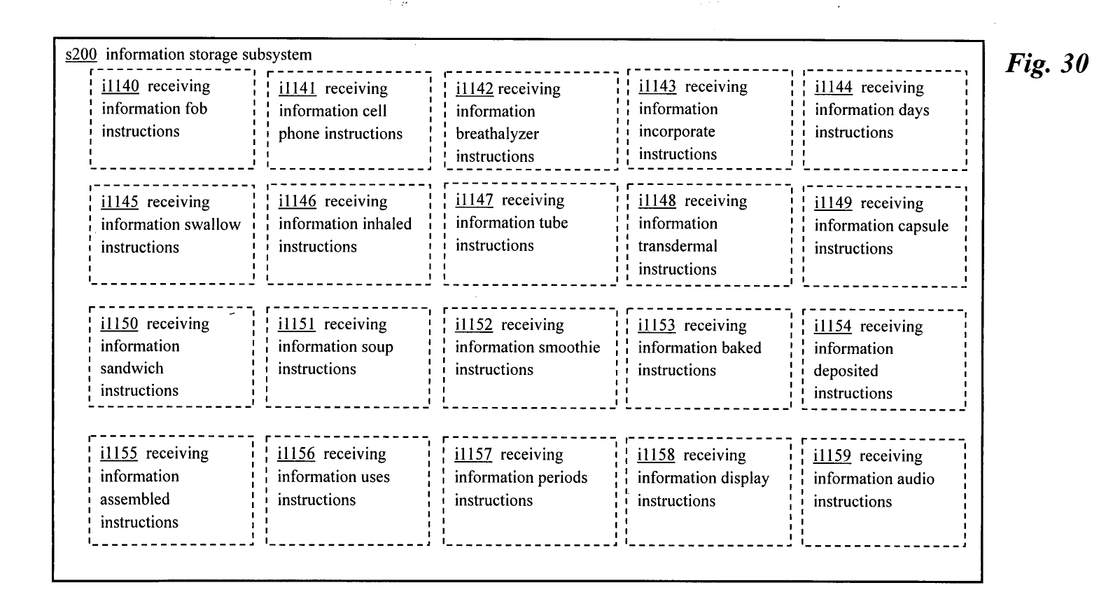

One or more exemplary instructions depicted in FIG. 30 as being borne in an exemplary version of a non-transitory signal bearing medium of information storage subsystem s200 include one or more receiving information fob instructions i1140, one or more receiving information cell phone instructions i1141, one or more receiving information breathalyzer instructions i1142, one or more receiving information incorporate instructions i1143, one or more receiving information days instructions i1144, one or more receiving information swallow instructions i1145, one or more receiving information inhaled instructions i1146, one or more receiving information tube instructions i1147, one or more receiving information transdermal instructions i1148, one or more receiving information capsule instructions i1149, one or more receiving information sandwich instructions i1150, one or more receiving information soup instructions i1151, one or more receiving information smoothie instructions i1152, one or more receiving information baked instructions i1153, one or more receiving information deposited instructions i1154, one or more receiving information assembled instructions i1155, one or more receiving information uses instructions i1156, one or more receiving information periods instructions i1157, one or more receiving information display instructions i1158, and one or more receiving information audio instructions i1159.

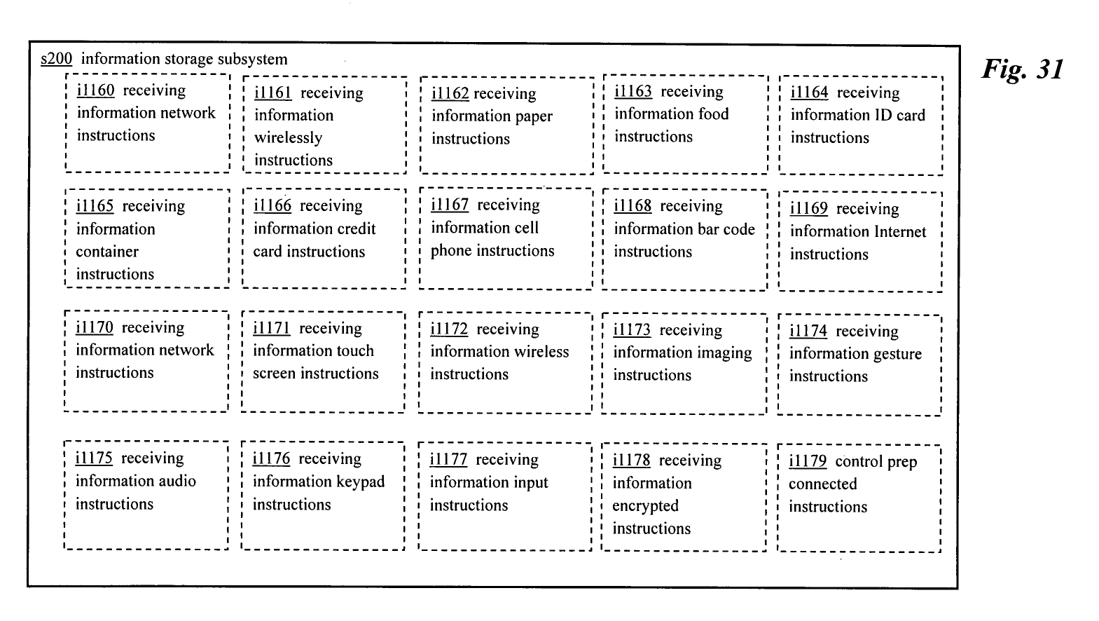

One or more exemplary instructions depicted in FIG. 31 as being borne in an exemplary version of a non-transitory signal bearing medium of information storage subsystem s200 include one or more receiving information network instructions i1160, one or more receiving information wirelessly instructions i1161, one or more receiving information paper instructions i1162, one or more receiving information food instructions i1163, one or more receiving information ID card instructions i1164, one or more receiving information container instructions i1165, and one or more receiving information credit card instructions i1166, one or more receiving information cell phone instructions i1167, one or more receiving information bar code instructions i1168, one or more receiving information Internet instructions i1169, one or more receiving information network instructions i1170, one or more receiving information touch screen instructions i1171, one or more receiving information wireless instructions i1172, one or more receiving information imaging instructions i1173, one or more receiving information gesture instructions i1174, one or more receiving information audio instructions i1175, one or more receiving information keypad instructions i1176, one or more receiving information input instructions i1177, one or more receiving information encrypted instructions i1178, and one or more control prep connected instructions i1179.

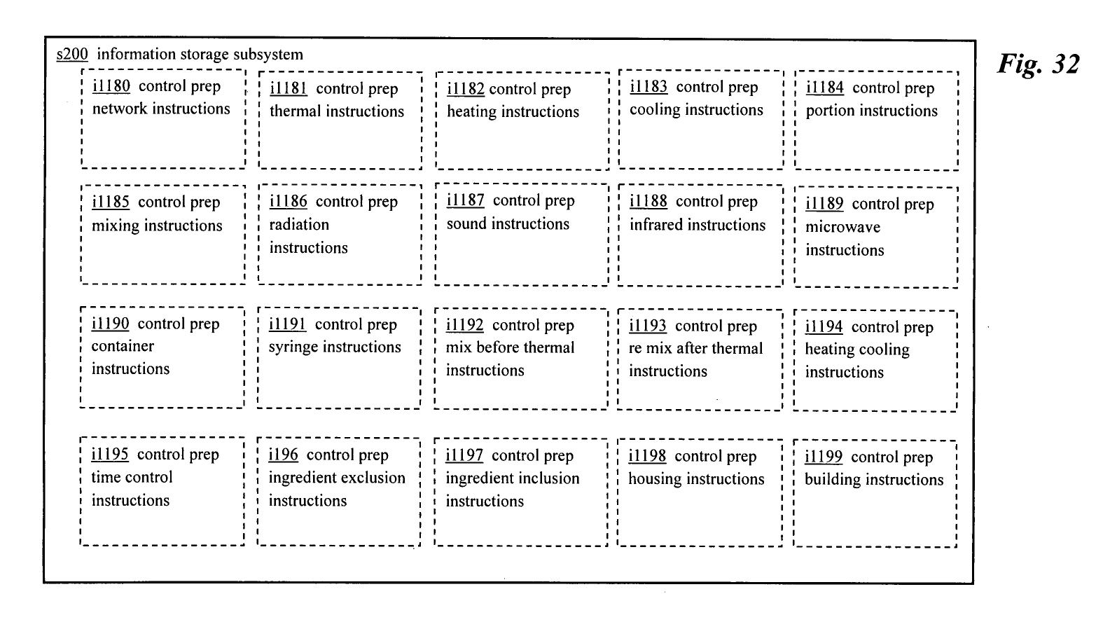

One or more exemplary instructions depicted in FIG. 32 as being borne in an exemplary version of a non-transitory signal bearing medium of information storage subsystem s200 include one or more control prep network instructions i1180, one or more control prep thermal instructions i1181, one or more control prep heating instructions i1182, one or more control prep cooling instructions i1183, one or more control prep portion instructions i1184, one or more control prep mixing instructions i1185, and one or more control prep radiation instructions i1186, one or more control prep sound instructions i1187, one or more control prep infrared instructions i1188, one or more control prep microwave instructions i1189, one or more control prep container instructions i1190, one or more control prep syringe instructions i1191, one or more control prep mix before thermal instructions i1192, one or more control prep re mix after thermal instructions i1193, one or more control prep heating cooling instructions i1194, one or more control prep time control instructions i1195, one or more control prep ingredient exclusion instructions i1196, one or more control prep ingredient inclusion instructions i1197, one or more control prep housing instructions i1198, and one or more control prep building instructions i1199.

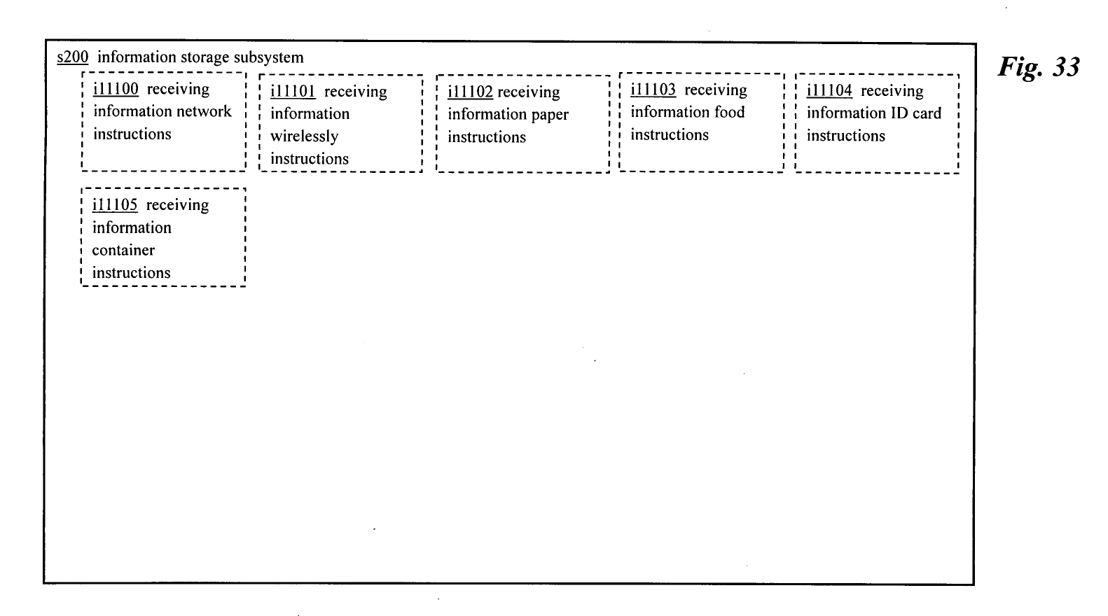

One or more exemplary instructions depicted in FIG. 33 as being borne in an exemplary version of a non-transitory signal bearing medium of information storage subsystem s200 include one or more control prep mall instructions i11100, one or more control prep restaurant instructions i11101, one or more control prep airplane instructions i11102, one or more control prep vehicle instructions i11103, one or more control prep territory instructions i11104, and one or more control prep region instructions i11105.

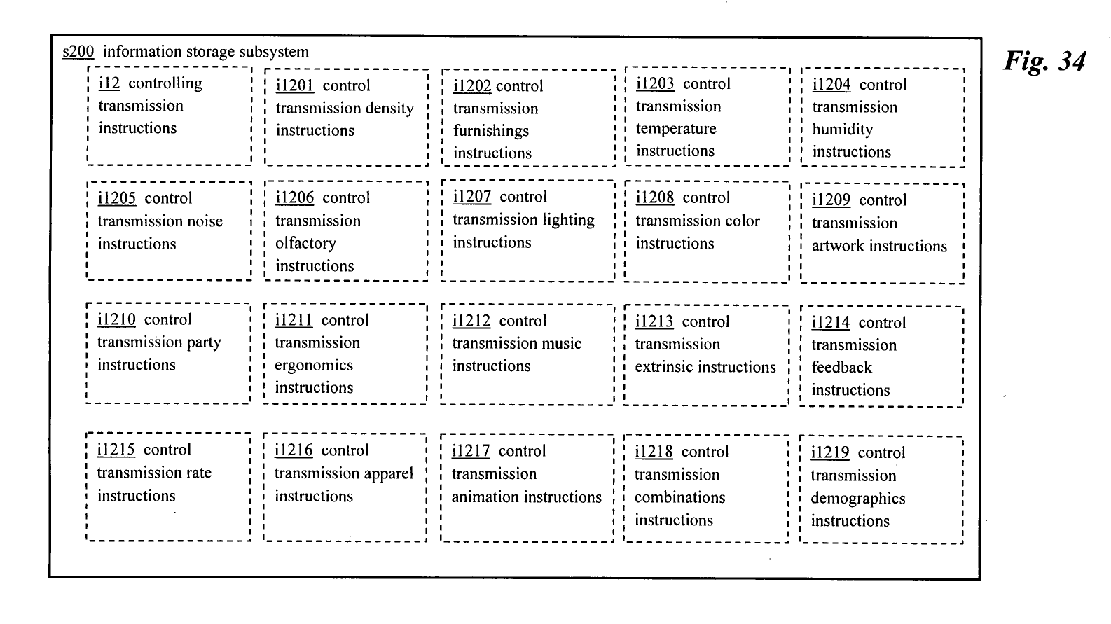

One or more exemplary instructions depicted in FIG. 34 as being borne in an exemplary version of a non-transitory signal bearing medium of information storage subsystem s200 include one or more controlling transmission instructions i12, one or more control transmission density instructions i1201, one or more control transmission furnishings instructions i1202, one or more control transmission temperature instructions i1203, one or more control transmission humidity instructions i1204, one or more control transmission noise instructions i1205, one or more control transmission olfactory instructions i1206, one or more control transmission lighting instructions i1207, one or more control transmission color instructions i1208, one or more control transmission artwork instructions i1209, one or more control transmission party instructions i1210, one or more control transmission ergonomics instructions i1211, one or more control transmission music instructions i1212, one or more control transmission extrinsic instructions i1213, one or more control transmission feedback instructions i1214, one or more control transmission rate instructions i1215, one or more control transmission apparel instructions i1216, one or more control transmission animation instructions i1217, one or more control transmission combinations instructions i1218, and one or more control transmission demographics instructions i1219.

One or more exemplary instructions depicted in FIG. 34 as being borne in an exemplary version of a non-transitory signal bearing medium of information storage subsystem s200 include one or more second vicinity transportation instructions i1220, one or more second vicinity building instructions i1221, one or more second vicinity mall instructions i1222, one or more second vicinity restaurant instructions i1223, one or more second vicinity airplane instructions i1224, one or more second vicinity ground instructions i1225, one or more second vicinity territory instructions i1226, one or more second vicinity region instructions i1227, one or more transmission conversation instructions i1228, one or more transmission gratuity instructions i1229, one or more transmission financial instructions i1230, one or more transmission leftovers instructions i1231, one or more transmission time instructions i1232, one or more transmission party instructions i1233, one or more transmission image instructions i1234, one or more transmission gesture instructions i1235, one or more transmission speech instructions i1236, one or more transmission keypad instructions i1237, one or more transmission input instructions i1238, and one or more transmission restaurant instructions i1239.

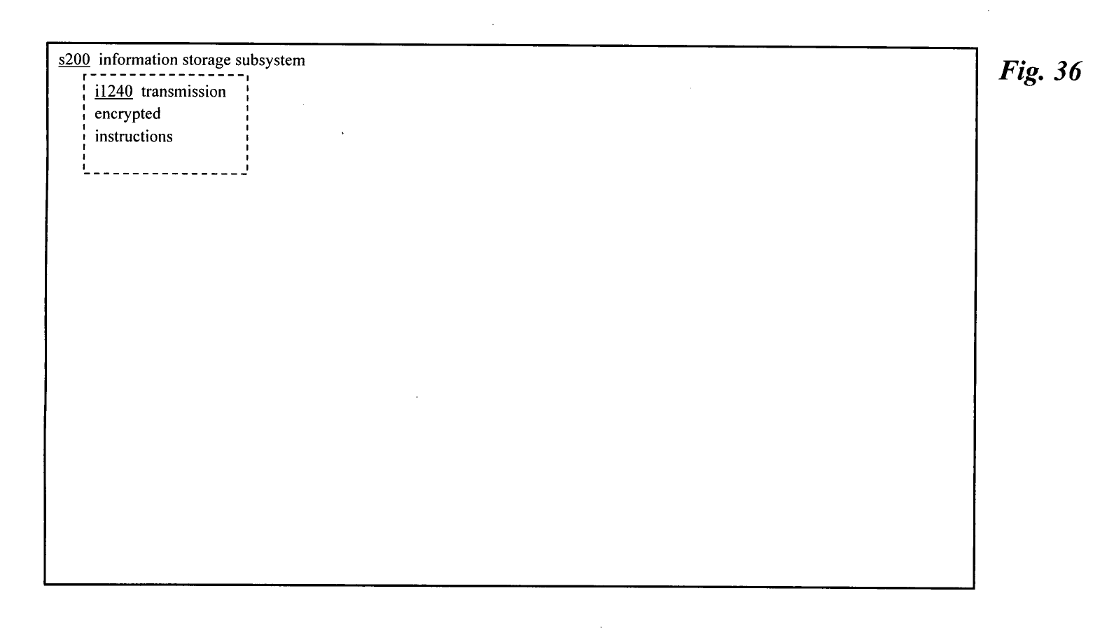

One or more exemplary instructions depicted in FIG. 36 as being borne in an exemplary version of a non-transitory signal bearing medium of information storage subsystem s200 include one or more controlling transmission instructions i1240.

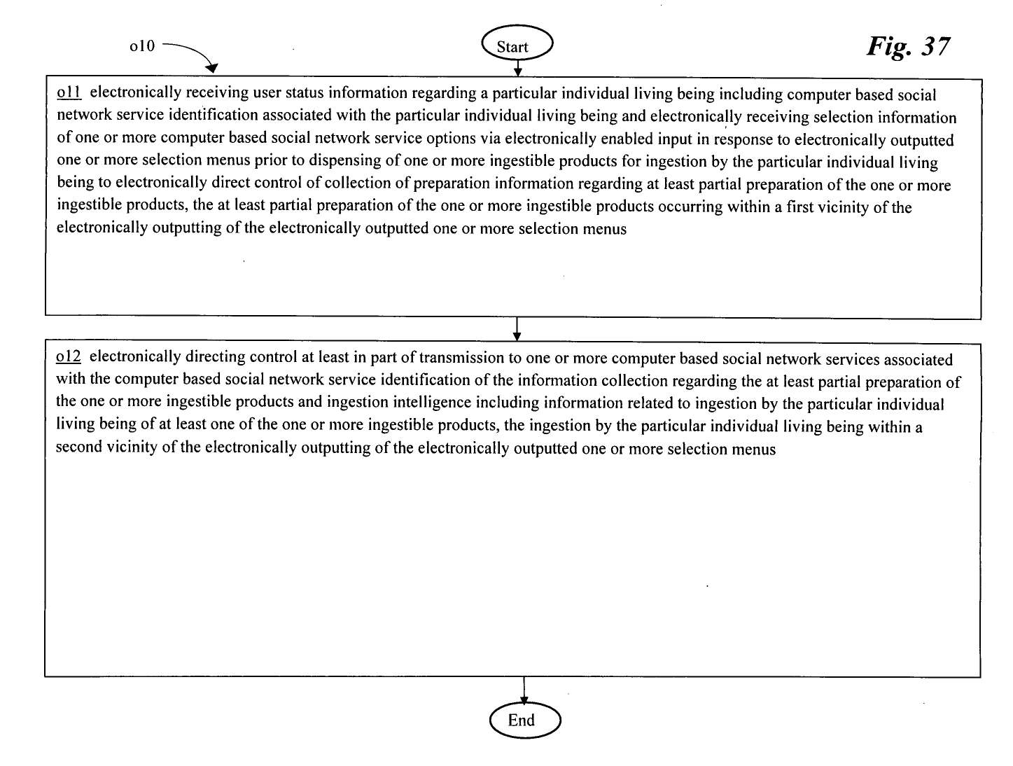

An operational flow o10 as shown in FIG. 37 represents example operations related to electronically receiving user status information regarding a particular individual living being including computer based social network service identification associated with the particular individual living being and electronically receiving selection information of one or more computer based social network service options via electronically enabled input in response to electronically outputted one or more selection menus prior to dispensing of one or more ingestible products for ingestion by the particular individual living being to electronically direct control of collection of preparation information regarding at least partial preparation of the one or more ingestible products, the at least partial preparation of the one or more ingestible products occurring within a first vicinity of the electronically outputting of the electronically outputted one or more selection menus and electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus.

FIG. 37 and those figures that follow may have various examples of operational flows, and explanation may be provided with respect to the above-described examples of FIGS. 1-7 and/or with respect to other examples and contexts. Nonetheless, it should be understood that the operational flows may be executed in a number of other environments and contexts, and/or in modified versions of FIGS. 1-7. Furthermore, although the various operational flows are presented in the sequence(s) illustrated, it should be understood that the various operations may be performed in other orders than those which are illustrated, or may be performed concurrently.

In FIG. 37 and those figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

As shown in FIG. 37, the operational flow o10 proceeds to operation o11 for electronically receiving user status information regarding a particular individual living being including computer based social network service identification associated with the particular individual living being and electronically receiving selection information of one or more computer based social network service options via electronically enabled input in response to electronically outputted one or more selection menus prior to dispensing of one or more ingestible products for ingestion by the particular individual living being to electronically direct control of collection of preparation information regarding at least partial preparation of the one or more ingestible products, the at least partial preparation of the one or more ingestible products occurring within a first vicinity of the electronically outputting of the electronically outputted one or more selection menus. An exemplary version of a non-transitory signal bearing medium of information storage subsystem s200 is depicted as bearing one or more receiving information instructions i11 that when executed will direct performance of the operation o11. In an implementation, the one or more receiving information instructions i11 when executed direct electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) user status information (e.g. one or more of user identification, user security access information, user affiliation information, use history, user type, user preferences, associates of user, etc.) regarding a particular individual living being (e.g. one of more of a consumer, a gourmand, a hobbyist, an athlete, a student, a dieter, a patient, an animal, an inmate, a health seeker, a worker, a pedestrian, etc.) including computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) associated with the particular individual living being (e.g. one of more of a consumer, a gourmand, a hobbyist, an athlete, a student, a dieter, a patient, an animal, an inmate, a health seeker, a worker, a pedestrian, etc.) and electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) selection information (e.g. information related to user completion of one or more checkboxes, button activations, blank fill-ins, voice input data, text data, gesture data, hand operated input data, touch data, eye tracking data, database data, etc.) of one or more computer-based social network service options (e.g. options related to affiliations, interest groups, forums, contacts, chat rooms, social networking websites, feature opt outs, private groups, blog posts, reporting options, friends selection, privacy selections, etc.) via electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) prior to dispensing (e.g. through use of one or more of the following types: automated, wait staff, pre-packaged, deli, vending machine, counter selection, on site fabrication, conveyor, lazy susan, buffet, sit-down, street stand, mobile truck, cafe, mart, etc.) of one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) for ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of preparation information regarding at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) occurring within a first vicinity (e.g. such as within visual distance thereof, within audio distance thereof, within same interior space thereof, within same neighborhood thereof, within same geographical region thereof, etc.) of the electronically outputting of the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.). Furthermore, the receiving information electrical circuitry arrangement (“elec circ arrange”) ell when activated will perform the operation o11. In an implementation, the receiving information electrical circuitry arrangement ell, when activated performs electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) user status information (e.g. one or more of user identification, user security access information, user affiliation information, use history, user type, user preferences, associates of user, etc.) regarding a particular individual living being (e.g. one of more of a consumer, a gourmand, a hobbyist, an athlete, a student, a dieter, a patient, an animal, an inmate, a health seeker, a worker, a pedestrian, etc.) including computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) associated with the particular individual living being (e.g. one of more of a consumer, a gourmand, a hobbyist, an athlete, a student, a dieter, a patient, an animal, an inmate, a health seeker, a worker, a pedestrian, etc.) and electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) selection information (e.g. information related to user completion of one or more checkboxes, button activations, blank fill-ins, voice input data, text data, gesture data, hand operated input data, touch data, eye tracking data, database data, etc.) of one or more computer-based social network service options (e.g. options related to affiliations, interest groups, forums, contacts, chat rooms, social networking websites, feature opt outs, private groups, blog posts, reporting options, friends selection, privacy selections, etc.) via electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) prior to dispensing (e.g. through use of one or more of the following types: automated, wait staff, pre-packaged, deli, vending machine, counter selection, on site fabrication, conveyor, lazy susan, buffet, sit-down, street stand, mobile truck, cafe, mart, etc.) of one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) for ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of preparation information regarding at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) occurring within a first vicinity (e.g. such as within visual distance thereof, within audio distance thereof, within same interior space thereof, within same neighborhood thereof, within same geographical region thereof, etc.) of the electronically outputting of the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.). In an implementation, the electronically receiving user status information regarding a particular individual living being including computer based social network service identification associated with the particular individual living being and electronically receiving selection information of one or more computer based social network service options via electronically enabled input in response to electronically outputted one or more selection menus prior to dispensing of one or more ingestible products for ingestion by the particular individual living being to electronically direct control of collection of preparation information regarding at least partial preparation of the one or more ingestible products, the at least partial preparation of the one or more ingestible products occurring within a first vicinity of the electronically outputting of the electronically outputted one or more selection menus is carried out by electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) user status information (e.g. one or more of user identification, user security access information, user affiliation information, use history, user type, user preferences, associates of user, etc.) regarding a particular individual living being (e.g. one of more of a consumer, a gourmand, a hobbyist, an athlete, a student, a dieter, a patient, an animal, an inmate, a health seeker, a worker, a pedestrian, etc.) including computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) associated with the particular individual living being (e.g. one of more of a consumer, a gourmand, a hobbyist, an athlete, a student, a dieter, a patient, an animal, an inmate, a health seeker, a worker, a pedestrian, etc.) and electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) selection information (e.g. information related to user completion of one or more checkboxes, button activations, blank fill-ins, voice input data, text data, gesture data, hand operated input data, touch data, eye tracking data, database data, etc.) of one or more computer-based social network service options (e.g. options related to affiliations, interest groups, forums, contacts, chat rooms, social networking websites, feature opt outs, private groups, blog posts, reporting options, friends selection, privacy selections, etc.) via electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) prior to dispensing (e.g. through use of one or more of the following types: automated, wait staff, pre-packaged, deli, vending machine, counter selection, on site fabrication, conveyor, lazy susan, buffet, sit-down, street stand, mobile truck, cafe, mart, etc.) of one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) for ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of preparation information regarding at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) occurring within a first vicinity (e.g. such as within visual distance thereof, within audio distance thereof, within same interior space thereof, within same neighborhood thereof, within same geographical region thereof, etc.) of the electronically outputting of the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.).

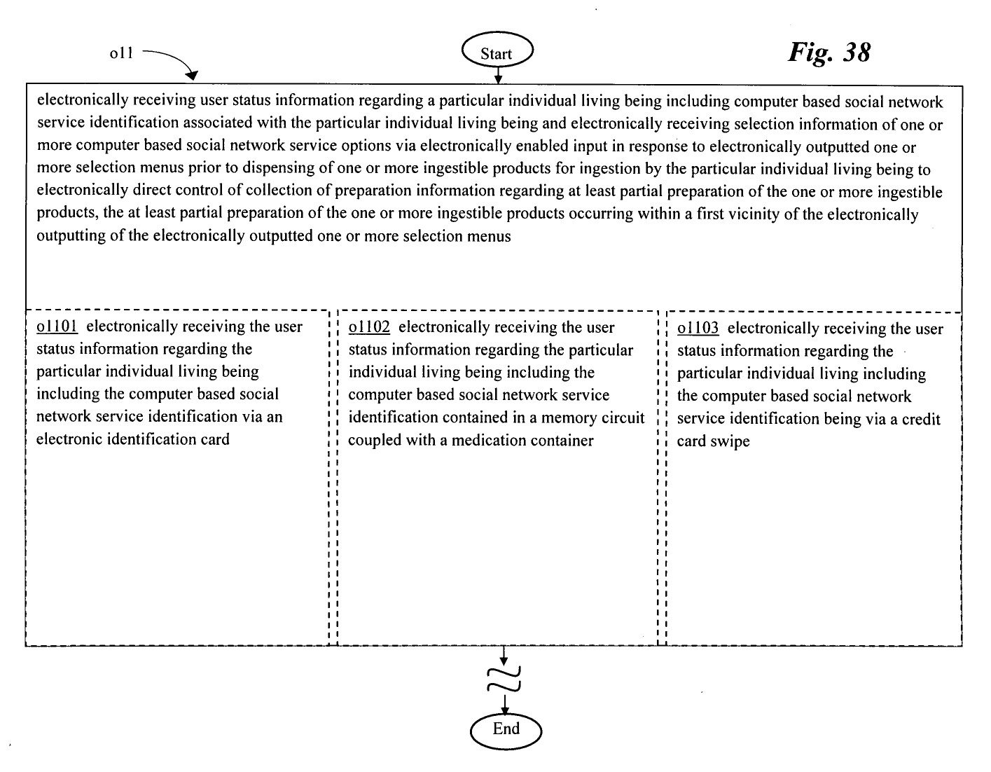

In one or more implementations, as shown in FIG. 38, operation o11 includes an operation o1101 for electronically receiving the user status information regarding the particular individual living being including the computer based social network service identification via an electronic identification card. Origination of an illustratively derived receiving information ID card component group can be accomplished through skilled in the art design choice selection of one or more of the above depicted components from one or more of the above depicted subsystems shown in FIG. 10. Components from the receiving information ID card component group can be used in implementing execution of the one or more receiving information ID card instructions i1101 of FIG. 28, can be used in performance of the receiving information ID card electrical circuitry arrangement e1101 of FIG. 19, and/or can be used in otherwise fulfillment of the operation o1101. An exemplary non-transitory signal bearing medium version of the information storage subsystem s200 is depicted in FIG. 28 as bearing the one or more receiving information ID card instructions i1101 that when executed will direct performance of the operation o1101. Furthermore, the receiving information ID card electrical circuitry arrangement (“elec circ arrange”) e1101, when activated, will perform the operation o1101. For instance, in one or more exemplary implementations, the one or more receiving information ID card instructions i1101, when executed, direct performance of the operation o1101 in the illustrative depiction as follows, and/or the receiving information ID card electrical circuitry arrangement e1101, when activated, performs the operation o1101 in the illustrative depiction as follows, and/or the operation o1101 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) via an electronic identification card (e.g. an implementation of the receiver component s528 is configured to electronically engage with a card having memory storage, etc.).

In one or more implementations, as shown in FIG. 38, operation o11 includes an operation o1102 for electronically receiving the user status information regarding the particular individual living being including the computer based social network service identification contained in a memory circuit coupled with a medication container. Origination of an illustratively derived receiving information memory component group can be accomplished through skilled in the art design choice selection of one or more of the above depicted components from one or more of the above depicted subsystems shown in FIG. 10. Components from the receiving information memory component group can be used in implementing execution of the one or more receiving information memory instructions i1102 of FIG. 28, can be used in performance of the receiving information memory electrical circuitry arrangement e1102 of FIG. 19, and/or can be used in otherwise fulfillment of the operation o1102. An exemplary non-transitory signal bearing medium version of the information storage subsystem s200 is depicted in FIG. 28 as bearing the one or more receiving information memory instructions i1102 that when executed will direct performance of the operation o1102. Furthermore, the receiving information memory electrical circuitry arrangement (“elec circ arrange”) e1102, when activated, will perform the operation o1102. For instance, in one or more exemplary implementations, the one or more receiving information memory instructions i1102, when executed, direct performance of the operation o1102 in the illustrative depiction as follows, and/or the receiving information memory electrical circuitry arrangement e1102, when activated, performs the operation o1102 in the illustrative depiction as follows, and/or the operation o1102 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) contained in a memory circuit coupled with a medication container (e.g. an implementation of the receiver component s528 is configured to electronically engage with a memory storage coupled with a medication container, etc.).

In one or more implementations, as shown in FIG. 38, operation o11 includes an operation o1103 for electronically receiving the user status information regarding the particular individual living including the computer based social network service identification being via a credit card swipe. Origination of an illustratively derived receiving information credit card component group can be accomplished through skilled in the art design choice selection of one or more of the above depicted components from one or more of the above depicted subsystems shown in FIG. 10. Components from the receiving information credit card component group can be used in implementing execution of the one or more receiving information credit card instructions i1103 of FIG. 28, can be used in performance of the receiving information credit card electrical circuitry arrangement e1103 of FIG. 19, and/or can be used in otherwise fulfillment of the operation o1103. An exemplary non-transitory signal bearing medium version of the information storage subsystem s200 is depicted in FIG. 28 as bearing the one or more receiving information credit card instructions i1103 that when executed will direct performance of the operation o1103. Furthermore, the receiving information credit card electrical circuitry arrangement (“elec circ arrange”) e1103, when activated, will perform the operation o1103. For instance, in one or more exemplary implementations, the one or more receiving information credit card instructions i1103, when executed, direct performance of the operation o1103 in the illustrative depiction as follows, and/or the receiving information credit card electrical circuitry arrangement e1103, when activated, performs the operation o1103 in the illustrative depiction as follows, and/or the operation o1103 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) being via a credit card swipe (e.g. an implementation of the receiver component s528 is configured to electronically engage with an electronic memory stripe integrated into a credit card, etc.).

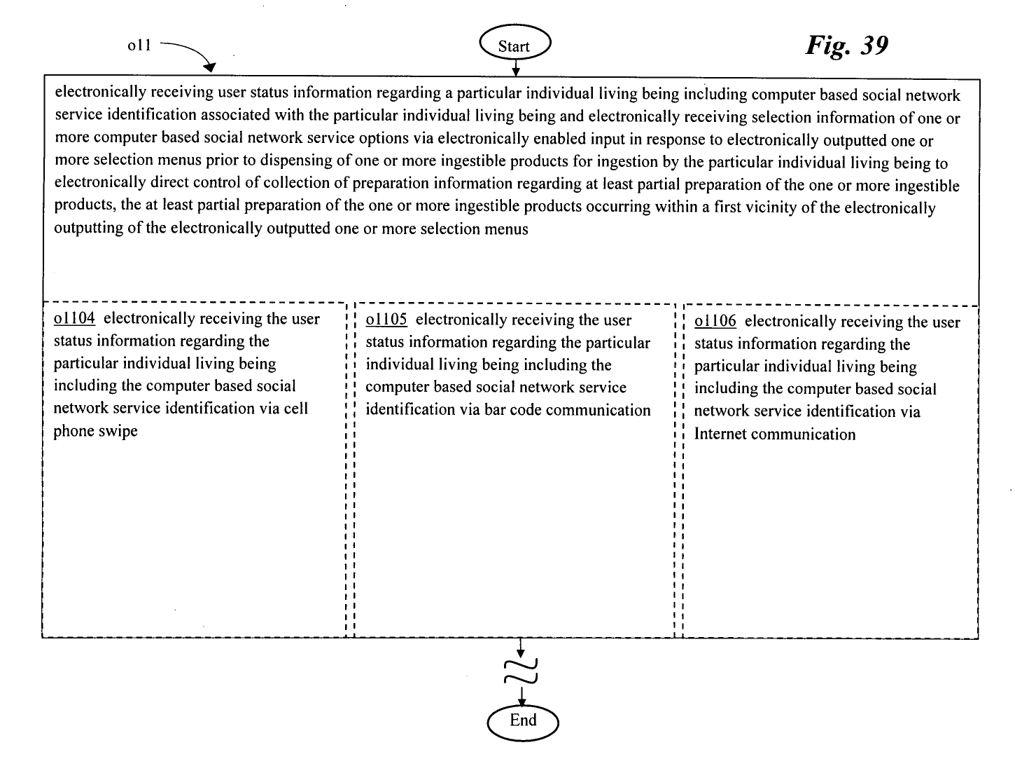

In one or more implementations, as shown in FIG. 39, operation o11 includes an operation o1104 for electronically receiving the user status information regarding the particular individual living being including the computer based social network service identification via cell phone swipe. Origination of an illustratively derived receiving information cell phone component group can be accomplished through skilled in the art design choice selection of one or more of the above depicted components from one or more of the above depicted subsystems shown in FIG. 10. Components from the receiving information cell phone component group can be used in implementing execution of the one or more receiving information cell phone instructions i1104 of FIG. 28, can be used in performance of the receiving information cell phone electrical circuitry arrangement e1104 of FIG. 19, and/or can be used in otherwise fulfillment of the operation o1104. An exemplary non-transitory signal bearing medium version of the information storage subsystem s200 is depicted in FIG. 28 as bearing the one or more receiving information cell phone instructions i1104 that when executed will direct performance of the operation o1104. Furthermore, the receiving information cell phone electrical circuitry arrangement (“elec circ arrange”) e1104, when activated, will perform the operation o1104. For instance, in one or more exemplary implementations, the one or more receiving information cell phone instructions i1104, when executed, direct performance of the operation o1104 in the illustrative depiction as follows, and/or the receiving information cell phone electrical circuitry arrangement e1104, when activated, performs the operation o1104 in the illustrative depiction as follows, and/or the operation o1104 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) via cell phone swipe (e.g. an implementation of the receiver component s528 is configured to electronically engage with an electronic memory component integrated into a cell phone, etc.).

In one or more implementations, as shown in FIG. 39, operation o11 includes an operation o1105 for electronically receiving the user status information regarding the particular individual living being including the computer based social network service identification via bar code communication. Origination of an illustratively derived receiving information bar code component group can be accomplished through skilled in the art design choice selection of one or more of the above depicted components from one or more of the above depicted subsystems shown in FIG. 10. Components from the receiving information bar code component group can be used in implementing execution of the one or more receiving information bar code instructions i1105 of FIG. 28, can be used in performance of the receiving information bar code electrical circuitry arrangement e1105 of FIG. 19, and/or can be used in otherwise fulfillment of the operation o1105. An exemplary non-transitory signal bearing medium version of the information storage subsystem s200 is depicted in FIG. 28 as bearing the one or more receiving information bar code instructions i1105 that when executed will direct performance of the operation o1105. Furthermore, the receiving information bar code electrical circuitry arrangement (“elec circ arrange”) e1105, when activated, will perform the operation o1105. For instance, in one or more exemplary implementations, the one or more receiving information bar code instructions i1105, when executed, direct performance of the operation o1105 in the illustrative depiction as follows, and/or the receiving information bar code electrical circuitry arrangement e1105, when activated, performs the operation o1105 in the illustrative depiction as follows, and/or the operation o1105 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) via bar code communication (e.g. an implementation of the receiver component s528 is configured to electronically read a bar code label to receive the user status information, etc.).

In one or more implementations, as shown in FIG. 39, operation o11 includes an operation o1106 for electronically receiving the user status information regarding the particular individual living being including the computer based social network service identification via Internet communication. Origination of an illustratively derived receiving information Internet component group can be accomplished through skilled in the art design choice selection of one or more of the above depicted components from one or more of the above depicted subsystems shown in FIG. 10. Components from the receiving information Internet component group can be used in implementing execution of the one or more receiving information Internet instructions i1106 of FIG. 28, can be used in performance of the receiving information Internet electrical circuitry arrangement e1106 of FIG. 19, and/or can be used in otherwise fulfillment of the operation o1106. An exemplary non-transitory signal bearing medium version of the information storage subsystem s200 is depicted in FIG. 28 as bearing the one or more receiving information Internet instructions i1106 that when executed will direct performance of the operation o1106. Furthermore, the receiving information Internet electrical circuitry arrangement (“elec circ arrange”) e1106, when activated, will perform the operation o1106. For instance, in one or more exemplary implementations, the one or more receiving information Internet instructions i1106, when executed, direct performance of the operation o1106 in the illustrative depiction as follows, and/or the receiving information Internet electrical circuitry arrangement e1106, when activated, performs the operation o1106 in the illustrative depiction as follows, and/or the operation o1106 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) via Internet communication (e.g. an implementation of the receiver component s528 is configured to electronically receive through the internet network component s508, etc.).

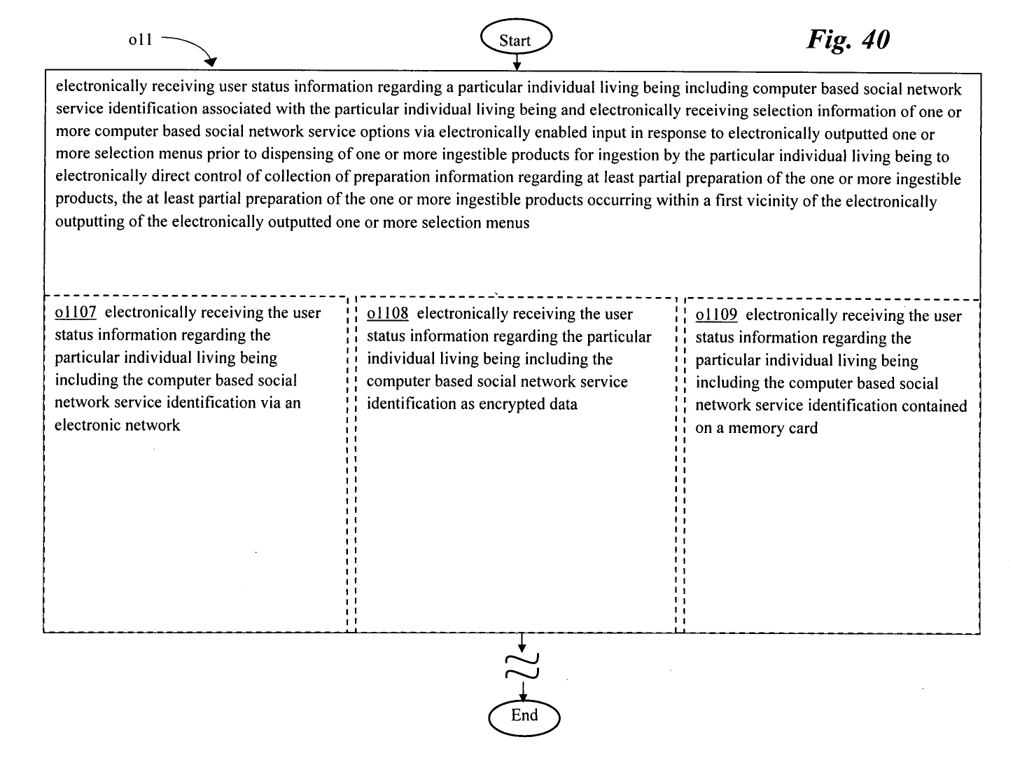

In one or more implementations, as shown in FIG. 40, operation o11 includes an operation o1107 for electronically receiving the user status information regarding the particular individual living being including the computer based social network service identification via an electronic network. Origination of an illustratively derived receiving information network component group can be accomplished through skilled in the art design choice selection of one or more of the above depicted components from one or more of the above depicted subsystems shown in FIG. 10. Components from the receiving information network component group can be used in implementing execution of the one or more receiving information network instructions i1107 of FIG. 28, can be used in performance of the receiving information network electrical circuitry arrangement e1107 of FIG. 19, and/or can be used in otherwise fulfillment of the operation o1107. An exemplary non-transitory signal bearing medium version of the information storage subsystem s200 is depicted in FIG. 28 as bearing the one or more receiving information network instructions i1107 that when executed will direct performance of the operation o1107. Furthermore, the receiving information network electrical circuitry arrangement (“elec circ arrange”) e1107, when activated, will perform the operation o1107. For instance, in one or more exemplary implementations, the one or more receiving information network instructions i1107, when executed, direct performance of the operation o1107 in the illustrative depiction as follows, and/or the receiving information network electrical circuitry arrangement e1107, when activated, performs the operation o1107 in the illustrative depiction as follows, and/or the operation o1107 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) via an electronic network (e.g. an implementation of the receiver component s528 is configured to electronically engage with the network cable component s502, etc.).

In one or more implementations, as shown in FIG. 40, operation o11 includes an operation o1108 for electronically receiving the user status information regarding the particular individual living being including the computer based social network service identification as encrypted data. Origination of an illustratively derived receiving encrypted information component group can be accomplished through skilled in the art design choice selection of one or more of the above depicted components from one or more of the above depicted subsystems shown in FIG. 10. Components from the receiving encrypted information component group can be used in implementing execution of the one or more receiving encrypted information instructions i1108 of FIG. 28, can be used in performance of the receiving encrypted information electrical circuitry arrangement e1108 of FIG. 19, and/or can be used in otherwise fulfillment of the operation o1108. An exemplary non-transitory signal bearing medium version of the information storage subsystem s200 is depicted in FIG. 28 as bearing the one or more receiving encrypted information instructions i1108 that when executed will direct performance of the operation o1108. Furthermore, the receiving encrypted information electrical circuitry arrangement (“elec circ arrange”) e1108, when activated, will perform the operation o1108. For instance, in one or more exemplary implementations, the one or more receiving encrypted information instructions i1108, when executed, direct performance of the operation o1108 in the illustrative depiction as follows, and/or the receiving encrypted information electrical circuitry arrangement e1108, when activated, performs the operation o1108 in the illustrative depiction as follows, and/or the operation o1108 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) as encrypted data (e.g. an implementation of the receiver component s528 is configured to electronically receive through the encrypted communication component s520, etc.).

In one or more implementations, as shown in FIG. 40, operation o11 includes an operation o1109 for electronically receiving the user status information regarding the particular individual living being including the computer based social network service identification contained on a memory card. Origination of an illustratively derived receiving information memory card component group can be accomplished through skilled in the art design choice selection of one or more of the above depicted components from one or more of the above depicted subsystems shown in FIG. 10. Components from the receiving information memory card component group can be used in implementing execution of the one or more receiving information memory card instructions i1109 of FIG. 28, can be used in performance of the receiving information memory card electrical circuitry arrangement e1109 of FIG. 19, and/or can be used in otherwise fulfillment of the operation o1109. An exemplary non-transitory signal bearing medium version of the information storage subsystem s200 is depicted in FIG. 28 as bearing the one or more receiving information memory card instructions i1109 that when executed will direct performance of the operation o1109. Furthermore, the receiving information memory card electrical circuitry arrangement (“elec circ arrange”) e1109, when activated, will perform the operation o1109. For instance, in one or more exemplary implementations, the one or more receiving information memory card instructions i1109, when executed, direct performance of the operation o1109 in the illustrative depiction as follows, and/or the receiving information memory card electrical circuitry arrangement e1109, when activated, performs the operation o1109 in the illustrative depiction as follows, and/or the operation o1109 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) contained on a memory card (e.g. an implementation of the receiver component s528 is configured to electronically engage with an electronic memory card to receive, etc.).

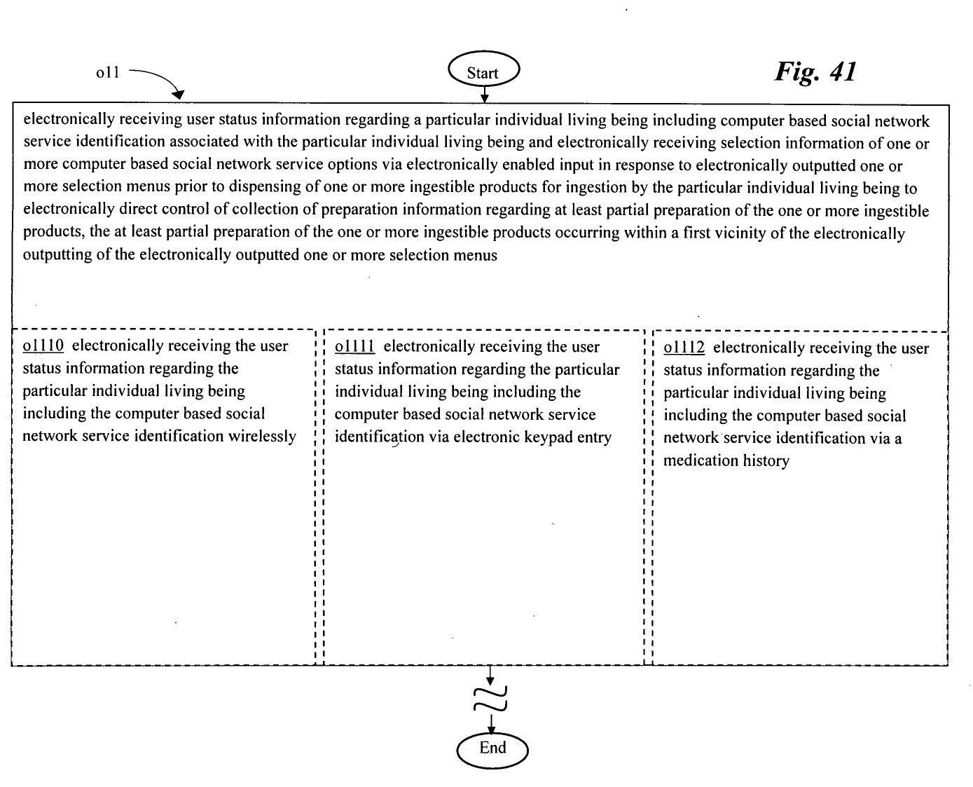

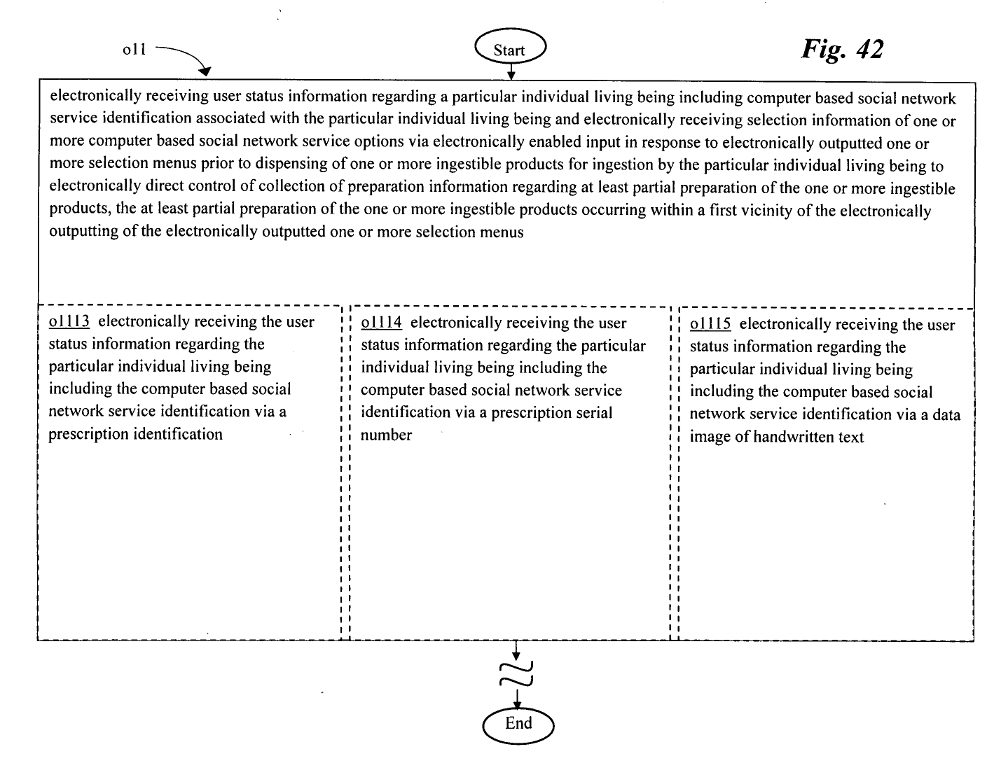

In one or more implementations, as shown in FIG. 41, operation o11 includes an operation o1110 for electronically receiving the user status information regarding the particular individual living being including the computer based social network service identification wirelessly. Origination of an illustratively derived receiving information wirelessly component group can be accomplished through skilled in the art design choice selection of one or more of the above depicted components from one or more of the above depicted subsystems shown in FIG. 10. Components from the receiving information wirelessly component group can be used in implementing execution of the one or more receiving information wirelessly instructions i1110 of FIG. 28, can be used in performance of the receiving information wirelessly electrical circuitry arrangement e1110 of FIG. 19, and/or can be used in otherwise fulfillment of the operation o1110. An exemplary non-transitory signal bearing medium version of the information storage subsystem s200 is depicted in FIG. 28 as bearing the one or more receiving information wirelessly instructions i1110 that when executed will direct performance of the operation o1110. Furthermore, the receiving information wirelessly electrical circuitry arrangement (“elec circ arrange”) e1110, when activated, will perform the operation o1110. For instance, in one or more exemplary implementations, the one or more receiving information wirelessly instructions i1110, when executed, direct performance of the operation o1110 in the illustrative depiction as follows, and/or the receiving information wirelessly electrical circuitry arrangement e1110, when activated, performs the operation o1110 in the illustrative depiction as follows, and/or the operation o1110 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) wirelessly (e.g. an implementation of the receiver component s528 is configured to electronically receive through the wireless network component s512, etc.).

In one or more implementations, as shown in FIG. 41, operation o11 includes an operation o1111 for electronically receiving the user status information regarding the particular individual living being including the computer based social network service identification via electronic keypad entry. Origination of an illustratively derived receiving information keypad entry component group can be accomplished through skilled in the art design choice selection of one or more of the above depicted components from one or more of the above depicted subsystems shown in FIG. 10. Components from the receiving information keypad entry component group can be used in implementing execution of the one or more receiving information keypad entry instructions it i1111 of FIG. 28, can be used in performance of the receiving information keypad entry electrical circuitry arrangement e1111 of FIG. 19, and/or can be used in otherwise fulfillment of the operation o1111. An exemplary non-transitory signal bearing medium version of the information storage subsystem s200 is depicted in FIG. 28 as bearing the one or more receiving information keypad entry instructions i1111 that when executed will direct performance of the operation o1111. Furthermore, the receiving information keypad entry electrical circuitry arrangement (“elec circ arrange”) e1111, when activated, will perform the operation o1111. For instance, in one or more exemplary implementations, the one or more receiving information keypad entry instructions i1111, when executed, direct performance of the operation o1111 in the illustrative depiction as follows, and/or the receiving information keypad entry electrical circuitry arrangement e1111, when activated, performs the operation o1111 in the illustrative depiction as follows, and/or the operation o1111 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) via electronic keypad entry (e.g. an implementation of the receiver component s528 is configured to electronically engage with the keypad component s308 to receive, etc.).

In one or more implementations, as shown in FIG. 41, operation o11 includes an operation o1112 for electronically receiving the user status information regarding the particular individual living being including the computer based social network service identification via a medication history. Origination of an illustratively derived receiving information meds history component group can be accomplished through skilled in the art design choice selection of one or more of the above depicted components from one or more of the above depicted subsystems shown in FIG. 10. Components from the receiving information meds history component group can be used in implementing execution of the one or more receiving information meds history instructions i1112 of FIG. 28, can be used in performance of the receiving information meds history electrical circuitry arrangement e1112 of FIG. 19, and/or can be used in otherwise fulfillment of the operation o1112. An exemplary non-transitory signal bearing medium version of the information storage subsystem s200 is depicted in FIG. 28 as bearing the one or more receiving information meds history instructions i1112 that when executed will direct performance of the operation o1112. Furthermore, the receiving information meds history electrical circuitry arrangement (“elec circ arrange”) e1112, when activated, will perform the operation o1112. For instance, in one or more exemplary implementations, the one or more receiving information meds history instructions i1112, when executed, direct performance of the operation o1112 in the illustrative depiction as follows, and/or the receiving information meds history electrical circuitry arrangement e1112, when activated, performs the operation o1112 in the illustrative depiction as follows, and/or the operation o1112 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) via a medication history (e.g. an implementation of the receiver component s528 is configured to electronically engage with the microprocessor component s102 to receive the name and control number of the medication history of the particular individual living being, etc.).

In one or more implementations, as shown in FIG. 42, operation o11 includes an operation o1113 for electronically receiving the user status information regarding the particular individual living being including the computer based social network service identification via a prescription identification. Origination of an illustratively derived receiving information prescription ID component group can be accomplished through skilled in the art design choice selection of one or more of the above depicted components from one or more of the above depicted subsystems shown in FIG. 10. Components from the receiving information prescription ID component group can be used in implementing execution of the one or more receiving information prescription ID instructions i1113 of FIG. 28, can be used in performance of the receiving information prescription ID electrical circuitry arrangement e1113 of FIG. 19, and/or can be used in otherwise fulfillment of the operation o1113. An exemplary non-transitory signal bearing medium version of the information storage subsystem s200 is depicted in FIG. 28 as bearing the one or more receiving information prescription ID instructions i1113 that when executed will direct performance of the operation o1113. Furthermore, the receiving information prescription ID electrical circuitry arrangement (“elec circ arrange”) e1113, when activated, will perform the operation o1113. For instance, in one or more exemplary implementations, the one or more receiving information prescription ID instructions i1113, when executed, direct performance of the operation o1113 in the illustrative depiction as follows, and/or the receiving information prescription ID electrical circuitry arrangement e1113, when activated, performs the operation o1113 in the illustrative depiction as follows, and/or the operation o1113 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) via a prescription identification (e.g. an implementation of the receiver component s528 is configured to electronically engage with the microprocessor component s102 to receive a prescription identification, etc.).

In one or more implementations, as shown in FIG. 42, operation o11 includes an operation o1114 for electronically receiving the user status information regarding the particular individual living being including the computer based social network service identification via a prescription serial number. Origination of an illustratively derived receiving information prescription number component group can be accomplished through skilled in the art design choice selection of one or more of the above depicted components from one or more of the above depicted subsystems shown in FIG. 10. Components from the receiving information prescription number component group can be used in implementing execution of the one or more receiving information prescription number instructions i1114 of FIG. 28, can be used in performance of the receiving information prescription number electrical circuitry arrangement e1114 of FIG. 19, and/or can be used in otherwise fulfillment of the operation o1114. An exemplary non-transitory signal bearing medium version of the information storage subsystem s200 is depicted in FIG. 28 as bearing the one or more receiving information prescription number instructions i1114 that when executed will direct performance of the operation o1114. Furthermore, the receiving information prescription number electrical circuitry arrangement (“elec circ arrange”) e1114, when activated, will perform the operation o1114. For instance, in one or more exemplary implementations, the one or more receiving information prescription number instructions i1114, when executed, direct performance of the operation o1114 in the illustrative depiction as follows, and/or the receiving information prescription number electrical circuitry arrangement e1114, when activated, performs the operation o1114 in the illustrative depiction as follows, and/or the operation o1114 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) via a prescription serial number (e.g. an implementation of the receiver component s528 is configured to electronically engage with the microprocessor component s102 to receive a prescription serial number, etc.).

In one or more implementations, as shown in FIG. 42, operation o11 includes an operation o1115 for electronically receiving the user status information regarding the particular individual living being including the computer based social network service identification via a data image of handwritten text. Origination of an illustratively derived receiving information handwritten component group can be accomplished through skilled in the art design choice selection of one or more of the above depicted components from one or more of the above depicted subsystems shown in FIG. 10. Components from the receiving information handwritten component group can be used in implementing execution of the one or more receiving information handwritten instructions i1115 of FIG. 28, can be used in performance of the receiving information handwritten electrical circuitry arrangement e1115 of FIG. 19, and/or can be used in otherwise fulfillment of the operation o1115. An exemplary non-transitory signal bearing medium version of the information storage subsystem s200 is depicted in FIG. 28 as bearing the one or more receiving information handwritten instructions i1115 that when executed will direct performance of the operation o1115. Furthermore, the receiving information handwritten electrical circuitry arrangement (“elec circ arrange”) e1115, when activated, will perform the operation o1115. For instance, in one or more exemplary implementations, the one or more receiving information handwritten instructions i1115, when executed, direct performance of the operation o1115 in the illustrative depiction as follows, and/or the receiving information handwritten electrical circuitry arrangement e1115, when activated, performs the operation o1115 in the illustrative depiction as follows, and/or the operation o1115 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) via a data image of handwritten text (e.g. an implementation of the receiver component s528 is configured to electronically engage with the microprocessor component s102 to receive t through electronic handwriting analysis of the data image of the handwritten text, etc.).

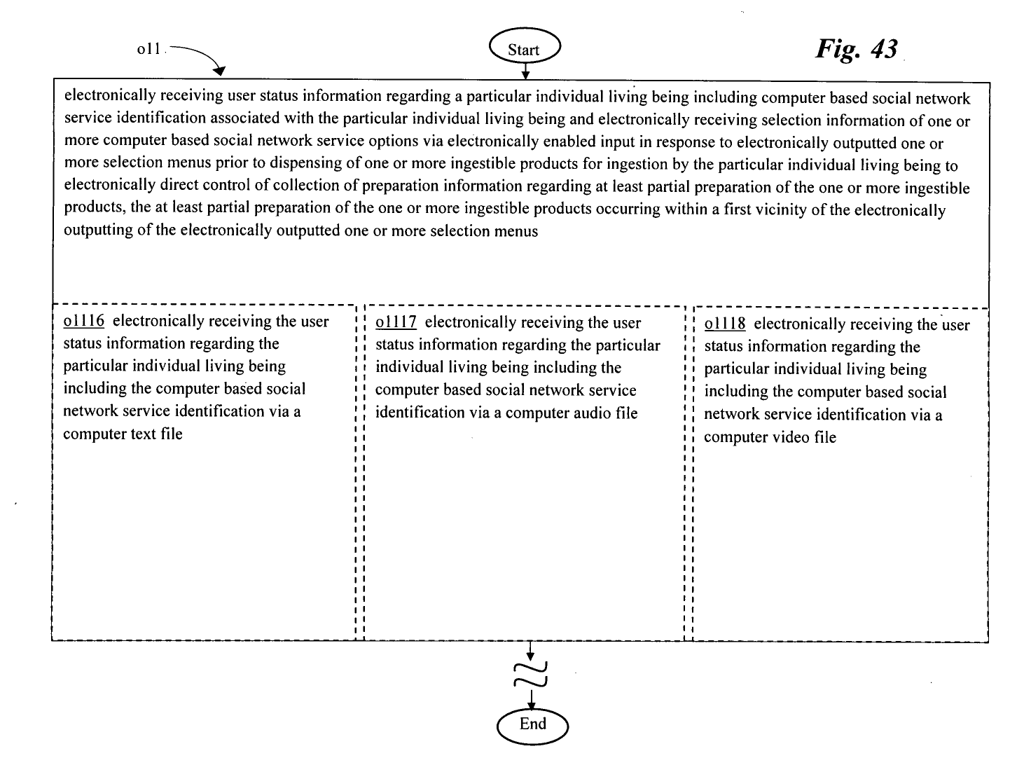

In one or more implementations, as shown in FIG. 43, operation o11 includes an operation o1116 for electronically receiving the user status information regarding the particular individual living being including the computer based social network service identification via a computer text file. Origination of an illustratively derived receiving information text file component group can be accomplished through skilled in the art design choice selection of one or more of the above depicted components from one or more of the above depicted subsystems shown in FIG. 10. Components from the receiving information text file component group can be used in implementing execution of the one or more receiving information text file instructions i1116 of FIG. 28, can be used in performance of the receiving information text file electrical circuitry arrangement e1116 of FIG. 19, and/or can be used in otherwise fulfillment of the operation o1116. An exemplary non-transitory signal bearing medium version of the information storage subsystem s200 is depicted in FIG. 28 as bearing the one or more receiving information text file instructions i1116 that when executed will direct performance of the operation o1116. Furthermore, the receiving information text file electrical circuitry arrangement (“elec circ arrange”) e1116, when activated, will perform the operation o1116. For instance, in one or more exemplary implementations, the one or more receiving information text file instructions i1116, when executed, direct performance of the operation o1116 in the illustrative depiction as follows, and/or the receiving information text file electrical circuitry arrangement e1116, when activated, performs the operation o1116 in the illustrative depiction as follows, and/or the operation o1116 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) via a computer text file (e.g. an implementation of the receiver component s528 is configured to electronically engage with the microprocessor component s102 to receive through electronic reading of the computer text file, etc.).

In one or more implementations, as shown in FIG. 43, operation o11 includes an operation o1117 for electronically receiving the user status information regarding the particular individual living being including the computer based social network service identification via a computer audio file. Origination of an illustratively derived receiving information audio file component group can be accomplished through skilled in the art design choice selection of one or more of the above depicted components from one or more of the above depicted subsystems shown in FIG. 10. Components from the receiving information audio file component group can be used in implementing execution of the one or more receiving information audio file instructions i1117 of FIG. 28, can be used in performance of the receiving information audio file electrical circuitry arrangement e1117 of FIG. 19, and/or can be used in otherwise fulfillment of the operation o1117. An exemplary non-transitory signal bearing medium version of the information storage subsystem s200 is depicted in FIG. 28 as bearing the one or more receiving information audio file instructions i1117 that when executed will direct performance of the operation o1117. Furthermore, the receiving information audio file electrical circuitry arrangement (“elec circ arrange”) e1117, when activated, will perform the operation o1117. For instance, in one or more exemplary implementations, the one or more receiving information audio file instructions i1117, when executed, direct performance of the operation o1117 in the illustrative depiction as follows, and/or the receiving information audio file electrical circuitry arrangement e1117, when activated, performs the operation o1117 in the illustrative depiction as follows, and/or the operation o1117 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) via a computer audio file (e.g. an implementation of the receiver component s528 is configured to electronically engage with the microprocessor component s102 to receive through electronic reading of the computer audio file, etc.).

In one or more implementations, as shown in FIG. 43, operation o11 includes an operation o1118 for electronically receiving the user status information regarding the particular individual living being including the computer based social network service identification via a computer video file. Origination of an illustratively derived receiving information video file component group can be accomplished through skilled in the art design choice selection of one or more of the above depicted components from one or more of the above depicted subsystems shown in FIG. 10. Components from the receiving information video file component group can be used in implementing execution of the one or more receiving information video file instructions i1118 of FIG. 28, can be used in performance of the receiving information video file electrical circuitry arrangement e1118 of FIG. 19, and/or can be used in otherwise fulfillment of the operation o1118. An exemplary non-transitory signal bearing medium version of the information storage subsystem s200 is depicted in FIG. 28 as bearing the one or more receiving information video file instructions i1118 that when executed will direct performance of the operation o1118. Furthermore, the receiving information video file electrical circuitry arrangement (“elec circ arrange”) e1118, when activated, will perform the operation o1118. For instance, in one or more exemplary implementations, the one or more receiving information video file instructions i1118, when executed, direct performance of the operation o1118 in the illustrative depiction as follows, and/or the receiving information video file electrical circuitry arrangement e1118, when activated, performs the operation o1118 in the illustrative depiction as follows, and/or the operation o1118 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) via a computer video file (e.g. an implementation of the receiver component s528 is configured to electronically engage with the microprocessor component s102 to receive through electronic reading of the computer video file, etc.).

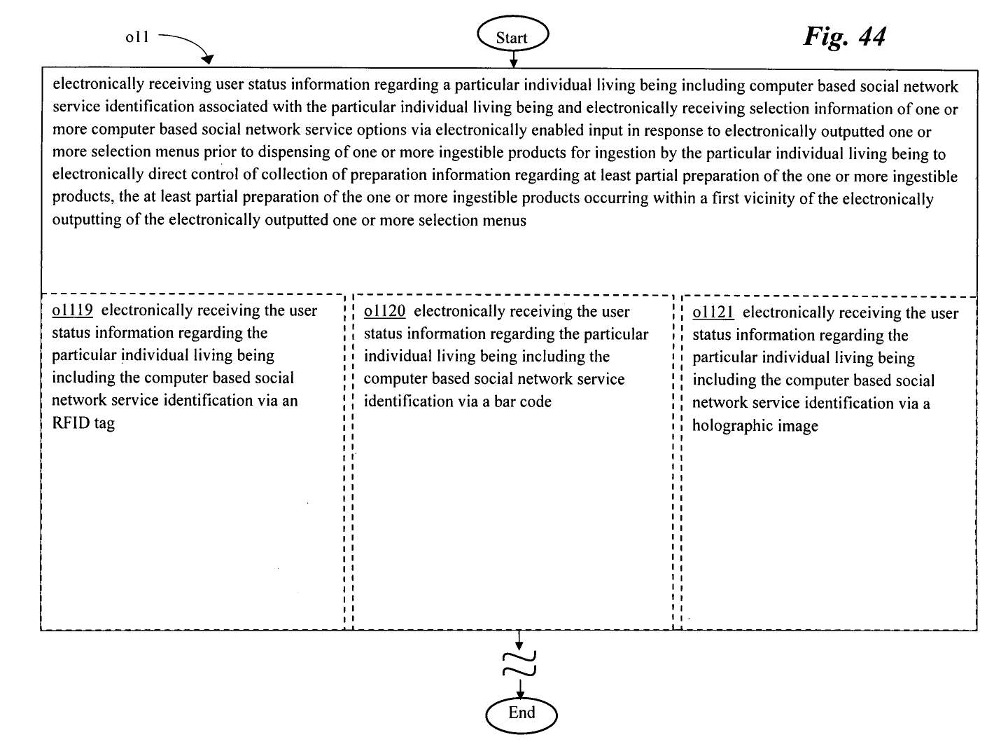

In one or more implementations, as shown in FIG. 44, operation o11 includes an operation o1119 for electronically receiving the user status information regarding the particular individual living being including the computer based social network service identification via an RFID tag. Origination of an illustratively derived receiving information RFID component group can be accomplished through skilled in the art design choice selection of one or more of the above depicted components from one or more of the above depicted subsystems shown in FIG. 10. Components from the receiving information RFID component group can be used in implementing execution of the one or more receiving information RFID instructions i1119 of FIG. 28, can be used in performance of the receiving information RFID electrical circuitry arrangement e1119 of FIG. 19, and/or can be used in otherwise fulfillment of the operation o1119. An exemplary non-transitory signal bearing medium version of the information storage subsystem s200 is depicted in FIG. 28 as bearing the one or more receiving information RFID instructions i1119 that when executed will direct performance of the operation o1119. Furthermore, the receiving information RFID electrical circuitry arrangement (“elec circ arrange”) e1119, when activated, will perform the operation o1119. For instance, in one or more exemplary implementations, the one or more receiving information RFID instructions i1119, when executed, direct performance of the operation o1119 in the illustrative depiction as follows, and/or the receiving information RFID electrical circuitry arrangement e1119, when activated, performs the operation o1119 in the illustrative depiction as follows, and/or the operation o1119 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) via an RFID tag (e.g. an implementation of the receiver component s528 is configured to electronically engage with the microprocessor component s102 to receive through electronic reading be the radio frequency identification (RFID) sensing component s414 of the RFID tag, etc.).

In one or more implementations, as shown in FIG. 44, operation o11 includes an operation o1120 for electronically receiving the user status information regarding the particular individual living being including the computer based social network service identification via a bar code. Origination of an illustratively derived receiving information bar code component group can be accomplished through skilled in the art design choice selection of one or more of the above depicted components from one or more of the above depicted subsystems shown in FIG. 10. Components from the receiving information bar code component group can be used in implementing execution of the one or more receiving information bar code instructions i1120 of FIG. 29, can be used in performance of the receiving information bar code electrical circuitry arrangement e1120 of FIG. 20, and/or can be used in otherwise fulfillment of the operation o1120. An exemplary non-transitory signal bearing medium version of the information storage subsystem s200 is depicted in FIG. 29 as bearing the one or more receiving information bar code instructions i1120 that when executed will direct performance of the operation o1120. Furthermore, the receiving information bar code electrical circuitry arrangement (“elec circ arrange”) e1120, when activated, will perform the operation o1120. For instance, in one or more exemplary implementations, the one or more receiving information bar code instructions i1120, when executed, direct performance of the operation o1120 in the illustrative depiction as follows, and/or the receiving information bar code electrical circuitry arrangement e1120, when activated, performs the operation o1120 in the illustrative depiction as follows, and/or the operation o1120 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) via a bar code (e.g. an implementation of the receiver component s528 is configured to electronically engage with the microprocessor component s102 to receive through electronic reading of the bar code, etc.).

In one or more implementations, as shown in FIG. 44, operation o11 includes an operation o1121 for electronically receiving the user status information regarding the particular individual living being including the computer based social network service identification via a holographic image. Origination of an illustratively derived receiving information holographic component group can be accomplished through skilled in the art design choice selection of one or more of the above depicted components from one or more of the above depicted subsystems shown in FIG. 10. Components from the receiving information holographic component group can be used in implementing execution of the one or more receiving information holographic instructions i1121 of FIG. 29, can be used in performance of the receiving information holographic electrical circuitry arrangement e1121 of FIG. 20, and/or can be used in otherwise fulfillment of the operation o1121. An exemplary non-transitory signal bearing medium version of the information storage subsystem s200 is depicted in FIG. 29 as bearing the one or more receiving information holographic instructions i1121 that when executed will direct performance of the operation o1121. Furthermore, the receiving information holographic electrical circuitry arrangement (“elec circ arrange”) e1121, when activated, will perform the operation o1121. For instance, in one or more exemplary implementations, the one or more receiving information holographic instructions i1121, when executed, direct performance of the operation o1121 in the illustrative depiction as follows, and/or the receiving information holographic electrical circuitry arrangement e1121, when activated, performs the operation o1121 in the illustrative depiction as follows, and/or the operation o1121 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) via a holographic image (e.g. an implementation of the receiver component s528 is configured to electronically engage with the microprocessor component s102 to receive through electronic reading of the holographic image, etc.).

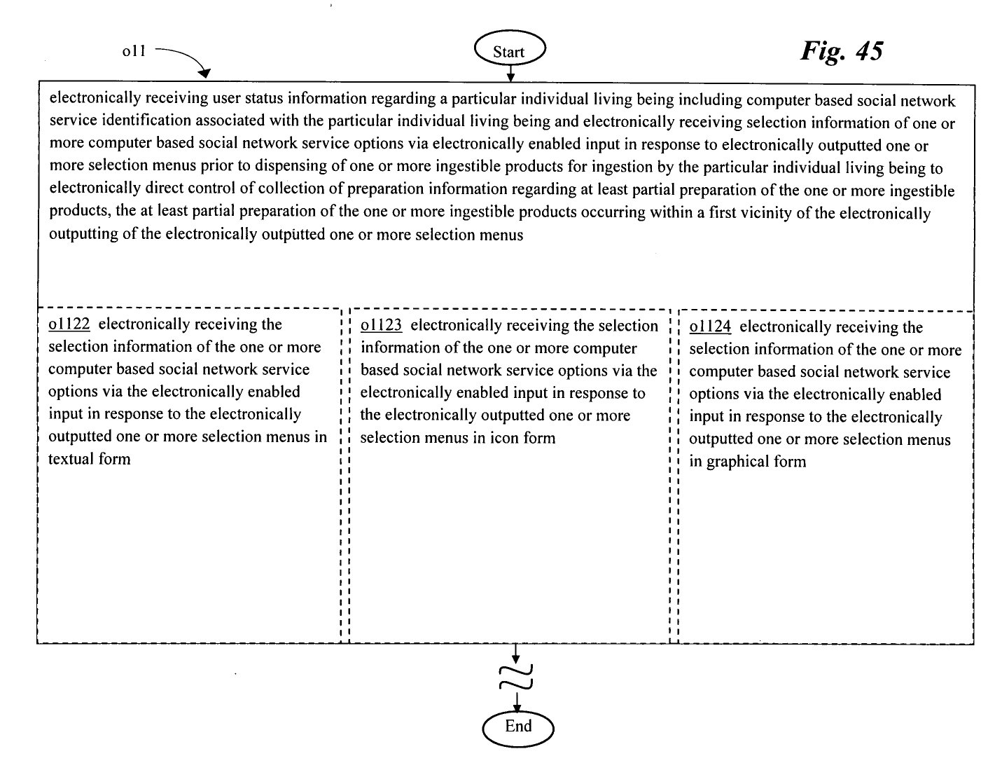

In one or more implementations, as shown in FIG. 45, operation o11 includes an operation o1122 for electronically receiving the selection information of the one or more computer based social network service options via the electronically enabled input in response to the electronically outputted one or more selection menus in textual form. Origination of an illustratively derived receiving information textual component group can be accomplished through skilled in the art design choice selection of one or more of the above depicted components from one or more of the above depicted subsystems shown in FIG. 10. Components from the receiving information textual component group can be used in implementing execution of the one or more receiving information textual instructions i1122 of FIG. 29, can be used in performance of the receiving information textual electrical circuitry arrangement e1122 of FIG. 20, and/or can be used in otherwise fulfillment of the operation o1122. An exemplary non-transitory signal bearing medium version of the information storage subsystem s200 is depicted in FIG. 29 as bearing the one or more receiving information textual instructions i1122 that when executed will direct performance of the operation o1122. Furthermore, the receiving information textual electrical circuitry arrangement (“elec circ arrange”) e1122, when activated, will perform the operation o1122. For instance, in one or more exemplary implementations, the one or more receiving information textual instructions i1122, when executed, direct performance of the operation o1122 in the illustrative depiction as follows, and/or the receiving information textual electrical circuitry arrangement e1122, when activated, performs the operation o1122 in the illustrative depiction as follows, and/or the operation o1122 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) in textual form (e.g. an implementation of the receiver component s528 is configured to electronically engage with the microprocessor component s102 to receive one or more selection menus in textual form, such as a menu containing textual one or more descriptions to select from, etc.).

In one or more implementations, as shown in FIG. 45, operation o11 includes an operation o1123 for electronically receiving the selection information of the one or more computer based social network service options via the electronically enabled input in response to the electronically outputted one or more selection menus in icon form. Origination of an illustratively derived receiving information icon component group can be accomplished through skilled in the art design choice selection of one or more of the above depicted components from one or more of the above depicted subsystems shown in FIG. 10. Components from the receiving information icon component group can be used in implementing execution of the one or more receiving information icon instructions i1123 of FIG. 29, can be used in performance of the receiving information icon electrical circuitry arrangement e1123 of FIG. 20, and/or can be used in otherwise fulfillment of the operation o1123. An exemplary non-transitory signal bearing medium version of the information storage subsystem s200 is depicted in FIG. 29 as bearing the one or more receiving information icon instructions i1123 that when executed will direct performance of the operation o1123. Furthermore, the receiving information icon electrical circuitry arrangement (“elec circ arrange”) e1123, when activated, will perform the operation o1123. For instance, in one or more exemplary implementations, the one or more receiving information icon instructions i1123, when executed, direct performance of the operation o1123 in the illustrative depiction as follows, and/or the receiving information icon electrical circuitry arrangement e1123, when activated, performs the operation o1123 in the illustrative depiction as follows, and/or the operation o1123 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) in icon form (e.g. an implementation of the receiver component s528 is configured to electronically engage with the microprocessor component s102 to receive one or more selection menus in icon form, such as a menu containing iconic one or more descriptions to select from, etc.).

In one or more implementations, as shown in FIG. 45, operation o11 includes an operation o1124 for electronically receiving the selection information of the one or more computer based social network service options via the electronically enabled input in response to the electronically outputted one or more selection menus in graphical form. Origination of an illustratively derived receiving information graphical component group can be accomplished through skilled in the art design choice selection of one or more of the above depicted components from one or more of the above depicted subsystems shown in FIG. 10. Components from the receiving information graphical component group can be used in implementing execution of the one or more receiving information graphical instructions i1124 of FIG. 29, can be used in performance of the receiving information graphical electrical circuitry arrangement e1124 of FIG. 20, and/or can be used in otherwise fulfillment of the operation o1124. An exemplary non-transitory signal bearing medium version of the information storage subsystem s200 is depicted in FIG. 29 as bearing the one or more receiving information graphical instructions i1124 that when executed will direct performance of the operation o1124. Furthermore, the receiving information graphical electrical circuitry arrangement (“elec circ arrange”) e1124, when activated, will perform the operation o1124. For instance, in one or more exemplary implementations, the one or more receiving information graphical instructions i1124, when executed, direct performance of the operation o1124 in the illustrative depiction as follows, and/or the receiving information graphical electrical circuitry arrangement e1124, when activated, performs the operation o1124 in the illustrative depiction as follows, and/or the operation o1124 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) in graphical form (e.g. an implementation of the receiver component s528 is configured to electronically engage with the microprocessor component s102 to receive one or more selection menus in graphical form, such as a menu containing graphical one or more descriptions to select from, etc.).

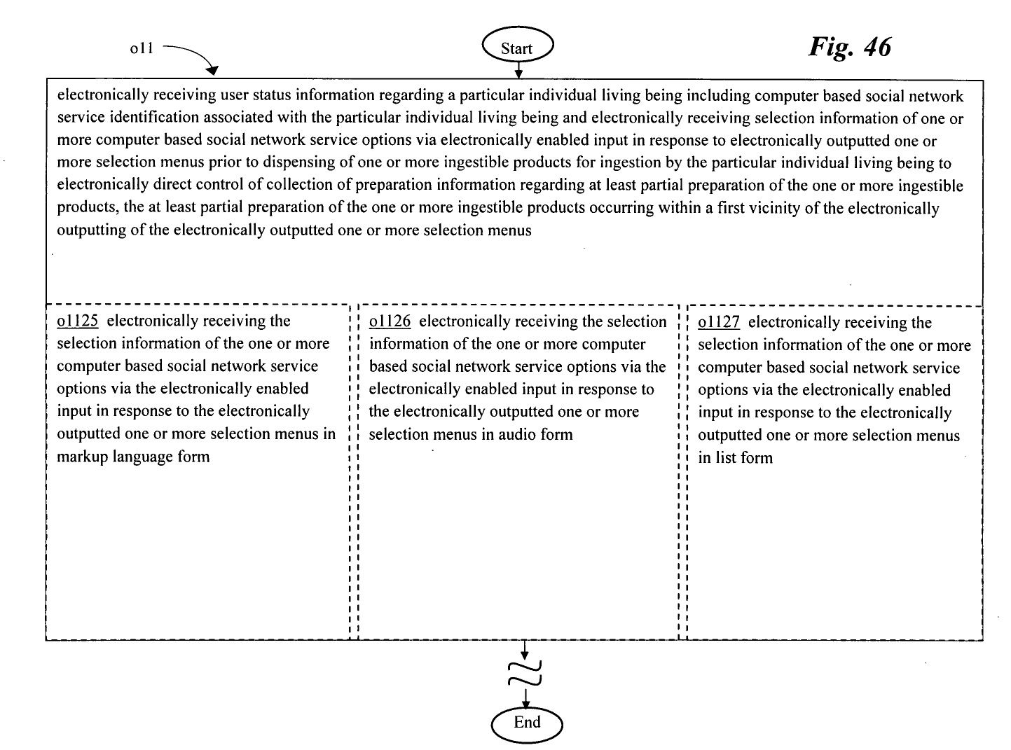

In one or more implementations, as shown in FIG. 46, operation o11 includes an operation o1125 for electronically receiving the selection information of the one or more computer based social network service options via the electronically enabled input in response to the electronically outputted one or more selection menus in markup language form. Origination of an illustratively derived receiving information markup component group can be accomplished through skilled in the art design choice selection of one or more of the above depicted components from one or more of the above depicted subsystems shown in FIG. 10. Components from the receiving information markup component group can be used in implementing execution of the one or more receiving information markup instructions i1125 of FIG. 29, can be used in performance of the receiving information markup electrical circuitry arrangement e1125 of FIG. 20, and/or can be used in otherwise fulfillment of the operation o1125. An exemplary non-transitory signal bearing medium version of the information storage subsystem s200 is depicted in FIG. 29 as bearing the one or more receiving information markup instructions i1125 that when executed will direct performance of the operation o1125. Furthermore, the receiving information markup electrical circuitry arrangement (“elec circ arrange”) e1125, when activated, will perform the operation o1125. For instance, in one or more exemplary implementations, the one or more receiving information markup instructions i1125, when executed, direct performance of the operation o1125 in the illustrative depiction as follows, and/or the receiving information markup electrical circuitry arrangement e1125, when activated, performs the operation o1125 in the illustrative depiction as follows, and/or the operation o1125 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) in markup language form (e.g. an implementation of the receiver component s528 is configured to electronically engage with the microprocessor component s102 to receive one or more selection menus in markup language form, such as a menu containing markup language one or more descriptions to select from, etc.).

In one or more implementations, as shown in FIG. 46, operation o11 includes an operation o1126 for electronically receiving the selection information of the one or more computer based social network service options via the electronically enabled input in response to the electronically outputted one or more selection menus in audio form. Origination of an illustratively derived receiving information audio component group can be accomplished through skilled in the art design choice selection of one or more of the above depicted components from one or more of the above depicted subsystems shown in FIG. 10. Components from the receiving information audio component group can be used in implementing execution of the one or more receiving information audio instructions i1126 of FIG. 29, can be used in performance of the receiving information audio electrical circuitry arrangement e1126 of FIG. 20, and/or can be used in otherwise fulfillment of the operation o1126. An exemplary non-transitory signal bearing medium version of the information storage subsystem s200 is depicted in FIG. 29 as bearing the one or more receiving information audio instructions i1126 that when executed will direct performance of the operation o1126. Furthermore, the receiving information audio electrical circuitry arrangement (“elec circ arrange”) e1126, when activated, will perform the operation o1126. For instance, in one or more exemplary implementations, the one or more receiving information audio instructions i1126, when executed, direct performance of the operation o1126 in the illustrative depiction as follows, and/or the receiving information audio electrical circuitry arrangement e1126, when activated, performs the operation o1126 in the illustrative depiction as follows, and/or the operation o1126 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) in audio form (e.g. an implementation of the receiver component s528 is configured to electronically engage with the microprocessor component s102 to receive one or more selection menus in audio form, such as a menu containing audio one or more descriptions to select from, etc.).

In one or more implementations, as shown in FIG. 46, operation o11 includes an operation o1127 for electronically receiving the selection information of the one or more computer based social network service options via the electronically enabled input in response to the electronically outputted one or more selection menus in list form. Origination of an illustratively derived receiving information list component group can be accomplished through skilled in the art design choice selection of one or more of the above depicted components from one or more of the above depicted subsystems shown in FIG. 10. Components from the receiving information list component group can be used in implementing execution of the one or more receiving information list instructions i1127 of FIG. 29, can be used in performance of the receiving information list electrical circuitry arrangement e1127 of FIG. 20, and/or can be used in otherwise fulfillment of the operation o1127. An exemplary non-transitory signal bearing medium version of the information storage subsystem s200 is depicted in FIG. 29 as bearing the one or more receiving information list instructions i1127 that when executed will direct performance of the operation o1127. Furthermore, the receiving information list electrical circuitry arrangement (“elec circ arrange”) e1127, when activated, will perform the operation o1127. For instance, in one or more exemplary implementations, the one or more receiving information list instructions i1127, when executed, direct performance of the operation o1127 in the illustrative depiction as follows, and/or the receiving information list electrical circuitry arrangement e1127, when activated, performs the operation o1127 in the illustrative depiction as follows, and/or the operation o1127 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) in list form (e.g. an implementation of the receiver component s528 is configured to electronically engage with the microprocessor component s102 to receive one or more selection menus in list form, such as a menu containing listed one or more descriptions to select from, etc.).

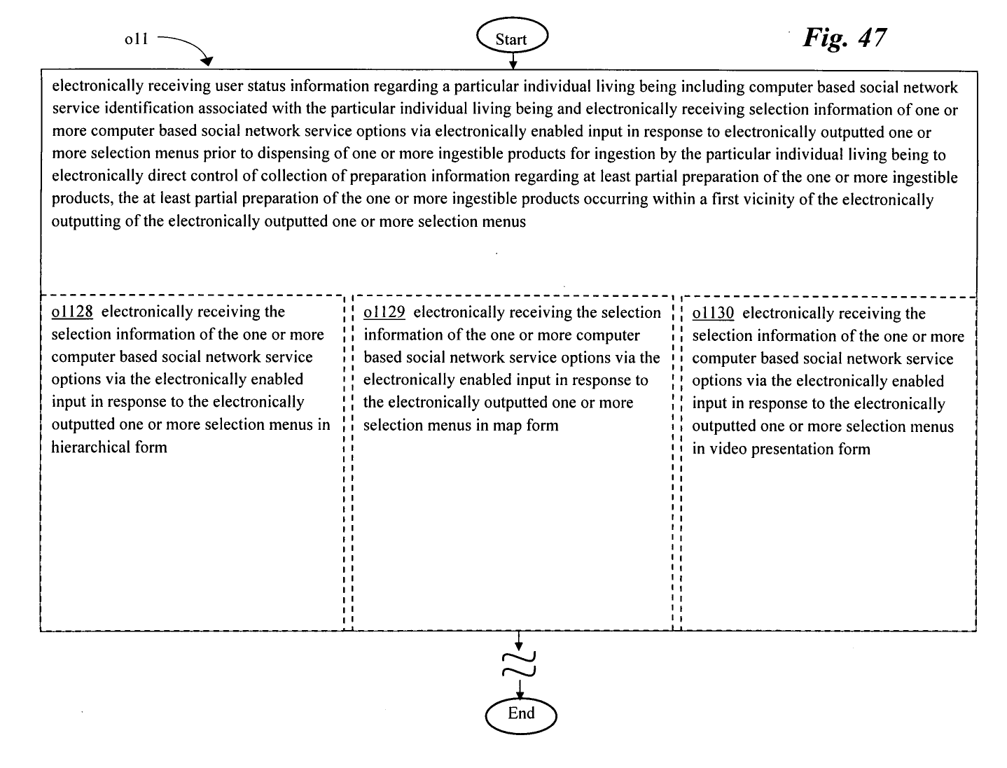

In one or more implementations, as shown in FIG. 47, operation o11 includes an operation o1128 for electronically receiving the selection information of the one or more computer based social network service options via the electronically enabled input in response to the electronically outputted one or more selection menus in hierarchical form. Origination of an illustratively derived receiving information hierarchical component group can be accomplished through skilled in the art design choice selection of one or more of the above depicted components from one or more of the above depicted subsystems shown in FIG. 10. Components from the receiving information hierarchical component group can be used in implementing execution of the one or more receiving information hierarchical instructions i1128 of FIG. 29, can be used in performance of the receiving information hierarchical electrical circuitry arrangement e1128 of FIG. 20, and/or can be used in otherwise fulfillment of the operation o1128. An exemplary non-transitory signal bearing medium version of the information storage subsystem s200 is depicted in FIG. 29 as bearing the one or more receiving information hierarchical instructions i1128 that when executed will direct performance of the operation o1128. Furthermore, the receiving information hierarchical electrical circuitry arrangement (“elec circ arrange”) e1128, when activated, will perform the operation o1128. For instance, in one or more exemplary implementations, the one or more receiving information hierarchical instructions i1128, when executed, direct performance of the operation o1128 in the illustrative depiction as follows, and/or the receiving information hierarchical electrical circuitry arrangement e1128, when activated, performs the operation o1128 in the illustrative depiction as follows, and/or the operation o1128 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) in hierarchical form (e.g. an implementation of the receiver component s528 is configured to electronically engage with the microprocessor component s102 to receive one or more selection menus in hierarchical form, such as a menu containing hierarchical one or more descriptions to select from, etc.).

In one or more implementations, as shown in FIG. 47, operation o11 includes an operation o1129 for electronically receiving the selection information of the one or more computer based social network service options via the electronically enabled input in response to the electronically outputted one or more selection menus in map form. Origination of an illustratively derived receiving information map component group can be accomplished through skilled in the art design choice selection of one or more of the above depicted components from one or more of the above depicted subsystems shown in FIG. 10. Components from the receiving information map component group can be used in implementing execution of the one or more receiving information map instructions i1129 of FIG. 29, can be used in performance of the receiving information map electrical circuitry arrangement e1129 of FIG. 20, and/or can be used in otherwise fulfillment of the operation o1129. An exemplary non-transitory signal bearing medium version of the information storage subsystem s200 is depicted in FIG. 29 as bearing the one or more receiving information map instructions i1129 that when executed will direct performance of the operation o1129. Furthermore, the receiving information map electrical circuitry arrangement (“elec circ arrange”) e1129, when activated, will perform the operation o1129. For instance, in one or more exemplary implementations, the one or more receiving information map instructions i1129, when executed, direct performance of the operation o1129 in the illustrative depiction as follows, and/or the receiving information map electrical circuitry arrangement e1129, when activated, performs the operation o1129 in the illustrative depiction as follows, and/or the operation o1129 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) in map form (e.g. an implementation of the receiver component s528 is configured to electronically engage with the microprocessor component s102 to receive one or more selection menus in map form, such as a menu having arrangements resembling one or more maps containing one or more selections and one or more descriptions to select from, etc.).

In one or more implementations, as shown in FIG. 47, operation o11 includes an operation o1130 for electronically receiving the selection information of the one or more computer based social network service options via the electronically enabled input in response to the electronically outputted one or more selection menus in video presentation form. Origination of an illustratively derived receiving information video component group can be accomplished through skilled in the art design choice selection of one or more of the above depicted components from one or more of the above depicted subsystems shown in FIG. 10. Components from the receiving information video component group can be used in implementing execution of the one or more receiving information video instructions i1130 of FIG. 29, can be used in performance of the receiving information video electrical circuitry arrangement e1130 of FIG. 20, and/or can be used in otherwise fulfillment of the operation o1130. An exemplary non-transitory signal bearing medium version of the information storage subsystem s200 is depicted in FIG. 29 as bearing the one or more receiving information video instructions i1130 that when executed will direct performance of the operation o1130. Furthermore, the receiving information video electrical circuitry arrangement (“elec circ arrange”) e1130, when activated, will perform the operation o1130. For instance, in one or more exemplary implementations, the one or more receiving information video instructions i1130, when executed, direct performance of the operation o1130 in the illustrative depiction as follows, and/or the receiving information video electrical circuitry arrangement e1130, when activated, performs the operation o1130 in the illustrative depiction as follows, and/or the operation o1130 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) in video presentation form (e.g. an implementation of the receiver component s528 is configured to electronically engage with the microprocessor component s102 to receive such as based on associated one or more prescriptions, one or more selection menus in video presentation form, such as a menu containing one or more video presentations having one or more descriptions to select from, etc.).

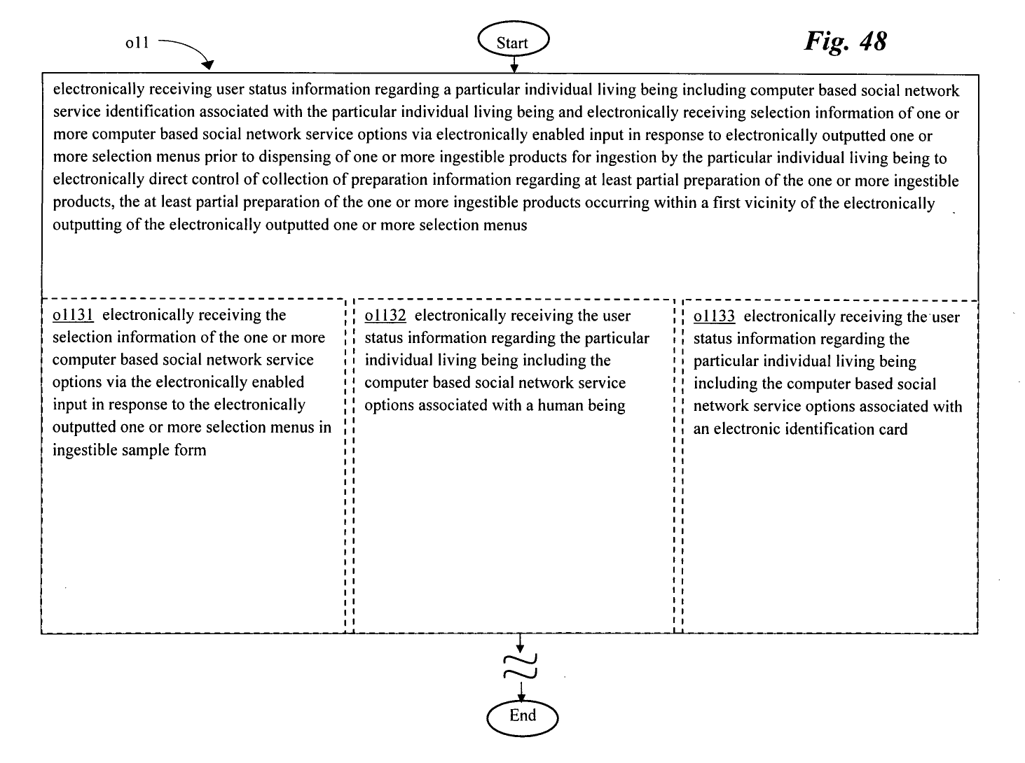

In one or more implementations, as shown in FIG. 48, operation o11 includes an operation o1131 for electronically receiving the selection information of the one or more computer based social network service options via the electronically enabled input in response to the electronically outputted one or more selection menus in ingestible sample form. Origination of an illustratively derived receiving information sample component group can be accomplished through skilled in the art design choice selection of one or more of the above depicted components from one or more of the above depicted subsystems shown in FIG. 10. Components from the receiving information sample component group can be used in implementing execution of the one or more receiving information sample instructions i1131 of FIG. 29, can be used in performance of the receiving information sample electrical circuitry arrangement e1131 of FIG. 20, and/or can be used in otherwise fulfillment of the operation o1131. An exemplary non-transitory signal bearing medium version of the information storage subsystem s200 is depicted in FIG. 29 as bearing the one or more receiving information sample instructions i1131 that when executed will direct performance of the operation o1131. Furthermore, the receiving information sample electrical circuitry arrangement (“elec circ arrange”) e1131, when activated, will perform the operation o1131. For instance, in one or more exemplary implementations, the one or more receiving information sample instructions i1131, when executed, direct performance of the operation o1131 in the illustrative depiction as follows, and/or the receiving information sample electrical circuitry arrangement e1131, when activated, performs the operation o1131 in the illustrative depiction as follows, and/or the operation o1131 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more-computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) in ingestible sample form (e.g. an implementation of the receiver component s528 is configured to electronically engage with the microprocessor component s102 to receive one or more selection menus in ingestible sample form, such as a menu containing ingestible samples that are either stored or produced in real time to serve as or otherwise complement one or more descriptions to select from, etc.

In one or more implementations, as shown in FIG. 48, operation o11 includes an operation o1132 for electronically receiving the user status information regarding the particular individual living being including the computer based social network service options associated with a human being. Origination of an illustratively derived receiving information human component group can be accomplished through skilled in the art design choice selection of one or more of the above depicted components from one or more of the above depicted subsystems shown in FIG. 10. Components from the receiving information human component group can be used in implementing execution of the one or more receiving information human instructions i1132 of FIG. 29, can be used in performance of the receiving information human electrical circuitry arrangement e1132 of FIG. 20, and/or can be used in otherwise fulfillment of the operation o1132. An exemplary non-transitory signal bearing medium version of the information storage subsystem s200 is depicted in FIG. 29 as bearing the one or more receiving information human instructions i1132 that when executed will direct performance of the operation o1132. Furthermore, the receiving information human electrical circuitry arrangement (“elec circ arrange”) e1132, when activated, will perform the operation o1132. For instance, in one or more exemplary implementations, the one or more receiving information human instructions i1132, when executed, direct performance of the operation o1132 in the illustrative depiction as follows, and/or the receiving information human electrical circuitry arrangement e1132, when activated, performs the operation o1132 in the illustrative depiction as follows, and/or the operation o1132 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) associated with a human being (e.g. an implementation of the receiver component s528 is configured to electronically engage with the microprocessor component s102 to receive to be identifying a human being, etc.).

In one or more implementations, as shown in FIG. 48, operation o11 includes an operation o1133 for electronically receiving the user status information regarding the particular individual living being including the computer based social network service options associated with an electronic identification card. Origination of an illustratively derived receiving information ID card component group can be accomplished through skilled in the art design choice selection of one or more of the above depicted components from one or more of the above depicted subsystems shown in FIG. 10. Components from the receiving information ID card component group can be used in implementing execution of the one or more receiving information ID card instructions i1133 of FIG. 29, can be used in performance of the receiving information ID card electrical circuitry arrangement e1133 of FIG. 20, and/or can be used in otherwise fulfillment of the operation o1133. An exemplary non-transitory signal bearing medium version of the information storage subsystem s200 is depicted in FIG. 29 as bearing the one or more receiving information ID card instructions i1133 that when executed will direct performance of the operation o1133. Furthermore, the receiving information ID card electrical circuitry arrangement (“elec circ arrange”) e1133, when activated, will perform the operation o1133. For instance, in one or more exemplary implementations, the one or more receiving information ID card instructions i1133, when executed, direct performance of the operation o1133 in the illustrative depiction as follows, and/or the receiving information ID card electrical circuitry arrangement e1133, when activated, performs the operation o1133 in the illustrative depiction as follows, and/or the operation o1133 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) associated with an electronic identification card (e.g. an implementation of the receiver component s528 is configured to electronically engage with the microprocessor component s102 to receive to be identifying a living being through the electronic identification card, etc.).

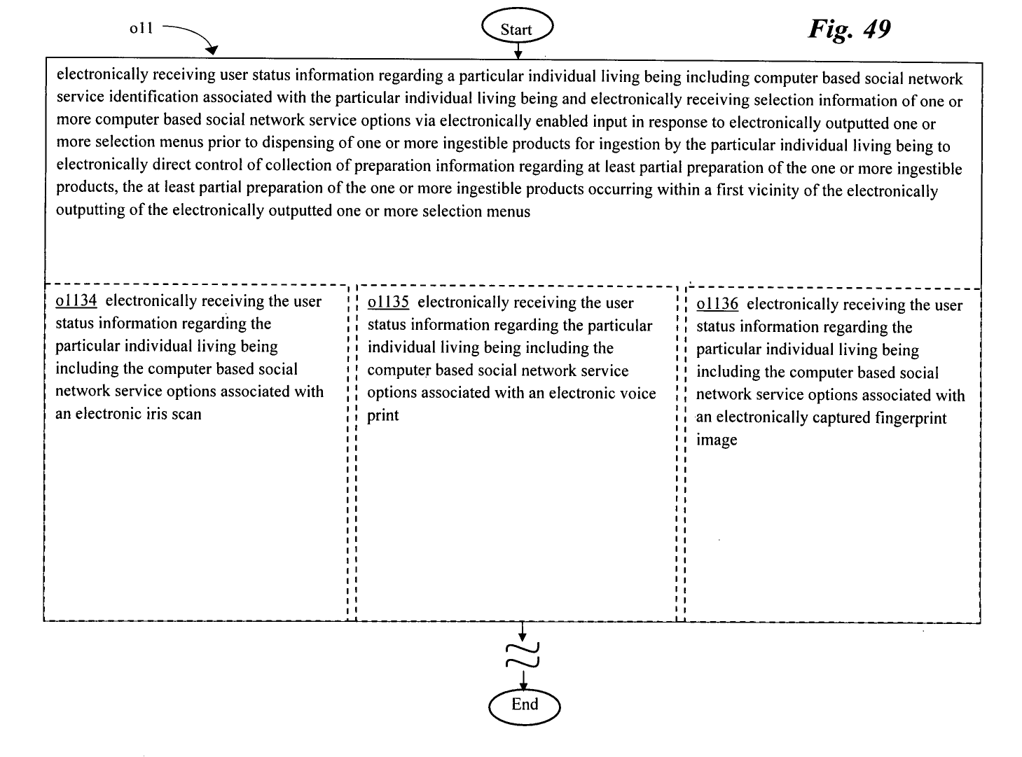

In one or more implementations, as shown in FIG. 49, operation o11 includes an operation o1134 for electronically receiving the user status information regarding the particular individual living being including the computer based social network service options associated with an electronic iris scan. Origination of an illustratively derived receiving information iris scan component group can be accomplished through skilled in the art design choice selection of one or more of the above depicted components from one or more of the above depicted subsystems shown in FIG. 10. Components from the receiving information iris scan component group can be used in implementing execution of the one or more receiving information iris scan instructions i1134 of FIG. 29, can be used in performance of the receiving information iris scan electrical circuitry arrangement e1134 of FIG. 20, and/or can be used in otherwise fulfillment of the operation o1134. An exemplary non-transitory signal bearing medium version of the information storage subsystem s200 is depicted in FIG. 29 as bearing the one or more receiving information iris scan instructions i1134 that when executed will direct performance of the operation o1134. Furthermore, the receiving information iris scan electrical circuitry arrangement (“elec circ arrange”) e1134, when activated, will perform the operation o1134. For instance, in one or more exemplary implementations, the one or more receiving information iris scan instructions i1134, when executed, direct performance of the operation o1134 in the illustrative depiction as follows, and/or the receiving information iris scan electrical circuitry arrangement e1134, when activated, performs the operation o1134 in the illustrative depiction as follows, and/or the operation o1134 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) associated with an electronic iris scan (e.g. an implementation of the receiver component s528 is configured to electronically engage with the microprocessor component s102 to receive the user status information regarding the particular individual living being including living being identification as determined by the microprocessor component to be identifying the living being through the electronic iris scan, etc.

In one or more implementations, as shown in FIG. 49, operation o11 includes an operation o1135 for electronically receiving the user status information regarding the particular individual living being including the computer based social network service options associated with an electronic voice print. Origination of an illustratively derived receiving information voice component group can be accomplished through skilled in the art design choice selection of one or more of the above depicted components from one or more of the above depicted subsystems shown in FIG. 10. Components from the receiving information voice component group can be used in implementing execution of the one or more receiving information voice instructions i1135 of FIG. 29, can be used in performance of the receiving information voice electrical circuitry arrangement e1135 of FIG. 20, and/or can be used in otherwise fulfillment of the operation o1135. An exemplary non-transitory signal bearing medium version of the information storage subsystem s200 is depicted in FIG. 29 as bearing the one or more receiving information voice instructions i1135 that when executed will direct performance of the operation o1135. Furthermore, the receiving information voice electrical circuitry arrangement (“elec circ arrange”) e1135, when activated, will perform the operation o1135. For instance, in one or more exemplary implementations, the one or more receiving information voice instructions i1135, when executed, direct performance of the operation o1135 in the illustrative depiction as follows, and/or the receiving information voice electrical circuitry arrangement e1135, when activated, performs the operation o1135 in the illustrative depiction as follows, and/or the operation o1135 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) associated with an electronic voice print (e.g. an implementation of the receiver component s528 is configured to electronically engage with the microprocessor component s102 to receive to be identifying the living being through the electronic voice print, etc.).

In one or more implementations, as shown in FIG. 49, operation o11 includes an operation o1136 for electronically receiving the user status information regarding the particular individual living being including the computer based social network service options associated with an electronically captured fingerprint image. Origination of an illustratively derived receiving information fingerprint component group can be accomplished through skilled in the art design choice selection of one or more of the above depicted components from one or more of the above depicted subsystems shown in FIG. 10. Components from the receiving information fingerprint component group can be used in implementing execution of the one or more receiving information fingerprint instructions i1136 of FIG. 29, can be used in performance of the receiving information fingerprint electrical circuitry arrangement e1136 of FIG. 20, and/or can be used in otherwise fulfillment of the operation o1136. An exemplary non-transitory signal bearing medium version of the information storage subsystem s200 is depicted in FIG. 29 as bearing the one or more receiving information fingerprint instructions i1136 that when executed will direct performance of the operation o1136. Furthermore, the receiving information fingerprint electrical circuitry arrangement (“elec circ arrange”) e1136, when activated, will perform the operation o1136. For instance, in one or more exemplary implementations, the one or more receiving information fingerprint instructions i1136, when executed, direct performance of the operation o1136 in the illustrative depiction as follows, and/or the receiving information fingerprint electrical circuitry arrangement e1136, when activated, performs the operation o1136 in the illustrative depiction as follows, and/or the operation o1136 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) associated with an electronically captured fingerprint image (e.g. an implementation of the receiver component s528 is configured to electronically engage with the microprocessor component s102 to receive to be identifying the living being through the electronically captured fingerprint image, etc.).

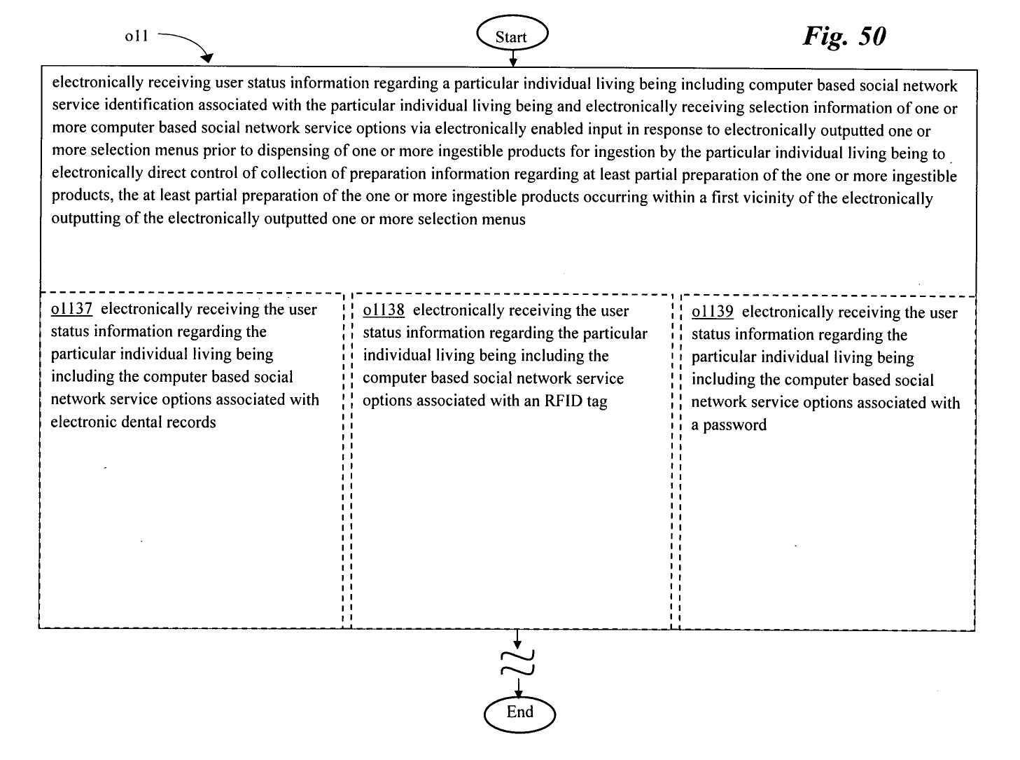

In one or more implementations, as shown in FIG. 50, operation o11 includes an operation o1137 for electronically receiving the user status information regarding the particular individual living being including the computer based social network service options associated with electronic dental records. Origination of an illustratively derived receiving information dental component group can be accomplished through skilled in the art design choice selection of one or more of the above depicted components from one or more of the above depicted subsystems shown in FIG. 10. Components from the receiving information dental component group can be used in implementing execution of the one or more receiving information dental instructions i1137 of FIG. 29, can be used in performance of the receiving information dental electrical circuitry arrangement e1137 of FIG. 20, and/or can be used in otherwise fulfillment of the operation o1137. An exemplary non-transitory signal bearing medium version of the information storage subsystem s200 is depicted in FIG. 29 as bearing the one or more receiving information dental instructions i1137 that when executed will direct performance of the operation o1137. Furthermore, the receiving information dental electrical circuitry arrangement (“elec circ arrange”) e1137, when activated, will perform the operation o1137. For instance, in one or more exemplary implementations, the one or more receiving information dental instructions i1137, when executed, direct performance of the operation o1137 in the illustrative depiction as follows, and/or the receiving information dental electrical circuitry arrangement e1137, when activated, performs the operation o1137 in the illustrative depiction as follows, and/or the operation o1137 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) associated with electronic dental records (e.g. an implementation of the receiver component s528 is configured to electronically engage with the microprocessor component s102 to receive to be identifying the living being through the electronic dental records, etc.).

In one or more implementations, as shown in FIG. 50, operation o11 includes an operation o1138 for electronically receiving the user status information regarding the particular individual living being including the computer based social network service options associated with an RFID tag. Origination of an illustratively derived receiving information RFID component group can be accomplished through skilled in the art design choice selection of one or more of the above depicted components from one or more of the above depicted subsystems shown in FIG. 10. Components from the receiving information RFID component group can be used in implementing execution of the one or more receiving information RFID instructions i1138 of FIG. 29, can be used in performance of the receiving information RFID electrical circuitry arrangement e1138 of FIG. 20, and/or can be used in otherwise fulfillment of the operation o1138. An exemplary non-transitory signal bearing medium version of the information storage subsystem s200 is depicted in FIG. 29 as bearing the one or more receiving information RFID instructions i1138 that when executed will direct performance of the operation o1138. Furthermore, the receiving information RFID electrical circuitry arrangement (“elec circ arrange”) e1138, when activated, will perform the operation o1138. For instance, in one or more exemplary implementations, the one or more receiving information RFID instructions i1138, when executed, direct performance of the operation o1138 in the illustrative depiction as follows, and/or the receiving information RFID electrical circuitry arrangement e1138, when activated, performs the operation o1138 in the illustrative depiction as follows, and/or the operation o1138 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) associated with an RFID tag (e.g. an implementation of the receiver component s528 is configured to electronically engage with the microprocessor component s102 to receive the user status information regarding the particular individual living being including living being identification as determined by the microprocessor component to be identifying the living being through the RFID tag, etc.).

In one or more implementations, as shown in FIG. 50, operation o11 includes an operation o1139 for electronically receiving the user status information regarding the particular individual living being including the computer based social network service options associated with a password. Origination of an illustratively derived receiving information password component group can be accomplished through skilled in the art design choice selection of one or more of the above depicted components from one or more of the above depicted subsystems shown in FIG. 10. Components from the receiving information password component group can be used in implementing execution of the one or more receiving information password instructions i1139 of FIG. 29, can be used in performance of the receiving information password electrical circuitry arrangement e1139 of FIG. 20, and/or can be used in otherwise fulfillment of the operation o1139. An exemplary non-transitory signal bearing medium version of the information storage subsystem s200 is depicted in FIG. 29 as bearing the one or more receiving information password instructions i1139 that when executed will direct performance of the operation o1139. Furthermore, the receiving information password electrical circuitry arrangement (“elec circ arrange”) e1139, when activated, will perform the operation o1139. For instance, in one or more exemplary implementations, the one or more receiving information password instructions i1139, when executed, direct performance of the operation o1139 in the illustrative depiction as follows, and/or the receiving information password electrical circuitry arrangement e1139, when activated, performs the operation o1139 in the illustrative depiction as follows, and/or the operation o1139 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) associated with a password (e.g. an implementation of the receiver component s528 is configured to electronically engage with the microprocessor component s102 to receive as determined by the microprocessor component to be identifying the living being through the password, etc.).

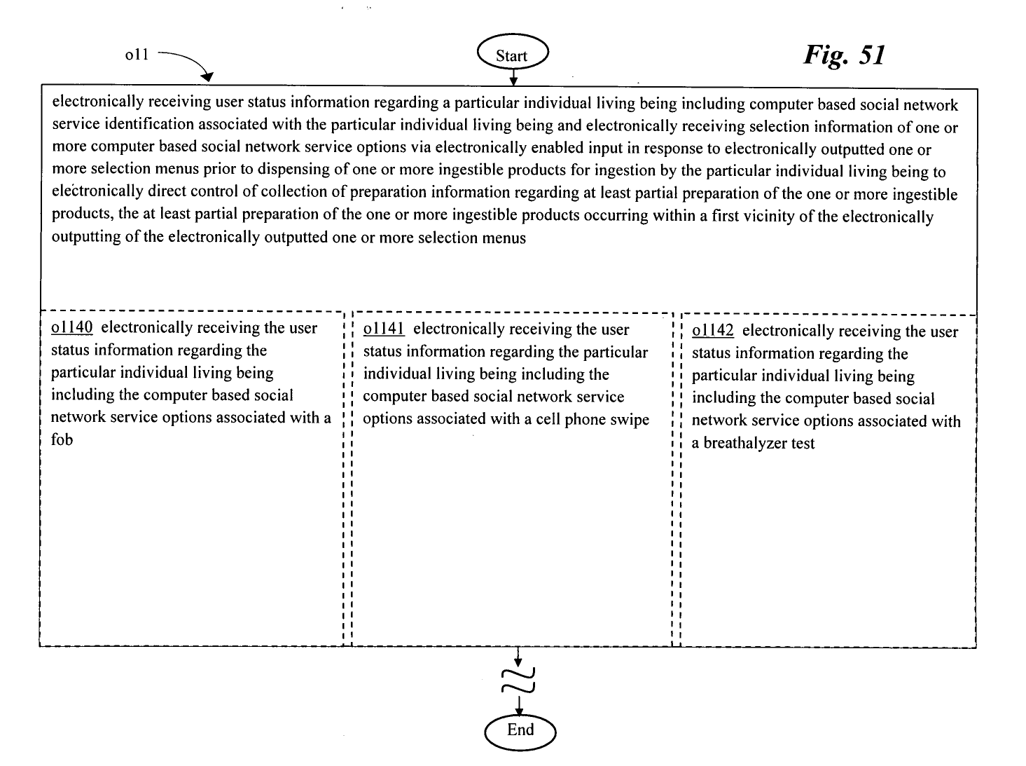

In one or more implementations, as shown in FIG. 51, operation o11 includes an operation o1140 for electronically receiving the user status information regarding the particular individual living being including the computer based social network service options associated with a fob. Origination of an illustratively derived receiving information fob component group can be accomplished through skilled in the art design choice selection of one or more of the above depicted components from one or more of the above depicted subsystems shown in FIG. 10. Components from the receiving information fob component group can be used in implementing execution of the one or more receiving information fob instructions i1140 of FIG. 30, can be used in performance of the receiving information fob electrical circuitry arrangement e1140 of FIG. 21, and/or can be used in otherwise fulfillment of the operation o1140. An exemplary non-transitory signal bearing medium version of the information storage subsystem s200 is depicted in FIG. 30 as bearing the one or more receiving information fob instructions i1140 that when executed will direct performance of the operation o1140. Furthermore, the receiving information fob electrical circuitry arrangement (“elec circ arrange”) e1140, when activated, will perform the operation o1140. For instance, in one or more exemplary implementations, the one or more receiving information fob instructions i1140, when executed, direct performance of the operation o1140 in the illustrative depiction as follows, and/or the receiving information fob electrical circuitry arrangement e1140, when activated, performs the operation o1140 in the illustrative depiction as follows, and/or the operation o1140 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) associated with a fob (e.g. an implementation of the receiver component s528 is configured to electronically engage with the microprocessor component s102 to receive to be identifying the living being through electronic data contained on the fob, etc.).

In one or more implementations, as shown in FIG. 51, operation o11 includes an operation o1141 for electronically receiving the user status information regarding the particular individual living being including the computer based social network service options associated with a cell phone swipe. Origination of an illustratively derived receiving information cell phone component group can be accomplished through skilled in the art design choice selection of one or more of the above depicted components from one or more of the above depicted subsystems shown in FIG. 10. Components from the receiving information cell phone component group can be used in implementing execution of the one or more receiving information cell phone instructions i1141 of FIG. 30, can be used in performance of the receiving information cell phone electrical circuitry arrangement e1141 of FIG. 21, and/or can be used in otherwise fulfillment of the operation o1141. An exemplary non-transitory signal bearing medium version of the information storage subsystem s200 is depicted in FIG. 30 as bearing the one or more receiving information cell phone instructions i1141 that when executed will direct performance of the operation o1141. Furthermore, the receiving information cell phone electrical circuitry arrangement (“elec circ arrange”) e1141, when activated, will perform the operation o1141. For instance, in one or more exemplary implementations, the one or more receiving information cell phone instructions i1141, when executed, direct performance of the operation o1141 in the illustrative depiction as follows, and/or the receiving information cell phone electrical circuitry arrangement e1141, when activated, performs the operation o1141 in the illustrative depiction as follows, and/or the operation o1141 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) associated with a cell phone swipe (e.g. an implementation of the receiver component s528 is configured to electronically engage with the microprocessor component s102 to receive to be identifying the living being through passing the cell phone in close proximity to the cell phone, etc.).

In one or more implementations, as shown in FIG. 51, operation o11 includes an operation o1142 for electronically receiving the user status information regarding the particular individual living being including the computer based social network service options associated with a breathalyzer test. Origination of an illustratively derived receiving information breathalyzer component group can be accomplished through skilled in the art design choice selection of one or more of the above depicted components from one or more of the above depicted subsystems shown in FIG. 10. Components from the receiving information breathalyzer component group can be used in implementing execution of the one or more receiving information breathalyzer instructions i1142 of FIG. 30, can be used in performance of the receiving information breathalyzer electrical circuitry arrangement e1142 of FIG. 21, and/or can be used in otherwise fulfillment of the operation o1142. An exemplary non-transitory signal bearing medium version of the information storage subsystem s200 is depicted in FIG. 30 as bearing the one or more receiving information breathalyzer instructions i1142 that when executed will direct performance of the operation o1142. Furthermore, the receiving information breathalyzer electrical circuitry arrangement (“elec circ arrange”) e1142, when activated, will perform the operation o1142. For instance, in one or more exemplary implementations, the one or more receiving information breathalyzer instructions i1142, when executed, direct performance of the operation o1142 in the illustrative depiction as follows, and/or the receiving information breathalyzer electrical circuitry arrangement e1142, when activated, performs the operation o1142 in the illustrative depiction as follows, and/or the operation o1142 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) regarding the particular individual living being (e.g. one of more of a consumer, a gourmand, a hobbyist, an athlete, a student, a dieter, a patient, an animal, an inmate, a health seeker, a worker, a pedestrian, etc.) including the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) associated with a breathalyzer test (e.g. an implementation of the receiver component s528 is configured to electronically engage with the microprocessor component s102 to receive to be identifying the living being through the breathalyzer test of the living being, etc.).

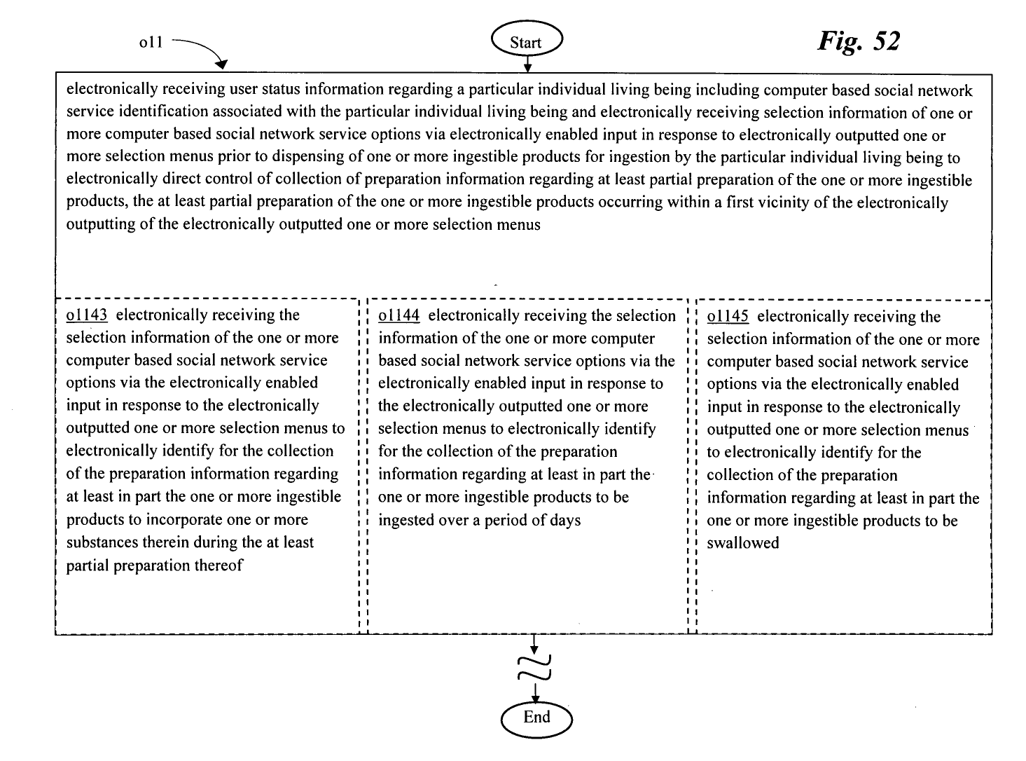

In one or more implementations, as shown in FIG. 52, operation o11 includes an operation o1143 for electronically receiving the selection information of the one or more computer based social network service options via the electronically enabled input in response to the electronically outputted one or more selection menus to electronically identify for the collection of the preparation information regarding at least in part the one or more ingestible products to incorporate one or more substances therein during the at least partial preparation thereof. Origination of an illustratively derived receiving information incorporate component group can be accomplished through skilled in the art design choice selection of one or more of the above depicted components from one or more of the above depicted subsystems shown in FIG. 10. Components from the receiving information incorporate component group can be used in implementing execution of the one or more receiving information incorporate instructions i1143 of FIG. 30, can be used in performance of the receiving information incorporate electrical circuitry arrangement e1143 of FIG. 21, and/or can be used in otherwise fulfillment of the operation o1143. An exemplary non-transitory signal bearing medium version of the information storage subsystem s200 is depicted in FIG. 30 as bearing the one or more receiving information incorporate instructions i1143 that when executed will direct performance of the operation o1143. Furthermore, the receiving information incorporate electrical circuitry arrangement (“elec circ arrange”) e1143, when activated, will perform the operation o1143. For instance, in one or more exemplary implementations, the one or more receiving information incorporate instructions i1143, when executed, direct performance of the operation o1143 in the illustrative depiction as follows, and/or the receiving information incorporate electrical circuitry arrangement e1143, when activated, performs the operation o1143 in the illustrative depiction as follows, and/or the operation o1143 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to electronically identify for the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding at least in part the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) to incorporate one or more substances (e.g. involving one or more of powder, liquid, bars, paste, slurry, particles, aerosol, etc.) therein during the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) thereof (e.g. an implementation of the receiver component s528 is configured to electronically receive the selection information of the one or more ingestible products and engage with the microprocessor component s102 in response to the electronically outputted one or more selection menus to include the substance as an amino acid incorporated into the sandwich, etc.).

In one or more implementations, as shown in FIG. 52, operation o11 includes an operation o1144 for electronically receiving the selection information of the one or more computer based social network service options via the electronically enabled input in response to the electronically outputted one or more selection menus to electronically identify for the collection of the preparation information regarding at least in part the one or more ingestible products to be ingested over a period of days. Origination of an illustratively derived receiving information days component group can be accomplished through skilled in the art design choice selection of one or more of the above depicted components from one or more of the above depicted subsystems shown in FIG. 10. Components from the receiving information days component group can be used in implementing execution of the one or more receiving information days instructions i1144 of FIG. 30, can be used in performance of the receiving information days electrical circuitry arrangement e1144 of FIG. 21, and/or can be used in otherwise fulfillment of the operation o1144. An exemplary non-transitory signal bearing medium version of the information storage subsystem s200 is depicted in FIG. 30 as bearing the one or more receiving information days instructions i1144 that when executed will direct performance of the operation o1144. Furthermore, the receiving information days electrical circuitry arrangement (“elec circ arrange”) e1144, when activated, will perform the operation o1144. For instance, in one or more exemplary implementations, the one or more receiving information days instructions i1144, when executed, direct performance of the operation o1144 in the illustrative depiction as follows, and/or the receiving information days electrical circuitry arrangement e1144, when activated, performs the operation o1144 in the illustrative depiction as follows, and/or the operation o1144 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to electronically identify for the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding at least in part the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) to be ingested over a period of days (e.g. such as a pharmaceutical agent that is encapsulated in pill form to be ingested over a period of days by a living being, such as a boy, at the same time that the smoothie is being ingested by the boy, etc.).

In one or more implementations, as shown in FIG. 52, operation o11 includes an operation o1145 for electronically receiving the selection information of the one or more computer based social network service options via the electronically enabled input in response to the electronically outputted one or more selection menus to electronically identify for the collection of the preparation information regarding at least in part the one or more ingestible products to be swallowed. Origination of an illustratively derived receiving information swallow component group can be accomplished through skilled in the art design choice selection of one or more of the above depicted components from one or more of the above depicted subsystems shown in FIG. 10. Components from the receiving information swallow component group can be used in implementing execution of the one or more receiving information swallow instructions i1145 of FIG. 30, can be used in performance of the receiving information swallow electrical circuitry arrangement e1145 of FIG. 21, and/or can be used in otherwise fulfillment of the operation o1145. An exemplary non-transitory signal bearing medium version of the information storage subsystem s200 is depicted in FIG. 30 as bearing the one or more receiving information swallow instructions i1145 that when executed will direct performance of the operation o1145. Furthermore, the receiving information swallow electrical circuitry arrangement (“elec circ arrange”) e1145, when activated, will perform the operation o1145. For instance, in one or more exemplary implementations, the one or more receiving information swallow instructions i1145, when executed, direct performance of the operation o1145 in the illustrative depiction as follows, and/or the receiving information swallow electrical circuitry arrangement e1145, when activated, performs the operation o1145 in the illustrative depiction as follows, and/or the operation o1145 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to electronically identify for the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding at least in part the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) to be swallowed (e.g. to be swallowed such as a snack bar, etc.).

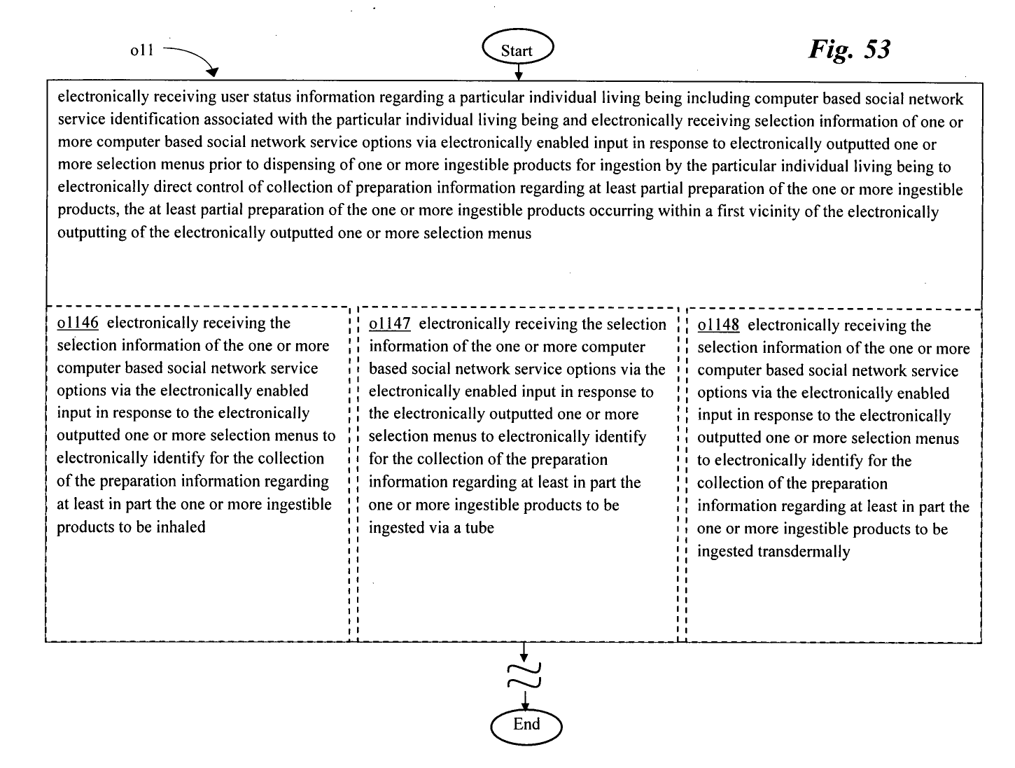

In one or more implementations, as shown in FIG. 53, operation o11 includes an operation o1146 for electronically receiving the selection information of the one or more computer based social network service options via the electronically enabled input in response to the electronically outputted one or more selection menus to electronically identify for the collection of the preparation information regarding at least in part the one or more ingestible products to be inhaled. Origination of an illustratively derived receiving information inhaled component group can be accomplished through skilled in the art design choice selection of one or more of the above depicted components from one or more of the above depicted subsystems shown in FIG. 10. Components from the receiving information inhaled component group can be used in implementing execution of the one or more receiving information inhaled instructions i1146 of FIG. 30, can be used in performance of the receiving information inhaled electrical circuitry arrangement e1146 of FIG. 21, and/or can be used in otherwise fulfillment of the operation o1146. An exemplary non-transitory signal bearing medium version of the information storage subsystem s200 is depicted in FIG. 30 as bearing the one or more receiving information inhaled instructions i1146 that when executed will direct performance of the operation o1146. Furthermore, the receiving information inhaled electrical circuitry arrangement (“elec circ arrange”) e1146, when activated, will perform the operation o1146. For instance, in one or more exemplary implementations, the one or more receiving information inhaled instructions i1146, when executed, direct performance of the operation o1146 in the illustrative depiction as follows, and/or the receiving information inhaled electrical circuitry arrangement e1146, when activated, performs the operation o1146 in the illustrative depiction as follows, and/or the operation o1146 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to electronically identify for the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding at least in part the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) to be inhaled (e.g. to be inhaled such as a medicament dispensed through a nebulizer, etc.).

In one or more implementations, as shown in FIG. 53, operation o11 includes an operation o1147 for electronically receiving the selection information of the one or more computer based social network service options via the electronically enabled input in response to the electronically outputted one or more selection menus to electronically identify for the collection of the preparation information regarding at least in part the one or more ingestible products to be ingested via a tube. Origination of an illustratively derived receiving information tube component group can be accomplished through skilled in the art design choice selection of one or more of the above depicted components from one or more of the above depicted subsystems shown in FIG. 10. Components from the receiving information tube component group can be used in implementing execution of the one or more receiving information tube instructions i1147 of FIG. 30, can be used in performance of the receiving information tube electrical circuitry arrangement e1147 of FIG. 21, and/or can be used in otherwise fulfillment of the operation o1147. An exemplary non-transitory signal bearing medium version of the information storage subsystem s200 is depicted in FIG. 30 as bearing the one or more receiving information tube instructions i1147 that when executed will direct performance of the operation o1147. Furthermore, the receiving information tube electrical circuitry arrangement (“elec circ arrange”) e1147, when activated, will perform the operation o1147. For instance, in one or more exemplary implementations, the one or more receiving information tube instructions i1147, when executed, direct performance of the operation o1147 in the illustrative depiction as follows, and/or the receiving information tube electrical circuitry arrangement e1147, when activated, performs the operation o1147 in the illustrative depiction as follows, and/or the operation o1147 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to electronically identify for the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding at least in part the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) to be ingested via a tube (e.g. to be ingested via a tube such as a liquid meal replacement, etc.).

In one or more implementations, as shown in FIG. 53, operation o11 includes an operation o1148 for electronically receiving the selection information of the one or more computer based social network service options via the electronically enabled input in response to the electronically outputted one or more selection menus to electronically identify for the collection of the preparation information regarding at least in part the one or more ingestible products to be ingested transdermally. Origination of an illustratively derived receiving information transdermal component group can be accomplished through skilled in the art design choice selection of one or more of the above depicted components from one or more of the above depicted subsystems shown in FIG. 10. Components from the receiving information transdermal component group can be used in implementing execution of the one or more receiving information transdermal instructions i1148 of FIG. 30, can be used in performance of the receiving information transdermal electrical circuitry arrangement e1148 of FIG. 21, and/or can be used in otherwise fulfillment of the operation o1148. An exemplary non-transitory signal bearing medium version of the information storage subsystem s200 is depicted in FIG. 30 as bearing the one or more receiving information transdermal instructions i1148 that when executed will direct performance of the operation o1148. Furthermore, the receiving information transdermal electrical circuitry arrangement (“elec circ arrange”) e1148, when activated, will perform the operation o1148. For instance, in one or more exemplary implementations, the one or more receiving information transdermal instructions i1148, when executed, direct performance of the operation o1148 in the illustrative depiction as follows, and/or the receiving information transdermal electrical circuitry arrangement e1148, when activated, performs the operation o1148 in the illustrative depiction as follows, and/or the operation o1148 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to electronically identify for the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding at least in part the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) to be ingested transdermally (e.g. to be ingested transdermally such as a cream, etc.).

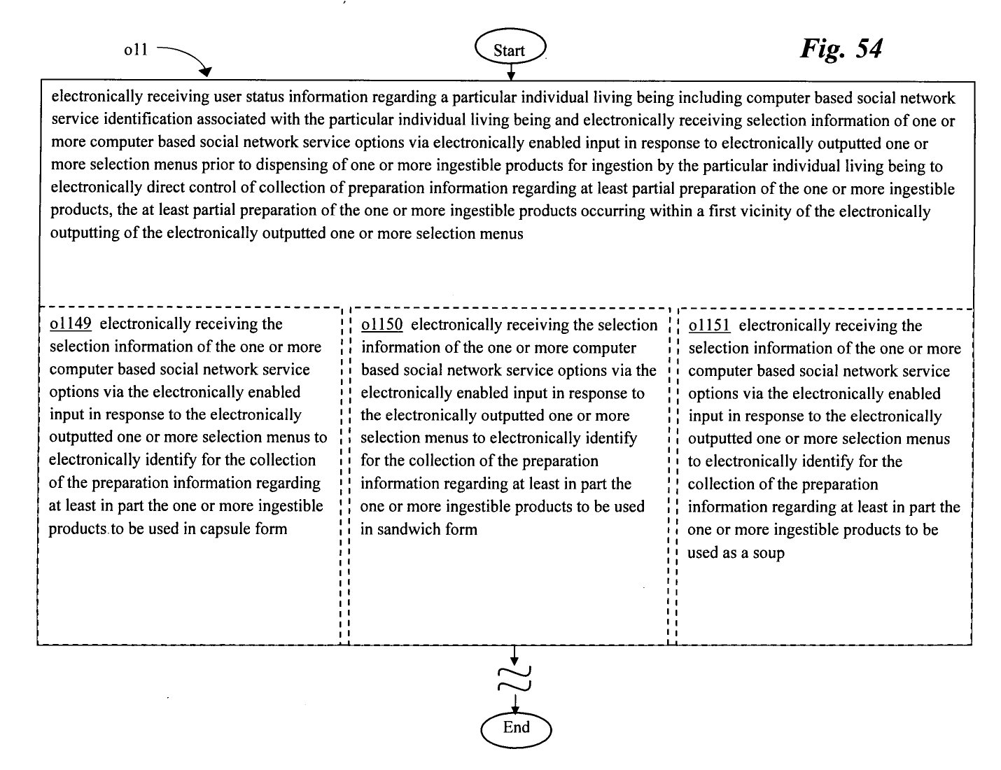

In one or more implementations, as shown in FIG. 54, operation o11 includes an operation o1149 for electronically receiving the selection information of the one or more computer based social network service options via the electronically enabled input in response to the electronically outputted one or more selection menus to electronically identify for the collection of the preparation information regarding at least in part the one or more ingestible products to be used in capsule form. Origination of an illustratively derived receiving information capsule component group can be accomplished through skilled in the art design choice selection of one or more of the above depicted components from one or more of the above depicted subsystems shown in FIG. 10. Components from the receiving information capsule component group can be used in implementing execution of the one or more receiving information capsule instructions i1149 of FIG. 30, can be used in performance of the receiving information capsule electrical circuitry arrangement e1149 of FIG. 21, and/or can be used in otherwise fulfillment of the operation o1149. An exemplary non-transitory signal bearing medium version of the information storage subsystem s200 is depicted in FIG. 30 as bearing the one or more receiving information capsule instructions i1149 that when executed will direct performance of the operation o1149. Furthermore, the receiving information capsule electrical circuitry arrangement (“elec circ arrange”) e1149, when activated, will perform the operation o1149. For instance, in one or more exemplary implementations, the one or more receiving information capsule instructions i1149, when executed, direct performance of the operation o1149 in the illustrative depiction as follows, and/or the receiving information capsule electrical circuitry arrangement e1149, when activated, performs the operation o1149 in the illustrative depiction as follows, and/or the operation o1149 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to electronically identify for the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding at least in part the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) to be used in capsule form (e.g. to be used in capsule form, such as through capsules via encapsulation, etc.).

In one or more implementations, as shown in FIG. 54, operation o11 includes an operation o1150 for electronically receiving the selection information of the one or more computer based social network service options via the electronically enabled input in response to the electronically outputted one or more selection menus to electronically identify for the collection of the preparation information regarding at least in part the one or more ingestible products to be used in sandwich form. Origination of an illustratively derived receiving information sandwich component group can be accomplished through skilled in the art design choice selection of one or more of the above depicted components from one or more of the above depicted subsystems shown in FIG. 10. Components from the receiving information sandwich component group can be used in implementing execution of the one or more receiving information sandwich instructions i1150 of FIG. 30, can be used in performance of the receiving information sandwich electrical circuitry arrangement e1150 of FIG. 21, and/or can be used in otherwise fulfillment of the operation o1150. An exemplary non-transitory signal bearing medium version of the information storage subsystem s200 is depicted in FIG. 30 as bearing the one or more receiving information sandwich instructions i1150 that when executed will direct performance of the operation o1150. Furthermore, the receiving information sandwich electrical circuitry arrangement (“elec circ arrange”) e1150, when activated, will perform the operation o1150. For instance, in one or more exemplary implementations, the one or more receiving information sandwich instructions i1150, when executed, direct performance of the operation o1150 in the illustrative depiction as follows, and/or the receiving information sandwich electrical circuitry arrangement e1150, when activated, performs the operation o1150 in the illustrative depiction as follows, and/or the operation o1150 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to electronically identify for the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding at least in part the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) to be used in sandwich form (e.g. in sandwich form such as a hamburger, etc.).

In one or more implementations, as shown in FIG. 54, operation o11 includes an operation o1151 for electronically receiving the selection information of the one or more computer based social network service options via the electronically enabled input in response to the electronically outputted one or more selection menus to electronically identify for the collection of the preparation information regarding at least in part the one or more ingestible products to be used as a soup. Origination of an illustratively derived receiving information soup component group can be accomplished through skilled in the art design choice selection of one or more of the above depicted components from one or more of the above depicted subsystems shown in FIG. 10. Components from the receiving information soup component group can be used in implementing execution of the one or more receiving information soup instructions i1151 of FIG. 30, can be used in performance of the receiving information soup electrical circuitry arrangement e1151 of FIG. 21, and/or can be used in otherwise fulfillment of the operation o1151. An exemplary non-transitory signal bearing medium version of the information storage subsystem s200 is depicted in FIG. 30 as bearing the one or more receiving information soup instructions i1151 that when executed will direct performance of the operation o1151. Furthermore, the receiving information soup electrical circuitry arrangement (“elec circ arrange”) e1151, when activated, will perform the operation o1151. For instance, in one or more exemplary implementations, the one or more receiving information soup instructions i1151, when executed, direct performance of the operation o1151 in the illustrative depiction as follows, and/or the receiving information soup electrical circuitry arrangement e1151, when activated, performs the operation o1151 in the illustrative depiction as follows, and/or the operation o1151 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to electronically identify for the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding at least in part the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) to be used as a soup (e.g. to be used as a soup such as tomato soup, etc.).

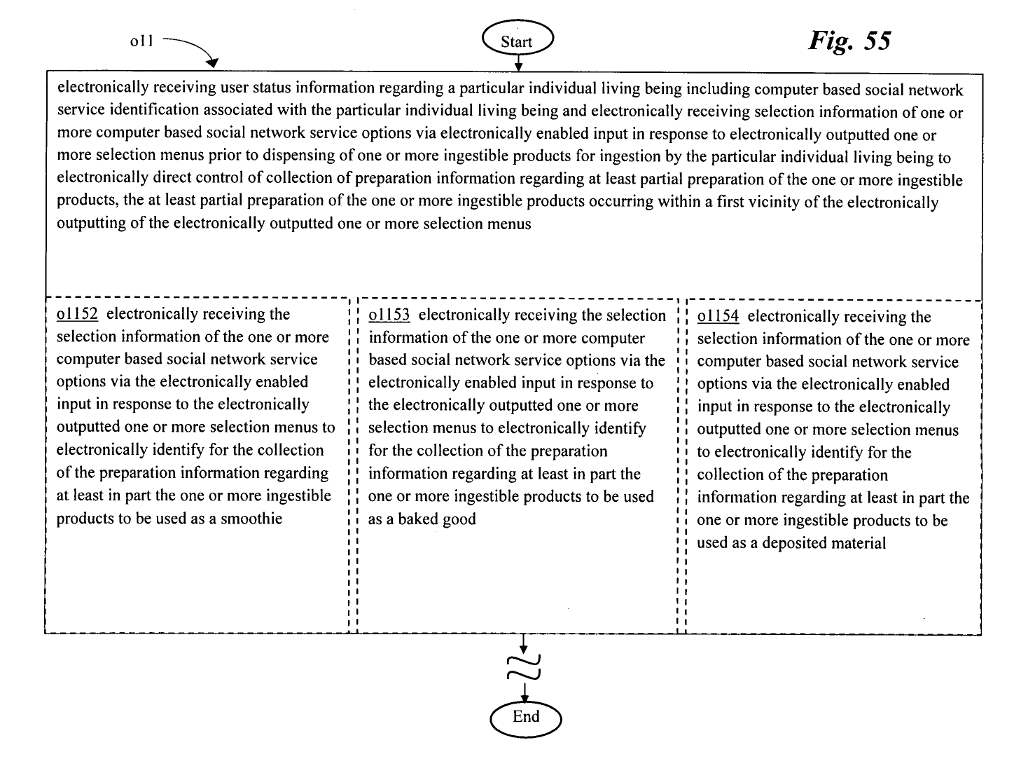

In one or more implementations, as shown in FIG. 55, operation o11 includes an operation o1152 for electronically receiving the selection information of the one or more computer based social network service options via the electronically enabled input in response to the electronically outputted one or more selection menus to electronically identify for the collection of the preparation information regarding at least in part the one or more ingestible products to be used as a smoothie. Origination of an illustratively derived receiving information smoothie component group can be accomplished through skilled in the art design choice selection of one or more of the above depicted components from one or more of the above depicted subsystems shown in FIG. 10. Components from the receiving information smoothie component group can be used in implementing execution of the one or more receiving information smoothie instructions i1152 of FIG. 30, can be used in performance of the receiving information smoothie electrical circuitry arrangement e1152 of FIG. 21, and/or can be used in otherwise fulfillment of the operation o1152. An exemplary non-transitory signal bearing medium version of the information storage subsystem s200 is depicted in FIG. 30 as bearing the one or more receiving information smoothie instructions i1152 that when executed will direct performance of the operation o1152. Furthermore, the receiving information smoothie electrical circuitry arrangement (“elec circ arrange”) e1152, when activated, will perform the operation o1152. For instance, in one or more exemplary implementations, the one or more receiving information smoothie instructions i1152, when executed, direct performance of the operation o1152 in the illustrative depiction as follows, and/or the receiving information smoothie electrical circuitry arrangement e1152, when activated, performs the operation o1152 in the illustrative depiction as follows, and/or the operation o1152 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to electronically identify for the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding at least in part the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) to be used as a smoothie (e.g. to be used a smoothie such as a fruit smoothie, etc.).

In one or more implementations, as shown in FIG. 55, operation o11 includes an operation o1153 for electronically receiving the selection information of the one or more computer based social network service options via the electronically enabled input in response to the electronically outputted one or more selection menus to electronically identify for the collection of the preparation information regarding at least in part the one or more ingestible products to be used as a baked good. Origination of an illustratively derived receiving information baked component group can be accomplished through skilled in the art design choice selection of one or more of the above depicted components from one or more of the above depicted subsystems shown in FIG. 10. Components from the receiving information baked component group can be used in implementing execution of the one or more receiving information baked instructions i1153 of FIG. 30, can be used in performance of the receiving information baked electrical circuitry arrangement e1153 of FIG. 21, and/or can be used in otherwise fulfillment of the operation o1153. An exemplary non-transitory signal bearing medium version of the information storage subsystem s200 is depicted in FIG. 30 as bearing the one or more receiving information baked instructions i1153 that when executed will direct performance of the operation o1153. Furthermore, the receiving information baked electrical circuitry arrangement (“elec circ arrange”) e1153, when activated, will perform the operation o1153. For instance, in one or more exemplary implementations, the one or more receiving information baked instructions i1153, when executed, direct performance of the operation o1153 in the illustrative depiction as follows, and/or the receiving information baked electrical circuitry arrangement e1153, when activated, performs the operation o1153 in the illustrative depiction as follows, and/or the operation o1153 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to electronically identify for the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding at least in part the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) to be used as a baked good (e.g. to be used as a baked good such as a muffin, etc.).

In one or more implementations, as shown in FIG. 55, operation o11 includes an operation o1154 for electronically receiving the selection information of the one or more computer based social network service options via the electronically enabled input in response to the electronically outputted one or more selection menus to electronically identify for the collection of the preparation information regarding at least in part the one or more ingestible products to be used as a deposited material. Origination of an illustratively derived receiving information deposited component group can be accomplished through skilled in the art design choice selection of one or more of the above depicted components from one or more of the above depicted subsystems shown in FIG. 10. Components from the receiving information deposited component group can be used in implementing execution of the one or more receiving information deposited instructions i1154 of FIG. 30, can be used in performance of the receiving information deposited electrical circuitry arrangement e1154 of FIG. 21, and/or can be used in otherwise fulfillment of the operation o1154. An exemplary non-transitory signal bearing medium version of the information storage subsystem s200 is depicted in FIG. 30 as bearing the one or more receiving information deposited instructions i1154 that when executed will direct performance of the operation o1154. Furthermore, the receiving information deposited electrical circuitry arrangement (“elec circ arrange”) e1154, when activated, will perform the operation o1154. For instance, in one or more exemplary implementations, the one or more receiving information deposited instructions i1154, when executed, direct performance of the operation o1154 in the illustrative depiction as follows, and/or the receiving information deposited electrical circuitry arrangement e1154, when activated, performs the operation o1154 in the illustrative depiction as follows, and/or the operation o1154 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to electronically identify for the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding at least in part the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) to be used as a deposited material (e.g. to be used as a deposited material such as a multi-layered cake, etc.).

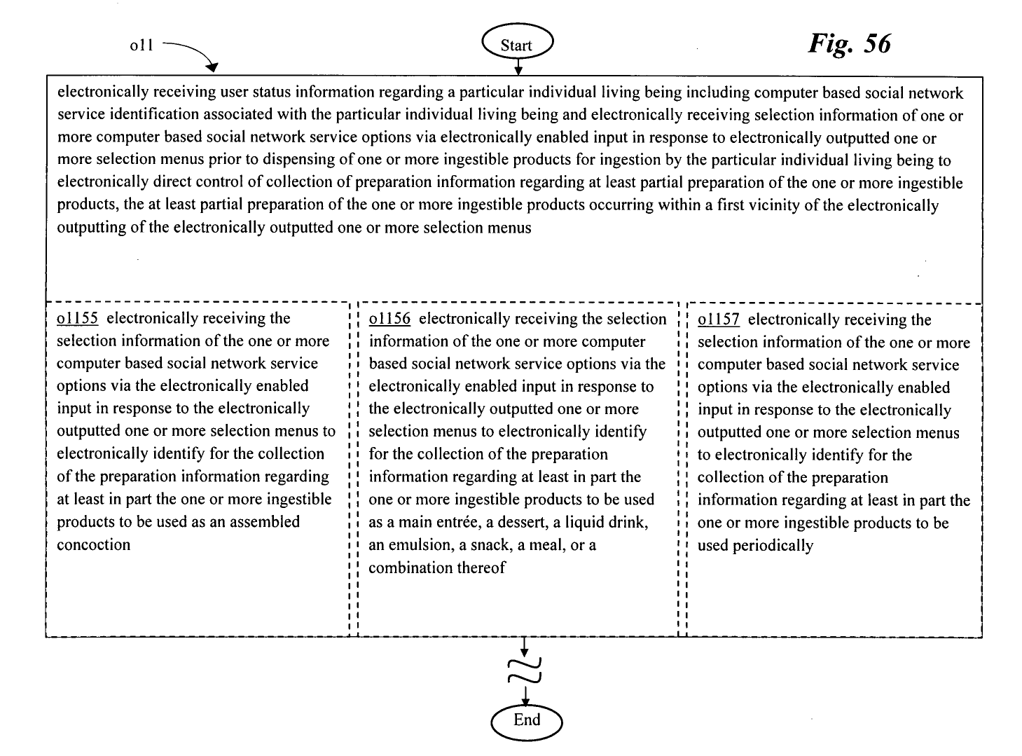

In one or more implementations, as shown in FIG. 56, operation o11 includes an operation o1155 for electronically receiving the selection information of the one or more computer based social network service options via the electronically enabled input in response to the electronically outputted one or more selection menus to electronically identify for the collection of the preparation information regarding at least in part the one or more ingestible products to be used as an assembled concoction. Origination of an illustratively derived receiving information assembled component group can be accomplished through skilled in the art design choice selection of one or more of the above depicted components from one or more of the above depicted subsystems shown in FIG. 10. Components from the receiving information assembled component group can be used in implementing execution of the one or more receiving information assembled instructions i1155 of FIG. 30, can be used in performance of the receiving information assembled electrical circuitry arrangement e1155 of FIG. 21, and/or can be used in otherwise fulfillment of the operation o1155. An exemplary non-transitory signal bearing medium version of the information storage subsystem s200 is depicted in FIG. 30 as bearing the one or more receiving information assembled instructions it i1155 that when executed will direct performance of the operation o1155. Furthermore, the receiving information assembled electrical circuitry arrangement (“elec circ arrange”) e1155, when activated, will perform the operation o1155. For instance, in one or more exemplary implementations, the one or more receiving information assembled instructions i1155, when executed, direct performance of the operation o1155 in the illustrative depiction as follows, and/or the receiving information assembled electrical circuitry arrangement e1155, when activated, performs the operation o1155 in the illustrative depiction as follows, and/or the operation o1155 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to electronically identify for the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding at least in part the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) to be used as an assembled concoction (e.g. to be used as an assembled concoction such as a decorated confection, etc.).

In one or more implementations, as shown in FIG. 56, operation o11 includes an operation o1156 for electronically receiving the selection information of the one or more computer based social network service options via the electronically enabled input in response to the electronically outputted one or more selection menus to electronically identify for the collection of the preparation information regarding at least in part the one or more ingestible products to be used as a main entrée, a dessert, a liquid drink, an emulsion, a snack, a meal, or a combination thereof. Origination of an illustratively derived receiving information uses component group can be accomplished through skilled in the art design choice selection of one or more of the above depicted components from one or more of the above depicted subsystems shown in FIG. 10. Components from the receiving information uses component group can be used in implementing execution of the one or more receiving information uses instructions i1156 of FIG. 30, can be used in performance of the receiving information uses electrical circuitry arrangement e1156 of FIG. 21, and/or can be used in otherwise fulfillment of the operation o1156. An exemplary non-transitory signal bearing medium version of the information storage subsystem s200 is depicted in FIG. 30 as bearing the one or more receiving information uses instructions i1156 that when executed will direct performance of the operation o1156. Furthermore, the receiving information uses electrical circuitry arrangement (“elec circ arrange”) e1156, when activated, will perform the operation o1156. For instance, in one or more exemplary implementations, the one or more receiving information uses instructions i1156, when executed, direct performance of the operation o1156 in the illustrative depiction as follows, and/or the receiving information uses electrical circuitry arrangement e1156, when activated, performs the operation o1156 in the illustrative depiction as follows, and/or the operation o1156 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to electronically identify for the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding at least in part the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) to be used as a main entrée, a dessert, a liquid drink, an emulsion, a snack, a meal, or a combination thereof (e.g. to be used as a as a main entrée, a dessert, a liquid drink, an emulsion, a snack, a meal, or a combination thereof such as a steak dinner, etc.).

In one or more implementations, as shown in FIG. 56, operation o11 includes an operation o1157 for electronically receiving the selection information of the one or more computer based social network service options via the electronically enabled input in response to the electronically outputted one or more selection menus to electronically identify for the collection of the preparation information regarding at least in part the one or more ingestible products to be used periodically. Origination of an illustratively derived receiving information periods component group can be accomplished through skilled in the art design choice selection of one or more of the above depicted components from one or more of the above depicted subsystems shown in FIG. 10. Components from the receiving information periods component group can be used in implementing execution of the one or more receiving information periods instructions i1157 of FIG. 30, can be used in performance of the receiving information periods electrical circuitry arrangement e1157 of FIG. 21, and/or can be used in otherwise fulfillment of the operation o1157. An exemplary non-transitory signal bearing medium version of the information storage subsystem s200 is depicted in FIG. 30 as bearing the one or more receiving information periods instructions i1157 that when executed will direct performance of the operation o1157. Furthermore, the receiving information periods electrical circuitry arrangement (“elec circ arrange”) e1157, when activated, will perform the operation o1157. For instance, in one or more exemplary implementations, the one or more receiving information periods instructions i1157, when executed, direct performance of the operation o1157 in the illustrative depiction as follows, and/or the receiving information periods electrical circuitry arrangement e1157, when activated, performs the operation o1157 in the illustrative depiction as follows, and/or the operation o1157 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to electronically identify for the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding at least in part the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) to be used periodically (e.g. to be used periodically such as once a week, etc.).

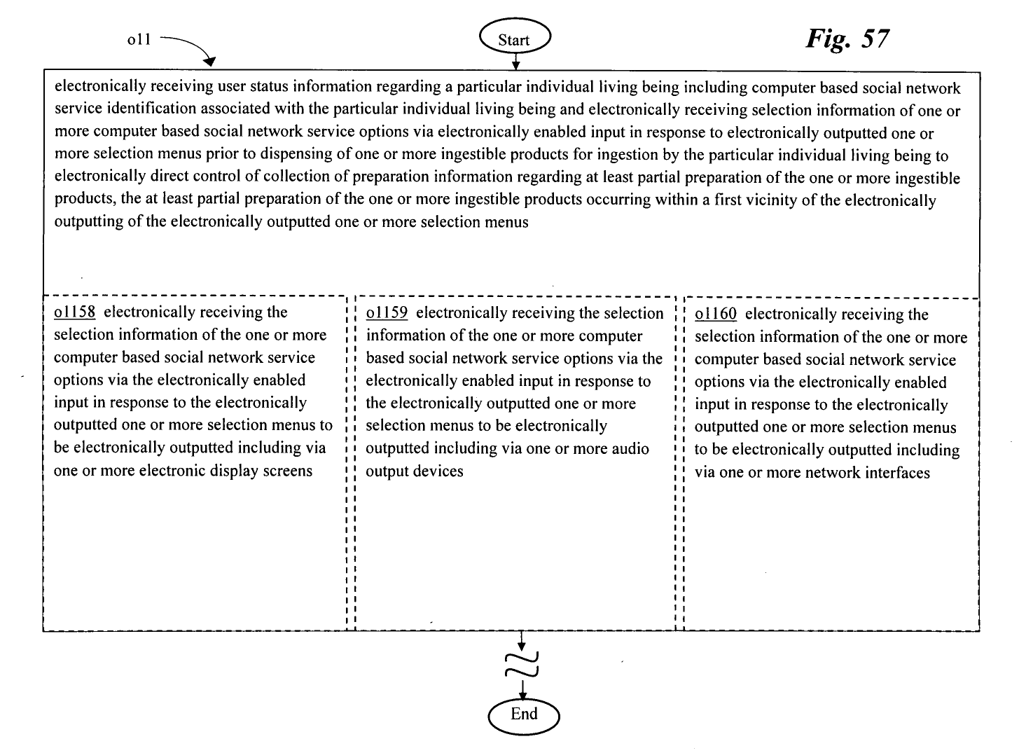

In one or more implementations, as shown in FIG. 57, operation o11 includes an operation o1158 for electronically receiving the selection information of the one or more computer based social network service options via the electronically enabled input in response to the electronically outputted one or more selection menus to be electronically outputted including via one or more electronic display screens. Origination of an illustratively derived receiving information display component group can be accomplished through skilled in the art design choice selection of one or more of the above depicted components from one or more of the above depicted subsystems shown in FIG. 10. Components from the receiving information display component group can be used in implementing execution of the one or more receiving information display instructions i1158 of FIG. 30, can be used in performance of the receiving information display electrical circuitry arrangement e1158 of FIG. 21, and/or can be used in otherwise fulfillment of the operation o1158. An exemplary non-transitory signal bearing medium version of the information storage subsystem s200 is depicted in FIG. 30 as bearing the one or more receiving information display instructions i1158 that when executed will direct performance of the operation o1158. Furthermore, the receiving information display electrical circuitry arrangement (“elec circ arrange”) e1158, when activated, will perform the operation o1158. For instance, in one or more exemplary implementations, the one or more receiving information display instructions i1158, when executed, direct performance of the operation o1158 in the illustrative depiction as follows, and/or the receiving information display electrical circuitry arrangement e1158, when activated, performs the operation o1158 in the illustrative depiction as follows, and/or the operation o1158 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to be electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) including via one or more electronic display screens (e.g. to be electronically outputted including via one or more display screens such as via graphical user interface (GUI) component s302, etc.).

In one or more implementations, as shown in FIG. 57, operation o11 includes an operation o1159 for electronically receiving the selection information of the one or more computer based social network service options via the electronically enabled input in response to the electronically outputted one or more selection menus to be electronically outputted including via one or more audio output devices. Origination of an illustratively derived receiving information audio component group can be accomplished through skilled in the art design choice selection of one or more of the above depicted components from one or more of the above depicted subsystems shown in FIG. 10. Components from the receiving information audio component group can be used in implementing execution of the one or more receiving information audio instructions i1159 of FIG. 30, can be used in performance of the receiving information audio electrical circuitry arrangement e1159 of FIG. 21, and/or can be used in otherwise fulfillment of the operation o1159. An exemplary non-transitory signal bearing medium version of the information storage subsystem s200 is depicted in FIG. 30 as bearing the one or more receiving information audio instructions i1159 that when executed will direct performance of the operation o1159. Furthermore, the receiving information audio electrical circuitry arrangement (“elec circ arrange”) e1159, when activated, will perform the operation o1159. For instance, in one or more exemplary implementations, the one or more receiving information audio instructions i1159, when executed, direct performance of the operation o1159 in the illustrative depiction as follows, and/or the receiving information audio electrical circuitry arrangement e1159, when activated, performs the operation o1159 in the illustrative depiction as follows, and/or the operation o1159 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to be electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) including via one or more audio output devices (e.g. to be electronically outputted including via one or more audio output devices such as via audio in/out component s328, etc.).

In one or more implementations, as shown in FIG. 57, operation o11 includes an operation o1160 for electronically receiving the selection information of the one or more computer based social network service options via the electronically enabled input in response to the electronically outputted one or more selection menus to be electronically outputted including via one or more network interfaces. Origination of an illustratively derived receiving information network component group can be accomplished through skilled in the art design choice selection of one or more of the above depicted components from one or more of the above depicted subsystems shown in FIG. 10. Components from the receiving information network component group can be used in implementing execution of the one or more receiving information network instructions i1160 of FIG. 31, can be used in performance of the receiving information network electrical circuitry arrangement e1160 of FIG. 22, and/or can be used in otherwise fulfillment of the operation o1160. An exemplary non-transitory signal bearing medium version of the information storage subsystem s200 is depicted in FIG. 31 as bearing the one or more receiving information network instructions i1160 that when executed will direct performance of the operation o1160. Furthermore, the receiving information network electrical circuitry arrangement (“elec circ arrange”) e1160, when activated, will perform the operation o1160. For instance, in one or more exemplary implementations, the one or more receiving information network instructions i1160, when executed, direct performance of the operation o1160 in the illustrative depiction as follows, and/or the receiving information network electrical circuitry arrangement e1160, when activated, performs the operation o1160 in the illustrative depiction as follows, and/or the operation o1160 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to be electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) including via one or more network interfaces (e.g. to be electronically outputted including via one or more network interfaces such as via wide area network component s516, etc.).

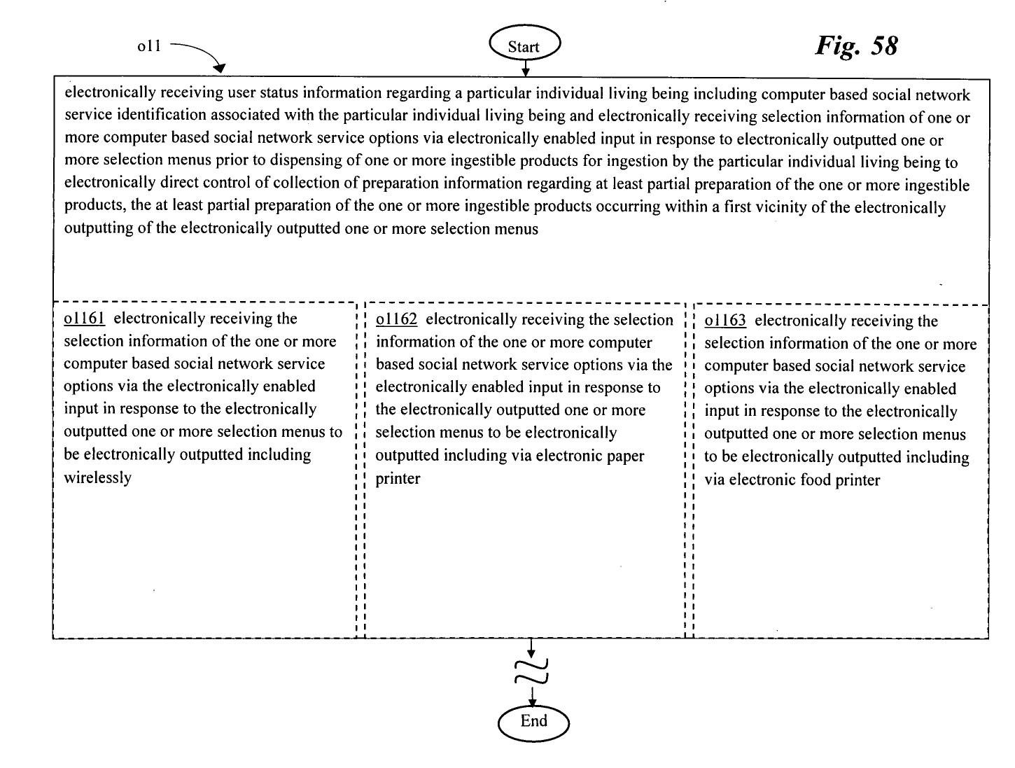

In one or more implementations, as shown in FIG. 58, operation o11 includes an operation o1161 for electronically receiving the selection information of the one or more computer based social network service options via the electronically enabled input in response to the electronically outputted one or more selection menus to be electronically outputted including wirelessly. Origination of an illustratively derived receiving information wirelessly component group can be accomplished through skilled in the art design choice selection of one or more of the above depicted components from one or more of the above depicted subsystems shown in FIG. 10. Components from the receiving information wirelessly component group can be used in implementing execution of the one or more receiving information wirelessly instructions i1161 of FIG. 31, can be used in performance of the receiving information wirelessly electrical circuitry arrangement e1161 of FIG. 22, and/or can be used in otherwise fulfillment of the operation o1161. An exemplary non-transitory signal bearing medium version of the information storage subsystem s200 is depicted in FIG. 31 as bearing the one or more receiving information wirelessly instructions i1161 that when executed will direct performance of the operation o1161. Furthermore, the receiving information wirelessly electrical circuitry arrangement (“elec circ arrange”) e1161, when activated, will perform the operation o1161. For instance, in one or more exemplary implementations, the one or more receiving information wirelessly instructions i1161, when executed, direct performance of the operation o1161 in the illustrative depiction as follows, and/or the receiving information wirelessly electrical circuitry arrangement e1161, when activated, performs the operation o1161 in the illustrative depiction as follows, and/or the operation o1161 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to be electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) including wirelessly (e.g. to be electronically outputted including wirelessly such as via wireless network component s510, etc.).

In one or more implementations, as shown in FIG. 58, operation o11 includes an operation o1162 for electronically receiving the selection information of the one or more computer based social network service options via the electronically enabled input in response to the electronically outputted one or more selection menus to be electronically outputted including via electronic paper printer. Origination of an illustratively derived receiving information paper component group can be accomplished through skilled in the art design choice selection of one or more of the above depicted components from one or more of the above depicted subsystems shown in FIG. 10. Components from the receiving information paper component group can be used in implementing execution of the one or more receiving information paper instructions i1162 of FIG. 31, can be used in performance of the receiving information paper electrical circuitry arrangement e1162 of FIG. 22, and/or can be used in otherwise fulfillment of the operation o1162. An exemplary non-transitory signal bearing medium version of the information storage subsystem s200 is depicted in FIG. 31 as bearing the one or more receiving information paper instructions i1162 that when executed will direct performance of the operation o1162. Furthermore, the receiving information paper electrical circuitry arrangement (“elec circ arrange”) e1162, when activated, will perform the operation o1162. For instance, in one or more exemplary implementations, the one or more receiving information paper instructions i1162, when executed, direct performance of the operation o1162 in the illustrative depiction as follows, and/or the receiving information paper electrical circuitry arrangement e1162, when activated, performs the operation o1162 in the illustrative depiction as follows, and/or the operation o1162 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to be electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) including via electronic paper printer (e.g. to be electronically outputted including via electronic paper printer such as via scanner component s338, etc.).

In one or more implementations, as shown in FIG. 58, operation o11 includes an operation o1163 for electronically receiving the selection information of the one or more computer based social network service options via the electronically enabled input in response to the electronically outputted one or more selection menus to be electronically outputted including via electronic food printer. Origination of an illustratively derived receiving information food component group can be accomplished through skilled in the art design choice selection of one or more of the above depicted components from one or more of the above depicted subsystems shown in FIG. 10. Components from the receiving information food component group can be used in implementing execution of the one or more receiving information food instructions i1163 of FIG. 31, can be used in performance of the receiving information food electrical circuitry arrangement e1163 of FIG. 22, and/or can be used in otherwise fulfillment of the operation o1163. An exemplary non-transitory signal bearing medium version of the information storage subsystem s200 is depicted in FIG. 31 as bearing the one or more receiving information food instructions i1163 that when executed will direct performance of the operation o1163. Furthermore, the receiving information food electrical circuitry arrangement (“elec circ arrange”) e1163, when activated, will perform the operation o1163. For instance, in one or more exemplary implementations, the one or more receiving information food instructions i1163, when executed, direct performance of the operation o1163 in the illustrative depiction as follows, and/or the receiving information food electrical circuitry arrangement e1163, when activated, performs the operation o1163 in the illustrative depiction as follows, and/or the operation o1163 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to be electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) including via electronic food printer (e.g. to be electronically outputted including via electronic food printer such as via deposition component s740, etc.).

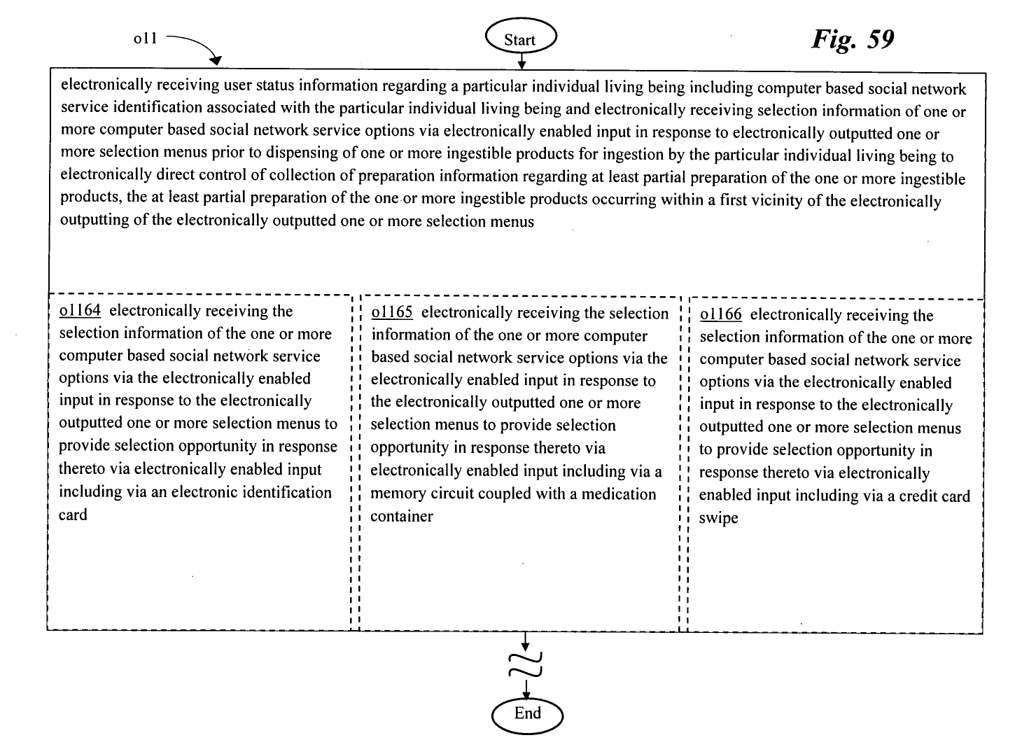

In one or more implementations, as shown in FIG. 59, operation o11 includes an operation o1164 for electronically receiving the selection information of the one or more computer based social network service options via the electronically enabled input in response to the electronically outputted one or more selection menus to provide selection opportunity in response thereto via electronically enabled input including via an electronic identification card. Origination of an illustratively derived receiving information ID card component group can be accomplished through skilled in the art design choice selection of one or more of the above depicted components from one or more of the above depicted subsystems shown in FIG. 10. Components from the receiving information ID card component group can be used in implementing execution of the one or more receiving information ID card instructions i1164 of FIG. 31, can be used in performance of the receiving information ID card electrical circuitry arrangement e1164 of FIG. 22, and/or can be used in otherwise fulfillment of the operation o1164. An exemplary non-transitory signal bearing medium version of the information storage subsystem s200 is depicted in FIG. 31 as bearing the one or more receiving information ID card instructions i1164 that when executed will direct performance of the operation o1164. Furthermore, the receiving information ID card electrical circuitry arrangement (“elec circ arrange”) e1164, when activated, will perform the operation o1164. For instance, in one or more exemplary implementations, the one or more receiving information ID card instructions i1164, when executed, direct performance of the operation o1164 in the illustrative depiction as follows, and/or the receiving information ID card electrical circuitry arrangement e1164, when activated, performs the operation o1164 in the illustrative depiction as follows, and/or the operation o1164 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to provide selection opportunity in response thereto via electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) including via an electronic identification card (e.g. an implementation of the receiver component s528 is configured to electronically engage with a card having memory storage holding information, etc.).

In one or more implementations, as shown in FIG. 59, operation o11 includes an operation o1165 for electronically receiving the selection information of the one or more computer based social network service options via the electronically enabled input in response to the electronically outputted one or more selection menus to provide selection opportunity in response thereto via electronically enabled input including via a memory circuit coupled with a medication container. Origination of an illustratively derived receiving information container component group can be accomplished through skilled in the art design choice selection of one or more of the above depicted components from one or more of the above depicted subsystems shown in FIG. 10. Components from the receiving information container component group can be used in implementing execution of the one or more receiving information container instructions i1165 of FIG. 31, can be used in performance of the receiving information container electrical circuitry arrangement e1165 of FIG. 22, and/or can be used in otherwise fulfillment of the operation o1165. An exemplary non-transitory signal bearing medium version of the information storage subsystem s200 is depicted in FIG. 31 as bearing the one or more receiving information container instructions i1165 that when executed will direct performance of the operation o1165. Furthermore, the receiving information container electrical circuitry arrangement (“elec circ arrange”) e1165, when activated, will perform the operation o1165. For instance, in one or more exemplary implementations, the one or more receiving information container instructions i1165, when executed, direct performance of the operation o1165 in the illustrative depiction as follows, and/or the receiving information container electrical circuitry arrangement e1165, when activated, performs the operation o1165 in the illustrative depiction as follows, and/or the operation o1165 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to provide selection opportunity in response thereto via electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) including via a memory circuit coupled with a medication container (e.g. an implementation of the receiver component s528 is configured to electronically engage with a memory storage coupled with a medication container to receive the electronically enabled input in electronic form, etc.).

In one or more implementations, as shown in FIG. 59, operation o11 includes an operation o1166 for electronically receiving the selection information of the one or more computer based social network service options via the electronically enabled input in response to the electronically outputted one or more selection menus to provide selection opportunity in response thereto via electronically enabled input including via a credit card swipe. Origination of an illustratively derived receiving information credit card component group can be accomplished through skilled in the art design choice selection of one or more of the above depicted components from one or more of the above depicted subsystems shown in FIG. 10. Components from the receiving information credit card component group can be used in implementing execution of the one or more receiving information credit card instructions i1166 of FIG. 31, can be used in performance of the receiving information credit card electrical circuitry arrangement e1166 of FIG. 22, and/or can be used in otherwise fulfillment of the operation o1166. An exemplary non-transitory signal bearing medium version of the information storage subsystem s200 is depicted in FIG. 31 as bearing the one or more receiving information credit card instructions i1166 that when executed will direct performance of the operation o1166. Furthermore, the receiving information credit card electrical circuitry arrangement (“elec circ arrange”) e1166, when activated, will perform the operation o1166. For instance, in one or more exemplary implementations, the one or more receiving information credit card instructions i1166, when executed, direct performance of the operation o1166 in the illustrative depiction as follows, and/or the receiving information credit card electrical circuitry arrangement e1166, when activated, performs the operation o1166 in the illustrative depiction as follows, and/or the operation o1166 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to provide selection opportunity in response thereto via electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) including via a credit card swipe (e.g. an implementation of the receiver component s528 is configured to electronically engage with an electronic memory stripe integrated into a credit card to receive the electronically enabled input, etc.).

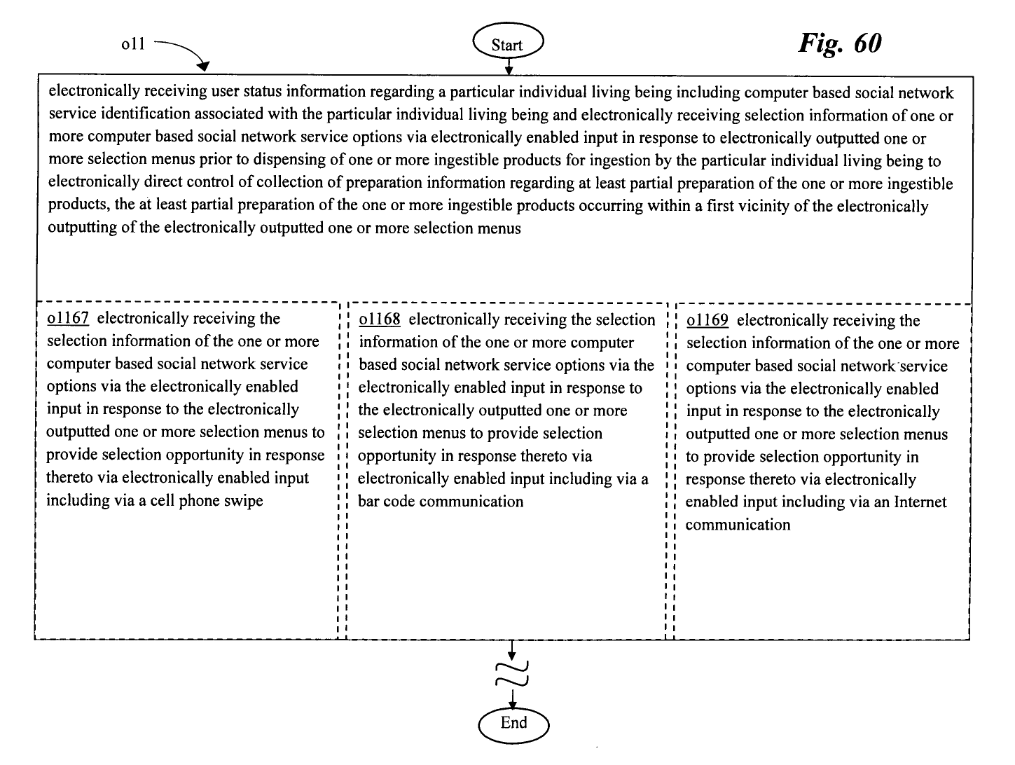

In one or more implementations, as shown in FIG. 60, operation o11 includes an operation o1167 for electronically receiving the selection information of the one or more computer based social network service options via the electronically enabled input in response to the electronically outputted one or more selection menus to provide selection opportunity in response thereto via electronically enabled input including via a cell phone swipe. Origination of an illustratively derived receiving information cell phone component group can be accomplished through skilled in the art design choice selection of one or more of the above depicted components from one or more of the above depicted subsystems shown in FIG. 10. Components from the receiving information cell phone component group can be used in implementing execution of the one or more receiving information cell phone instructions i1167 of FIG. 31, can be used in performance of the receiving information cell phone electrical circuitry arrangement e1167 of FIG. 22, and/or can be used in otherwise fulfillment of the operation o1167. An exemplary non-transitory signal bearing medium version of the information storage subsystem s200 is depicted in FIG. 31 as bearing the one or more receiving information cell phone instructions i1167 that when executed will direct performance of the operation o1167. Furthermore, the receiving information cell phone electrical circuitry arrangement (“elec circ arrange”) e1167, when activated, will perform the operation o1167. For instance, in one or more exemplary implementations, the one or more receiving information cell phone instructions i1167, when executed, direct performance of the operation o1167 in the illustrative depiction as follows, and/or the receiving information cell phone electrical circuitry arrangement e1167, when activated, performs the operation o1167 in the illustrative depiction as follows, and/or the operation o1167 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to provide selection opportunity in response thereto via electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) including via a cell phone swipe (e.g. an implementation of the receiver component s528 is configured to electronically engage with an electronic memory component integrated into a cell phone to receive the electronically enabled input, etc.).

In one or more implementations, as shown in FIG. 60, operation o11 includes an operation o1168 for electronically receiving the selection information of the one or more computer based social network service options via the electronically enabled input in response to the electronically outputted one or more selection menus to provide selection opportunity in response thereto via electronically enabled input including via a bar code communication. Origination of an illustratively derived receiving information bar code component group can be accomplished through skilled in the art design choice selection of one or more of the above depicted components from one or more of the above depicted subsystems shown in FIG. 10. Components from the receiving information bar code component group can be used in implementing execution of the one or more receiving information bar code instructions i1168 of FIG. 31, can be used in performance of the receiving information bar code electrical circuitry arrangement e1168 of FIG. 22, and/or can be used in otherwise fulfillment of the operation o1168. An exemplary non-transitory signal bearing medium version of the information storage subsystem s200 is depicted in FIG. 31 as bearing the one or more receiving information bar code instructions i1168 that when executed will direct performance of the operation o1168. Furthermore, the receiving information bar code electrical circuitry arrangement (“elec circ arrange”) e1168, when activated, will perform the operation o1168. For instance, in one or more exemplary implementations, the one or more receiving information bar code instructions i1168, when executed, direct performance of the operation o1168 in the illustrative depiction as follows, and/or the receiving information bar code electrical circuitry arrangement e1168, when activated, performs the operation o1168 in the illustrative depiction as follows, and/or the operation o1168 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to provide selection opportunity in response thereto via electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) including via a bar code communication (e.g. an implementation of the receiver component s528 is configured to electronically read a bar code label to receive the electronically enabled input, etc.).

In one or more implementations, as shown in FIG. 60, operation o11 includes an operation o1169 for electronically receiving the selection information of the one or more computer based social network service options via the electronically enabled input in response to the electronically outputted one or more selection menus to provide selection opportunity in response thereto via electronically enabled input including via an Internet communication. Origination of an illustratively derived receiving information Internet component group can be accomplished through skilled in the art design choice selection of one or more of the above depicted components from one or more of the above depicted subsystems shown in FIG. 10. Components from the receiving information Internet component group can be used in implementing execution of the one or more receiving information Internet instructions i1169 of FIG. 31, can be used in performance of the receiving information Internet electrical circuitry arrangement e1169 of FIG. 22, and/or can be used in otherwise fulfillment of the operation o1169. An exemplary non-transitory signal bearing medium version of the information storage subsystem s200 is depicted in FIG. 31 as bearing the one or more receiving information Internet instructions i1169 that when executed will direct performance of the operation o1169. Furthermore, the receiving information Internet electrical circuitry arrangement (“elec circ arrange”) e1169, when activated, will perform the operation o1169. For instance, in one or more exemplary implementations, the one or more receiving information Internet instructions i1169, when executed, direct performance of the operation o1169 in the illustrative depiction as follows, and/or the receiving information Internet electrical circuitry arrangement e1169, when activated, performs the operation o1169 in the illustrative depiction as follows, and/or the operation o1169 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to provide selection opportunity in response thereto via electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) including via an Internet communication (e.g. an implementation of the receiver component s528 is configured to electronically receive through the interne network, etc.).

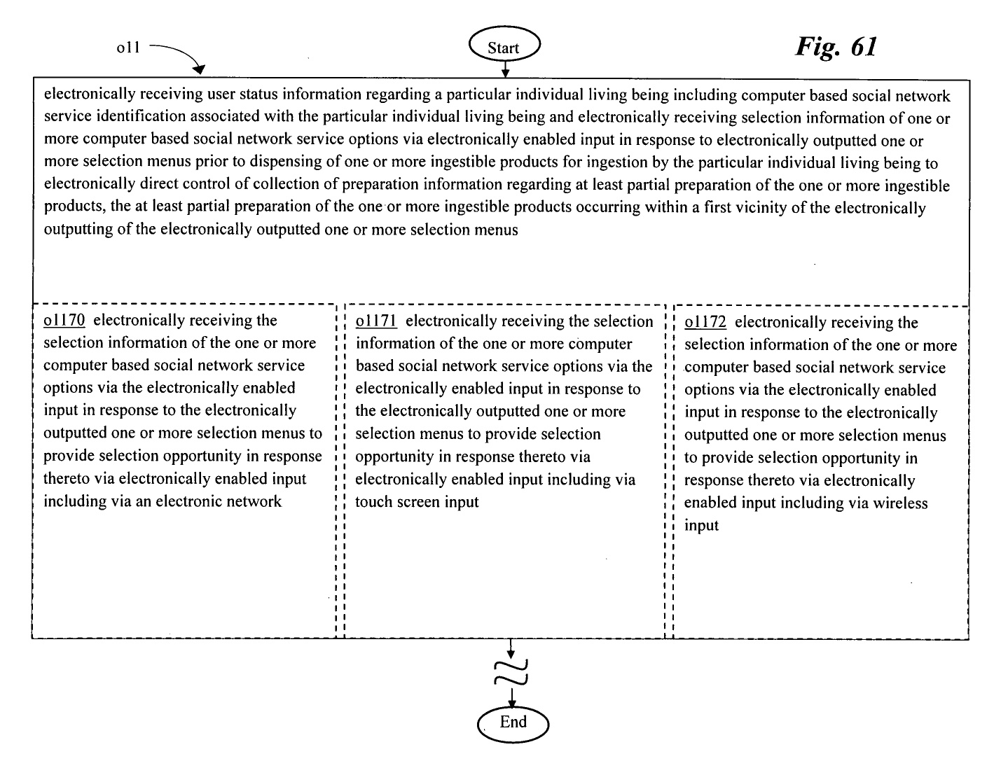

In one or more implementations, as shown in FIG. 61, operation o11 includes an operation o1170 for electronically receiving the selection information of the one or more computer based social network service options via the electronically enabled input in response to the electronically outputted one or more selection menus to provide selection opportunity in response thereto via electronically enabled input including via an electronic network. Origination of an illustratively derived receiving information network component group can be accomplished through skilled in the art design choice selection of one or more of the above depicted components from one or more of the above depicted subsystems shown in FIG. 10. Components from the receiving information network component group can be used in implementing execution of the one or more receiving information network instructions i1170 of FIG. 31, can be used in performance of the receiving information network electrical circuitry arrangement e1170 of FIG. 22, and/or can be used in otherwise fulfillment of the operation o1170. An exemplary non-transitory signal bearing medium version of the information storage subsystem s200 is depicted in FIG. 31 as bearing the one or more receiving information network instructions i1170 that when executed will direct performance of the operation o1170. Furthermore, the receiving information network electrical circuitry arrangement (“elec circ arrange”) e1170, when activated, will perform the operation o1170. For instance, in one or more exemplary implementations, the one or more receiving information network instructions i1170, when executed, direct performance of the operation o1170 in the illustrative depiction as follows, and/or the receiving information network electrical circuitry arrangement e1170, when activated, performs the operation o1170 in the illustrative depiction as follows, and/or the operation o1170 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to provide selection opportunity in response thereto via electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) including via an electronic network (e.g. an implementation of the receiver component s528 is configured to electronically engage with the network cable component s502 to receive the electronically enabled input, etc.).

In one or more implementations, as shown in FIG. 61, operation o11 includes an operation o1171 for electronically receiving the selection information of the one or more computer based social network service options via the electronically enabled input in response to the electronically outputted one or more selection menus to provide selection opportunity in response thereto via electronically enabled input including via touch screen input. Origination of an illustratively derived receiving information touch screen component group can be accomplished through skilled in the art design choice selection of one or more of the above depicted components from one or more of the above depicted subsystems shown in FIG. 10. Components from the receiving information touch screen component group can be used in implementing execution of the one or more receiving information touch screen instructions i1171 of FIG. 31, can be used in performance of the receiving information touch screen electrical circuitry arrangement e1171 of FIG. 22, and/or can be used in otherwise fulfillment of the operation o1171. An exemplary non-transitory signal bearing medium version of the information storage subsystem s200 is depicted in FIG. 31 as bearing the one or more receiving information touch screen instructions i1171 that when executed will direct performance of the operation o1171. Furthermore, the receiving information touch screen electrical circuitry arrangement (“elec circ arrange”) e1171, when activated, will perform the operation o1171. For instance, in one or more exemplary implementations, the one or more receiving information touch screen instructions i1171, when executed, direct performance of the operation o1171 in the illustrative depiction as follows, and/or the receiving information touch screen electrical circuitry arrangement e1171, when activated, performs the operation o1171 in the illustrative depiction as follows, and/or the operation o1171 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to provide selection opportunity in response thereto via electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) including via touch screen input (e.g. an implementation of the receiver component s528 is configured to electronically receive through the touch screen component s314, etc.).

In one or more implementations, as shown in FIG. 61, operation o11 includes an operation o1172 for electronically receiving the selection information of the one or more computer based social network service options via the electronically enabled input in response to the electronically outputted one or more selection menus to provide selection opportunity in response thereto via electronically enabled input including via wireless input. Origination of an illustratively derived receiving information wireless component group can be accomplished through skilled in the art design choice selection of one or more of the above depicted components from one or more of the above depicted subsystems shown in FIG. 10. Components from the receiving information wireless component group can be used in implementing execution of the one or more receiving information wireless instructions i1172 of FIG. 31, can be used in performance of the receiving information wireless electrical circuitry arrangement e1172 of FIG. 22, and/or can be used in otherwise fulfillment of the operation o1172. An exemplary non-transitory signal bearing medium version of the information storage subsystem s200 is depicted in FIG. 31 as bearing the one or more receiving information wireless instructions i1172 that when executed will direct performance of the operation o1172. Furthermore, the receiving information wireless electrical circuitry arrangement (“elec circ arrange”) e1172, when activated, will perform the operation o1172. For instance, in one or more exemplary implementations, the one or more receiving information wireless instructions i1172, when executed, direct performance of the operation o1172 in the illustrative depiction as follows, and/or the receiving information wireless electrical circuitry arrangement e1172, when activated, performs the operation o1172 in the illustrative depiction as follows, and/or the operation o1172 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to provide selection opportunity in response thereto via electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) including via wireless input (e.g. an implementation of the receiver component s528 is configured to electronically receive through the wireless network component s510 to receive the electronically enabled input, etc.).

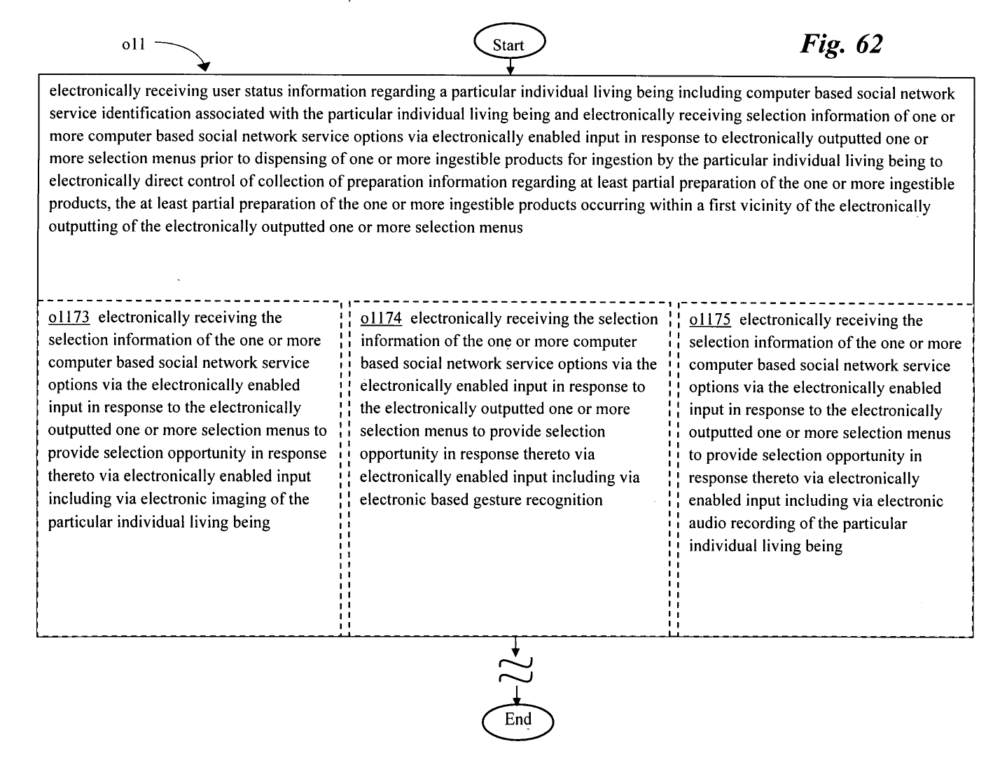

In one or more implementations, as shown in FIG. 62, operation o11 includes an operation o1173 for electronically receiving the selection information of the one or more computer based social network service options via the electronically enabled input in response to the electronically outputted one or more selection menus to provide selection opportunity in response thereto via electronically enabled input including via electronic imaging of the particular individual living being. Origination of an illustratively derived receiving information imaging component group can be accomplished through skilled in the art design choice selection of one or more of the above depicted components from one or more of the above depicted subsystems shown in FIG. 10. Components from the receiving information imaging component group can be used in implementing execution of the one or more receiving information imaging instructions it i1173 of FIG. 31, can be used in performance of the receiving information imaging electrical circuitry arrangement e1173 of FIG. 22, and/or can be used in otherwise fulfillment of the operation o1173. An exemplary non-transitory signal bearing medium version of the information storage subsystem s200 is depicted in FIG. 31 as bearing the one or more receiving information imaging instructions i1173 that when executed will direct performance of the operation o1173. Furthermore, the receiving information imaging electrical circuitry arrangement (“elec circ arrange”) e1173, when activated, will perform the operation o1173. For instance, in one or more exemplary implementations, the one or more receiving information imaging instructions i1173, when executed, direct performance of the operation o1173 in the illustrative depiction as follows, and/or the receiving information imaging electrical circuitry arrangement e1173, when activated, performs the operation o1173 in the illustrative depiction as follows, and/or the operation o1173 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522; infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to provide selection opportunity in response thereto via electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) including via electronic imaging (e.g. an implementation of the receiver component s528 is configured to electronically receive through the wireless network component s510 to receive the electronically enabled input, etc.) of the particular individual living being (e.g. one of more of a consumer, a gourmand, a hobbyist, an athlete, a student, a dieter, a patient, an animal, an inmate, a health seeker, a worker, a pedestrian, etc.).

In one or more implementations, as shown in FIG. 62, operation o11 includes an operation o1174 for electronically receiving the selection information of the one or more computer based social network service options via the electronically enabled input in response to the electronically outputted one or more selection menus to provide selection opportunity in response thereto via electronically enabled input including via electronic based gesture recognition. Origination of an illustratively derived receiving information gesture component group can be accomplished through skilled in the art design choice selection of one or more of the above depicted components from one or more of the above depicted subsystems shown in FIG. 10. Components from the receiving information gesture component group can be used in implementing execution of the one or more receiving information gesture instructions i1174 of FIG. 31, can be used in performance of the receiving information gesture electrical circuitry arrangement e1174 of FIG. 22, and/or can be used in otherwise fulfillment of the operation o1174. An exemplary non-transitory signal bearing medium version of the information storage subsystem s200 is depicted in FIG. 31 as bearing the one or more receiving information gesture instructions i1174 that when executed will direct performance of the operation o1174. Furthermore, the receiving information gesture electrical circuitry arrangement (“elec circ arrange”) e1174, when activated, will perform the operation o1174. For instance, in one or more exemplary implementations, the one or more receiving information gesture instructions i1174, when executed, direct performance of the operation o1174 in the illustrative depiction as follows, and/or the receiving information gesture electrical circuitry arrangement e1174, when activated, performs the operation o1174 in the illustrative depiction as follows, and/or the operation o1174 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to provide selection opportunity in response thereto via electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) including via electronic based gesture recognition (e.g. an implementation of the receiver component s528 is configured to electronically engage with the optical sensing component s418 to receive the electronically enabled input as inputted by a user, etc.).

In one or more implementations, as shown in FIG. 62, operation o11 includes an operation o1175 for electronically receiving the selection information of the one or more computer based social network service options via the electronically enabled input in response to the electronically outputted one or more selection menus to provide selection opportunity in response thereto via electronically enabled input including via electronic audio recording of the particular individual living being. Origination of an illustratively derived receiving information audio component group can be accomplished through skilled in the art design choice selection of one or more of the above depicted components from one or more of the above depicted subsystems shown in FIG. 10. Components from the receiving information audio component group can be used in implementing execution of the one or more receiving information audio instructions i1175 of FIG. 31, can be used in performance of the receiving information audio electrical circuitry arrangement e1175 of FIG. 22, and/or can be used in otherwise fulfillment of the operation o1175. An exemplary non-transitory signal bearing medium version of the information storage subsystem s200 is depicted in FIG. 31 as bearing the one or more receiving information audio instructions i1175 that when executed will direct performance of the operation o1175. Furthermore, the receiving information audio electrical circuitry arrangement (“elec circ arrange”) e1175, when activated, will perform the operation o1175. For instance, in one or more exemplary implementations, the one or more receiving information audio instructions i1175, when executed, direct performance of the operation o1175 in the illustrative depiction as follows, and/or the receiving information audio electrical circuitry arrangement e1175, when activated, performs the operation o1175 in the illustrative depiction as follows, and/or the operation o1175 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to provide selection opportunity in response thereto via electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) including via electronic audio recording (e.g. an implementation of the receiver component s528 is configured to electronically engage with the sound sensing component s420 to receive the electronically enabled input, etc.) of the particular individual living being (e.g. one of more of a consumer, a gourmand, a hobbyist, an athlete, a student, a dieter, a patient, an animal, an inmate, a health seeker, a worker, a pedestrian, etc.).

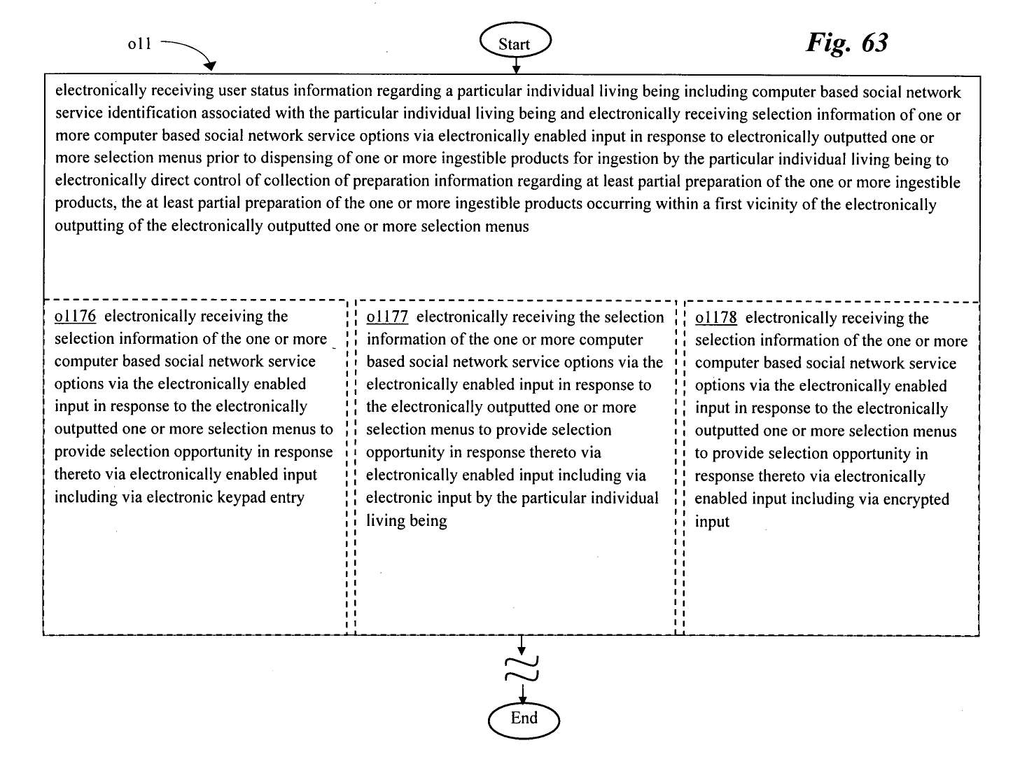

In one or more implementations, as shown in FIG. 63, operation o11 includes an operation o1176 for electronically receiving the selection information of the one or more computer based social network service options via the electronically enabled input in response to the electronically outputted one or more selection menus to provide selection opportunity in response thereto via electronically enabled input including via electronic keypad entry. Origination of an illustratively derived receiving information keypad component group can be accomplished through skilled in the art design choice selection of one or more of the above depicted components from one or more of the above depicted subsystems shown in FIG. 10. Components from the receiving information keypad component group can be used in implementing execution of the one or more receiving information keypad instructions i1176 of FIG. 31, can be used in performance of the receiving information keypad electrical circuitry arrangement e1176 of FIG. 22, and/or can be used in otherwise fulfillment of the operation o1176. An exemplary non-transitory signal bearing medium version of the information storage subsystem s200 is depicted in FIG. 31 as bearing the one or more receiving information keypad instructions i1176 that when executed will direct performance of the operation o1176. Furthermore, the receiving information keypad electrical circuitry arrangement (“elec circ arrange”) e1176, when activated, will perform the operation o1176. For instance, in one or more exemplary implementations, the one or more receiving information keypad instructions i1176, when executed, direct performance of the operation o1176 in the illustrative depiction as follows, and/or the receiving information keypad electrical circuitry arrangement e1176, when activated, performs the operation o1176 in the illustrative depiction as follows, and/or the operation o1176 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to provide selection opportunity in response thereto via electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) including via electronic keypad entry (e.g. an implementation of the receiver component s528 is configured to electronically engage with the keypad component s308 to receive the electronically enabled input, etc.).

In one or more implementations, as shown in FIG. 63, operation o11 includes an operation o1177 for electronically receiving the selection information of the one or more computer based social network service options via the electronically enabled input in response to the electronically outputted one or more selection menus to provide selection opportunity in response thereto via electronically enabled input including via electronic input by the particular individual living being. Origination of an illustratively derived receiving information input component group can be accomplished through skilled in the art design choice selection of one or more of the above depicted components from one or more of the above depicted subsystems shown in FIG. 10. Components from the receiving information input component group can be used in implementing execution of the one or more receiving information input instructions i1177 of FIG. 31, can be used in performance of the receiving information input electrical circuitry arrangement e1177 of FIG. 22, and/or can be used in otherwise fulfillment of the operation o1177. An exemplary non-transitory signal bearing medium version of the information storage subsystem s200 is depicted in FIG. 31 as bearing the one or more receiving information input instructions i1177 that when executed will direct performance of the operation o1177. Furthermore, the receiving information input electrical circuitry arrangement (“elec circ arrange”) e1177, when activated, will perform the operation o1177. For instance, in one or more exemplary implementations, the one or more receiving information input instructions i1177, when executed, direct performance of the operation o1177 in the illustrative depiction as follows, and/or the receiving information input electrical circuitry arrangement e1177, when activated, performs the operation o1177 in the illustrative depiction as follows, and/or the operation o1177 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to provide selection opportunity in response thereto via electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) including via electronic input (e.g. an implementation of the receiver component s528 is configured to electronically engage with the electromagnetic sensing component s402 to receive the electronically enabled input, etc.) by the particular individual living being (e.g. one of more of a consumer, a gourmand, a hobbyist, an athlete, a student, a dieter, a patient, an animal, an inmate, a health seeker, a worker, a pedestrian, etc.).

In one or more implementations, as shown in FIG. 63, operation o11 includes an operation o1178 for electronically receiving the selection information of the one or more computer based social network service options via the electronically enabled input in response to the electronically outputted one or more selection menus to provide selection opportunity in response thereto via electronically enabled input including via encrypted input. Origination of an illustratively derived receiving information encrypted component group can be accomplished through skilled in the art design choice selection of one or more of the above depicted components from one or more of the above depicted subsystems shown in FIG. 10. Components from the receiving information encrypted component group can be used in implementing execution of the one or more receiving information encrypted instructions i1178 of FIG. 31, can be used in performance of the receiving information encrypted electrical circuitry arrangement e1178 of FIG. 22, and/or can be used in otherwise fulfillment of the operation o1178. An exemplary non-transitory signal bearing medium version of the information storage subsystem s200 is depicted in FIG. 31 as bearing the one or more receiving information encrypted instructions i1178 that when executed will direct performance of the operation o1178. Furthermore, the receiving information encrypted electrical circuitry arrangement (“elec circ arrange”) e1178, when activated, will perform the operation o1178. For instance, in one or more exemplary implementations, the one or more receiving information encrypted instructions i1178, when executed, direct performance of the operation o1178 in the illustrative depiction as follows, and/or the receiving information encrypted electrical circuitry arrangement e1178, when activated, performs the operation o1178 in the illustrative depiction as follows, and/or the operation o1178 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the selection information (e.g. information related to user completion of one or more checkboxes, button activations, blank fill-ins, voice input data, text data, gesture data, hand operated input data, touch data, eye tracking data, database data, etc.) of the one or more computer-based social network service options (e.g. options related to affiliations, interest groups, forums, contacts, chat rooms, social networking websites, feature opt outs, private groups, blog posts, reporting options, friends selection, privacy selections, etc.) via the electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) in response to the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) to provide selection opportunity in response thereto via electronically enabled input (e.g. through use of at least one of the following: trackball component s310, joystick component s312, touch screen component s314, mouse component s316, switch component s318, dial component s320, button component s322, audio in/out component s328, projection component s334, camera component s336, scanner component s338, etc.) including via encrypted input (e.g. an implementation of the receiver component s528 is configured to electronically engage with the encrypted communication component s520 to receive the electronically enabled input, etc.).

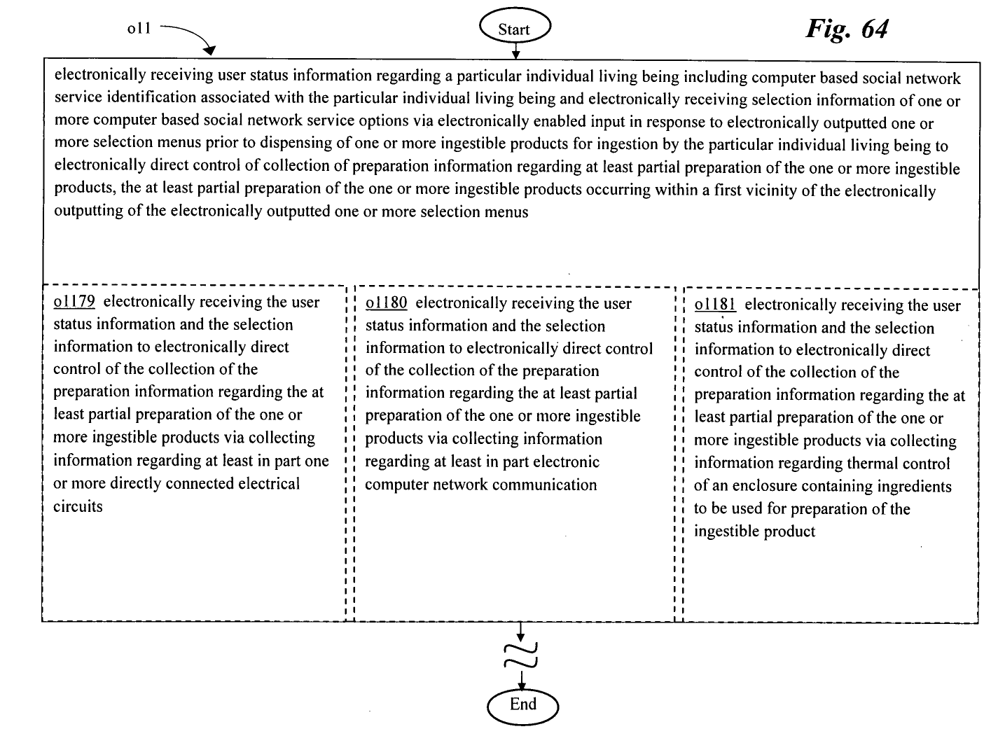

In one or more implementations, as shown in FIG. 64, operation o11 includes an operation o1179 for electronically receiving the user status information and the selection information to electronically direct control of the collection of the preparation information regarding the at least partial preparation of the one or more ingestible products via collecting information regarding at least in part one or more directly connected electrical circuits. Origination of an illustratively derived control prep connected component group can be accomplished through skilled in the art design choice selection of one or more of the above depicted components from one or more of the above depicted subsystems shown in FIG. 10. Components from the control prep connected component group can be used in implementing execution of the one or more control prep connected instructions i1179 of FIG. 31, can be used in performance of the control prep connected electrical circuitry arrangement e1179 of FIG. 22, and/or can be used in otherwise fulfillment of the operation o1179. An exemplary non-transitory signal bearing medium version of the information storage subsystem s200 is depicted in FIG. 31 as bearing the one or more control prep connected instructions i1179 that when executed will direct performance of the operation o1179. Furthermore, the control prep connected electrical circuitry arrangement (“elec circ arrange”) e1179, when activated, will perform the operation o1179. For instance, in one or more exemplary implementations, the one or more control prep connected instructions i1179, when executed, direct performance of the operation o1179 in the illustrative depiction as follows, and/or the control prep connected electrical circuitry arrangement e1179, when activated, performs the operation o1179 in the illustrative depiction as follows, and/or the operation o1179 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) via collecting information regarding at least in part one or more directly connected electrical circuits (e.g. an implementation of the microprocessor component s102 is configured to electronically receive through receiver component s528 co-located within a common housing of the ingestible product preparation system 10 to control the material processing subsystem 700, etc.).

In one or more implementations, as shown in FIG. 64, operation o11 includes an operation o1180 for electronically receiving the user status information and the selection information to electronically direct control of the collection of the preparation information regarding the at least partial preparation of the one or more ingestible products via collecting information regarding at least in part electronic computer network communication. Origination of an illustratively derived control prep network component group can be accomplished through skilled in the art design choice selection of one or more of the above depicted components from one or more of the above depicted subsystems shown in FIG. 10. Components from the control prep network component group can be used in implementing execution of the one or more control prep network instructions i1180 of FIG. 32, can be used in performance of the control prep network electrical circuitry arrangement e1180 of FIG. 23, and/or can be used in otherwise fulfillment of the operation o1180. An exemplary non-transitory signal bearing medium version of the information storage subsystem s200 is depicted in FIG. 32 as bearing the one or more control prep network instructions i1180 that when executed will direct performance of the operation o1180. Furthermore, the control prep network electrical circuitry arrangement (“elec circ arrange”) e1180, when activated, will perform the operation o1180. For instance, in one or more exemplary implementations, the one or more control prep network instructions i1180, when executed, direct performance of the operation o1180 in the illustrative depiction as follows, and/or the control prep network electrical circuitry arrangement e1180, when activated, performs the operation o1180 in the illustrative depiction as follows, and/or the operation o1180 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) via collecting information regarding at least in part electronic computer network communication (e.g. an implementation of the microprocessor component s102 is configured to electronically receive through interne network components s508, etc.).

In one or more implementations, as shown in FIG. 64, operation o11 includes an operation o1181 for electronically receiving the user status information and the selection information to electronically direct control of the collection of the preparation information regarding the at least partial preparation of the one or more ingestible products via collecting information regarding thermal control of an enclosure containing ingredients to be used for preparation of the ingestible product. Origination of an illustratively derived control prep thermal component group can be accomplished through skilled in the art design choice selection of one or more of the above depicted components from one or more of the above depicted subsystems shown in FIG. 10. Components from the control prep thermal component group can be used in implementing execution of the one or more control prep thermal instructions i1181 of FIG. 32, can be used in performance of the control prep thermal electrical circuitry arrangement e1181 of FIG. 23, and/or can be used in otherwise fulfillment of the operation o1181. An exemplary non-transitory signal bearing medium version of the information storage subsystem s200 is depicted in FIG. 32 as bearing the one or more control prep thermal instructions i1181 that when executed will direct performance of the operation o1181. Furthermore, the control prep thermal electrical circuitry arrangement (“elec circ arrange”) e1181, when activated, will perform the operation o1181. For instance, in one or more exemplary implementations, the one or more control prep thermal instructions i1181, when executed, direct performance of the operation o1181 in the illustrative depiction as follows, and/or the control prep thermal electrical circuitry arrangement e1181, when activated, performs the operation o1181 in the illustrative depiction as follows, and/or the operation o1181 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) via collecting information regarding thermal control of an enclosure containing ingredients to be used for preparation of the ingestible product (e.g. an implementation of the microprocessor component s102 is configured to electronically control the laser component s708 according to a temperature profile received thereby, etc.).

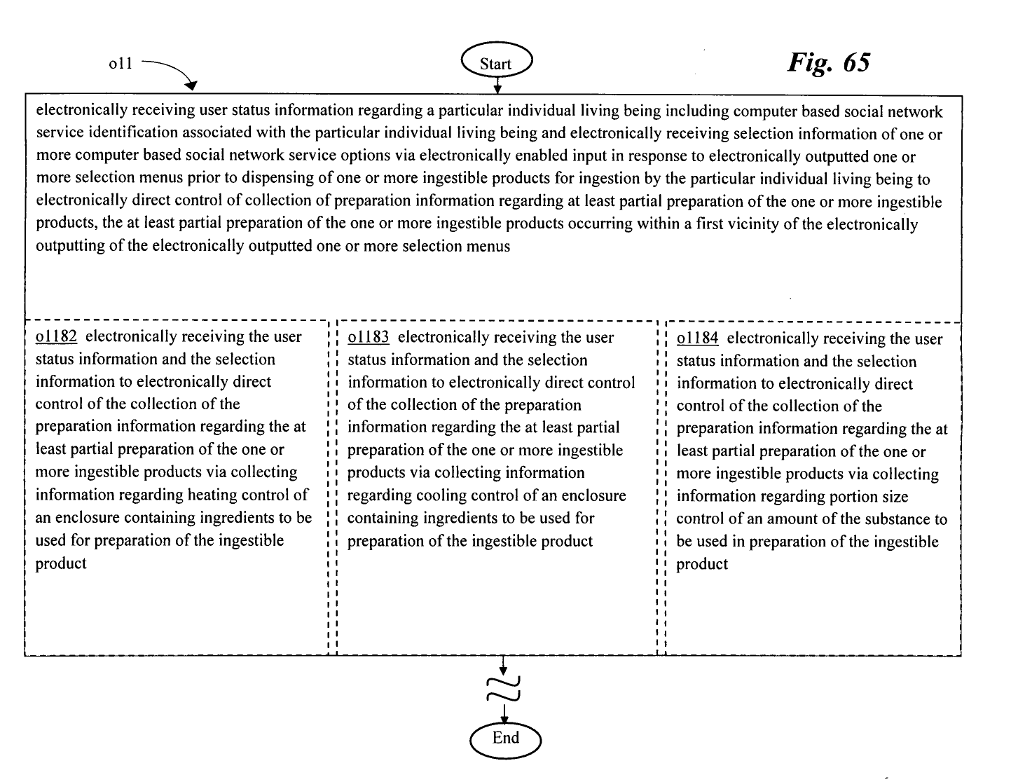

In one or more implementations, as shown in FIG. 65, operation o11 includes an operation o1182 for electronically receiving the user status information and the selection information to electronically direct control of the collection of the preparation information regarding the at least partial preparation of the one or more ingestible products via collecting information regarding heating control of an enclosure containing ingredients to be used for preparation of the ingestible product. Origination of an illustratively derived control prep heating component group can be accomplished through skilled in the art design choice selection of one or more of the above depicted components from one or more of the above depicted subsystems shown in FIG. 10. Components from the control prep heating component group can be used in implementing execution of the one or more control prep heating instructions i1182 of FIG. 32, can be used in performance of the control prep heating electrical circuitry arrangement e1182 of FIG. 23, and/or can be used in otherwise fulfillment of the operation o1182. An exemplary non-transitory signal bearing medium version of the information storage subsystem s200 is depicted in FIG. 32 as bearing the one or more control prep heating instructions i1182 that when executed will direct performance of the operation o1182. Furthermore, the control prep heating electrical circuitry arrangement (“elec circ arrange”) e1182, when activated, will perform the operation o1182. For instance, in one or more exemplary implementations, the one or more control prep heating instructions i1182, when executed, direct performance of the operation o1182 in the illustrative depiction as follows, and/or the control prep heating electrical circuitry arrangement e1182, when activated, performs the operation o1182 in the illustrative depiction as follows, and/or the operation o1182 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) via collecting information regarding heating control of an enclosure containing ingredients to be used for preparation of the ingestible product (e.g. an implementation of the microprocessor component s102 is configured to electronically control the heating component s702 according to a temperature profile received thereby, etc.).

In one or more implementations, as shown in FIG. 65, operation o11 includes an operation o1183 for electronically receiving the user status information and the selection information to electronically direct control of the collection of the preparation information regarding the at least partial preparation of the one or more ingestible products via collecting information regarding cooling control of an enclosure containing ingredients to be used for preparation of the ingestible product. Origination of an illustratively derived control prep cooling component group can be accomplished through skilled in the art design choice selection of one or more of the above depicted components from one or more of the above depicted subsystems shown in FIG. 10. Components from the control prep cooling component group can be used in implementing execution of the one or more control prep cooling instructions i1183 of FIG. 32, can be used in performance of the control prep cooling electrical circuitry arrangement e1183 of FIG. 23, and/or can be used in otherwise fulfillment of the operation o1183. An exemplary non-transitory signal bearing medium version of the information storage subsystem s200 is depicted in FIG. 32 as bearing the one or more control prep cooling instructions i1183 that when executed will direct performance of the operation o1183. Furthermore, the control prep cooling electrical circuitry arrangement (“elec circ arrange”) e1183, when activated, will perform the operation o1183. For instance, in one or more exemplary implementations, the one or more control prep cooling instructions i1183, when executed, direct performance of the operation o1183 in the illustrative depiction as follows, and/or the control prep cooling electrical circuitry arrangement e1183, when activated, performs the operation o1183 in the illustrative depiction as follows, and/or the operation o1183 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) via collecting information regarding cooling control of an enclosure containing ingredients to be used for preparation of the ingestible product (e.g. an implementation of the microprocessor component s102 is configured to electronically control the cooling component s704 according to a temperature profile received thereby, etc.).

In one or more implementations, as shown in FIG. 65, operation o11 includes an operation o1184 for electronically receiving the user status information and the selection information to electronically direct control of the collection of the preparation information regarding the at least partial preparation of the one or more ingestible products via collecting information regarding portion size control of an amount of the substance to be used in preparation of the ingestible product. Origination of an illustratively derived control prep portion component group can be accomplished through skilled in the art design choice selection of one or more of the above depicted components from one or more of the above depicted subsystems shown in FIG. 10. Components from the control prep portion component group can be used in implementing execution of the one or more control prep portion instructions i1184 of FIG. 32, can be used in performance of the control prep portion electrical circuitry arrangement e1184 of FIG. 23, and/or can be used in otherwise fulfillment of the operation o1184. An exemplary non-transitory signal bearing medium version of the information storage subsystem s200 is depicted in FIG. 32 as bearing the one or more control prep portion instructions i1184 that when executed will direct performance of the operation o1184. Furthermore, the control prep portion electrical circuitry arrangement (“elec circ arrange”) e1184, when activated, will perform the operation o1184. For instance, in one or more exemplary implementations, the one or more control prep portion instructions i1184, when executed, direct performance of the operation o1184 in the illustrative depiction as follows, and/or the control prep portion electrical circuitry arrangement e1184, when activated, performs the operation o1184 in the illustrative depiction as follows, and/or the operation o1184 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) via collecting information regarding portion size control of an amount of the substance to be used in preparation of the ingestible product (e.g. an implementation of the microprocessor component s102 is configured to electronically control the sorting component s728 according to an ingredient size distribution profile received thereby, etc.).

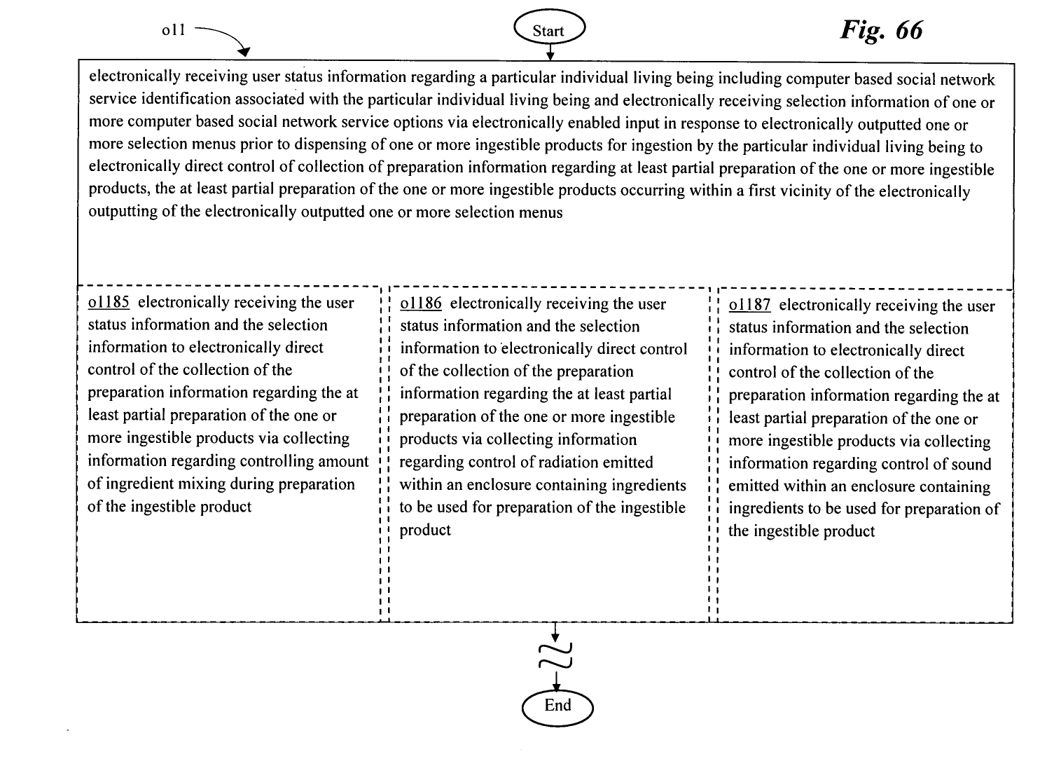

In one or more implementations, as shown in FIG. 66, operation o11 includes an operation o1185 for electronically receiving the user status information and the selection information to electronically direct control of the collection of the preparation information regarding the at least partial preparation of the one or more ingestible products via collecting information regarding controlling amount of ingredient mixing during preparation of the ingestible product. Origination of an illustratively derived control prep mixing component group can be accomplished through skilled in the art design choice selection of one or more of the above depicted components from one or more of the above depicted subsystems shown in FIG. 10. Components from the control prep mixing component group can be used in implementing execution of the one or more control prep mixing instructions i1185 of FIG. 32, can be used in performance of the control prep mixing electrical circuitry arrangement e1185 of FIG. 23, and/or can be used in otherwise fulfillment of the operation o1185. An exemplary non-transitory signal bearing medium version of the information storage subsystem s200 is depicted in FIG. 32 as bearing the one or more control prep mixing instructions i1185 that when executed will direct performance of the operation o1185. Furthermore, the control prep mixing electrical circuitry arrangement (“elec circ arrange”) e1185, when activated, will perform the operation o1185. For instance, in one or more exemplary implementations, the one or more control prep mixing instructions i1185, when executed, direct performance of the operation o1185 in the illustrative depiction as follows, and/or the control prep mixing electrical circuitry arrangement e1185, when activated, performs the operation o1185 in the illustrative depiction as follows, and/or the operation o1185 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) via collecting information regarding controlling amount of ingredient mixing during preparation of the ingestible product (e.g. an implementation of the microprocessor component s102 is configured to electronically control the mixer component s716 according to a mixing profile received thereby, etc.).

In one or more implementations, as shown in FIG. 66, operation o11 includes an operation o1186 for electronically receiving the user status information and the selection information to electronically direct control of the collection of the preparation information regarding the at least partial preparation of the one or more ingestible products via collecting information regarding control of radiation emitted within an enclosure containing ingredients to be used for preparation of the ingestible product. Origination of an illustratively derived control prep radiation component group can be accomplished through skilled in the art design choice selection of one or more of the above depicted components from one or more of the above depicted subsystems shown in FIG. 10. Components from the control prep radiation component group can be used in implementing execution of the one or more control prep radiation instructions i1186 of FIG. 32, can be used in performance of the control prep radiation electrical circuitry arrangement e1186 of FIG. 23, and/or can be used in otherwise fulfillment of the operation o1186. An exemplary non-transitory signal bearing medium version of the information storage subsystem s200 is depicted in FIG. 32 as bearing the one or more control prep radiation instructions i1186 that when executed will direct performance of the operation o1186. Furthermore, the control prep radiation electrical circuitry arrangement (“elec circ arrange”) e1186, when activated, will perform the operation o1186. For instance, in one or more exemplary implementations, the one or more control prep radiation instructions i1186, when executed, direct performance of the operation o1186 in the illustrative depiction as follows, and/or the control prep radiation electrical circuitry arrangement e1186, when activated, performs the operation o1186 in the illustrative depiction as follows, and/or the operation o1186 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) via collecting information regarding control of radiation emitted within an enclosure containing ingredients to be used for preparation of the ingestible product (e.g. an implementation of the microprocessor component s102 is configured to electronically control the energy emitting component s724 configured to emit radiation according to a radiation profile received thereby, etc.).

In one or more implementations, as shown in FIG. 66, operation o11 includes an operation o1187 for electronically receiving the user status information and the selection information to electronically direct control of the collection of the preparation information regarding the at least partial preparation of the one or more ingestible products via collecting information regarding control of sound emitted within an enclosure containing ingredients to be used for preparation of the ingestible product. Origination of an illustratively derived control prep sound component group can be accomplished through skilled in the art design choice selection of one or more of the above depicted components from one or more of the above depicted subsystems shown in FIG. 10. Components from the control prep sound component group can be used in implementing execution of the one or more control prep sound instructions i1187 of FIG. 32, can be used in performance of the control prep sound electrical circuitry arrangement e1187 of FIG. 23, and/or can be used in otherwise fulfillment of the operation o1187. An exemplary non-transitory signal bearing medium version of the information storage subsystem s200 is depicted in FIG. 32 as bearing the one or more control prep sound instructions i1187 that when executed will direct performance of the operation o1187. Furthermore, the control prep sound electrical circuitry arrangement (“elec circ arrange”) e1187, when activated, will perform the operation o1187. For instance, in one or more exemplary implementations, the one or more control prep sound instructions i1187, when executed, direct performance of the operation o1187 in the illustrative depiction as follows, and/or the control prep sound electrical circuitry arrangement e1187, when activated, performs the operation o1187 in the illustrative depiction as follows, and/or the operation o1187 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710: peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) via collecting information regarding control of sound emitted within an enclosure containing ingredients to be used for preparation of the ingestible product (e.g. an implementation of the microprocessor component s102 is configured to electronically control the acoustic energy component s718 according to an acoustic energy profile received thereby, etc.).

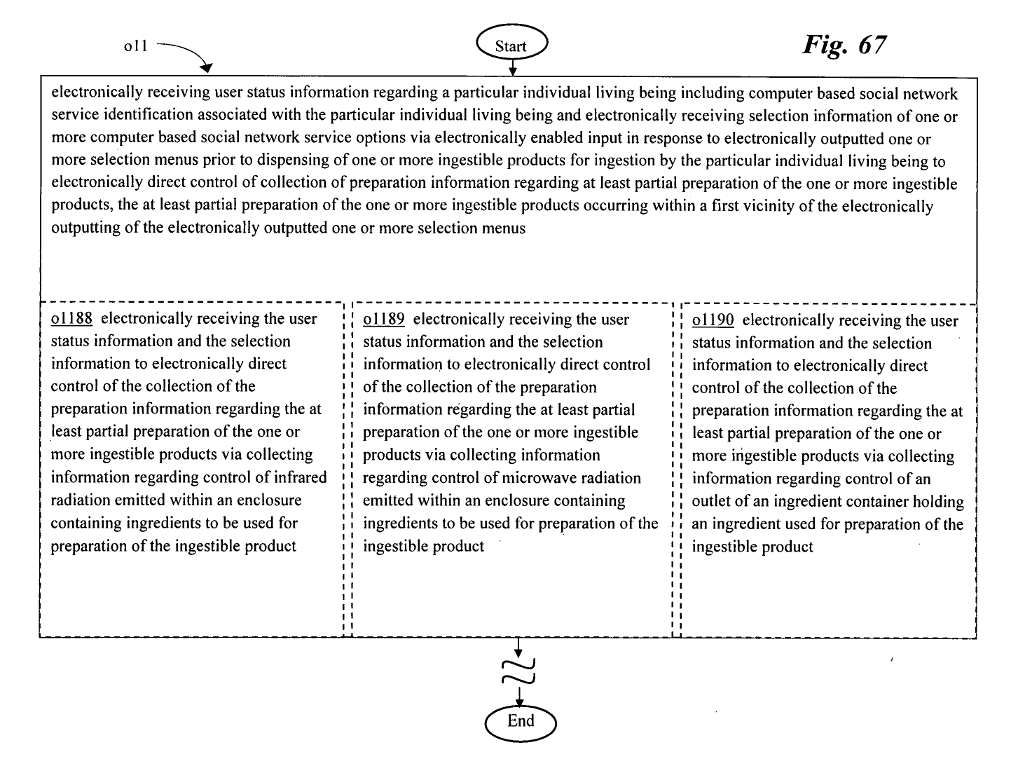

In one or more implementations, as shown in FIG. 67, operation o11 includes an operation o1188 for electronically receiving the user status information and the selection information to electronically direct control of the collection of the preparation information regarding the at least partial preparation of the one or more ingestible products via collecting information regarding control of infrared radiation emitted within an enclosure containing ingredients to be used for preparation of the ingestible product. Origination of an illustratively derived control prep infrared component group can be accomplished through skilled in the art design choice selection of one or more of the above depicted components from one or more of the above depicted subsystems shown in FIG. 10. Components from the control prep infrared component group can be used in implementing execution of the one or more Control prep infrared instructions i1188 of FIG. 32, can be used in performance of the control prep infrared electrical circuitry arrangement e1188 of FIG. 23, and/or can be used in otherwise fulfillment of the operation o1188. An exemplary non-transitory signal bearing medium version of the information storage subsystem s200 is depicted in FIG. 32 as bearing the one or more control prep infrared instructions i1188 that when executed will direct performance of the operation o1188. Furthermore, the control prep infrared electrical circuitry arrangement (“elec circ arrange”) e1188, when activated, will perform the operation o1188. For instance, in one or more exemplary implementations, the one or more control prep infrared instructions i1188, when executed, direct performance of the operation o1188 in the illustrative depiction as follows, and/or the control prep infrared electrical circuitry arrangement e1188, when activated, performs the operation o1188 in the illustrative depiction as follows, and/or the operation o1188 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) via collecting information regarding control of infrared radiation emitted within an enclosure containing ingredients to be used for preparation of the ingestible product (e.g. an implementation of the microprocessor component s102 is configured to electronically control the infrared component s730 according to a temperature profile received thereby, etc.).

In one or more implementations, as shown in FIG. 67, operation o11 includes an operation o1189 for electronically receiving the user status information and the selection information to electronically direct control of the collection of the preparation information regarding the at least partial preparation of the one or more ingestible products via collecting information regarding control of microwave radiation emitted within an enclosure containing ingredients to be used for preparation of the ingestible product. Origination of an illustratively derived control prep microwave component group can be accomplished through skilled in the art design choice selection of one or more of the above depicted components from one or more of the above depicted subsystems shown in FIG. 10. Components from the control prep microwave component group can be used in implementing execution of the one or more control prep microwave instructions i1189 of FIG. 32, can be used in performance of the control prep microwave electrical circuitry arrangement e1189 of FIG. 23, and/or can be used in otherwise fulfillment of the operation o1189. An exemplary non-transitory signal bearing medium version of the information storage subsystem s200 is depicted in FIG. 32 as bearing the one or more control prep microwave instructions i1189 that when executed will direct performance of the operation o1189. Furthermore, the control prep microwave electrical circuitry arrangement (“elec circ arrange”) e1189, when activated, will perform the operation o1189. For instance, in one or more exemplary implementations, the one or more control prep microwave instructions i1189, when executed, direct performance of the operation o1189 in the illustrative depiction as follows, and/or the control prep microwave electrical circuitry arrangement e1189, when activated, performs the operation o1189 in the illustrative depiction as follows, and/or the operation o1189 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc:) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) via collecting information regarding control of microwave radiation emitted within an enclosure containing ingredients to be used for preparation of the ingestible product (e.g. an implementation of the microprocessor component s102 is configured to electronically control the microwave component s706 according to a temperature profile received thereby, etc.).

In one or more implementations, as shown in FIG. 67, operation o11 includes an operation o1190 for electronically receiving the user status information and the selection information to electronically direct control of the collection of the preparation information regarding the at least partial preparation of the one or more ingestible products via collecting information regarding control of an outlet of an ingredient container holding an ingredient used for preparation of the ingestible product. Origination of an illustratively derived control prep container component group can be accomplished through skilled in the art design choice selection of one or more of the above depicted components from one or more of the above depicted subsystems shown in FIG. 10. Components from the control prep container component group can be used in implementing execution of the one or more control prep container instructions i1190 of FIG. 32, can be used in performance of the control prep container electrical circuitry arrangement e1190 of FIG. 23, and/or can be used in otherwise fulfillment of the operation o1190. An exemplary non-transitory signal bearing medium version of the information storage subsystem s200 is depicted in FIG. 32 as bearing the one or more control prep container instructions i1190 that when executed will direct performance of the operation o1190. Furthermore, the control prep container electrical circuitry arrangement (“elec circ arrange”) e1190, when activated, will perform the operation o1190. For instance, in one or more exemplary implementations, the one or more control prep container instructions i1190, when executed, direct performance of the operation o1190 in the illustrative depiction as follows, and/or the control prep container electrical circuitry arrangement e1190, when activated, performs the operation o1190 in the illustrative depiction as follows, and/or the operation o1190 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522; infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) via collecting information regarding control of an outlet of an ingredient container holding an ingredient used for preparation of the ingestible product (e.g. an implementation of the microprocessor component s102 is configured to electronically control an outlet of the material storage component s734 configured as an ingredient container according to an access profile received thereby, etc.).

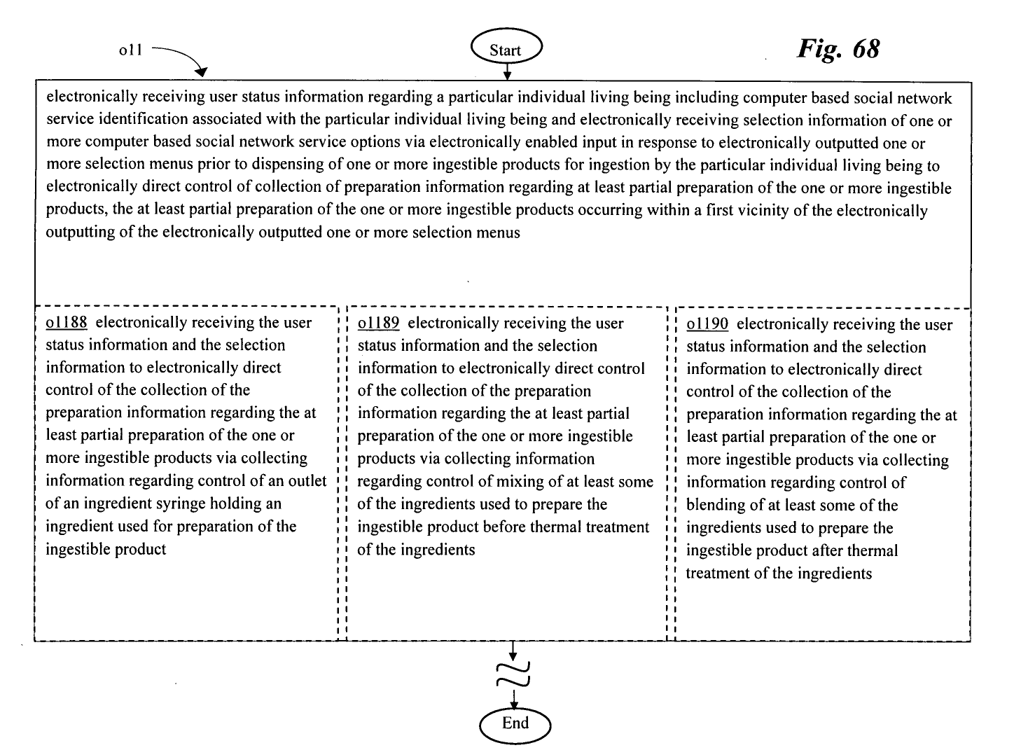

In one or more implementations, as shown in FIG. 68, operation o11 includes an operation o1191 for electronically receiving the user status information and the selection information to electronically direct control of the collection of the preparation information regarding the at least partial preparation of the one or more ingestible products via collecting information regarding control of an outlet of an ingredient syringe holding an ingredient used for preparation of the ingestible product. Origination of an illustratively derived control prep syringe component group can be accomplished through skilled in the art design choice selection of one or more of the above depicted components from one or more of the above depicted subsystems shown in FIG. 10. Components from the control prep syringe component group can be used in implementing execution of the one or more control prep syringe instructions i1191 of FIG. 32, can be used in performance of the control prep syringe electrical circuitry arrangement e1191 of FIG. 23, and/or can be used in otherwise fulfillment of the operation o1191. An exemplary non-transitory signal bearing medium version of the information storage subsystem s200 is depicted in FIG. 32 as bearing the one or more control prep syringe instructions i1191 that when executed will direct performance of the operation o1191. Furthermore, the control prep syringe electrical circuitry arrangement (“elec circ arrange”) e1191, when activated, will perform the operation o1191. For instance, in one or more exemplary implementations, the one or more control prep syringe instructions i1191, when executed, direct performance of the operation o1191 in the illustrative depiction as follows, and/or the control prep syringe electrical circuitry arrangement e1191, when activated, performs the operation o1191 in the illustrative depiction as follows, and/or the operation o1191 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) via collecting information regarding control of an outlet of an ingredient syringe holding an ingredient used for preparation of the ingestible product (e.g. an implementation of the microprocessor component s102 is configured to electronically control an outlet of the material storage component s734 configured as an ingredient syringe according to an access profile received thereby, etc.).

In one or more implementations, as shown in FIG. 68, operation o11 includes an operation o1192 for electronically receiving the user status information and the selection information to electronically direct control of the collection of the preparation information regarding the at least partial preparation of the one or more ingestible products via collecting information regarding control of mixing of at least some of the ingredients used to prepare the ingestible product before thermal treatment of the ingredients. Origination of an illustratively derived control prep mix before thermal component group can be accomplished through skilled in the art design choice selection of one or more of the above depicted components from one or more of the above depicted subsystems shown in FIG. 10. Components from the control prep mix before thermal component group can be used in implementing execution of the one or more control prep mix before thermal instructions i1192 of FIG. 32, can be used in performance of the control prep mix before thermal electrical circuitry arrangement e1192 of FIG. 23, and/or can be used in otherwise fulfillment of the operation o1192. An exemplary non-transitory signal bearing medium version of the information storage subsystem s200 is depicted in FIG. 32 as bearing the one or more control prep mix before thermal instructions i1192 that when executed will direct performance of the operation o1192. Furthermore, the control prep mix before thermal electrical circuitry arrangement (“elec circ arrange”) e1192, when activated, will perform the operation o1192. For instance, in one or more exemplary implementations, the one or more control prep mix before thermal instructions i1192, when executed, direct performance of the operation o1192 in the illustrative depiction as follows, and/or the control prep mix before thermal electrical circuitry arrangement e1192, when activated, performs the operation o1192 in the illustrative depiction as follows, and/or the operation o1192 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) via collecting information regarding control of mixing of at least some of the ingredients used to prepare the ingestible product before thermal treatment of the ingredients (e.g. an implementation of the microprocessor component s102 is configured to electronically control the mixer component s716 according to a mixing profile received thereby, etc.).

In one or more implementations, as shown in FIG. 68, operation o11 includes an operation o1193 for electronically receiving the user status information and the selection information to electronically direct control of the collection of the preparation information regarding the at least partial preparation of the one or more ingestible products via collecting information regarding control of blending of at least some of the ingredients used to prepare the ingestible product after thermal treatment of the ingredients. Origination of an illustratively derived control prep re mix after thermal component group can be accomplished through skilled in the art design choice selection of one or more of the above depicted components from one or more of the above depicted subsystems shown in FIG. 10. Components from the control prep re mix after thermal component group can be used in implementing execution of the one or more control prep re mix after thermal instructions i1193 of FIG. 32, can be used in performance of the control prep re mix after thermal electrical circuitry arrangement e1193 of FIG. 23, and/or can be used in otherwise fulfillment of the operation o1193. An exemplary non-transitory signal bearing medium version of the information storage subsystem s200 is depicted in FIG. 32 as bearing the one or more control prep re mix after thermal instructions i1193 that when executed will direct performance of the operation o1193. Furthermore, the control prep re mix after thermal electrical circuitry arrangement (“elec circ arrange”) e1193, when activated, will perform the operation o1193. For instance, in one or more exemplary implementations, the one or more control prep re mix after thermal instructions i1193, when executed, direct performance of the operation o1193 in the illustrative depiction as follows, and/or the control prep re mix after thermal electrical circuitry arrangement e1193, when activated, performs the operation o1193 in the illustrative depiction as follows, and/or the operation o1193 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) via collecting information regarding control of blending of at least some of the ingredients used to prepare the ingestible product after thermal treatment of the ingredients (e.g. an implementation of the microprocessor component s102 is configured to electronically control the blending component s714 according to a blending profile, etc.).

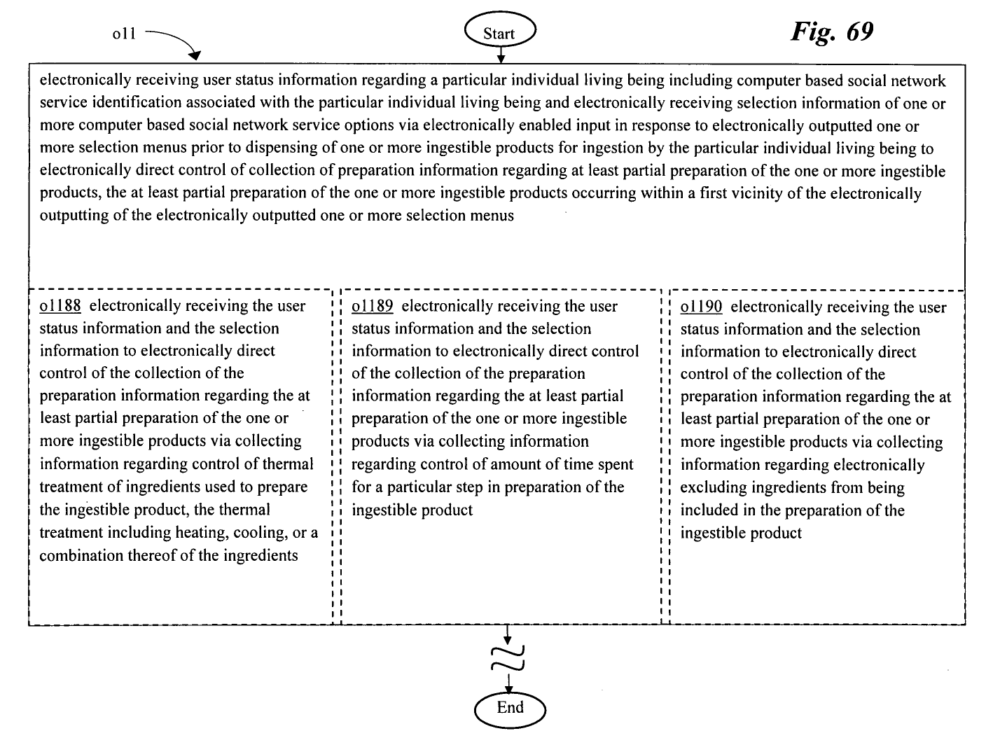

In one or more implementations, as shown in FIG. 69, operation o11 includes an operation o1194 for electronically receiving the user status information and the selection information to electronically direct control of the collection of the preparation information regarding the at least partial preparation of the one or more ingestible products via collecting information regarding control of thermal treatment of ingredients used to prepare the ingestible product, the thermal treatment including heating, cooling, or a combination thereof of the ingredients. Origination of an illustratively derived control prep heating cooling component group can be accomplished through skilled in the art design choice selection of one or more of the above depicted components from one or more of the above depicted subsystems shown in FIG. 10. Components from the control prep heating cooling component group can be used in implementing execution of the one or more control prep heating cooling instructions i1194 of FIG. 32, can be used in performance of the control prep heating cooling electrical circuitry arrangement e1194 of FIG. 23, and/or can be used in otherwise fulfillment of the operation o1194. An exemplary non-transitory signal bearing medium version of the information storage subsystem s200 is depicted in FIG. 32 as bearing the one or more control prep heating cooling instructions i1194 that when executed will direct performance of the operation o1194. Furthermore, the control prep heating cooling electrical circuitry arrangement (“elec circ arrange”) e1194, when activated, will perform the operation o1194. For instance, in one or more exemplary implementations, the one or more control prep heating cooling instructions i1194, when executed, direct performance of the operation o1194 in the illustrative depiction as follows, and/or the control prep heating cooling electrical circuitry arrangement e1194, when activated, performs the operation o1194 in the illustrative depiction as follows, and/or the operation o1194 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) via collecting information regarding control of thermal treatment of ingredients used to prepare the ingestible product, the thermal treatment including heating, cooling, or a combination thereof of the ingredient (e.g. an implementation of the microprocessor component s102 is configured to electronically control the heating component s702 and/or the cooling component s704 according to a thermal profile received thereby, etc.).

In one or more implementations, as shown in FIG. 69, operation o11 includes an operation o1195 for electronically receiving the user status information and the selection information to electronically direct control of the collection of the preparation information regarding the at least partial preparation of the one or more ingestible products via collecting information regarding control of amount of time spent for a particular step in preparation of the ingestible product. Origination of an illustratively derived control prep time control component group can be accomplished through skilled in the art design choice selection of one or more of the above depicted components from one or more of the above depicted subsystems shown in FIG. 10. Components from the control prep time control component group can be used in implementing execution of the one or more control prep time control instructions i1195 of FIG. 32, can be used in performance of the control prep time control electrical circuitry arrangement e1195 of FIG. 23, and/or can be used in otherwise fulfillment of the operation o1195. An exemplary non-transitory signal bearing medium version of the information storage subsystem s200 is depicted in FIG. 32 as bearing the one or more control prep time control instructions i1195 that when executed will direct performance of the operation o1195. Furthermore, the control prep time control electrical circuitry arrangement (“elec circ arrange”) e1195, when activated, will perform the operation o1195. For instance, in one or more exemplary implementations, the one or more control prep time control instructions i1195, when executed, direct performance of the operation o1195 in the illustrative depiction as follows, and/or the control prep time control electrical circuitry arrangement e1195, when activated, performs the operation o1195 in the illustrative depiction as follows, and/or the operation o1195 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) via collecting information regarding control of amount of time spent for a particular step in preparation of the ingestible product (e.g. an implementation of the microprocessor component s102 is configured to electronically control components of the material processing subsystem s700 based upon an internal clock of the microprocessor according to a time profile received thereby, etc.).

In one or more implementations, as shown in FIG. 69, operation o11 includes an operation o1196 for electronically receiving the user status information and the selection information to electronically direct control of the collection of the preparation information regarding the at least partial preparation of the one or more ingestible products via collecting information regarding electronically excluding ingredients from being included in the preparation of the ingestible product. Origination of an illustratively derived control prep ingredient exclusion component group can be accomplished through skilled in the art design choice selection of one or more of the above depicted components from one or more of the above depicted subsystems shown in FIG. 10. Components from the control prep ingredient exclusion component group can be used in implementing execution of the one or more control prep ingredient exclusion instructions i1196 of FIG. 32, can be used in performance of the control prep ingredient exclusion electrical circuitry arrangement e1196 of FIG. 23, and/or can be used in otherwise fulfillment of the operation o1196. An exemplary non-transitory signal bearing medium version of the information storage subsystem s200 is depicted in FIG. 32 as bearing the one or more control prep ingredient exclusion instructions i1196 that when executed will direct performance of the operation o1196. Furthermore, the control prep ingredient exclusion electrical circuitry arrangement (“elec circ arrange”) e1196, when activated, will perform the operation o1196. For instance, in one or more exemplary implementations, the one or more control prep ingredient exclusion instructions i1196, when executed, direct performance of the operation o1196 in the illustrative depiction as follows, and/or the control prep ingredient exclusion electrical circuitry arrangement e1196, when activated, performs the operation o1196 in the illustrative depiction as follows, and/or the operation o1196 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) via collecting information regarding electronically excluding ingredients from being included in the preparation of the ingestible product (e.g. an implementation of the microprocessor component s102 is configured to electronically control components of the material processing subsystem s700 based upon an internal clock of the microprocessor according to a time profile received thereby, etc.).

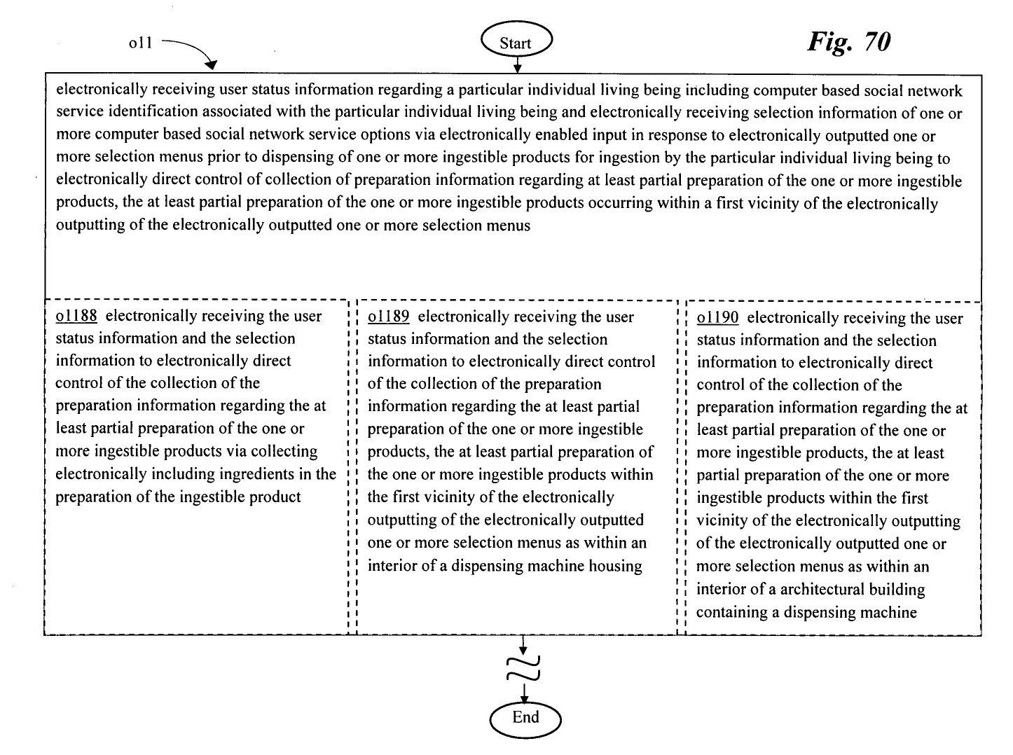

In one or more implementations, as shown in FIG. 70, operation o11 includes an operation o1197 for electronically receiving the user status information and the selection information to electronically direct control of the collection of the preparation information regarding the at least partial preparation of the one or more ingestible products via collecting electronically including ingredients in the preparation of the ingestible product. Origination of an illustratively derived control prep ingredient inclusion component group can be accomplished through skilled in the art design choice selection of one or more of the above depicted components from one or more of the above depicted subsystems shown in FIG. 10. Components from the control prep ingredient inclusion component group can be used in implementing execution of the one or more control prep ingredient inclusion instructions i1197 of FIG. 32, can be used in performance of the control prep ingredient inclusion electrical circuitry arrangement e1197 of FIG. 23, and/or can be used in otherwise fulfillment of the operation o1197. An exemplary non-transitory signal bearing medium version of the information storage subsystem s200 is depicted in FIG. 32 as bearing the one or more control prep ingredient inclusion instructions i1197 that when executed will direct performance of the operation o1197. Furthermore, the control prep ingredient inclusion electrical circuitry arrangement (“elec circ arrange”) e1197, when activated, will perform the operation o1197. For instance, in one or more exemplary implementations, the one or more control prep ingredient inclusion instructions i1197, when executed, direct performance of the operation o1197 in the illustrative depiction as follows, and/or the control prep ingredient inclusion electrical circuitry arrangement e1197, when activated, performs the operation o1197 in the illustrative depiction as follows, and/or the operation o1197 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) via collecting electronically including ingredients in the preparation of the ingestible product (e.g. an implementation of the microprocessor component s102 is configured to electronically control the sorting component s728 to include one or more ingredients in the ingestible product according to an inclusion profile received thereby, etc.).

In one or more implementations, as shown in FIG. 70, operation o11 includes an operation o1198 for electronically receiving the user status information and the selection information to electronically direct control of the collection of the preparation information regarding the at least partial preparation of the one or more ingestible products, the at least partial preparation of the one or more ingestible products within the first vicinity of the electronically outputting of the electronically outputted one or more selection menus as within an interior of a dispensing machine housing. Origination of an illustratively derived control prep housing component group can be accomplished through skilled in the art design choice selection of one or more of the above depicted components from one or more of the above depicted subsystems shown in FIG. 10. Components from the control prep housing component group can be used in implementing execution of the one or more control prep housing instructions i1198 of FIG. 32, can be used in performance of the control prep housing electrical circuitry arrangement e1198 of FIG. 23, and/or can be used in otherwise fulfillment of the operation o1198. An exemplary non-transitory signal bearing medium version of the information storage subsystem s200 is depicted in FIG. 32 as bearing the one or more control prep housing instructions i1198 that when executed will direct performance of the operation o1198. Furthermore, the control prep housing electrical circuitry arrangement (“elec circ arrange”) e1198, when activated, will perform the operation o1198. For instance, in one or more exemplary implementations, the one or more control prep housing instructions i1198, when executed, direct performance of the operation o1198 in the illustrative depiction as follows, and/or the control prep housing electrical circuitry arrangement e1198, when activated, performs the operation o1198 in the illustrative depiction as follows, and/or the operation o1198 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) within the first vicinity (e.g. such as within visual distance thereof, within audio distance thereof, within same interior space thereof, within same neighborhood thereof, within same geographical region thereof, etc.) of the electronically outputting of the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) as within an interior of a dispensing (e.g. through use of one or more of the following types: automated, wait staff, pre-packaged, deli, vending machine, counter selection, on site fabrication, conveyor, lazy susan, buffet, sit-down, street stand, mobile truck, cafe, mart, etc.) machine housing (e.g. an implementation of the microprocessor component s102 is configured to receive through the electronic communication subsystem 500 to electronically direct control of the material processing subsystem 700 within the first vicinity as within the interior of the digestible product preparation system 10 that uses for instance visual display component s304 to electronically output the electronically generated one or more selection menus, etc.).

In one or more implementations, as shown in FIG. 70, operation o11 includes an operation o1199 for electronically receiving the user status information and the selection information to electronically direct control of the collection of the preparation information regarding the at least partial preparation of the one or more ingestible products, the at least partial preparation of the one or more ingestible products within the first vicinity of the electronically outputting of the electronically outputted one or more selection menus as within an interior of an architectural building containing a dispensing machine. Origination of an illustratively derived control prep building component group can be accomplished through skilled in the art design choice selection of one or more of the above depicted components from one or more of the above depicted subsystems shown in FIG. 10. Components from the control prep building component group can be used in implementing execution of the one or more control prep building instructions i1199 of FIG. 32, can be used in performance of the control prep building electrical circuitry arrangement e1199 of FIG. 23, and/or can be used in otherwise fulfillment of the operation o1199. An exemplary non-transitory signal bearing medium version of the information storage subsystem s200 is depicted in FIG. 32 as bearing the one or more control prep building instructions i1199 that when executed will direct performance of the operation o1199. Furthermore, the control prep building electrical circuitry arrangement (“elec circ arrange”) e1199, when activated, will perform the operation o1199. For instance, in one or more exemplary implementations, the one or more control prep building instructions i1199, when executed, direct performance of the operation o1199 in the illustrative depiction as follows, and/or the control prep building electrical circuitry arrangement e1199, when activated, performs the operation o1199 in the illustrative depiction as follows, and/or the operation o1199 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) within the first vicinity (e.g. such as within visual distance thereof, within audio distance thereof, within same interior space thereof, within same neighborhood thereof, within same geographical region thereof, etc.) of the electronically outputting of the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) as within an interior of an architectural building containing a dispensing machine (e.g. an implementation of the microprocessor component s102 is configured to receive through the electronic communication subsystem 500 to electronically direct control of the material processing subsystem 700 within the first vicinity as within the interior of an airport wherein the digestible product preparation system 10 is located that communicates with for instance the visual display component s304 to electronically output the electronically generated one or more selection menus also within the airport, etc.).

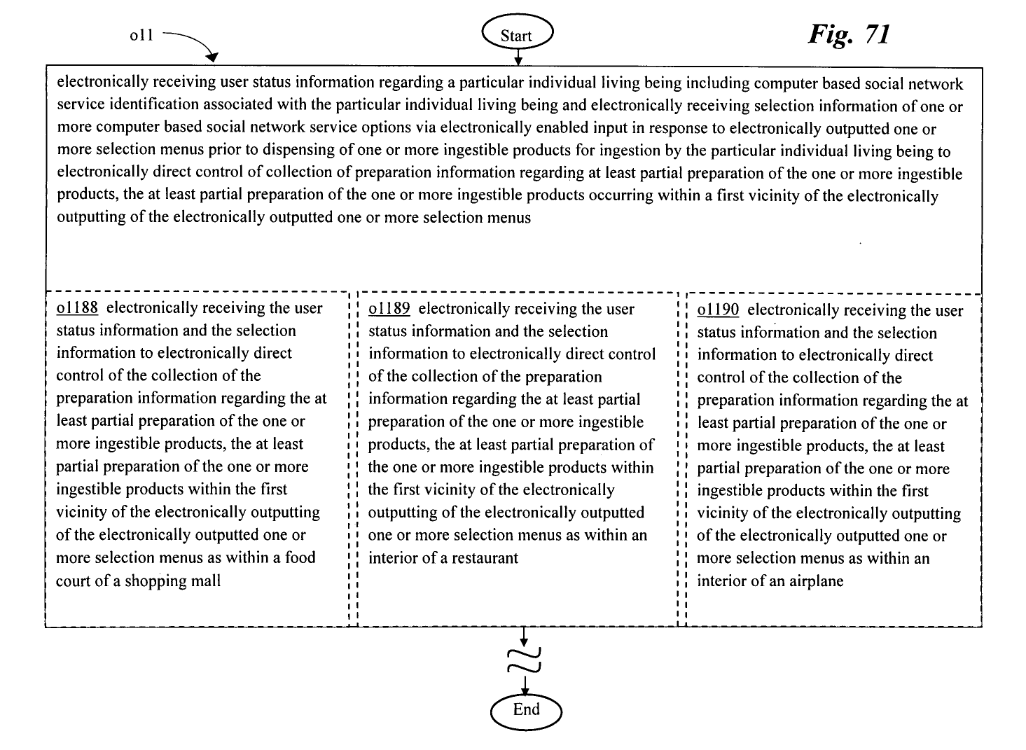

In one or more implementations, as shown in FIG. 71, operation o11 includes an operation o11100 for electronically receiving the user status information and the selection information to electronically direct control of the collection of the preparation information regarding the at least partial preparation of the one or more ingestible products, the at least partial preparation of the one or more ingestible products within the first vicinity of the electronically outputting of the electronically outputted one or more selection menus as within a food court of a shopping mall. Origination of an illustratively derived control prep mall component group can be accomplished through skilled in the art design choice selection of one or more of the above depicted components from one or more of the above depicted subsystems shown in FIG. 10. Components from the control prep mall component group can be used in implementing execution of the one or more control prep mall instructions i11100 of FIG. 33, can be used in performance of the control prep mall electrical circuitry arrangement e11100 of FIG. 24, and/or can be used in otherwise fulfillment of the operation o11100. An exemplary non-transitory signal bearing medium version of the information storage subsystem s200 is depicted in FIG. 33 as bearing the one or more control prep mall instructions i11100 that when executed will direct performance of the operation o11100. Furthermore, the control prep mall electrical circuitry arrangement (“elec circ arrange”) e11100, when activated, will perform the operation o11100. For instance, in one or more exemplary implementations, the one or more control prep mall instructions i11100, when executed, direct performance of the operation o11100 in the illustrative depiction as follows, and/or the control prep mall electrical circuitry arrangement e11100, when activated, performs the operation o11100 in the illustrative depiction as follows, and/or the operation o11100 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) within the first vicinity (e.g. such as within visual distance thereof, within audio distance thereof, within same interior space thereof, within same neighborhood thereof, within same geographical region thereof, etc.) of the electronically outputting of the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) as within a food court of a shopping mall (e.g. an implementation of the microprocessor component s102 is configured to receive through the electronic communication subsystem 500 to electronically direct control of the material processing subsystem 700 within the first vicinity as within the food court of the shopping mall wherein the digestible product preparation system 10 is located that communicates with for instance the visual display component s304 to electronically output the electronically generated one or more selection menus also within the food court of the shopping mall, etc.).

In one or more implementations, as shown in FIG. 71, operation o11 includes an operation o11101 for electronically receiving the user status information and the selection information to electronically direct control of the collection of the preparation information regarding the at least partial preparation of the one or more ingestible products, the at least partial preparation of the one or more ingestible products within the first vicinity of the electronically outputting of the electronically outputted one or more selection menus as within an interior of a restaurant. Origination of an illustratively derived control prep restaurant component group can be accomplished through skilled in the art design choice selection of one or more of the above depicted components from one or more of the above depicted subsystems shown in FIG. 10. Components from the control prep restaurant component group can be used in implementing execution of the one or more control prep restaurant instructions i11101 of FIG. 33, can be used in performance of the control prep restaurant electrical circuitry arrangement e11101 of FIG. 24, and/or can be used in otherwise fulfillment of the operation o11101. An exemplary non-transitory signal bearing medium version of the information storage subsystem s200 is depicted in FIG. 33 as bearing the one or more control prep restaurant instructions i11101 that when executed will direct performance of the operation o11101. Furthermore, the control prep restaurant electrical circuitry arrangement (“elec circ arrange”) e11101, when activated, will perform the operation o11101. For instance, in one or more exemplary implementations, the one or more control prep restaurant instructions i11101, when executed, direct performance of the operation o11101 in the illustrative depiction as follows, and/or the control prep restaurant electrical circuitry arrangement e11101, when activated, performs the operation o11101 in the illustrative depiction as follows, and/or the operation o11101 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) within the first vicinity (e.g. such as within visual distance thereof, within audio distance thereof, within same interior space thereof, within same neighborhood thereof, within same geographical region thereof, etc.) of the electronically outputting of the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) as within an interior of a restaurant (e.g. an implementation of the microprocessor component s102 is configured to receive through the electronic communication subsystem 500 to electronically direct control of the material processing subsystem 700 within the first vicinity as within the interior of the restaurant wherein the digestible product preparation system 10 is located that communicates with for instance the visual display component s304 to electronically output the electronically generated one or more selection menus also within the restaurant, etc.).

In one or more implementations, as shown in FIG. 71, operation o11 includes an operation o11102 for electronically receiving the user status information and the selection information to electronically direct control of the collection of the preparation information regarding the at least partial preparation of the one or more ingestible products, the at least partial preparation of the one or more ingestible products within the first vicinity of the electronically outputting of the electronically outputted one or more selection menus as within an interior of an airplane. Origination of an illustratively derived control prep airplane component group can be accomplished through skilled in the art design choice selection of one or more of the above depicted components from one or more of the above depicted subsystems shown in FIG. 10. Components from the control prep airplane component group can be used in implementing execution of the one or more control prep airplane instructions i11102 of FIG. 33, can be used in performance of the control prep airplane electrical circuitry arrangement e11102 of FIG. 24, and/or can be used in otherwise fulfillment of the operation o11102. An exemplary non-transitory signal bearing medium version of the information storage subsystem s200 is depicted in FIG. 33 as bearing the one or more control prep airplane instructions i11102 that when executed will direct performance of the operation o11102. Furthermore, the control prep airplane electrical circuitry arrangement (“elec circ arrange”) e11102, when activated, will perform the operation o11102. For instance, in one or more exemplary implementations, the one or more control prep airplane instructions i11102, when executed, direct performance of the operation o11102 in the illustrative depiction as follows, and/or the control prep airplane electrical circuitry arrangement e11102, when activated, performs the operation o11102 in the illustrative depiction as follows, and/or the operation o11102 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) within the first vicinity (e.g. such as within visual distance thereof, within audio distance thereof, within same interior space thereof, within same neighborhood thereof, within same geographical region thereof, etc.) of the electronically outputting of the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) as within an interior of an airplane (e.g. an implementation of the microprocessor component s102 is configured to receive through the electronic communication subsystem 500 to electronically direct control of the material processing subsystem 700 within the first vicinity as within the interior of the airplane wherein the digestible product preparation system 10 is located that communicates with for instance the visual display component s304 to electronically output the electronically generated one or more selection menus also within the airplane, etc.).

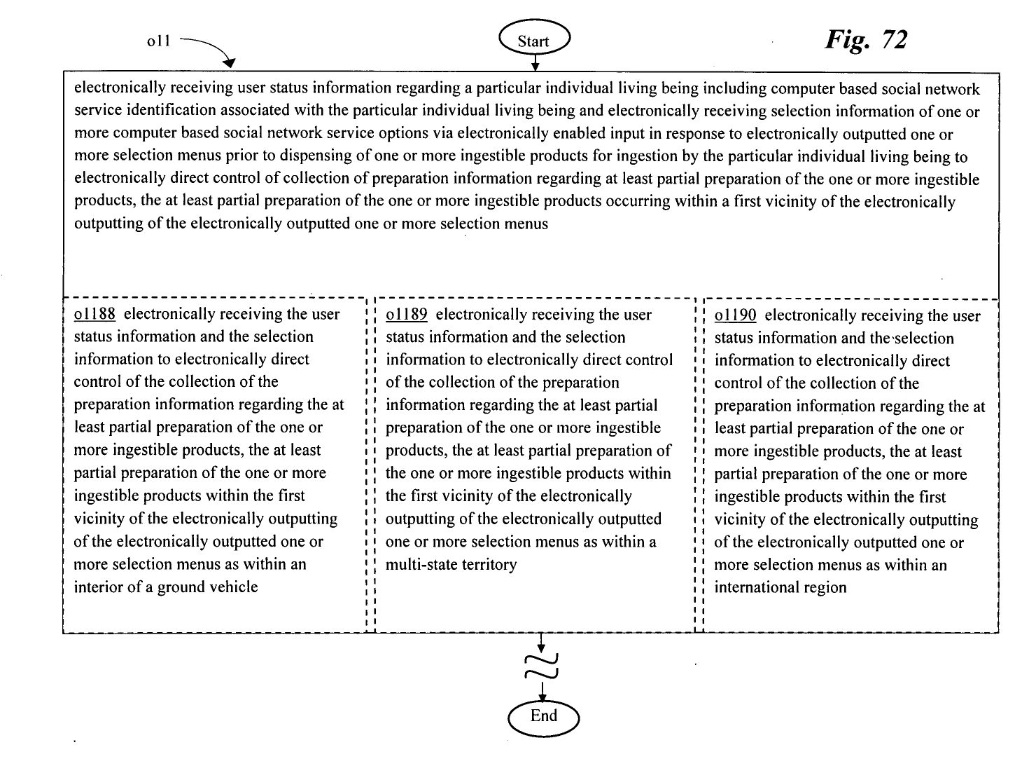

In one or more implementations, as shown in FIG. 72, operation o11 includes an operation o11103 for electronically receiving the user status information and the selection information to electronically direct control of the collection of the preparation information regarding the at least partial preparation of the one or more ingestible products, the at least partial preparation of the one or more ingestible products within the first vicinity of the electronically outputting of the electronically outputted one or more selection menus as within an interior of a ground vehicle. Origination of an illustratively derived control prep vehicle component group can be accomplished through skilled in the art design choice selection of one or more of the above depicted components from one or more of the above depicted subsystems shown in FIG. 10. Components from the control prep vehicle component group can be used in implementing execution of the one or more control prep vehicle instructions i11103 of FIG. 33, can be used in performance of the control prep vehicle electrical circuitry arrangement e11103 of FIG. 24, and/or can be used in otherwise fulfillment of the operation o11103. An exemplary non-transitory signal bearing medium version of the information storage subsystem s200 is depicted in FIG. 33 as bearing the one or more control prep vehicle instructions i11103 that when executed will direct performance of the operation o11103. Furthermore, the control prep vehicle electrical circuitry arrangement (“elec circ arrange”) e11103, when activated, will perform the operation o11103. For instance, in one or more exemplary implementations, the one or more control prep vehicle instructions i11103, when executed, direct performance of the operation o11103 in the illustrative depiction as follows, and/or the control prep vehicle electrical circuitry arrangement e11103, when activated, performs the operation o11103 in the illustrative depiction as follows, and/or the operation o11103 is otherwise carried out in the illustrative depiction as follows: electronically receiving (e.g. through use of one or more of network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) within the first vicinity (e.g. such as within visual distance thereof, within audio distance thereof, within same interior space thereof, within same neighborhood thereof, within same geographical region thereof, etc.) of the electronically outputting of the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) as within an interior of a ground vehicle (e.g. an implementation of the microprocessor component s102 is configured to receive through the electronic communication subsystem 500 to electronically direct control of the material processing subsystem 700 within the first vicinity as within the interior of the ground vehicle wherein the digestible product preparation system 10 is located that communicates with for instance the visual display component s304 to electronically output the electronically generated one or more selection menus also within the ground vehicle, etc.).

In one or more implementations, as shown in FIG. 72, operation o11 includes an operation o11104 for electronically receiving the user status information and the selection information to electronically direct control of the collection of the preparation information regarding the at least partial preparation of the one or more ingestible products, the at least partial preparation of the one or more ingestible products within the first vicinity of the electronically outputting of the electronically outputted one or more selection menus as within a multi-state territory. Origination of an illustratively derived control prep territory component group can be accomplished through skilled in the art design choice selection of one or more of the above depicted components from one or more of the above depicted subsystems shown in FIG. 10. Components from the control prep territory component group can be used in implementing execution of the one or more control prep territory instructions i11104 of FIG. 33, can be used in performance of the control prep territory electrical circuitry arrangement e11104 of FIG. 24, and/or can be used in otherwise fulfillment of the operation o11104. An exemplary non-transitory signal bearing medium version of the information storage subsystem s200 is depicted in FIG. 33 as bearing the one or more control prep territory instructions i11104 that when executed will direct performance of the operation o11104. Furthermore, the control prep territory electrical circuitry arrangement (“elec circ arrange”) e11104, when activated, will perform the operation o11104. For instance, in one or more exemplary implementations, the one or more control prep territory instructions i11104, when executed, direct performance of the operation o11104 in the illustrative depiction as follows, and/or the control prep territory electrical circuitry arrangement e11104, when activated, performs the operation o11104 in the illustrative depiction as follows, and/or the operation o11104 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) within the first vicinity (e.g. such as within visual distance thereof, within audio distance thereof, within same interior space thereof, within same neighborhood thereof, within same geographical region thereof, etc.) of the electronically outputting of the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) as within a multi state territory (e.g. an implementation of the microprocessor component s102 is configured to receive through the electronic communication subsystem 500 to electronically direct control of the material processing subsystem 700 within the first vicinity as within the interior of the multi state territory of Colorado, Wyoming, Montana, Utah, New Mexico, and Texas wherein the digestible product preparation system 10 is located that communicates with for instance the visual display component s304 to electronically output the electronically generated one or more selection menus also within the multi state territory of Colorado, Wyoming, Montana, Utah, New Mexico, and Texas, etc.).

In one or more implementations, as shown in FIG. 72, operation o11 includes an operation o11105 for electronically receiving the user status information and the selection information to electronically direct control of the collection of the preparation information regarding the at least partial preparation of the one or more ingestible products, the at least partial preparation of the one or more ingestible products within the first vicinity of the electronically outputting of the electronically outputted one or more selection menus as within an international region. Origination of an illustratively derived control prep region component group can be accomplished through skilled in the art design choice selection of one or more of the above depicted components from one or more of the above depicted subsystems shown in FIG. 10. Components from the control prep region component group can be used in implementing execution of the one or more control prep region instructions i11105 of FIG. 33, can be used in performance of the control prep region electrical circuitry arrangement e11105 of FIG. 24, and/or can be used in otherwise fulfillment of the operation o11105. An exemplary non-transitory signal bearing medium version of the information storage subsystem s200 is depicted in FIG. 33 as bearing the one or more control prep region instructions i11105 that when executed will direct performance of the operation o11105. Furthermore, the control prep region electrical circuitry arrangement (“elec circ arrange”) e11105, when activated, will perform the operation o11105. For instance, in one or more exemplary implementations, the one or more control prep region instructions i11105, when executed, direct performance of the operation o11105 in the illustrative depiction as follows, and/or the control prep region electrical circuitry arrangement e11105, when activated, performs the operation o11105 in the illustrative depiction as follows, and/or the operation o11105 is otherwise carried out in the illustrative depiction as follows: electronically receiving (e.g. through use of one or more of network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, receiver component s528, etc.) the user status information (e.g. one or more of user identification, user security access information, user affiliation information, use history, user type, user preferences, associates of user, etc.) and the selection information (e.g. information related to user completion of one or more checkboxes, button activations, blank fill-ins, voice input data, text data, gesture data, hand operated input data, touch data, eye tracking data, database data, etc.) to electronically direct control (e.g. through use of one or more of the following: microprocessor component s102, central processing unit (CPU) component s104, application specific integrated circuit (ASIC) component s108, field programmable gate array (FPGA) component s110, multiprocessor component s112, optical processing component s114, logic component s116, etc.) of the collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) of the preparation information regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) within the first vicinity (e.g. such as within visual distance thereof, within audio distance thereof, within same interior space thereof, within same neighborhood thereof, within same geographical region thereof, etc.) of the electronically outputting of the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.) as within an international region (e.g. an implementation of the microprocessor component s102 is configured to receive through the electronic communication subsystem 500 to electronically direct control of the material processing subsystem 700 within the first vicinity as within the international region of England, Germany, France, Brazil, Russia, India, China, and the United States wherein the digestible product preparation system 10 is located that communicates with for instance the visual display component s304 to electronically output the electronically generated one or more selection menus also within the international region of England, Germany, France, Brazil, Russia, India, China, and the United States, etc..

As shown in FIG. 37, the operational flow o10 proceeds to operation o12 for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus. An exemplary version of a non-transitory signal bearing medium of information storage subsystem s200 is depicted as bearing one or more controlling transmission instructions i12 that when executed will direct performance of the operation o12. In an implementation, the one or more controlling transmission instructions i12 when executed direct electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the information collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) and ingestion (e.g. by one of more of the following: oral intake, nasal intake, swallowing, chewing, topical, injected, sublingual, tear duct applied, transversed gut membrane, etc.) intelligence including information related to ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) within a second vicinity (e.g. such as within visual distance thereof, within audio distance thereof, within same interior space thereof, within same neighborhood thereof, within same geographical region thereof, etc.) of the electronically outputting of the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.). Furthermore, the controlling transmission electrical circuitry arrangement e12 when activated will perform the operation o12. In an implementation, the controlling transmission electrical circuitry arrangement e12, when activated performs electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the information collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) and ingestion (e.g. by one of more of the following: oral intake, nasal intake, swallowing, chewing, topical, injected, sublingual, tear duct applied, transversed gut membrane, etc.) intelligence including information related to ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) within a second vicinity (e.g. such as within visual distance thereof, within audio distance thereof, within same interior space thereof, within same neighborhood thereof, within same geographical region thereof, etc.) of the electronically outputting of the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.). In an implementation, the electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus is carried out by electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the information collection (e.g. through use of one or more of the following: random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, optical storage component s236, computer readable signal bearing medium s238, Blu Ray disk component s240, etc.) regarding the at least partial preparation (e.g. through use of one or more of the following: heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, controlled substance receiving assembly s736, controlled substance containing assembly s738, deposition component s740, etc.) of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) and ingestion (e.g. by one of more of the following: oral intake, nasal intake, swallowing, chewing, topical, injected, sublingual, tear duct applied, transversed gut membrane, etc.) intelligence including information related to ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) within a second vicinity (e.g. such as within visual distance thereof, within audio distance thereof, within same interior space thereof, within same neighborhood thereof, within same geographical region thereof, etc.) of the electronically outputting of the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.).

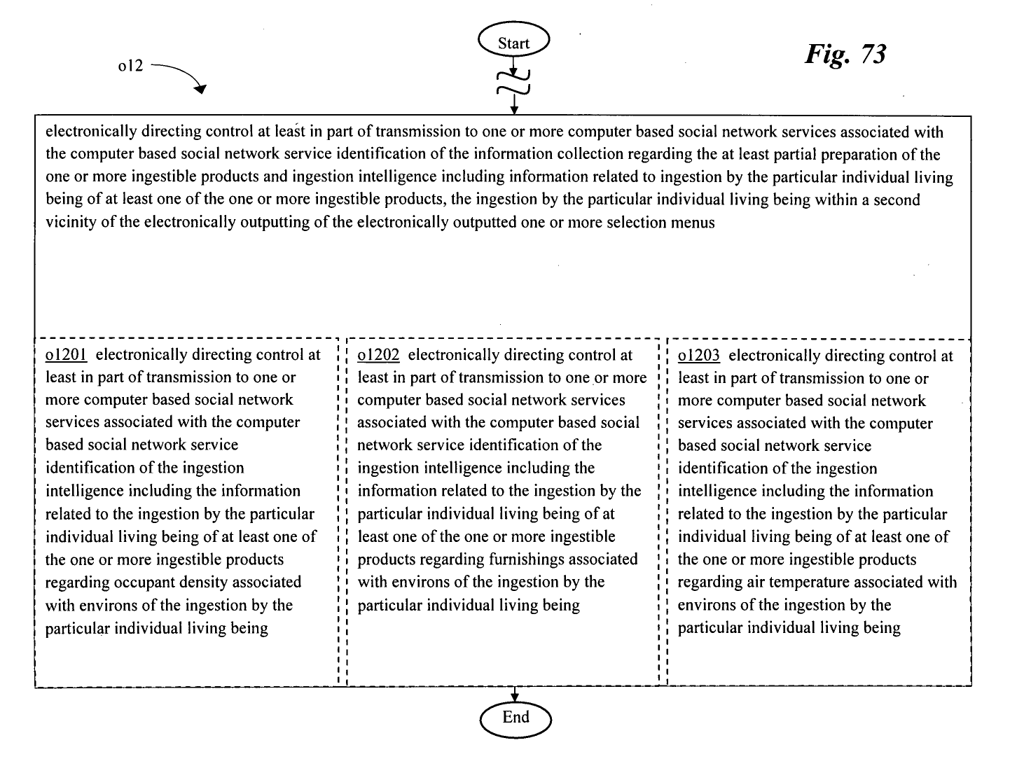

In one or more implementations, as shown in FIG. 73, operation o12 includes an operation o1201 for electronically directing control at least in part of transmission to one or more computer based social network services associated with the computer based social network service identification of the ingestion intelligence including the information related to the ingestion by the particular individual living being of at least one of the one or more ingestible products regarding occupant density associated with environs of the ingestion by the particular individual living being. Origination of an illustratively derived control transmission density component group can be accomplished through skilled in the art design choice selection of one or more of the above depicted components from one or more of the above depicted subsystems shown in FIG. 10. Components from the control transmission density component group can be used in implementing execution of the one or more control transmission density instructions i1201 of FIG. 34, can be used in performance of the control transmission density electrical circuitry arrangement e1201 of FIG. 25, and/or can be used in otherwise fulfillment of the operation o1201. An exemplary non-transitory signal bearing medium version of the information storage subsystem s200 is depicted in FIG. 34 as bearing the one or more control transmission density instructions i1201 that when executed will direct performance of the operation o1201. Furthermore, the control transmission density electrical circuitry arrangement (“elec circ arrange”) e1201, when activated, will perform the operation o1201. For instance, in one or more exemplary implementations, the one or more control transmission density instructions i1201, when executed, direct performance of the operation o1201 in the illustrative depiction as follows, and/or the control transmission density electrical circuitry arrangement e1201, when activated, performs the operation o1201 in the illustrative depiction as follows, and/or the operation o1201 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding occupant density (e.g. an implementation of the microprocessor component s102 is configured to electronically direct control at lest in part of the acquisition of the ingestion intelligence including the information related to the ingestion by the particular individual living being of at least one of the one or more selected ingestible products such as through transmitter component s526 regarding occupant density such as how many customers of a restaurant are occupying a certain designated area of the restaurant associated with environs such as the restaurant of the ingestion by the particular individual living being, etc.) associated with environs of the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.).

In one or more implementations, as shown in FIG. 73, operation o12 includes an operation o1202 for electronically directing control at least in part of transmission to one or more computer based social network services associated with the computer based social network service identification of the ingestion intelligence including the information related to the ingestion by the particular individual living being of at least one of the one or more ingestible products regarding furnishings associated with environs of the ingestion by the particular individual living being. Origination of an illustratively derived control transmission furnishings component group can be accomplished through skilled in the art design choice selection of one or more of the above depicted components from one or more of the above depicted subsystems shown in FIG. 10. Components from the control transmission furnishings component group can be used in implementing execution of the one or more control transmission furnishings instructions i1202 of FIG. 34, can be used in performance of the control transmission furnishings electrical circuitry arrangement e1202 of FIG. 25, and/or can be used in otherwise fulfillment of the operation o1202. An exemplary non-transitory signal bearing medium version of the information storage subsystem s200 is depicted in FIG. 34 as bearing the one or more control transmission furnishings instructions i1202 that when executed will direct performance of the operation o1202. Furthermore, the control transmission furnishings electrical circuitry arrangement (“elec circ arrange”) e1202, when activated, will perform the operation o1202. For instance, in one or more exemplary implementations, the one or more control transmission furnishings instructions i1202, when executed, direct performance of the operation o1202 in the illustrative depiction as follows, and/or the control transmission furnishings electrical circuitry arrangement e1202, when activated, performs the operation o1202 in the illustrative depiction as follows, and/or the operation o1202 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding furnishings (e.g. an implementation of the microprocessor component s102 is configured to electronically direct control at least in part of the acquisition of the ingestion intelligence such as through other nonvolatile memory component s220 including the information related to the ingestion by the particular individual living being of at least one of the one or more selected ingestible products regarding furnishings such as interior design and decoration associated with environs such as a food court of the ingestion by the particular individual living being, etc.) associated with environs of the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.).

In one or more implementations, as shown in FIG. 73, operation o12 includes an operation o1203 for electronically directing control at least in part of transmission to one or more computer based social network services associated with the computer based social network service identification of the ingestion intelligence including the information related to the ingestion by the particular individual living being of at least one of the one or more ingestible products regarding air temperature associated with environs of the ingestion by the particular individual living being. Origination of an illustratively derived control transmission temperature component group can be accomplished through skilled in the art design choice selection of one or more of the above depicted components from one or more of the above depicted subsystems shown in FIG. 10. Components from the control transmission temperature component group can be used in implementing execution of the one or more control transmission temperature instructions i1203 of FIG. 34, can be used in performance of the control transmission temperature electrical circuitry arrangement e1203 of FIG. 25, and/or can be used in otherwise fulfillment of the operation o1203. An exemplary non-transitory signal bearing medium version of the information storage subsystem s200 is depicted in FIG. 34 as bearing the one or more control transmission temperature instructions i1203 that when executed will direct performance of the operation o1203. Furthermore, the control transmission temperature electrical circuitry arrangement (“elec circ arrange”) e1203, when activated, will perform the operation o1203. For instance, in one or more exemplary implementations, the one or more control transmission temperature instructions i1203, when executed, direct performance of the operation o1203 in the illustrative depiction as follows, and/or the control transmission temperature electrical circuitry arrangement e1203, when activated, performs the operation o1203 in the illustrative depiction as follows, and/or the operation o1203 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding air temperature (e.g. an implementation of the microprocessor component s102 is configured to electronically control at least in part the acquisition of the ingestion intelligence such as through temperature sensing component s412 including the information related to the ingestion by the particular individual living being of at least one of the one or more selected ingestible products regarding air temperature associated with environs such as the outdoor temperature near a street vending machine of the ingestion by the particular individual living being, etc.) associated with environs of the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.).

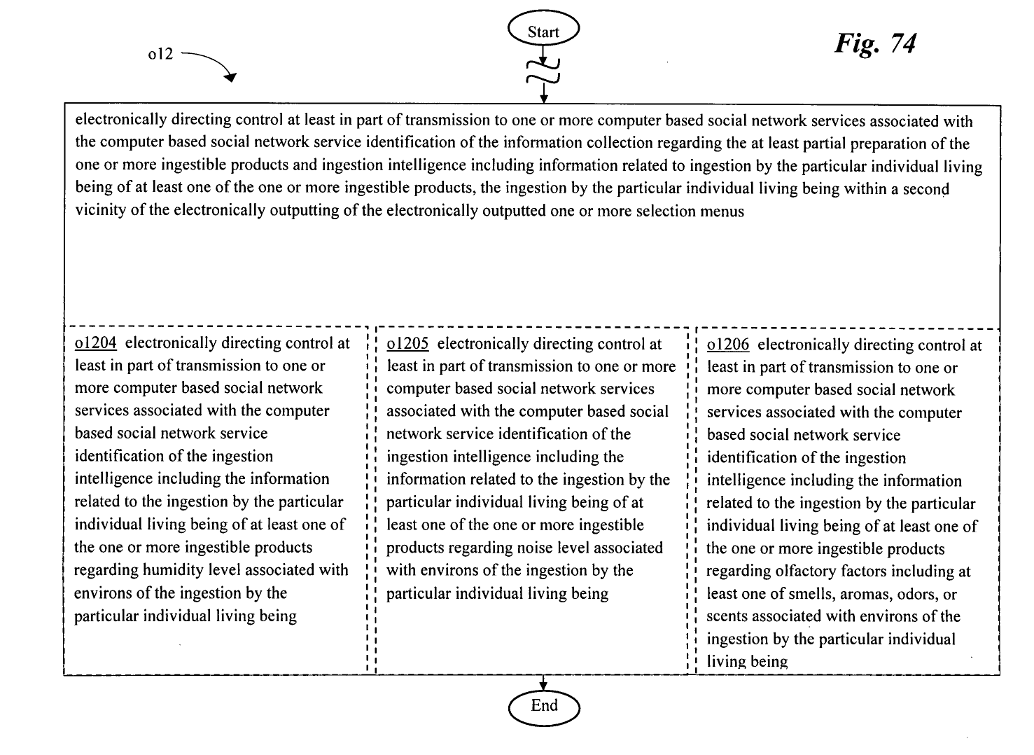

In one or more implementations, as shown in FIG. 74, operation o12 includes an operation o1204 for electronically directing control at least in part of transmission to one or more computer based social network services associated with the computer based social network service identification of the ingestion intelligence including the information related to the ingestion by the particular individual living being of at least one of the one or more ingestible products regarding humidity level associated with environs of the ingestion by the particular individual living being. Origination of an illustratively derived control transmission humidity component group can be accomplished through skilled in the art design choice selection of one or more of the above depicted components from one or more of the above depicted subsystems shown in FIG. 10. Components from the control transmission humidity component group can be used in implementing execution of the one or more control transmission humidity instructions i1204 of FIG. 34, can be used in performance of the control transmission humidity electrical circuitry arrangement e1204 of FIG. 25, and/or can be used in otherwise fulfillment of the operation o1204. An exemplary non-transitory signal bearing medium version of the information storage subsystem s200 is depicted in FIG. 34 as bearing the one or more control transmission humidity instructions i1204 that when executed will direct performance of the operation o1204. Furthermore, the control transmission humidity electrical circuitry arrangement (“elec circ arrange”) e1204, when activated, will perform the operation o1204. For instance, in one or more exemplary implementations, the one or more control transmission humidity instructions i1204, when executed, direct performance of the operation o1204 in the illustrative depiction as follows, and/or the control transmission humidity electrical circuitry arrangement e1204, when activated, performs the operation o1204 in the illustrative depiction as follows, and/or the operation o1204 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding humidity level (e.g. an implementation of the microprocessor component s102 is configured to electronically control at least in part the acquisition of the ingestion intelligence such as through sensing subsystem s402 including the information related to the ingestion by the particular individual living being of at least one of the one or more selected ingestible products regarding humidity level associated with environs such as a street cafe of the ingestion by the particular individual living being, etc.) associated with environs of the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.).

In one or more implementations, as shown in FIG. 74, operation o12 includes an operation o1205 for electronically directing control at least in part of transmission to one or more computer based social network services associated with the computer based social network service identification of the ingestion intelligence including the information related to the ingestion by the particular individual living being of at least one of the one or more ingestible products regarding noise level associated with environs of the ingestion by the particular individual living being. Origination of an illustratively derived control transmission noise component group can be accomplished through skilled in the art design choice selection of one or more of the above depicted components from one or more of the above depicted subsystems shown in FIG. 10. Components from the control transmission noise component group can be used in implementing execution of the one or more control transmission noise instructions i1205 of FIG. 34, can be used in performance of the control transmission noise electrical circuitry arrangement e1205 of FIG. 25, and/or can be used in otherwise fulfillment of the operation o1205. An exemplary non-transitory signal bearing medium version of the information storage subsystem s200 is depicted in FIG. 34 as bearing the one or more control transmission noise instructions i1205 that when executed will direct performance of the operation o1205. Furthermore, the control transmission noise electrical circuitry arrangement (“elec circ arrange”) e1205, when activated, will perform the operation o1205. For instance, in one or more exemplary implementations, the one or more control transmission noise instructions i1205, when executed, direct performance of the operation o1205 in the illustrative depiction as follows, and/or the control transmission noise electrical circuitry arrangement e1205, when activated, performs the operation o1205 in the illustrative depiction as follows, and/or the operation o1205 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding noise level (e.g. an implementation of the microprocessor component s102 is configured to electronically control at least in part the acquisition of the ingestion intelligence such as through sounding sensing component s420 including the information related to the ingestion by the particular individual living being of at least one of the one or more selected ingestible products regarding noise level associated with environs such as a restaurant of the ingestion by the particular individual living being, etc.) associated with environs of the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.).

In one or more implementations, as shown in FIG. 74, operation o12 includes an operation o1206 for electronically directing control at least in part of transmission to one or more computer based social network services associated with the computer based social network service identification of the ingestion intelligence including the information related to the ingestion by the particular individual living being of at least one of the one or more ingestible products regarding olfactory factors including at least one of smells, aromas, odors, or scents associated with environs of the ingestion by the particular individual living being. Origination of an illustratively derived control transmission olfactory component group can be accomplished through skilled in the art design choice selection of one or more of the above depicted components from one or more of the above depicted subsystems shown in FIG. 10. Components from the control transmission olfactory component group can be used in implementing execution of the one or more control transmission olfactory instructions i1206 of FIG. 34, can be used in performance of the control transmission olfactory electrical circuitry arrangement e1206 of FIG. 25, and/or can be used in otherwise fulfillment of the operation o1206. An exemplary non-transitory signal bearing medium version of the information storage subsystem s200 is depicted in FIG. 34 as bearing the one or more control transmission olfactory instructions i1206 that when executed will direct performance of the operation o1206. Furthermore, the control transmission olfactory electrical circuitry arrangement (“elec circ arrange”) e1206, when activated, will perform the operation o1206. For instance, in one or more exemplary implementations, the one or more control transmission olfactory instructions i1206, when executed, direct performance of the operation o1206 in the illustrative depiction as follows, and/or the control transmission olfactory electrical circuitry arrangement e1206, when activated, performs the operation o1206 in the illustrative depiction as follows, and/or the operation o1206 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding olfactory factors including at least one of smells, aromas, odors, or scents (e.g. an implementation of the microprocessor component s102 is configured to electronically control at least in part the acquisition such as through sensing subsystem s402 of the ingestion intelligence including the information related to the ingestion by the particular individual living being of at least one of the one or more selected ingestible products regarding olfactory factors including at least one of smells, aromas, odors, or scents associated with environs such as a cafeteria of the ingestion by the particular individual living being, etc.) associated with environs of the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.).

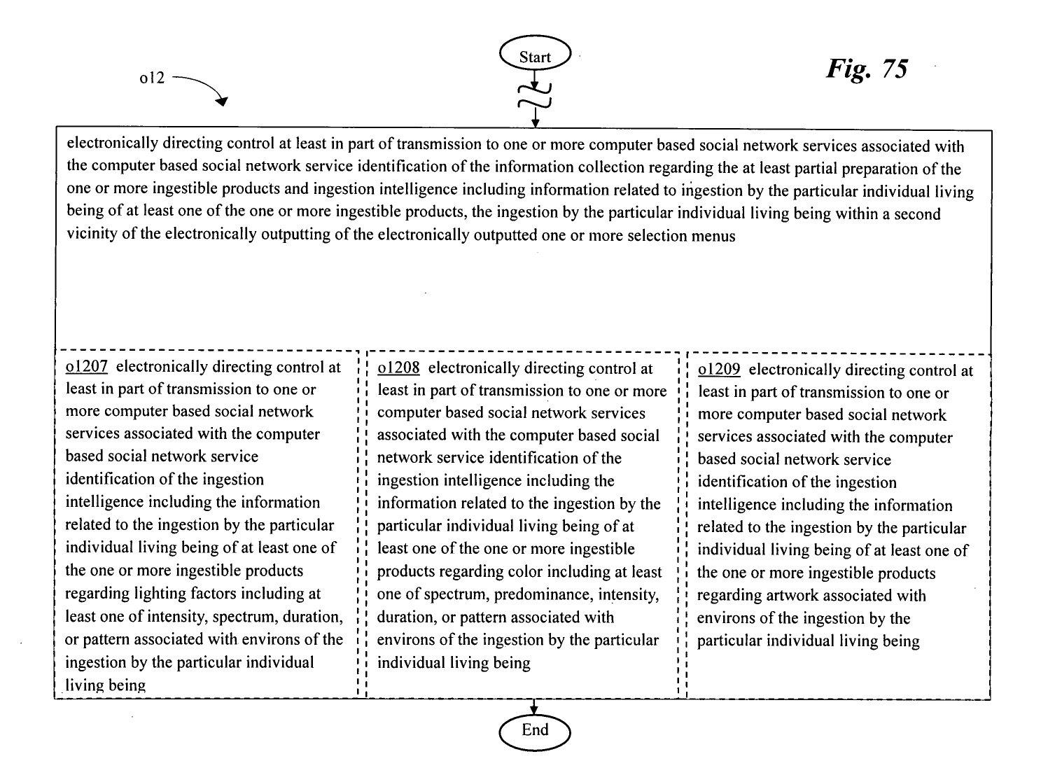

In one or more implementations, as shown in FIG. 75, operation o12 includes an operation o1207 for electronically directing control at least in part of transmission to one or more computer based social network services associated with the computer based social network service identification of the ingestion intelligence including the information related to the ingestion by the particular individual living being of at least one of the one or more ingestible products regarding lighting factors including at least one of intensity, spectrum, duration, or pattern associated with environs of the ingestion by the particular individual living being. Origination of an illustratively derived control transmission lighting component group can be accomplished through skilled in the art design choice selection of one or more of the above depicted components from one or more of the above depicted subsystems shown in FIG. 10. Components from the control transmission lighting component group can be used in implementing execution of the one or more control transmission lighting instructions i1207 of FIG. 34, can be used in performance of the control transmission lighting electrical circuitry arrangement e1207 of FIG. 25, and/or can be used in otherwise fulfillment of the operation o1207. An exemplary non-transitory signal bearing medium version of the information storage subsystem s200 is depicted in FIG. 34 as bearing the one or more control transmission lighting instructions i1207 that when executed will direct performance of the operation o1207. Furthermore, the control transmission lighting electrical circuitry arrangement (“elec circ arrange”) e1207, when activated, will perform the operation o1207. For instance, in one or more exemplary implementations, the one or more control transmission lighting instructions i1207, when executed, direct performance of the operation o1207 in the illustrative depiction as follows, and/or the control transmission lighting electrical circuitry arrangement e1207, when activated, performs the operation o1207 in the illustrative depiction as follows, and/or the operation o1207 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding lighting factors including at least one of intensity, spectrum, duration, or pattern (e.g. an implementation of the microprocessor component s102 is configured to electronically control at least in part the acquisition of the ingestion intelligence such as through photodetecting components s406 including the information related to the ingestion by the particular individual living being of at least one of the one or more selected ingestible products regarding lighting factors including at least one of intensity, spectrum, duration, or pattern associated with environs such as a restaurant of the ingestion by the particular individual living being, etc.) associated with environs of the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.).

In one or more implementations, as shown in FIG. 75, operation o12 includes an operation o1208 for electronically directing control at least in part of transmission to one or more computer based social network services associated with the computer based social network service identification of the ingestion intelligence including the information related to the ingestion by the particular individual living being of at least one of the one or more ingestible products regarding color including at least one of spectrum, predominance, intensity, duration, or pattern associated with environs of the ingestion by the particular individual living being. Origination of an illustratively derived control transmission color component group can be accomplished through skilled in the art design choice selection of one or more of the above depicted components from one or more of the above depicted subsystems shown in FIG. 10. Components from the control transmission color component group can be used in implementing execution of the one or more control transmission color instructions i1208 of FIG. 34, can be used in performance of the control transmission color electrical circuitry arrangement e1208 of FIG. 25, and/or can be used in otherwise fulfillment of the operation o1208. An exemplary non-transitory signal bearing medium version of the information storage subsystem s200 is depicted in FIG. 34 as bearing the one or more control transmission color instructions i1208 that when executed will direct performance of the operation o1208. Furthermore, the control transmission color electrical circuitry arrangement (“elec circ arrange”) e1208, when activated, will perform the operation o1208. For instance, in one or more exemplary implementations, the one or more control transmission color instructions i1208, when executed, direct performance of the operation o1208 in the illustrative depiction as follows, and/or the control transmission color electrical circuitry arrangement e1208, when activated, performs the operation o1208 in the illustrative depiction as follows, and/or the operation o1208 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding color including at least one of spectrum, predominance, intensity, duration, or pattern (e.g. an implementation of the microprocessor component s102 is configured to electronically control at least in part the acquisition of the ingestion intelligence such as through electromagnetic sensing component s402 including the information related to the ingestion by the particular individual living being of at least one of the one or more selected ingestible products regarding color including at least one of spectrum, predominance, intensity, duration, or pattern associated with environs such as colors used for interior of a restaurant of the ingestion by the particular individual living being, etc.) associated with environs of the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.).

In one or more implementations, as shown in FIG. 75, operation o12 includes an operation o1209 for electronically directing control at least in part of transmission to one or more computer based social network services associated with the computer based social network service identification of the ingestion intelligence including the information related to the ingestion by the particular individual living being of at least one of the one or more ingestible products regarding artwork associated with environs of the ingestion by the particular individual living being. Origination of an illustratively derived control transmission artwork component group can be accomplished through skilled in the art design choice selection of one or more of the above depicted components from one or more of the above depicted subsystems shown in FIG. 10. Components from the control transmission artwork component group can be used in implementing execution of the one or more control transmission artwork instructions i1209 of FIG. 34, can be used in performance of the control transmission artwork electrical circuitry arrangement e1209 of FIG. 25, and/or can be used in otherwise fulfillment of the operation o1209. An exemplary non-transitory signal bearing medium version of the information storage subsystem s200 is depicted in FIG. 34 as bearing the one or more control transmission artwork instructions i1209 that when executed will direct performance of the operation o1209. Furthermore, the control transmission artwork electrical circuitry arrangement (“elec circ arrange”) e1209, when activated, will perform the operation o1209. For instance, in one or more exemplary implementations, the one or more control transmission artwork instructions i1209, when executed, direct performance of the operation o1209 in the illustrative depiction as follows, and/or the control transmission artwork electrical circuitry arrangement e1209, when activated, performs the operation o1209 in the illustrative depiction as follows, and/or the operation o1209 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding artwork (e.g. an implementation of the microprocessor component s102 is configured to electronically control at least in part the acquisition of the ingestion intelligence such as through disk farm component s224 including the information related to the ingestion by the particular individual living being of at least one of the one or more selected ingestible products regarding artwork associated with environs regarding an eating establishment of the ingestion by the particular individual living being, etc.) associated with environs of the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.).

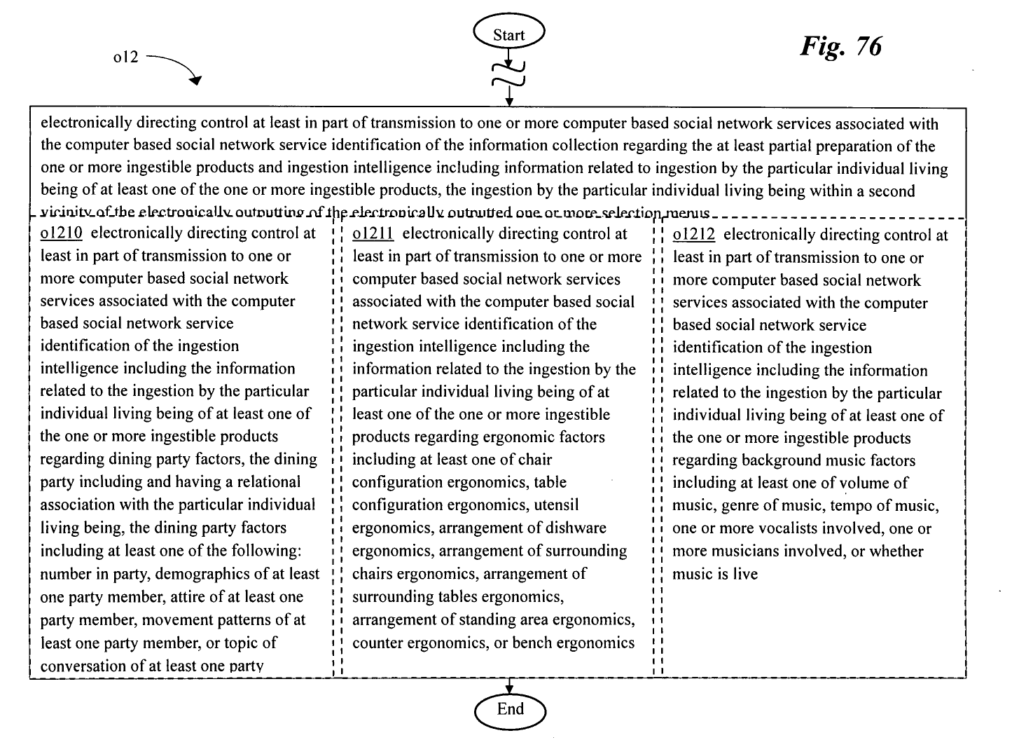

In one or more implementations, as shown in FIG. 76, operation o12 includes an operation o1210 for electronically directing control at least in part of transmission to one or more computer based social network services associated with the computer based social network service identification of the ingestion intelligence including the information related to the ingestion by the particular individual living being of at least one of the one or more ingestible products regarding dining party factors, the dining party including and having a relational association with the particular individual living being, the dining party factors including at least one of the following: number in party, demographics of at least one party member, attire of at least one party member, movement patterns of at least one party member, or topic of conversation of at least one party member. Origination of an illustratively derived control transmission party component group can be accomplished through skilled in the art design choice selection of one or more of the above depicted components from one or more of the above depicted subsystems shown in FIG. 10. Components from the control transmission party component group can be used in implementing execution of the one or more control transmission party instructions i1210 of FIG. 34, can be used in performance of the control transmission party electrical circuitry arrangement e1210 of FIG. 25, and/or can be used in otherwise fulfillment of the operation o1210. An exemplary non-transitory signal bearing medium version of the information storage subsystem s200 is depicted in FIG. 34 as bearing the one or more control transmission party instructions i1210 that when executed will direct performance of the operation o1210. Furthermore, the control transmission party electrical circuitry arrangement (“elec circ arrange”) e1210, when activated, will perform the operation o1210. For instance, in one or more exemplary implementations, the one or more control transmission party instructions i1210, when executed, direct performance of the operation o1210 in the illustrative depiction as follows, and/or the control transmission party electrical circuitry arrangement e1210, when activated, performs the operation o1210 in the illustrative depiction as follows, and/or the operation o1210 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding dining party factors, the dining party including and having a relational association with the particular individual living being (e.g. one of more of a consumer, a gourmand, a hobbyist, an athlete, a student, a dieter, a patient, an animal, an inmate, a health seeker, a worker, a pedestrian, etc.), the dining party factors including at least one of the following: number in party, demographics of at least one party member, attire of at least one party member, movement patterns of at least one party member, or topic of conversation of at least one party member (e.g. an implementation of the microprocessor component s102 is configured to electronically control at least in part the acquisition of the ingestion intelligence such as through sound sensing component s420, camera component s336, and/or server component s230 along with recognition application implemented with the microprocessor component s102 including the information related to the ingestion by the particular individual living being of at least one of the one or more selected ingestible products regarding dining party factors, the dining party including and having a relational association with the particular individual living being, the dining party factors including at least one of the following: number in party, demographics of at least one party member, attire of at least one party member, movement patterns of at least one party member, or topic of conversation of at least one party member, etc.

In one or more implementations, as shown in FIG. 76, operation o12 includes an operation o1211 for electronically directing control at least in part of transmission to one or more computer based social network services associated with the computer based social network service identification of the ingestion intelligence including the information related to the ingestion by the particular individual living being of at least one of the one or more ingestible products regarding ergonomic factors including at least one of chair configuration ergonomics, table configuration ergonomics, utensil ergonomics, arrangement of dishware ergonomics, arrangement of surrounding chairs ergonomics, arrangement of surrounding tables ergonomics, arrangement of standing area ergonomics, counter ergonomics, or bench ergonomics. Origination of an illustratively derived control transmission ergonomics component group can be accomplished through skilled in the art design choice selection of one or more of the above depicted components from one or more of the above depicted subsystems shown in FIG. 10. Components from the control transmission ergonomics component group can be used in implementing execution of the one or more control transmission ergonomics instructions i1211 of FIG. 34, can be used in performance of the control transmission ergonomics electrical circuitry arrangement e1211 of FIG. 25, and/or can be used in otherwise fulfillment of the operation o1211. An exemplary non-transitory signal bearing medium version of the information storage subsystem s200 is depicted in FIG. 34 as bearing the one or more control transmission ergonomics instructions i1211 that when executed will direct performance of the operation o1211. Furthermore, the control transmission ergonomics electrical circuitry arrangement (“elec circ arrange”) e1211, when activated, will perform the operation o1211. For instance, in one or more exemplary implementations, the one or more control transmission ergonomics instructions i1211, when executed, direct performance of the operation o1211 in the illustrative depiction as follows, and/or the control transmission ergonomics electrical circuitry arrangement e1211, when activated, performs the operation o1211 in the illustrative depiction as follows, and/or the operation o1211 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding ergonomic factors including at least one of chair configuration ergonomics, table configuration ergonomics, utensil ergonomics, arrangement of dishware ergonomics, arrangement of surrounding chairs ergonomics, arrangement of surrounding tables ergonomics, arrangement of standing area ergonomics, counter ergonomics, or bench ergonomics (e.g. an implementation of the microprocessor component s102 is configured to electronically control at least in part the acquisition such as through camera component s336 and recognition application implemented through the microprocessor component of the ingestion intelligence including the information related to the ingestion by the particular individual living being of at least one of the one or more selected ingestible products regarding ergonomic factors including at least one of chair configuration ergonomics, table configuration ergonomics, utensil ergonomics, arrangement of dishware ergonomics, arrangement of surrounding chairs ergonomics, arrangement of surrounding tables ergonomics, arrangement of standing area ergonomics, counter ergonomics, or bench ergonomics, etc.).

In one or more implementations, as shown in FIG. 76, operation o12 includes an operation o1212 for electronically directing control at least in part of transmission to one or more computer based social network services associated with the computer based social network service identification of the ingestion intelligence including the information related to the ingestion by the particular individual living being of at least one of the one or more ingestible products regarding background music factors including at least one of volume of music, genre of music, tempo of music, one or more vocalists involved, one or more musicians involved, or whether music is live. Origination of an illustratively derived control transmission music component group can be accomplished through skilled in the art design choice selection of one or more of the above depicted components from one or more of the above depicted subsystems shown in FIG. 10. Components from the control transmission music component group can be used in implementing execution of the one or more control transmission music instructions i1212 of FIG. 34, can be used in performance of the control transmission music electrical circuitry arrangement e1212 of FIG. 25, and/or can be used in otherwise fulfillment of the operation o1212. An exemplary non-transitory signal bearing medium version of the information storage subsystem s200 is depicted in FIG. 34 as bearing the one or more control transmission music instructions i1212 that when executed will direct performance of the operation o1212. Furthermore, the control transmission music electrical circuitry arrangement (“elec circ arrange”) e1212, when activated, will perform the operation o1212. For instance, in one or more exemplary implementations, the one or more control transmission music instructions i1212, when executed, direct performance of the operation o1212 in the illustrative depiction as follows, and/or the control transmission music electrical circuitry arrangement e1212, when activated, performs the operation o1212 in the illustrative depiction as follows, and/or the operation o1212 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding background music factors including at least one of volume of music, genre of music, tempo of music, one or more vocalists involved, one or more musicians involved, or whether music is live (e.g. an implementation of the microprocessor component s102 is configured to electronically control at least in part the acquisition such as through sound sensing component s420 and recognition application implemented by the microprocessor component s102 of the ingestion intelligence including the information related to the ingestion by the particular individual living being of at least one of the one or more selected ingestible products regarding background music factors including at least one of volume of music, genre of music, tempo of music, one or more vocalists involved, one or more musicians involved, or whether music is live, etc.).

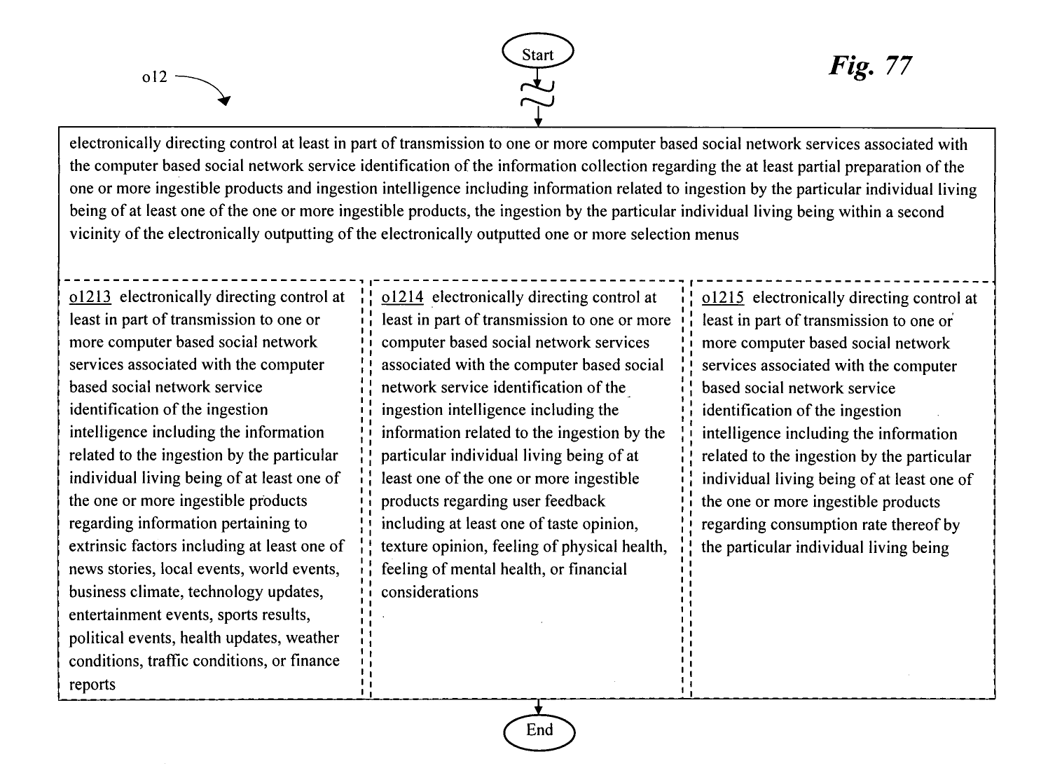

In one or more implementations, as shown in FIG. 77, operation o12 includes an operation o1213 for electronically directing control at least in part of transmission to one or more computer based social network services associated with the computer based social network service identification of the ingestion intelligence including the information related to the ingestion by the particular individual living being of at least one of the one or more ingestible products regarding information pertaining to extrinsic factors including at least one of news stories, local events, world events, business climate, technology updates, entertainment events, sports results, political events, health updates, weather conditions, traffic conditions, or finance reports. Origination of an illustratively derived control transmission extrinsic component group can be accomplished through skilled in the art design choice selection of one or more of the above depicted components from one or more of the above depicted subsystems shown in FIG. 10. Components from the control transmission extrinsic component group can be used in implementing execution of the one or more control transmission extrinsic instructions i1213 of FIG. 34, can be used in performance of the control transmission extrinsic electrical circuitry arrangement e1213 of FIG. 25, and/or can be used in otherwise fulfillment of the operation o1213. An exemplary non-transitory signal bearing medium version of the information storage subsystem s200 is depicted in FIG. 34 as bearing the one or more control transmission extrinsic instructions i1213 that when executed will direct performance of the operation o1213. Furthermore, the control transmission extrinsic electrical circuitry arrangement (“elec circ arrange”) e1213, when activated, will perform the operation o1213. For instance, in one or more exemplary implementations, the one or more control transmission extrinsic instructions i1213, when executed, direct performance of the operation o1213 in the illustrative depiction as follows, and/or the control transmission extrinsic electrical circuitry arrangement e1213, when activated, performs the operation o1213 in the illustrative depiction as follows, and/or the operation o1213 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding information pertaining to extrinsic factors including at least one of news stories, local events, world events, business climate, technology updates, entertainment events, sports results, political events, health updates, weather conditions, traffic conditions, or finance reports (e.g. an implementation of the microprocessor component s102 is configured to electronically control at least in part the acquisition such as through interne network component s508 of the ingestion intelligence including the information related to the ingestion by the particular individual living being of at least one of the one or more selected ingestible products regarding information pertaining to extrinsic factors including at least one of news stories, local events, world events, business climate, technology updates, entertainment events, sports results, political events, health updates, weather conditions, traffic conditions, or finance reports, etc.).

In one or more implementations, as shown in FIG. 77, operation o12 includes an operation o1214 for electronically directing control at least in part of transmission to one or more computer based social network services associated with the computer based social network service identification of the ingestion intelligence including the information related to the ingestion by the particular individual living being of at least one of the one or more ingestible products regarding user feedback including at least one of taste opinion, texture opinion, feeling of physical health, feeling of mental health, or financial considerations. Origination of an illustratively derived control transmission feedback component group can be accomplished through skilled in the art design choice selection of one or more of the above depicted components from one or more of the above depicted subsystems shown in FIG. 10. Components from the control transmission feedback component group can be used in implementing execution of the one or more control transmission feedback instructions i1214 of FIG. 34, can be used in performance of the control transmission feedback electrical circuitry arrangement e1214 of FIG. 25, and/or can be used in otherwise fulfillment of the operation o1214. An exemplary non-transitory signal bearing medium version of the information storage subsystem s200 is depicted in FIG. 34 as bearing the one or more control transmission feedback instructions i1214 that when executed will direct performance of the operation o1214. Furthermore, the control transmission feedback electrical circuitry arrangement (“elec circ arrange”) e1214, when activated, will perform the operation o1214. For instance, in one or more exemplary implementations, the one or more control transmission feedback instructions i1214, when executed, direct performance of the operation o1214 in the illustrative depiction as follows, and/or the control transmission feedback electrical circuitry arrangement e1214, when activated, performs the operation o1214 in the illustrative depiction as follows, and/or the operation o1214 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding user feedback including at least one of taste opinion, texture opinion, feeling of physical health, feeling of mental health, or financial considerations (e.g. an implementation of the microprocessor component s102 is configured to electronically control at least in part the acquisition of the ingestion intelligence such as through touch screen component s314 including the information related to the ingestion by the particular individual living being of at least one of the one or more selected ingestible products regarding user feedback including at least one of taste opinion, texture opinion, feeling of physical health, feeling of mental health, or financial considerations, etc.).

In one or more implementations, as shown in FIG. 77, operation o12 includes an operation o1215 for electronically directing control at least in part of transmission to one or more computer based social network services associated with the computer based social network service identification of the ingestion intelligence including the information related to the ingestion by the particular individual living being of at least one of the one or more ingestible products regarding consumption rate thereof by the particular individual living being. Origination of an illustratively derived control transmission rate component group can be accomplished through skilled in the art design choice selection of one or more of the above depicted components from one or more of the above depicted subsystems shown in FIG. 10. Components from the control transmission rate component group can be used in implementing execution of the one or more control transmission rate instructions i1215 of FIG. 34, can be used in performance of the control transmission rate electrical circuitry arrangement e1215 of FIG. 25, and/or can be used in otherwise fulfillment of the operation o1215. An exemplary non-transitory signal bearing medium version of the information storage subsystem s200 is depicted in FIG. 34 as bearing the one or more control transmission rate instructions i1215 that when executed will direct performance of the operation o1215. Furthermore, the control transmission rate electrical circuitry arrangement (“elec circ arrange”) e1215, when activated, will perform the operation o1215. For instance, in one or more exemplary implementations, the one or more control transmission rate instructions i1215, when executed, direct performance of the operation o1215 in the illustrative depiction as follows, and/or the control transmission rate electrical circuitry arrangement e1215, when activated, performs the operation o1215 in the illustrative depiction as follows, and/or the operation o1215 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding consumption rate thereof (e.g. an implementation of the microprocessor component s102 is configured to electronically control at least in part the acquisition of the ingestion intelligence such as through camera component s336 and recognition application implemented by the microprocessor component s102 including the information related to the ingestion by the particular individual living being of at least one of the one or more selected ingestible products regarding consumption rate thereof by the particular individual living being, etc.) by the particular individual living being (e.g. one of more of a consumer, a gourmand, a hobbyist, an athlete, a student, a dieter, a patient, an animal, an inmate, a health seeker, a worker, a pedestrian, etc.).

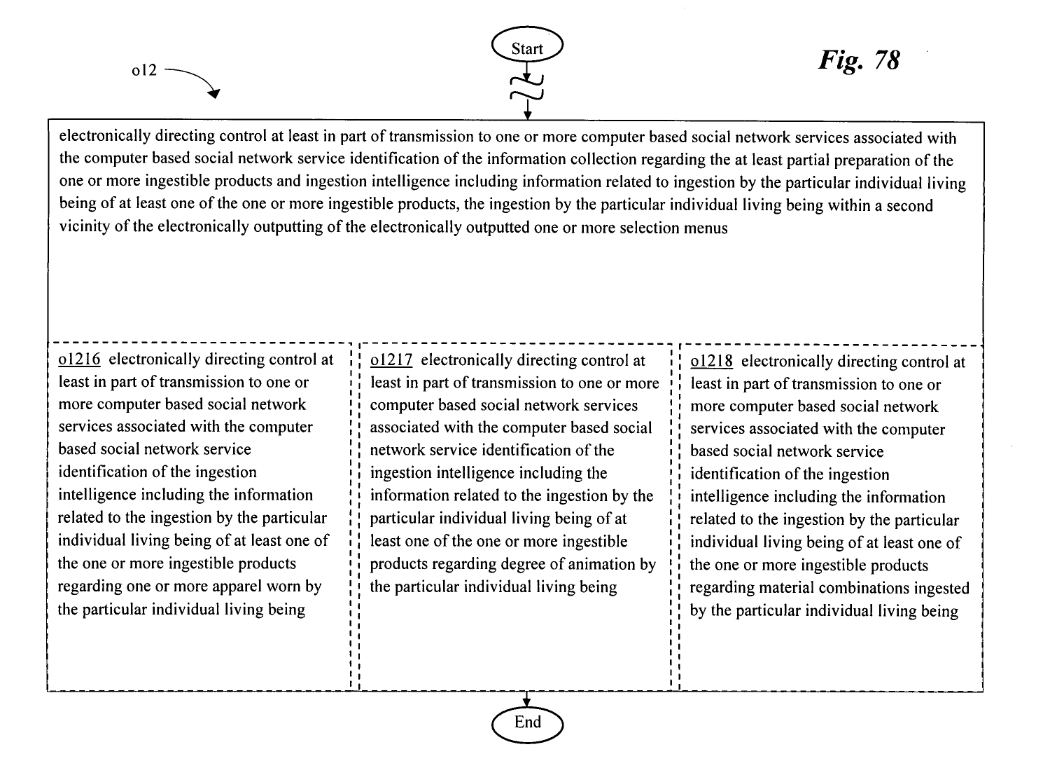

In one or more implementations, as shown in FIG. 78, operation o12 includes an operation o1216 for electronically directing control at least in part of transmission to one or more computer based social network services associated with the computer based social network service identification of the ingestion intelligence including the information related to the ingestion by the particular individual living being of at least one of the one or more ingestible products regarding one or more apparel worn by the particular individual living being. Origination of an illustratively derived control transmission apparel component group can be accomplished through skilled in the art design choice selection of one or more of the above depicted components from one or more of the above depicted subsystems shown in FIG. 10. Components from the control transmission apparel component group can be used in implementing execution of the one or more control transmission apparel instructions i1216 of FIG. 34, can be used in performance of the control transmission apparel electrical circuitry arrangement e1216 of FIG. 25, and/or can be used in otherwise fulfillment of the operation o1216. An exemplary non-transitory signal bearing medium version of the information storage subsystem s200 is depicted in FIG. 34 as bearing the one or more control transmission apparel instructions i1216 that when executed will direct performance of the operation o1216. Furthermore, the control transmission apparel electrical circuitry arrangement (“elec circ arrange”) e1216, when activated, will perform the operation o1216. For instance, in one or more exemplary implementations, the one or more control transmission apparel instructions i1216, when executed, direct performance of the operation o1216 in the illustrative depiction as follows, and/or the control transmission apparel electrical circuitry arrangement e1216, when activated, performs the operation o1216 in the illustrative depiction as follows, and/or the operation o1216 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding one or more apparel worn (e.g. an implementation of the microprocessor component s102 is configured to electronically control at least in part the acquisition such as through the camera component s336 and recognition application implemented by the microprocessor component s102 of the ingestion intelligence including the information related to the ingestion by the particular individual living being of at least one of the one or more selected ingestible products regarding one or more apparel worn by the particular individual living being, etc.) by the particular individual living being (e.g. one of more of a consumer, a gourmand, a hobbyist, an athlete, a student, a dieter, a patient, an animal, an inmate, a health seeker, a worker, a pedestrian, etc.).

In one or more implementations, as shown in FIG. 78, operation o12 includes an operation o1217 for electronically directing control at least in part of transmission to one or more computer based social network services associated with the computer based social network service identification of the ingestion intelligence including the information related to the ingestion by the particular individual living being of at least one of the one or more ingestible products regarding degree of animation by the particular individual living being. Origination of an illustratively derived control transmission animation component group can be accomplished through skilled in the art design choice selection of one or more of the above depicted components from one or more of the above depicted subsystems shown in FIG. 10. Components from the control transmission animation component group can be used in implementing execution of the one or more control transmission animation instructions i1217 of FIG. 34, can be used in performance of the control transmission animation electrical circuitry arrangement e1217 of FIG. 25, and/or can be used in otherwise fulfillment of the operation o1217. An exemplary non-transitory signal bearing medium version of the information storage subsystem s200 is depicted in FIG. 34 as bearing the one or more control transmission animation instructions i1217 that when executed will direct performance of the operation o1217. Furthermore, the control transmission animation electrical circuitry arrangement (“elec circ arrange”) e1217, when activated, will perform the operation o1217. For instance, in one or more exemplary implementations, the one or more control transmission animation instructions i1217, when executed, direct performance of the operation o1217 in the illustrative depiction as follows, and/or the control transmission animation electrical circuitry arrangement e1217, when activated, performs the operation o1217 in the illustrative depiction as follows, and/or the operation o1217 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding degree of animation (e.g. an implementation of the microprocessor component s102 is configured to electronically control at least in part the acquisition such as through camera component s336 and recognition application implemented by microprocessor component s102 of the ingestion intelligence including the information related to the ingestion by the particular individual living being of at least one of the one or more selected ingestible products regarding degree of animation by the particular individual living being, etc.) by the particular individual living being (e.g. one of more of a consumer, a gourmand, a hobbyist, an athlete, a student, a dieter, a patient, an animal, an inmate, a health seeker, a worker, a pedestrian, etc.).

In one or more implementations, as shown in FIG. 78, operation o12 includes an operation o1218 for electronically directing control at least in part of transmission to one or more computer based social network services associated with the computer based social network service identification of the ingestion intelligence including the information related to the ingestion by the particular individual living being of at least one of the one or more ingestible products regarding material combinations ingested by the particular individual living being. Origination of an illustratively derived control transmission combinations component group can be accomplished through skilled in the art design choice selection of one or more of the above depicted components from one or more of the above depicted subsystems shown in FIG. 10. Components from the control transmission combinations component group can be used in implementing execution of the one or more control transmission combinations instructions i1218 of FIG. 34, can be used in performance of the control transmission combinations electrical circuitry arrangement e1218 of FIG. 25, and/or can be used in otherwise fulfillment of the operation o1218. An exemplary non-transitory signal bearing medium version of the information storage subsystem s200 is depicted in FIG. 34 as bearing the one or more control transmission combinations instructions i1218 that when executed will direct performance of the operation o1218. Furthermore, the control transmission combinations electrical circuitry arrangement (“elec circ arrange”) e1218, when activated, will perform the operation o1218. For instance, in one or more exemplary implementations, the one or more control transmission combinations instructions i1218, when executed, direct performance of the operation o1218 in the illustrative depiction as follows, and/or the control transmission combinations electrical circuitry arrangement e1218, when activated, performs the operation o1218 in the illustrative depiction as follows, and/or the operation o1218 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding material combinations ingested (e.g. an implementation of the microprocessor component s102 is configured to electronically control at least in part the acquisition such as through chemical sensing component s416 and recognition application implemented by the microprocessor component s102 of the ingestion intelligence including the information related to the ingestion by the particular individual living being of at least one of the one or more selected ingestible products regarding material combinations ingested by the particular individual living being, etc.) by the particular individual living being (e.g. one of more of a consumer, a gourmand, a hobbyist, an athlete, a student, a dieter, a patient, an animal, an inmate, a health seeker, a worker, a pedestrian, etc.).

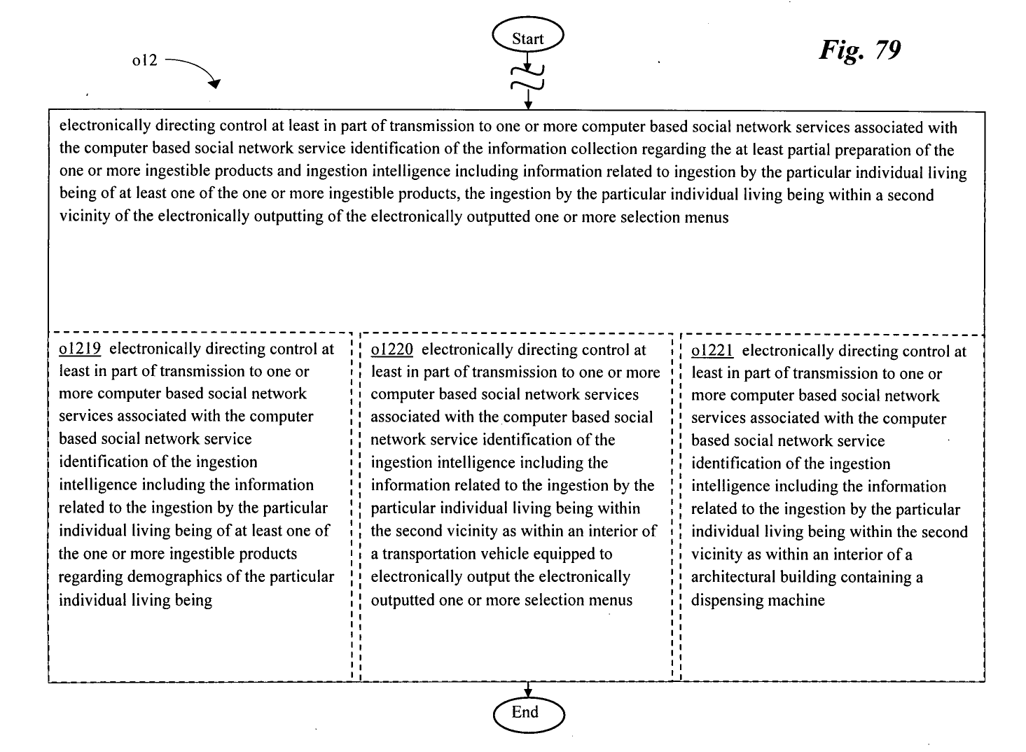

In one or more implementations, as shown in FIG. 79, operation o12 includes an operation o1219 for electronically directing control at least in part of transmission to one or more computer based social network services associated with the computer based social network service identification of the ingestion intelligence including the information related to the ingestion by the particular individual living being of at least one of the one or more ingestible products regarding demographics of the particular individual living being. Origination of an illustratively derived control transmission demographics component group can be accomplished through skilled in the art design choice selection of one or more of the above depicted components from one or more of the above depicted subsystems shown in FIG. 10. Components from the control transmission demographics component group can be used in implementing execution of the one or more control transmission demographics instructions i1219 of FIG. 34, can be used in performance of the control transmission demographics electrical circuitry arrangement e1219 of FIG. 25, and/or can be used in otherwise fulfillment of the operation o1219. An exemplary non-transitory signal bearing medium version of the information storage subsystem s200 is depicted in FIG. 34 as bearing the one or more control transmission demographics instructions i1219 that when executed will direct performance of the operation o1219. Furthermore, the control transmission demographics electrical circuitry arrangement (“elec circ arrange”) e1219, when activated, will perform the operation o1219. For instance, in one or more exemplary implementations, the one or more control transmission demographics instructions i1219, when executed, direct performance of the operation o1219 in the illustrative depiction as follows, and/or the control transmission demographics electrical circuitry arrangement e1219, when activated, performs the operation o1219 in the illustrative depiction as follows, and/or the operation o1219 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding demographics (e.g. an implementation of the microprocessor component s102 is configured to electronically control at least in part the acquisition of the ingestion intelligence such as through disk farm component s224 including the information related to the ingestion by the particular individual living being of at least one of the one or more selected ingestible products regarding demographics of the particular individual living being, etc.) of the particular individual living being (e.g. one of more of a consumer, a gourmand, a hobbyist, an athlete, a student, a dieter, a patient, an animal, an inmate, a health seeker, a worker, a pedestrian, etc.).

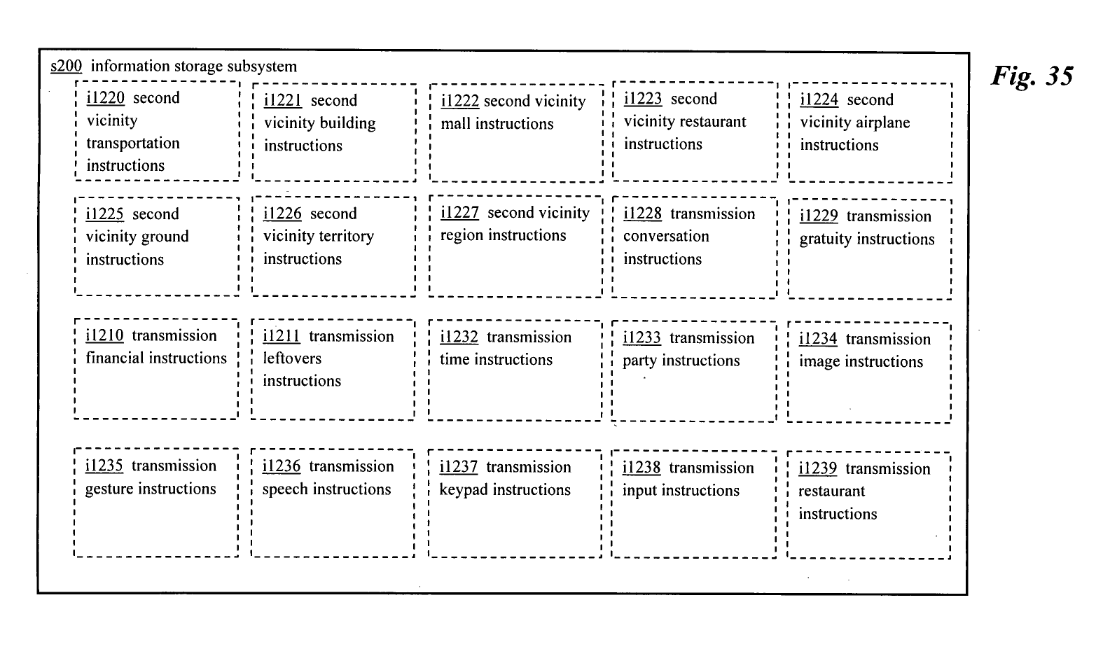

In one or more implementations, as shown in FIG. 79, operation o12 includes an operation o1220 for electronically directing control at least in part of transmission to one or more computer based social network services associated with the computer based social network service identification of the ingestion intelligence including the information related to the ingestion by the particular individual living being within the second vicinity as within an interior of a transportation vehicle equipped to electronically output the electronically outputted one or more selection menus. Origination of an illustratively derived second vicinity transportation component group can be accomplished through skilled in the art design choice selection of one or more of the above depicted components from one or more of the above depicted subsystems shown in FIG. 10. Components from the second vicinity transportation component group can be used in implementing execution of the one or more second vicinity transportation instructions i1220 of FIG. 35, can be used in performance of the second vicinity transportation electrical circuitry arrangement e1220 of FIG. 26, and/or can be used in otherwise fulfillment of the operation o1220. An exemplary non-transitory signal bearing medium version of the information storage subsystem s200 is depicted in FIG. 35 as bearing the one or more second vicinity transportation instructions i1220 that when executed will direct performance of the operation o1220. Furthermore, the second vicinity transportation electrical circuitry arrangement (“elec circ arrange”) e1220, when activated, will perform the operation o1220. For instance, in one or more exemplary implementations, the one or more second vicinity transportation instructions i1220, when executed, direct performance of the operation o1220 in the illustrative depiction as follows, and/or the second vicinity transportation electrical circuitry arrangement e1220, when activated, performs the operation o1220 in the illustrative depiction as follows, and/or the operation o1220 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) within the second vicinity (e.g. such as within visual distance thereof, within audio distance thereof, within same interior space thereof, within same neighborhood thereof, within same geographical region thereof, etc.) as within an interior of a transportation vehicle (e.g. an automobile) equipped to electronically output the electronically outputted (e.g. through use of at least one of the following: interface (GUI) component s302, visual display component s304, touch screen component s314, button component s322, gauge component s324, light emitting component s326, audio in/out component s328, vibration emitting component s330, projection component s334, etc.) one or more selection menus (e.g. through use of one or more of the following types of selection menus: question-response, interrogation, fill-in blanks, check-box, buttons, gesture, text, voice, eye-track, facial, image, etc.).

In one or more implementations, as shown in FIG. 79, operation o12 includes an operation o1221 for electronically directing control at least in part of transmission to one or more computer based social network services associated with the computer based social network service identification of the ingestion intelligence including the information related to the ingestion by the particular individual living being within the second vicinity as within an interior of an architectural building containing a dispensing machine. Origination of an illustratively derived second vicinity building component group can be accomplished through skilled in the art design choice selection of one or more of the above depicted components from one or more of the above depicted subsystems shown in FIG. 10. Components from the second vicinity building component group can be used in implementing execution of the one or more second vicinity building instructions i1221 of FIG. 35, can be used in performance of the second vicinity building electrical circuitry arrangement e1221 of FIG. 26, and/or can be used in otherwise fulfillment of the operation o1221. An exemplary non-transitory signal bearing medium version of the information storage subsystem s200 is depicted in FIG. 35 as bearing the one or more second vicinity building instructions i1221 that when executed will direct performance of the operation o1221. Furthermore, the second vicinity building electrical circuitry arrangement (“elec circ arrange”) e1221, when activated, will perform the operation o1221. For instance, in one or more exemplary implementations, the one or more second vicinity building instructions i1221, when executed, direct performance of the operation o1221 in the illustrative depiction as follows, and/or the second vicinity building electrical circuitry arrangement e1221, when activated, performs the operation o1221 in the illustrative depiction as follows, and/or the operation o1221 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) within the second vicinity (e.g. such as within visual distance thereof, within audio distance thereof, within same interior space thereof, within same neighborhood thereof, within same geographical region thereof, etc.) as within an interior of an architectural building containing a dispensing machine (e.g. an implementation of the microprocessor component s102 is configured through the electronic communication subsystem 500 to electronically direct control at least in part of the acquisition of the ingestion intelligence within the second vicinity as within the interior of an airport wherein the digestible product preparation system 10 is located that communicates with for instance the visual display component s304 to electronically output the electronically generated one or more selection menus also within the airport, etc.).

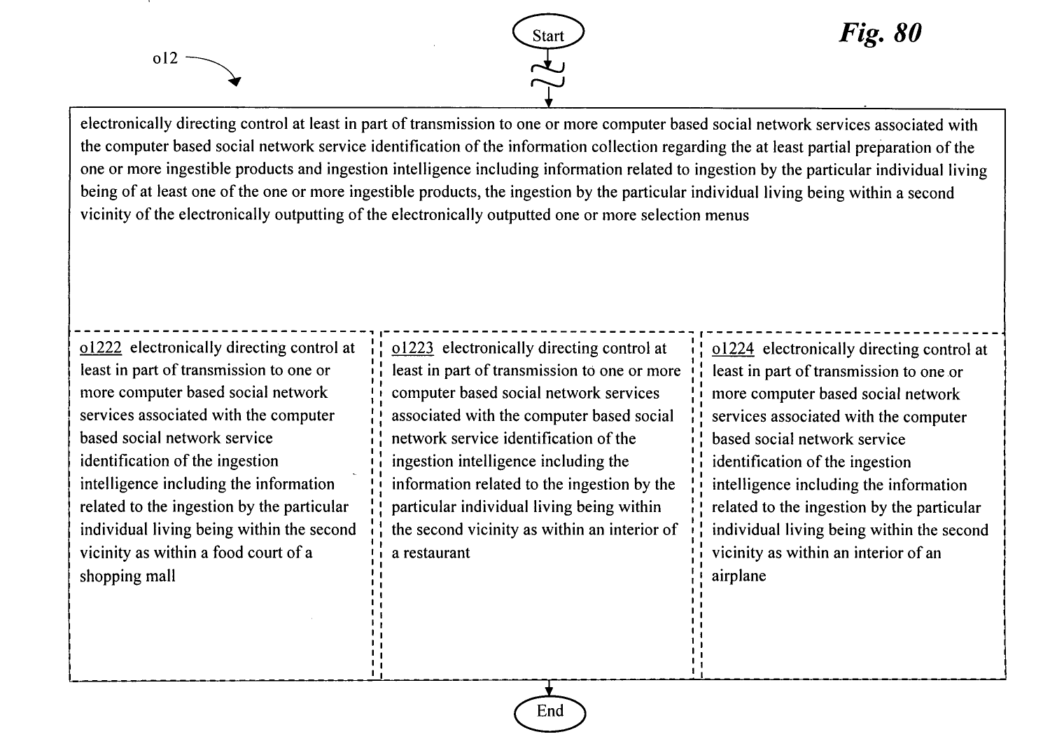

In one or more implementations, as shown in FIG. 80, operation o12 includes an operation o1222 for electronically directing control at least in part of transmission to one or more computer based social network services associated with the computer based social network-Service identification of the ingestion intelligence including the information related to the ingestion by the particular individual living being within the second vicinity as within a food court of a shopping mall. Origination of an illustratively derived second vicinity mall component group can be accomplished through skilled in the art design choice selection of one or more of the above depicted components from one or more of the above depicted subsystems shown in FIG. 10. Components from the second vicinity mall component group can be used in implementing execution of the one or more second vicinity mall instructions i1222 of FIG. 35, can be used in performance of the second vicinity mall electrical circuitry arrangement e1222 of FIG. 26, and/or can be used in otherwise fulfillment of the operation o1222. An exemplary non-transitory signal bearing medium version of the information storage subsystem s200 is depicted in FIG. 35 as bearing the one or more second vicinity mall instructions i1222 that when executed will direct performance of the operation o1222. Furthermore, the second vicinity mall electrical circuitry arrangement (“elec circ arrange”) e1222, when activated, will perform the operation o1222. For instance, in one or more exemplary implementations, the one or more second vicinity mall instructions i1222, when executed, direct performance of the operation o1222 in the illustrative depiction as follows, and/or the second vicinity mall electrical circuitry arrangement e1222, when activated, performs the operation o1222 in the illustrative depiction as follows, and/or the operation o1222 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) within the second vicinity (e.g. such as within visual distance thereof, within audio distance thereof, within same interior space thereof, within same neighborhood thereof, within same geographical region thereof, etc.) as within a food court of a shopping mall (e.g. an implementation of the microprocessor component s102 is configured through the electronic communication subsystem 500 to electronically direct control at least in part of the acquisition of the ingestion intelligence within the second vicinity as within the food court of the shopping mall wherein the digestible product preparation system 10 is located that communicates with for instance the visual display component s304 to electronically output the electronically generated one or more selection menus also within the food court of the shopping mall, etc.).

In one or more implementations, as shown in FIG. 80, operation o12 includes an operation o1223 for electronically directing control at least in part of transmission to one or more computer based social network services associated with the computer based social network service identification of the ingestion intelligence including the information related to the ingestion by the particular individual living being within the second vicinity as within an interior of a restaurant. Origination of an illustratively derived second vicinity restaurant component group can be accomplished through skilled in the art design choice selection of one or more of the above depicted components from one or more of the above depicted subsystems shown in FIG. 10. Components from the second vicinity restaurant component group can be used in implementing execution of the one or more second vicinity restaurant instructions i1223 of FIG. 35, can be used in performance of the second vicinity restaurant electrical circuitry arrangement e1223 of FIG. 26, and/or can be used in otherwise fulfillment of the operation o1223. An exemplary non-transitory signal bearing medium version of the information storage subsystem s200 is depicted in FIG. 35 as bearing the one or more second vicinity restaurant instructions i1223 that when executed will direct performance of the operation o1223. Furthermore, the second vicinity restaurant electrical circuitry arrangement (“elec circ arrange”) e1223, when activated, will perform the operation o1223. For instance, in one or more exemplary implementations, the one or more second vicinity restaurant instructions i1223, when executed, direct performance of the operation o1223 in the illustrative depiction as follows, and/or the second vicinity restaurant electrical circuitry arrangement e1223, when activated, performs the operation o1223 in the illustrative depiction as follows, and/or the operation o1223 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) within the second vicinity (e.g. such as within visual distance thereof, within audio distance thereof, within same interior space thereof, within same neighborhood thereof, within same geographical region thereof, etc.) as within an interior of a restaurant (e.g. an implementation of the microprocessor component s102 is configured through the electronic communication subsystem 500 to electronically direct control at least in part of the acquisition of the ingestion intelligence within the second vicinity as within the interior of the restaurant wherein the digestible product preparation system 10 is located that communicates with for instance the visual display component s304 to electronically output the electronically generated one or more selection menus also within the restaurant, etc.).

In one or more implementations, as shown in FIG. 80, operation o12 includes an operation o1224 for electronically directing control at least in part of transmission to one or more computer based social network services associated with the computer based social network service identification of the ingestion intelligence including the information related to the ingestion by the particular individual living being within the second vicinity as within an interior of an airplane. Origination of an illustratively derived second vicinity airplane component group can be accomplished through skilled in the art design choice selection of one or more of the above depicted components from one or more of the above depicted subsystems shown in FIG. 10. Components from the second vicinity airplane component group can be used in implementing execution of the one or more second vicinity airplane instructions i1224 of FIG. 35, can be used in performance of the second vicinity airplane electrical circuitry arrangement e1224 of FIG. 26, and/or can be used in otherwise fulfillment of the operation o1224. An exemplary non-transitory signal bearing medium version of the information storage subsystem s200 is depicted in FIG. 35 as bearing the one or more second vicinity airplane instructions i1224 that when executed will direct performance of the operation o1224. Furthermore, the second vicinity airplane electrical circuitry arrangement (“elec circ arrange”) e1224, when activated, will perform the operation o1224. For instance, in one or more exemplary implementations, the one or more second vicinity airplane instructions i1224, when executed, direct performance of the operation o1224 in the illustrative depiction as follows, and/or the second vicinity airplane electrical circuitry arrangement e1224, when activated, performs the operation o1224 in the illustrative depiction as follows, and/or the operation o1224 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) within the second vicinity (e.g. such as within visual distance thereof, within audio distance thereof, within same interior space thereof, within same neighborhood thereof, within same geographical region thereof, etc.) as within an interior of an airplane (e.g. an implementation of the microprocessor component s102 is configured through the electronic communication subsystem 500 to electronically direct control at least in part of the acquisition of the ingestion intelligence within the second vicinity as within the interior of the airplane wherein the digestible product preparation system 10 is located that communicates with for instance the visual display component s304 to electronically output the electronically generated one or more selection menus also within the airplane, etc.).

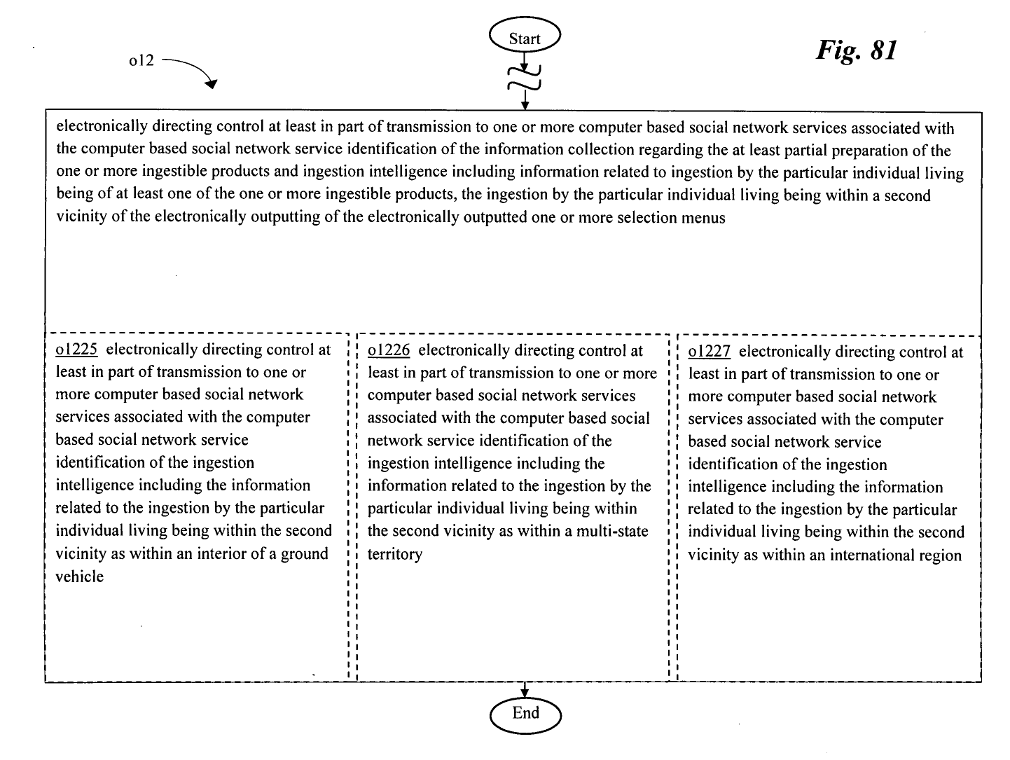

In one or more implementations, as shown in FIG. 81, operation o12 includes an operation o1225 for electronically directing control at least in part of transmission to one or more computer based social network services associated with the computer based social network service identification of the ingestion intelligence including the information related to the ingestion by the particular individual living being within the second vicinity as within an interior of a ground vehicle. Origination of an illustratively derived second vicinity ground component group can be accomplished through skilled in the art design choice selection of one or more of the above depicted components from one or more of the above depicted subsystems shown in FIG. 10. Components from the second vicinity ground component group can be used in implementing execution of the one or more second vicinity ground instructions i1225 of FIG. 35, can be used in performance of the second vicinity ground electrical circuitry arrangement e1225 of FIG. 26, and/or can be used in otherwise fulfillment of the operation o1225. An exemplary non-transitory signal bearing medium version of the information storage subsystem s200 is depicted in FIG. 35 as bearing the one or more second vicinity ground instructions i1225 that when executed will direct performance of the operation o1225. Furthermore, the second vicinity ground electrical circuitry arrangement (“elec circ arrange”) e1225, when activated, will perform the operation o1225. For instance, in one or more exemplary implementations, the one or more second vicinity ground instructions i1225, when executed, direct performance of the operation o1225 in the illustrative depiction as follows, and/or the second vicinity ground electrical circuitry arrangement e1225, when activated, performs the operation o1225 in the illustrative depiction as follows, and/or the operation o1225 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) within the second vicinity (e.g. such as within visual distance thereof, within audio distance thereof, within same interior space thereof, within same neighborhood thereof, within same geographical region thereof, etc.) as within an interior of a ground vehicle (e.g. an implementation of the microprocessor component s102 is configured through the electronic communication subsystem 500 to electronically direct control at least in part of the acquisition of the ingestion intelligence within the second vicinity as within the interior of the ground vehicle wherein the digestible product preparation system 10 is located that communicates with for instance the visual display component s304 to electronically output the electronically generated one or more selection menus also within the ground vehicle, etc.).

In one or more implementations, as shown in FIG. 81, operation o12 includes an operation o1226 for electronically directing control at least in part of transmission to one or more computer based social network services associated with the computer based social network service identification of the ingestion intelligence including the information related to the ingestion by the particular individual living being within the second vicinity as within a multi-state territory. Origination of an illustratively derived second vicinity territory component group can be accomplished through skilled in the art design choice selection of one or more of the above depicted components from one or more of the above depicted subsystems shown in FIG. 10. Components from the second vicinity territory component group can be used in implementing execution of the one or more second vicinity territory instructions i1226 of FIG. 35, can be used in performance of the second vicinity territory electrical circuitry arrangement e1226 of FIG. 26, and/or can be used in otherwise fulfillment of the operation o1226. An exemplary non-transitory signal bearing medium version of the information storage subsystem s200 is depicted in FIG. 35 as bearing the one or more second vicinity territory instructions i1226 that when executed will direct performance of the operation o1226. Furthermore, the second vicinity territory electrical circuitry arrangement (“elec circ arrange”) e1226, when activated, will perform the operation o1226. For instance, in one or more exemplary implementations, the one or more second vicinity territory instructions i1226, when executed, direct performance of the operation o1226 in the illustrative depiction as follows, and/or the second vicinity territory electrical circuitry arrangement e1226, when activated, performs the operation o1226 in the illustrative depiction as follows, and/or the operation o1226 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) within the second vicinity (e.g. such as within visual distance thereof, within audio distance thereof, within same interior space thereof, within same neighborhood thereof, within same geographical region thereof, etc.) as within a multi state territory (e.g. an implementation of the microprocessor component s102 is configured through the electronic communication subsystem 500 to electronically direct control at least in part of the acquisition of the ingestion intelligence within the second vicinity as within the interior of the multi state territory of Colorado, Wyoming, Montana, Utah, New Mexico, and Texas wherein the digestible product preparation system 10 is located that communicates with for instance the visual display component s304 to electronically output the electronically generated one or more selection menus also within the multi state territory of Colorado, Wyoming, Montana, Utah, New Mexico, and Texas, etc.).

In one or more implementations, as shown in FIG. 81, operation o12 includes an operation o1227 for electronically directing control at least in part of transmission to one or more computer based social network services associated with the computer based social network service identification of the ingestion intelligence including the information related to the ingestion by the particular individual living being within the second vicinity as within an international region. Origination of an illustratively derived second vicinity region component group can be accomplished through skilled in the art design choice selection of one or more of the above depicted components from one or more of the above depicted subsystems shown in FIG. 10. Components from the second vicinity region component group can be used in implementing execution of the one or more second vicinity region instructions i1227 of FIG. 35, can be used in performance of the second vicinity region electrical circuitry arrangement e1227 of FIG. 26, and/or can be used in otherwise fulfillment of the operation o1227. An exemplary non-transitory signal bearing medium version of the information storage subsystem s200 is depicted in FIG. 35 as bearing the one or more second vicinity region instructions i1227 that when executed will direct performance of the operation o1227. Furthermore, the second vicinity region electrical circuitry arrangement (“elec circ arrange”) e1227, when activated, will perform the operation o1227. For instance, in one or more exemplary implementations, the one or more second vicinity region instructions i1227, when executed, direct performance of the operation o1227 in the illustrative depiction as follows, and/or the second vicinity region electrical circuitry arrangement e1227, when activated, performs the operation o1227 in the illustrative depiction as follows, and/or the operation o1227 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) within the second vicinity (e.g. such as within visual distance thereof, within audio distance thereof, within same interior space thereof, within same neighborhood thereof, within same geographical region thereof, etc.) as within an international region (e.g. an implementation of the microprocessor component s102 is configured through the electronic communication subsystem 500 to electronically direct control at least in part of the acquisition of the ingestion intelligence within the second vicinity as within the international region of England, Germany, France, Brazil, Russia, India, China, and the United States wherein the digestible product preparation system 10 is located that communicates with for instance the visual display component s304 to electronically output the electronically generated one or more selection menus also within the international region of England, Germany, France, Brazil, Russia, India, China, and the United States, etc.).

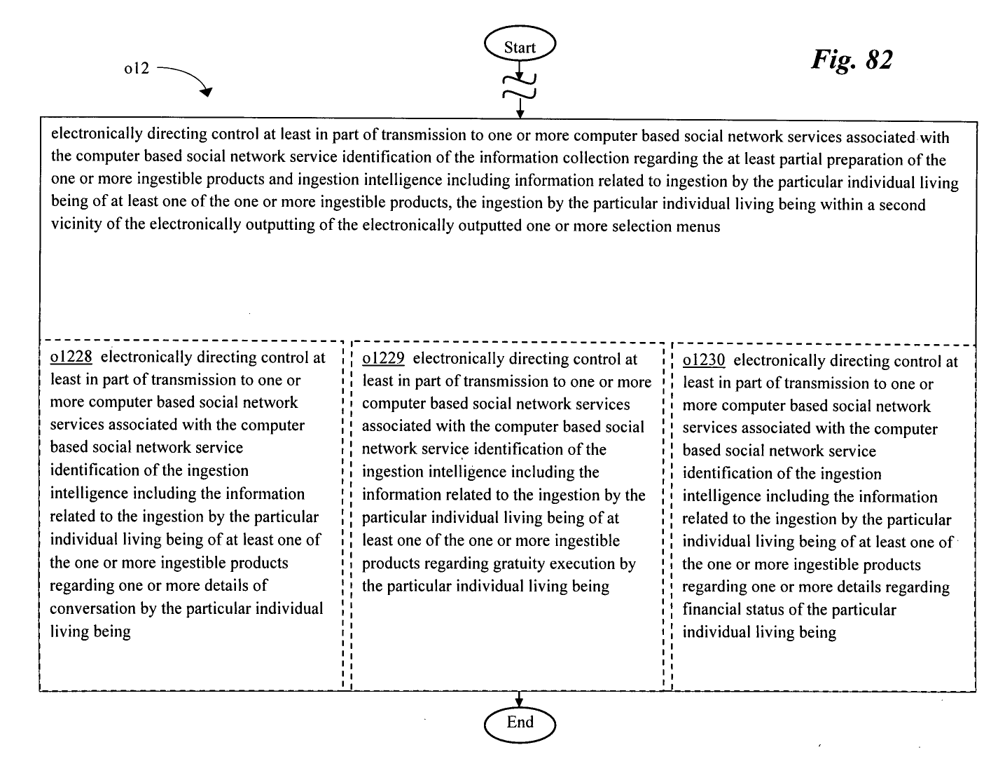

In one or more implementations, as shown in FIG. 82, operation o12 includes an operation o1228 for electronically directing control at least in part of transmission to one or more computer based social network services associated with the computer based social network service identification of the ingestion intelligence including the information related to the ingestion by the particular individual living being of at least one of the one or more ingestible products regarding one or more details of conversation by the particular individual living being. Origination of an illustratively derived transmission conversation component group can be accomplished through skilled in the art design choice selection of one or more of the above depicted components from one or more of the above depicted subsystems shown in FIG. 10. Components from the transmission conversation component group can be used in implementing execution of the one or more transmission conversation instructions i1228 of FIG. 35, can be used in performance of the transmission conversation electrical circuitry arrangement e1228 of FIG. 26, and/or can be used in otherwise fulfillment of the operation o1228. An exemplary non-transitory signal bearing medium version of the information storage subsystem s200 is depicted in FIG. 35 as bearing the one or more transmission conversation instructions i1228 that when executed will direct performance of the operation o1228. Furthermore, the transmission conversation electrical circuitry arrangement (“elec circ arrange”) e1228, when activated, will perform the operation o1228. For instance, in one or more exemplary implementations, the one or more transmission conversation instructions i1228, when executed, direct performance of the operation o1228 in the illustrative depiction as follows, and/or the transmission conversation electrical circuitry arrangement e1228, when activated, performs the operation o1228 in the illustrative depiction as follows, and/or the operation o1228 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding one or more details of conversation (e.g. an implementation of the microprocessor component s102 is configured to electronically control at least in part the acquisition such as through sound sensing component s420 and recognition application implemented by microprocessor component s102 of the ingestion intelligence including the information related to the ingestion by the particular individual living being of at least one of the one or more selected ingestible products regarding one or more details of conversation by the particular individual living being, etc.) by the particular individual living being (e.g. one of more of a consumer, a gourmand, a hobbyist, an athlete, a student, a dieter, a patient, an animal, an inmate, a health seeker, a worker, a pedestrian, etc.).

In one or more implementations, as shown in FIG. 82, operation o12 includes an operation o1229 for electronically directing control at least in part of transmission to one or more computer based social network services associated with the computer based social network service identification of the ingestion intelligence including the information related to the ingestion by the particular individual living being of at least one of the one or more ingestible products regarding gratuity execution by the particular individual living being. Origination of an illustratively derived transmission gratuity component group can be accomplished through skilled in the art design choice selection of one or more of the above depicted components from one or more of the above depicted subsystems shown in FIG. 10. Components from the transmission gratuity component group can be used in implementing execution of the one or more transmission gratuity instructions i1229 of FIG. 35, can be used in performance of the transmission gratuity electrical circuitry arrangement e1229 of FIG. 26, and/or can be used in otherwise fulfillment of the operation o1229. An exemplary non-transitory signal bearing medium version of the information storage subsystem s200 is depicted in FIG. 35 as bearing the one or more transmission gratuity instructions i1229 that when executed will direct performance of the operation o1229. Furthermore, the transmission gratuity electrical circuitry arrangement (“elec circ arrange”) e1229, when activated, will perform the operation o1229. For instance, in one or more exemplary implementations, the one or more transmission gratuity instructions i1229, when executed, direct performance of the operation o1229 in the illustrative depiction as follows, and/or the transmission gratuity electrical circuitry arrangement e1229, when activated, performs the operation o1229 in the illustrative depiction as follows, and/or the operation o1229 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding gratuity execution (e.g. an implementation of the microprocessor component s102 is configured to electronically control at least in part the acquisition such as through camera component s336 and recognition application implemented by microprocessor component s102 of the ingestion intelligence including the information related to the ingestion by the particular individual living being of at least one of the one or more selected ingestible products regarding gratuity execution by the particular individual living being, etc.) by the particular individual living being (e.g. one of more of a consumer, a gourmand, a hobbyist, an athlete, a student, a dieter, a patient, an animal, an inmate, a health seeker, a worker, a pedestrian, etc.).

In one or more implementations, as shown in FIG. 82, operation o12 includes an operation o1230 for electronically directing control at least in part of transmission to one or more computer based social network services associated with the computer based social network service identification of the ingestion intelligence including the information related to the ingestion by the particular individual living being of at least one of the one or more ingestible products regarding one or more details regarding financial status of the particular individual living being. Origination of an illustratively derived transmission financial component group can be accomplished through skilled in the art design choice selection of one or more of the above depicted components from one or more of the above depicted subsystems shown in FIG. 10. Components from the transmission financial component group can be used in implementing execution of the one or more transmission financial instructions i1230 of FIG. 35, can be used in performance of the transmission financial electrical circuitry arrangement e1230 of FIG. 26, and/or can be used in otherwise fulfillment of the operation o1230. An exemplary non-transitory signal bearing medium version of the information storage subsystem s200 is depicted in FIG. 35 as bearing the one or more transmission financial instructions i1230 that when executed will direct performance of the operation o1230. Furthermore, the transmission financial electrical circuitry arrangement (“elec circ arrange”) e1230, when activated, will perform the operation o1230. For instance, in one or more exemplary implementations, the one or more transmission financial instructions i1230, when executed, direct performance of the operation o1230 in the illustrative depiction as follows, and/or the transmission financial electrical circuitry arrangement e1230, when activated, performs the operation o1230 in the illustrative depiction as follows, and/or the operation o1230 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding one or more details regarding financial status (e.g. an implementation of the microprocessor component s102 is configured to electronically control at least in part the acquisition such as through camera component s336 and recognition application implemented by microprocessor component s102 of the ingestion intelligence including the information related to the ingestion by the particular individual living being of at least one of the one or more selected ingestible products regarding financial status by the particular individual living being, etc.) of the particular individual living being (e.g. one of more of a consumer, a gourmand, a hobbyist, an athlete, a student, a dieter, a patient, an animal, an inmate, a health seeker, a worker, a pedestrian, etc.).

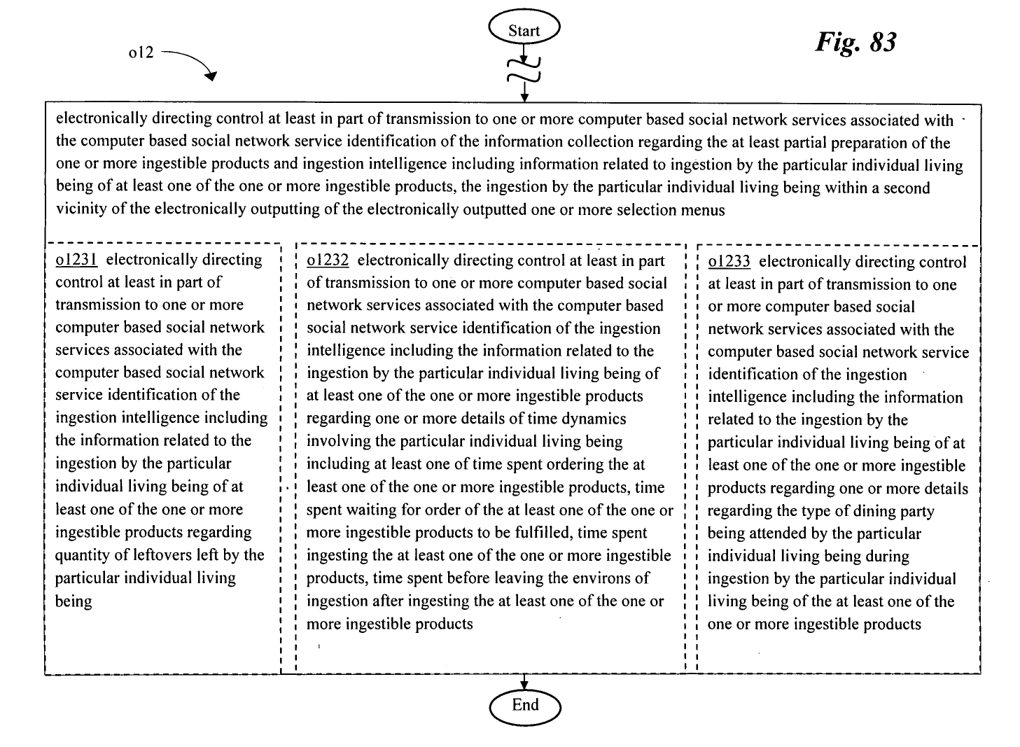

In one or more implementations, as shown in FIG. 83, operation o12 includes an operation o1231 for electronically directing control at least in part of transmission to one or more computer based social network services associated with the computer based social network service identification of the ingestion intelligence including the information related to the ingestion by the particular individual living being of at least one of the one or more ingestible products regarding quantity of leftovers left by the particular individual living being. Origination of an illustratively derived transmission leftovers component group can be accomplished through skilled in the art design choice selection of one or more of the above depicted components from one or more of the above depicted subsystems shown in FIG. 10. Components from the transmission leftovers component group can be used in implementing execution of the one or more transmission leftovers instructions i1231 of FIG. 35, can be used in performance of the transmission leftovers electrical circuitry arrangement e1231 of FIG. 26, and/or can be used in otherwise fulfillment of the operation o1231. An exemplary non-transitory signal bearing medium version of the information storage subsystem s200 is depicted in FIG. 35 as bearing the one or more transmission leftovers instructions i1231 that when executed will direct performance of the operation o1231. Furthermore, the transmission leftovers electrical circuitry arrangement (“elec circ arrange”) e1231, when activated, will perform the operation o1231. For instance, in one or more exemplary implementations, the one or more transmission leftovers instructions i1231, when executed, direct performance of the operation o1231 in the illustrative depiction as follows, and/or the transmission leftovers electrical circuitry arrangement e1231, when activated, performs the operation o1231 in the illustrative depiction as follows, and/or the operation o1231 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding quantity of leftovers left (e.g. an implementation of the microprocessor component s102 is configured to electronically control at least in part the acquisition such as through camera component s336 and recognition application implemented by microprocessor component s102 of the ingestion intelligence including the information related to the ingestion by the particular individual living being of at least one of the one or more selected ingestible products regarding quantity of leftovers left by the particular individual living being, etc.) by the particular individual living being (e.g. one of more of a consumer, a gourmand, a hobbyist, an athlete, a student, a dieter, a patient, an animal, an inmate, a health seeker, a worker, a pedestrian, etc.).

In one or more implementations, as shown in FIG. 83, operation o12 includes an operation o1232 for electronically directing control at least in part of transmission to one or more computer based social network services associated with the computer based social network service identification of the ingestion intelligence including the information related to the ingestion by the particular individual living being of at least one of the one or more ingestible products regarding one or more details of time dynamics involving the particular individual living being including at least one of time spent ordering the at least one of the one or more ingestible products, time spent waiting for order of the at least one of the one or more ingestible products to be fulfilled, time spent ingesting the at least one of the one or more ingestible products, time spent before leaving the environs of ingestion after ingesting the at least one of the one or more ingestible products. Origination of an illustratively derived transmission time component group can be accomplished through skilled in the art design choice selection of one or more of the above depicted components from one or more of the above depicted subsystems shown in FIG. 10. Components from the transmission time component group can be used in implementing execution of the one or more transmission time instructions i1232 of FIG. 35, can be used in performance of the transmission time electrical circuitry arrangement e1232 of FIG. 26, and/or can be used in otherwise fulfillment of the operation o1232. An exemplary non-transitory signal bearing medium version of the information storage subsystem s200 is depicted in FIG. 35 as bearing the one or more transmission time instructions i1232 that when executed will direct performance of the operation o1232. Furthermore, the transmission time electrical circuitry arrangement (“elec circ arrange”) e1232, when activated, will perform the operation o1232. For instance, in one or more exemplary implementations, the one or more transmission time instructions i1232, when executed, direct performance of the operation o1232 in the illustrative depiction as follows, and/or the transmission time electrical circuitry arrangement e1232, when activated, performs the operation o1232 in the illustrative depiction as follows, and/or the operation o1232 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding one or more details of time dynamics involving the particular individual living being (e.g. one of more of a consumer, a gourmand, a hobbyist, an athlete, a student, a dieter, a patient, an animal, an inmate, a health seeker, a worker, a pedestrian, etc.) including at least one of time spent ordering the at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), time spent waiting for order of the at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) to be fulfilled, time spent ingesting the at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), time spent before leaving (e.g. an implementation of the microprocessor component s102 is configured to electronically control at least in part the acquisition such as through camera component s336 and recognition application implemented by microprocessor component s102 of the ingestion intelligence including the information related to the ingestion by the particular individual living being of at least one of the one or more selected ingestible products regarding one or more details of time dynamics involving the particular individual living being including at least one of time spent ordering the at least one of the one or more selected ingestible products, time spent waiting for order of the at least one of the one or more selected ingestible products to be fulfilled, time spent ingesting the at least one of the one or more selected ingestible products, time spent before leaving the environs such as a restaurant of ingestion after ingesting the at least one of the one or more selected ingestible products, etc.) the environs of ingestion (e.g. by one of more of the following: oral intake, nasal intake, swallowing, chewing, topical, injected, sublingual, tear duct applied, transversed gut membrane, etc.) after ingesting the at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.).

In one or more implementations, as shown in FIG. 83, operation o12 includes an operation o1233 for electronically directing control at least in part of transmission to one or more computer based social network services associated with the computer based social network service identification of the ingestion intelligence including the information related to the ingestion by the particular individual living being of at least one of the one or more ingestible products regarding one or more details regarding the type of dining party being attended by the particular individual living being during ingestion by the particular individual living being of the at least one of the one or more ingestible products. Origination of an illustratively derived transmission party component group can be accomplished through skilled in the art design choice selection of one or more of the above depicted components from one or more of the above depicted subsystems shown in FIG. 10. Components from the transmission party component group can be used in implementing execution of the one or more transmission party instructions i1233 of FIG. 35, can be used in performance of the transmission party electrical circuitry arrangement e1233 of FIG. 26, and/or can be used in otherwise fulfillment of the operation o1233. An exemplary non-transitory signal bearing medium version of the information storage subsystem s200 is depicted in FIG. 35 as bearing the one or more transmission party instructions i1233 that when executed will direct performance of the operation o1233. Furthermore, the transmission party electrical circuitry arrangement (“elec circ arrange”) e1233, when activated, will perform the operation o1233. For instance, in one or more exemplary implementations, the one or more transmission party instructions i1233, when executed, direct performance of the operation o1233 in the illustrative depiction as follows, and/or the transmission party electrical circuitry arrangement e1233, when activated, performs the operation o1233 in the illustrative depiction as follows, and/or the operation o1233 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including the information related to the ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.) regarding one or more details regarding the type of dining party being attended (e.g. an implementation of the microprocessor component s102 is configured to electronically control at least in part the acquisition such as through camera component s336 and recognition application implemented by microprocessor component s102 of the ingestion intelligence including the information related to the ingestion by the particular individual living being of at least one of the one or more selected ingestible products regarding the type of dining party being attended, such as formal, business, casual, celebratory, etc., by the particular individual living being during ingestion by the particular individual living being of the at least one of the one or more selected ingestible products, etc.) by the particular individual living being (e.g. one of more of a consumer, a gourmand, a hobbyist, an athlete, a student, a dieter, a patient, an animal, an inmate, a health seeker, a worker, a pedestrian, etc.) during ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of the at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.).

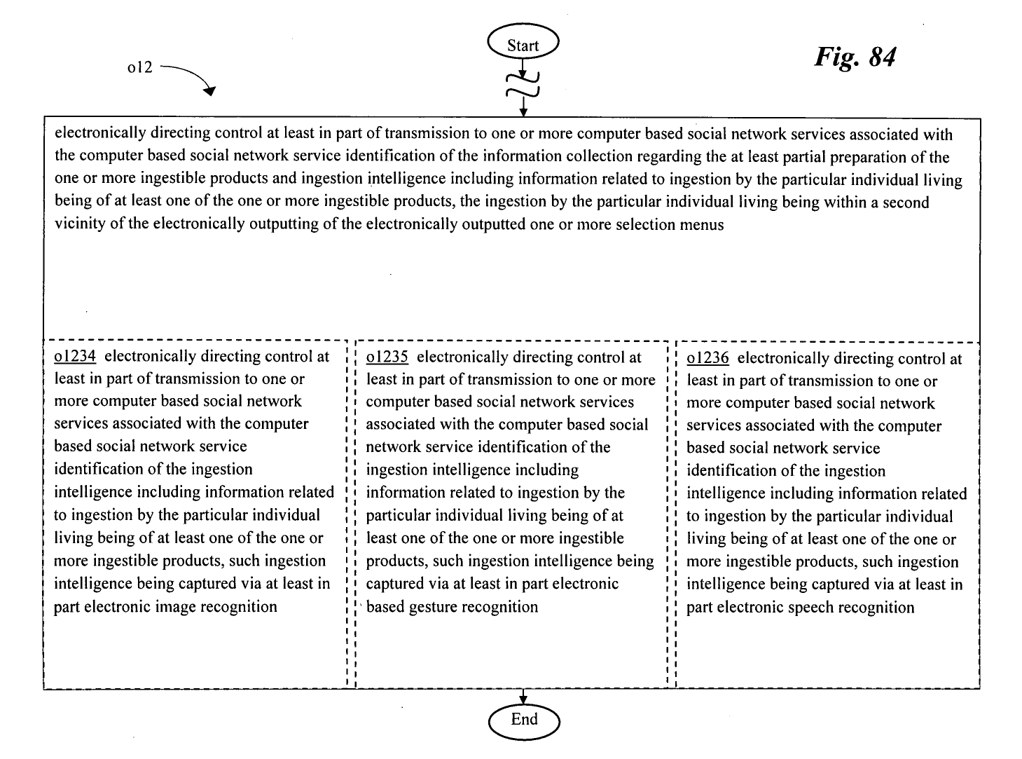

In one or more implementations, as shown in FIG. 84, operation o12 includes an operation o1234 for electronically directing control at least in part of transmission to one or more computer based social network services associated with the computer based social network service identification of the ingestion intelligence including information related to ingestion by the particular individual living being of at least one of the one or more ingestible products, such ingestion intelligence being captured via at least in part electronic image recognition. Origination of an illustratively derived transmission image component group can be accomplished through skilled in the art design choice selection of one or more of the above depicted components from one or more of the above depicted subsystems shown in FIG. 10. Components from the transmission image component group can be used in implementing execution of the one or more transmission image instructions i1234 of FIG. 35, can be used in performance of the transmission image electrical circuitry arrangement e1234 of FIG. 26, and/or can be used in otherwise fulfillment of the operation o1234. An exemplary non-transitory signal bearing medium version of the information storage subsystem s200 is depicted in FIG. 35 as bearing the one or more transmission image instructions i1234 that when executed will direct performance of the operation o1234. Furthermore, the transmission image electrical circuitry arrangement (“elec circ arrange”) e1234, when activated, will perform the operation o1234. For instance, in one or more exemplary implementations, the one or more transmission image instructions i1234, when executed, direct performance of the operation o1234 in the illustrative depiction as follows, and/or the transmission image electrical circuitry arrangement e1234, when activated, performs the operation o1234 in the illustrative depiction as follows, and/or the operation o1234 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including information related to ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), such ingestion (e.g. by one of more of the following: oral intake, nasal intake, swallowing, chewing, topical, injected, sublingual, tear duct applied, transversed gut membrane, etc.) intelligence being captured via at least in part electronic image recognition (e.g. an implementation of the microprocessor component s102 is configured to electronically control at least in part the acquisition such as through camera component s336 and recognition application implemented by microprocessor component s102 of the ingestion intelligence including the information related to the ingestion by the particular individual living being of at least one of the one or more selected ingestible products via at least in part electronic image recognition products such as the image recognition application implemented by the microprocessor component s102, etc.).

In one or more implementations, as shown in FIG. 84, operation o12 includes an operation o1235 for electronically directing control at least in part of transmission to one or more computer based social network services associated with the computer based social network service identification of the ingestion intelligence including information related to ingestion by the particular individual living being of at least one of the one or more ingestible products, such ingestion intelligence being captured via at least in part electronic based gesture recognition. Origination of an illustratively derived transmission gesture component group can be accomplished through skilled in the art design choice selection of one or more of the above depicted components from one or more of the above depicted subsystems shown in FIG. 10. Components from the transmission gesture component group can be used in implementing execution of the one or more transmission gesture instructions i1235 of FIG. 35, can be used in performance of the transmission gesture electrical circuitry arrangement e1235 of FIG. 26, and/or can be used in otherwise fulfillment of the operation o1235. An exemplary non-transitory signal bearing medium version of the information storage subsystem s200 is depicted in FIG. 35 as bearing the one or more transmission gesture instructions i1235 that when executed will direct performance of the operation o1235. Furthermore, the transmission gesture electrical circuitry arrangement (“elec circ arrange”) e1235, when activated, will perform the operation o1235. For instance, in one or more exemplary implementations, the one or more transmission gesture instructions i1235, when executed, direct performance of the operation o1235 in the illustrative depiction as follows, and/or the transmission gesture electrical circuitry arrangement e1235, when activated, performs the operation o1235 in the illustrative depiction as follows, and/or the operation o1235 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including information related to ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), such ingestion (e.g. by one of more of the following: oral intake, nasal intake, swallowing, chewing, topical, injected, sublingual, tear duct applied, transversed gut membrane, etc.) intelligence being captured via at least in part electronic based gesture recognition (e.g. an implementation of the microprocessor component s102 is configured to electronically control at least in part the acquisition such as through camera component s336 and recognition application implemented by microprocessor component s102 of the ingestion intelligence including the information related to the ingestion by the particular individual living being of at least one of the one or more selected ingestible products via at least in part electronic image recognition products such as a gesture recognition application implemented by the microprocessor component s102, etc.).

In one or more implementations, as shown in FIG. 84, operation o12 includes an operation o1236 for electronically directing control at least in part of transmission to one or more computer based social network services associated with the computer based social network service identification of the ingestion intelligence including information related to ingestion by the particular individual living being of at least one of the one or more ingestible products, such ingestion intelligence being captured via at least in part electronic speech recognition. Origination of an illustratively derived transmission speech component group can be accomplished through skilled in the art design choice selection of one or more of the above depicted components from one or more of the above depicted subsystems shown in FIG. 10. Components from the transmission speech component group can be used in implementing execution of the one or more transmission speech instructions i1236 of FIG. 35, can be used in performance of the transmission speech electrical circuitry arrangement e1236 of FIG. 26, and/or can be used in otherwise fulfillment of the operation o1236. An exemplary non-transitory signal bearing medium version of the information storage subsystem s200 is depicted in FIG. 35 as bearing the one or more transmission speech instructions i1236 that when executed will direct performance of the operation o1236. Furthermore, the transmission speech electrical circuitry arrangement (“elec circ arrange”) e1236, when activated, will perform the operation o1236. For instance, in one or more exemplary implementations, the one or more transmission speech instructions i1236, when executed, direct performance of the operation o1236 in the illustrative depiction as follows, and/or the transmission speech electrical circuitry arrangement e1236, when activated, performs the operation o1236 in the illustrative depiction as follows, and/or the operation o1236 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including information related to ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), such ingestion (e.g. by one of more of the following: oral intake, nasal intake, swallowing, chewing, topical, injected, sublingual, tear duct applied, transversed gut membrane, etc.) intelligence being captured via at least in part electronic speech recognition (e.g. an implementation of the microprocessor component s102 is configured to electronically control at least in part the acquisition such as through camera component s336 and recognition application implemented by microprocessor component s102 of the ingestion intelligence including the information related to the ingestion by the particular individual living being of at least one of the one or more selected ingestible products via at least in part electronic image recognition products such as a speech recognition application implemented by the microprocessor component s102, etc.).

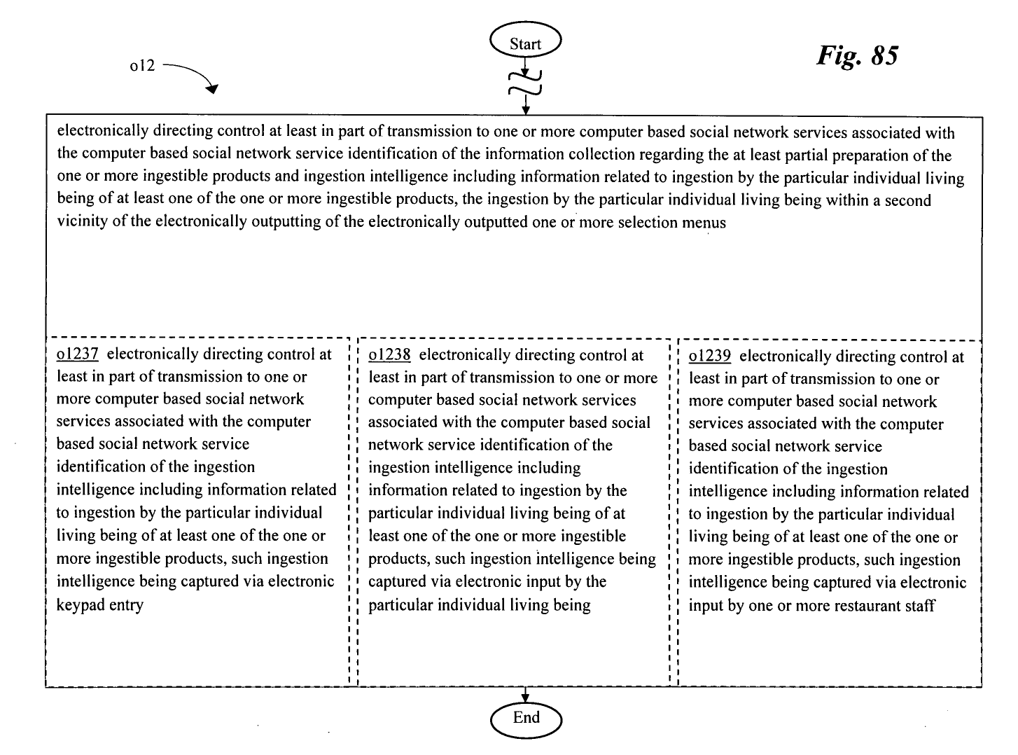

In one or more implementations, as shown in FIG. 85, operation o12 includes an operation o1237 for electronically directing control at least in part of transmission to one or more computer based social network services associated with the computer based social network service identification of the ingestion intelligence including information related to ingestion by the particular individual living being of at least one of the one or more ingestible products, such ingestion intelligence being captured via electronic keypad entry. Origination of an illustratively derived transmission keypad component group can be accomplished through skilled in the art design choice selection of one or more of the above depicted components from one or more of the above depicted subsystems shown in FIG. 10. Components from the transmission keypad component group can be used in implementing execution of the one or more transmission keypad instructions i1237 of FIG. 35, can be used in performance of the transmission keypad electrical circuitry arrangement e1237 of FIG. 26, and/or can be used in otherwise fulfillment of the operation o1237. An exemplary non-transitory signal bearing medium version of the information storage subsystem s200 is depicted in FIG. 35 as bearing the one or more transmission keypad instructions i1237 that when executed will direct performance of the operation o1237. Furthermore, the transmission keypad electrical circuitry arrangement (“elec circ arrange”) e1237, when activated, will perform the operation o1237. For instance, in one or more exemplary implementations, the one or more transmission keypad instructions i1237, when executed, direct performance of the operation o1237 in the illustrative depiction as follows, and/or the transmission keypad electrical circuitry arrangement e1237, when activated, performs the operation o1237 in the illustrative depiction as follows, and/or the operation o1237 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including information related to ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), such ingestion (e.g. by one of more of the following: oral intake, nasal intake, swallowing, chewing, topical, injected, sublingual, tear duct applied, transversed gut membrane, etc.) intelligence being captured via electronic keypad entry (e.g. an implementation of the microprocessor component s102 is configured to electronically control at least in part the acquisition of the ingestion intelligence including the information related to the ingestion by the particular individual living being of at least one of the one or more selected ingestible products via electronic keypad such as keypad component s308 communicatively linked to the microprocessor component s102, etc.

In one or more implementations, as shown in FIG. 85, operation o12 includes an operation o1238 for electronically directing control at least in part of transmission to one or more computer based social network services associated with the computer based social network service identification of the ingestion intelligence including information related to ingestion by the particular individual living being of at least one of the one or more ingestible products, such ingestion intelligence being captured via electronic input by the particular individual living being. Origination of an illustratively derived transmission input component group can be accomplished through skilled in the art design choice selection of one or more of the above depicted components from one or more of the above depicted subsystems shown in FIG. 10. Components from the transmission input component group can be used in implementing execution of the one or more transmission input instructions i1238 of FIG. 35, can be used in performance of the transmission input electrical circuitry arrangement e1238 of FIG. 26, and/or can be used in otherwise fulfillment of the operation o1238. An exemplary non-transitory signal bearing medium version of the information storage subsystem s200 is depicted in FIG. 35 as bearing the one or more transmission input instructions i1238 that when executed will direct performance of the operation o1238. Furthermore, the transmission input electrical circuitry arrangement (“elec circ arrange”) e1238, when activated, will perform the operation o1238. For instance, in one or more exemplary implementations, the one or more transmission input instructions i1238, when executed, direct performance of the operation o1238 in the illustrative depiction as follows, and/or the transmission input electrical circuitry arrangement e1238, when activated, performs the operation o1238 in the illustrative depiction as follows, and/or the operation o1238 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, interne network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including information related to ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), such ingestion (e.g. by one of more of the following: oral intake, nasal intake, swallowing, chewing, topical, injected, sublingual, tear duct applied, transversed gut membrane, etc.) intelligence being captured via electronic input (e.g. an implementation of the microprocessor component s102 is configured to electronically control at least in part the acquisition of the ingestion intelligence including the information related to the ingestion by the particular individual living being of at least one of the one or more selected ingestible products via electronic input by the particular individual living being such as through use of the graphical user interface (GUI) component s302, etc.) by the particular individual living being (e.g. one of more of a consumer, a gourmand, a hobbyist, an athlete, a student, a dieter, a patient, an animal, an inmate, a health seeker, a worker, a pedestrian, etc.).

In one or more implementations, as shown in FIG. 85, operation o12 includes an operation o1239 for electronically directing control at least in part of transmission to one or more computer based social network services associated with the computer based social network service identification of the ingestion intelligence including information related to ingestion by the particular individual living being of at least one of the one or more ingestible products, such ingestion intelligence being captured via electronic input by one or more restaurant staff. Origination of an illustratively derived transmission restaurant component group can be accomplished through skilled in the art design choice selection of one or more of the above depicted components from one or more of the above depicted subsystems shown in FIG. 10. Components from the transmission restaurant component group can be used in implementing execution of the one or more transmission restaurant instructions i1239 of FIG. 35, can be used in performance of the transmission restaurant electrical circuitry arrangement e1239 of FIG. 26, and/or can be used in otherwise fulfillment of the operation o1239. An exemplary non-transitory signal bearing medium version of the information storage subsystem s200 is depicted in FIG. 35 as bearing the one or more transmission restaurant instructions i1239 that when executed will direct performance of the operation o1239. Furthermore, the transmission restaurant electrical circuitry arrangement (“elec circ arrange”) e1239, when activated, will perform the operation o1239. For instance, in one or more exemplary implementations, the one or more transmission restaurant instructions i1239, when executed, direct performance of the operation o1239 in the illustrative depiction as follows, and/or the transmission restaurant electrical circuitry arrangement e1239, when activated, performs the operation o1239 in the illustrative depiction as follows, and/or the operation o1239 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including information related to ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), such ingestion (e.g. by one of more of the following: oral intake, nasal intake, swallowing, chewing, topical, injected, sublingual, tear duct applied, transversed gut membrane, etc.) intelligence being captured via electronic input by one or more restaurant staff (e.g. an implementation of the microprocessor component s102 is configured to electronically control at least in part the acquisition of the ingestion intelligence including the information related to the ingestion by the particular individual living being of at least one of the one or more selected ingestible products via electronic input by one or more restaurant staff such as a wait person using a touch screen component s314, etc.).

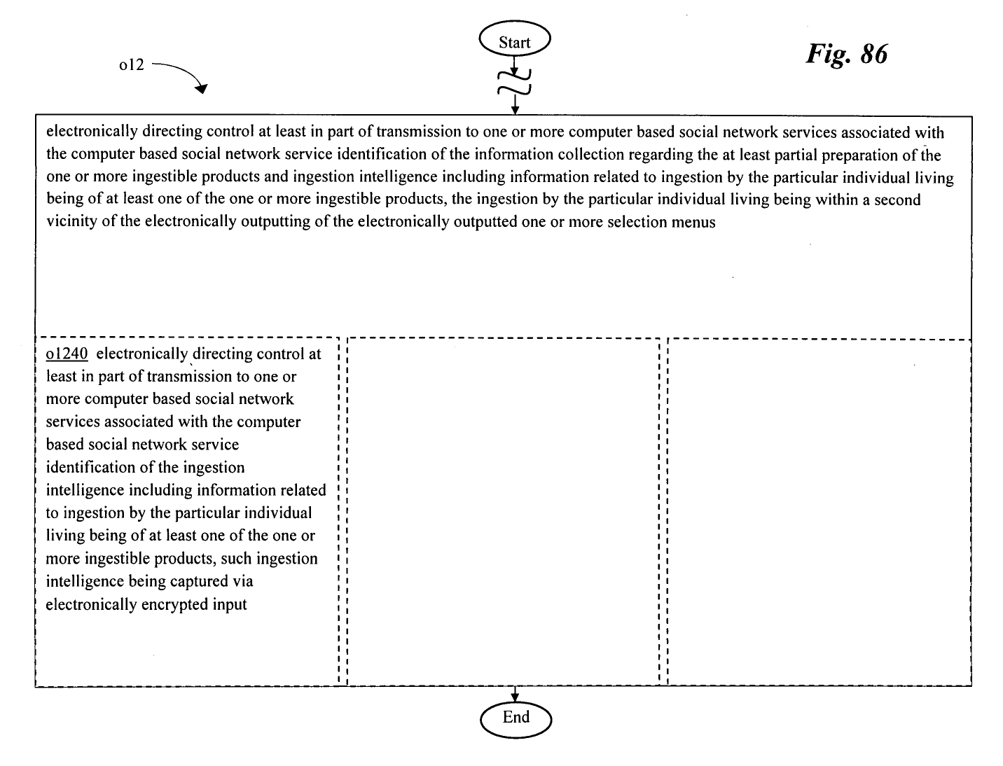

In one or more implementations, as shown in FIG. 86, operation o12 includes an operation o1240 for electronically directing control at least in part of transmission to one or more computer based social network services associated with the computer based social network service identification of the ingestion intelligence including information related to ingestion by the particular individual living being of at least one of the one or more ingestible products, such ingestion intelligence being captured via electronically encrypted input. Origination of an illustratively derived transmission encrypted component group can be accomplished through skilled in the art design choice selection of one or more of the above depicted components from one or more of the above depicted subsystems shown in FIG. 10. Components from the transmission encrypted component group can be used in implementing execution of the one or more transmission encrypted instructions i1240 of FIG. 36, can be used in performance of the transmission encrypted electrical circuitry arrangement e1240 of FIG. 27, and/or can be used in otherwise fulfillment of the operation o1240. An exemplary non-transitory signal bearing medium version of the information storage subsystem s200 is depicted in FIG. 36 as bearing the one or more transmission encrypted instructions i1240 that when executed will direct performance of the operation o1240. Furthermore, the transmission encrypted electrical circuitry arrangement (“elec circ arrange”) e1240, when activated, will perform the operation o1240. For instance, in one or more exemplary implementations, the one or more transmission encrypted instructions i1240, when executed, direct performance of the operation o1240 in the illustrative depiction as follows, and/or the transmission encrypted electrical circuitry arrangement e1240, when activated, performs the operation o1240 in the illustrative depiction as follows, and/or the operation o1240 is otherwise carried out in the illustrative depiction as follows: electronically directing control (e.g. through use of one or more of the following: central processing unit (CPU) component s104, digital signal processor (DSP) component s106, application specific integrated circuit (ASIC) component s108, field programmable gate array (FPGA) component s110, multiprocessor component s112, optical processing component s114, logic component s116, etc.) at least in part of transmission (e.g. through use of one or more of the following: network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, etc.) to one or more computer based social network services (e.g. involving one or more of the following: Orkut, Mixi, Multiply, Wretch, renren, Cyworld, Linkedin, recommendation services, Facebook, Google+, Twitter, The Sphere, Nexopia, Bebo, VKontakte, Hi5, Hyves, Draugiem.Iv, StudiVZ, iWiW, Tuenti, Nasza-Klasa, Decayenne, Tagged XING, Badoo, Skyrock, instant messaging-based service, profile-based service, individual-centered service, community-centered service, category based services, people matching services, trusted services, online-based service, online platform, computer-based network site, non-web-based service, Internet based service, e-mail based service, etc.) associated with the computer-based social network service identification (e.g. identification that identifies one or more usernames, passwords, user biometric data, user ages, user locations, user interests, user pictures, user affiliations, common interest groups, related forums, contacts, related phone numbers, related geographic attributes, chat rooms, personal attributes, brand images, particular online computer based social networking websites, profiles, friends list, user character qualities, etc.) of the ingestion (e.g. by one of more of the following: oral intake, nasal intake, swallowing, chewing, topical, injected, sublingual, tear duct applied, transversed gut membrane, etc.) intelligence including information related to ingestion (e.g. by one of more of the following: oral intake, nasal intake, swallowing, chewing, topical, injected, sublingual, tear duct applied, transversed gut membrane, etc.) by the particular individual living being (e.g. one of more of a consumer, a gourmand, a hobbyist, an athlete, a student, a dieter, a patient, an animal, an inmate, a health seeker, a worker, a pedestrian, etc.) of at least one of the one or more ingestible products (e.g. one of more of the following: sandwich, smoothie, drink, meat dish, vegetarian dish, injection, topical cream, pill form, powder, full course meal, plant based, animal based, synthesized, deposited, sprayed, molded, etc.), such ingestion (e.g. by one of more of the following: oral intake, nasal intake, swallowing, chewing, topical, injected, sublingual, tear duct applied, transversed gut membrane, etc.) intelligence being captured via electronically encrypted input (e.g. an implementation of the microprocessor component s102 is configured to electronically control at least in part the acquisition of the ingestion intelligence including the information related to the ingestion by the particular individual living being of at least one of the one or more selected ingestible products via electronic encrypted input such as through an encrypted version of wireless network component s510, etc.).

Those having skill in the art will recognize that the state of the art has progressed to the point where there is little distinction left between hardware and software implementations of aspects of systems; the use of hardware or software is generally (but not always, in that in certain contexts the choice between hardware an d software can become significant) a design choice representing cost vs. efficiency tradeoffs. Those having skill in the art will appreciate that there are various vehicles by which processes and/or systems and/or other technologies described herein can be effected (e.g., hardware, software, and/or firmware in one or more machines or articles of manufacture), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation that is implemented in one or more machines or articles of manufacture; or, yet again alternatively, the implementer may opt for some combination of hardware, software, and/or firmware in one or more machines or articles of manufacture (limited to patentable subject matter under 35 USC 101). Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware in one or more machines or articles of manufacture.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof (limited to patentable subject matter under 35 U.S.C. 101). In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure (limited to patentable subject matter under 35 USC 101). In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof (limited to patentable subject matter under 35 U.S.C. 101) can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

1.-292. (canceled)

293. A system comprising:
a receiving information electrical circuitry arrangement operable for electronically receiving user status information regarding a particular individual living being including computer based social network service identification associated with the particular individual living being and electronically receiving selection information of one or more computer based social network service options via electronically enabled input in response to electronically outputted one or more selection menus prior to dispensing of one or more ingestible products for ingestion by the particular individual living being to electronically direct control of collection of preparation information regarding at least partial preparation of the one or more ingestible products, the at least partial preparation of the one or more ingestible products occurring within a first vicinity of the electronically outputting of the electronically outputted one or more selection menus; and
a controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus.

294.-304. (canceled)

305. The system of claim 293, wherein the receiving information electrical circuitry arrangement operable for electronically receiving user status information regarding a particular individual living being including computer based social network service identification associated with the particular individual living being and electronically receiving selection information of one or more computer based social network service options via electronically enabled input in response to electronically outputted one or more selection menus prior to dispensing of one or more ingestible products for ingestion by the particular individual living being to electronically direct control of collection of preparation information regarding at least partial preparation of the one or more ingestible products, the at least partial preparation of the one or more ingestible products occurring within a first vicinity of the electronically outputting of the electronically outputted one or more selection menus comprises:
a receiving information meds history electrical circuitry arrangement operable for electronically receiving the user status information regarding the particular individual living being including the computer based social network service identification via a medication history.

306.-316. (canceled)

317. The system of claim 293, wherein the receiving information electrical circuitry arrangement operable for electronically receiving user status information regarding a particular individual living being including computer based social network service identification associated with the particular individual living being and electronically receiving selection information of one or more computer based social network service options via electronically enabled input in response to electronically outputted one or more selection menus prior to dispensing of one or more ingestible products for ingestion by the particular individual living being to electronically direct control of collection of preparation information regarding at least partial preparation of the one or more ingestible products, the at least partial preparation of the one or more ingestible products occurring within a first vicinity of the electronically outputting of the electronically outputted one or more selection menus comprises:
a receiving information graphical electrical circuitry arrangement operable for electronically receiving the selection information of the one or more computer based social network service options via the electronically enabled input in response to the electronically outputted one or more selection menus in graphical form.

318.-328. (canceled)

329. The system of claim 293, wherein the receiving information electrical circuitry arrangement operable for electronically receiving user status information regarding a particular individual living being including computer based social network service identification associated with the particular individual living being and electronically receiving selection information of one or more computer based social network service options via electronically enabled input in response to electronically outputted one or more selection menus prior to dispensing of one or more ingestible products for ingestion by the particular individual living being to electronically direct control of collection of preparation information regarding at least partial preparation of the one or more ingestible products, the at least partial preparation of the one or more ingestible products occurring within a first vicinity of the electronically outputting of the electronically outputted one or more selection menus comprises:
a receiving information fingerprint electrical circuitry arrangement operable for electronically receiving the user status information regarding the particular individual living being including the computer based social network service options associated with an electronically captured fingerprint image.

330.-340. (canceled)

341. The system of claim 293, wherein the receiving information electrical circuitry arrangement operable for electronically receiving user status information regarding a particular individual living being including computer based social network service identification associated with the particular individual living being and electronically receiving selection information of one or more computer based social network service options via electronically enabled input in response to electronically outputted one or more selection menus prior to dispensing of one or more ingestible products for ingestion by the particular individual living being to electronically direct control of collection of preparation information regarding at least partial preparation of the one or more ingestible products, the at least partial preparation of the one or more ingestible products occurring within a first vicinity of the electronically outputting of the electronically outputted one or more selection menus comprises:
a receiving information transdermal electrical circuitry arrangement operable for electronically receiving the selection information of the one or more computer based social network service options via the electronically enabled input in response to the electronically outputted one or more selection menus to electronically identify for the collection of the preparation information regarding at least in part the one or more ingestible products to be ingested transdermally.

342.-352. (canceled)

353. The system of claim 293, wherein the receiving information electrical circuitry arrangement operable for electronically receiving user status information regarding a particular individual living being including computer based social network service identification associated with the particular individual living being and electronically receiving selection information of one or more computer based social network service options via electronically enabled input in response to electronically outputted one or more selection menus prior to dispensing of one or more ingestible products for ingestion by the particular individual living being to electronically direct control of collection of preparation information regarding at least partial preparation of the one or more ingestible products, the at least partial preparation of the one or more ingestible products occurring within a first vicinity of the electronically outputting of the electronically outputted one or more selection menus comprises:
a receiving information network electrical circuitry arrangement operable for electronically receiving the selection information of the one or more computer based social network service options via the electronically enabled input in response to the electronically outputted one or more selection menus to be electronically outputted including via one or more network interfaces.

354.-398. (canceled)

399. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a control transmission density electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding occupant density associated with environs of the ingestion by the particular individual living being.

400. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a control transmission furnishings electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding furnishings associated with environs of the ingestion by the particular individual living being.

401. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a control transmission temperature electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding air temperature associated with environs of the ingestion by the particular individual living being.

402. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a control transmission humidity electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding humidity level associated with environs of the ingestion by the particular individual living being.

403. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a control transmission noise electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding noise level associated with environs of the ingestion by the particular individual living being.

404. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a control transmission olfactory electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding olfactory factors including at least one of smells, aromas, odors, or scents associated with environs of the ingestion by the particular individual living being.

405. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a control transmission lighting electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding lighting factors including at least one of intensity, spectrum, duration, or pattern associated with environs of the ingestion by the particular individual living being.

406. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a control transmission color electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding color including at least one of spectrum, predominance, intensity, duration, or pattern associated with environs of the ingestion by the particular individual living being.

407. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a control transmission artwork electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding artwork associated with environs of the ingestion by the particular individual living being.

408. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a control transmission party electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding dining party factors, the dining party including and having a relational association with the particular individual living being, the dining party factors including at least one of the following: number in party, demographics of at least one party member, attire of at least one party member, movement patterns of at least one party member, or topic of conversation of at least one party member.

409. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a control transmission ergonomics electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding ergonomic factors including at least one of chair configuration ergonomics, table configuration ergonomics, utensil ergonomics, arrangement of dishware ergonomics, arrangement of surrounding chairs ergonomics, arrangement of surrounding tables ergonomics, arrangement of standing area ergonomics, counter ergonomics, or bench ergonomics.

410. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a control transmission music electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding background music factors including at least one of volume of music, genre of music, tempo of music, one or more vocalists involved, one or more musicians involved, or whether music is live.

411. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a control transmission extrinsic electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding information pertaining to extrinsic factors including at least one of news stories, local events, world events, business climate, technology updates, entertainment events, sports results, political events, health updates, weather conditions, traffic conditions, or finance reports.

412. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a control transmission feedback electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding user feedback including at least one of taste opinion, texture opinion, feeling of physical health, feeling of mental health, or financial considerations.

413. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a control transmission rate electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding consumption rate thereof by the particular individual living being.

414. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a control transmission apparel electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding one or more apparel worn by the particular individual living being.

415. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a control transmission animation electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding degree of animation by the particular individual living being.

416. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a control transmission combinations electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding material combinations ingested by the particular individual living being.

417. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a control transmission demographics electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding demographics of the particular individual living being.

418. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a second vicinity transportation electrical circuitry arrangement operable for electronically directing control at least in part of transmission to one or more computer based social network services associated with the computer based social network service identification of the ingestion intelligence including the information related to the ingestion by the particular individual living being within the second vicinity as within an interior of a transportation vehicle equipped to electronically output the electronically outputted one or more selection menus.

419. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a second vicinity building electrical circuitry arrangement operable for electronically directing control at least in part of transmission to one or more computer based social network services associated with the computer based social network service identification of the ingestion intelligence including the information related to the ingestion by the particular individual living being within the second vicinity as within an interior of an architectural building containing a dispensing machine.

420. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a second vicinity mall electrical circuitry arrangement operable for electronically directing control at least in part of transmission to one or more computer based social network services associated with the computer based social network service identification of the ingestion intelligence including the information related to the ingestion by the particular individual living being within the second vicinity as within a food court of a shopping mall.

421. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a second vicinity restaurant electrical circuitry arrangement operable for electronically directing control at least in part of transmission to one or more computer based social network services associated with the computer based social network service identification of the ingestion intelligence including the information related to the ingestion by the particular individual living being within the second vicinity as within an interior of a restaurant.

422. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a second vicinity airplane electrical circuitry arrangement operable for electronically directing control at least in part of transmission to one or more computer based social network services associated with the computer based social network service identification of the ingestion intelligence including the information related to the ingestion by the particular individual living being within the second vicinity as within an interior of an airplane.

423. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a second vicinity ground electrical circuitry arrangement operable for electronically directing control at least in part of transmission to one or more computer based social network services associated with the computer based social network service identification of the ingestion intelligence including the information related to the ingestion by the particular individual living being within the second vicinity as within an interior of a ground vehicle.

424. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a second vicinity territory electrical circuitry arrangement operable for electronically directing control at least in part of transmission to one or more computer based social network services associated with the computer based social network service identification of the ingestion intelligence including the information related to the ingestion by the particular individual living being within the second vicinity as within a multi-state territory.

425. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a second vicinity region electrical circuitry arrangement operable for electronically directing control at least in part of transmission to one or more computer based social network services associated with the computer based social network service identification of the ingestion intelligence including the information related to the ingestion by the particular individual living being within the second vicinity as within an international region.

426. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a transmission conversation electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding one or more details of conversation by the particular individual living being.

427. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a transmission gratuity electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding gratuity execution by the particular individual living being.

428. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a transmission financial electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding one or more details regarding financial status of the particular individual living being.

429. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a transmission leftovers electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding quantity of leftovers left by the particular individual living being.

430. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a transmission time electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding one or more details of time dynamics involving the particular individual living being including at least one of time spent ordering the at least one of the one or more ingestible products, time spent waiting for order of the at least one of the one or more ingestible products to be fulfilled, time spent ingesting the at least one of the one or more ingestible products, time spent before leaving the environs of ingestion after ingesting the at least one of the one or more ingestible products.

431. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a transmission party electrical circuitry arrangement operable for electronically directing control at least in part of transmission to one or more computer based social network services associated with the computer based social network service identification of the ingestion intelligence including the information related to the ingestion by the particular individual living being of at least one of the one or more ingestible products regarding one or more details regarding the type of dining party being attended by the particular individual living being during ingestion by the particular individual living being of the at least one of the one or more ingestible products.

432. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a transmission image electrical circuitry arrangement operable for electronically directing control at least in part of transmission to one or more computer based social network services associated with the computer based social network service identification of the ingestion intelligence including information related to ingestion by the particular individual living being of at least one of the one or more ingestible products, such ingestion intelligence being captured via at least in part electronic image recognition.

433. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a transmission gesture electrical circuitry arrangement operable for electronically directing control at least in part of transmission to one or more computer based social network services associated with the computer based social network service identification of the ingestion intelligence including information related to ingestion by the particular individual living being of at least one of the one or more ingestible products, such ingestion intelligence being captured via at least in part electronic based gesture recognition.

434. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a transmission speech electrical circuitry arrangement operable for electronically directing control at least in part of transmission to one or more computer based social network services associated with the computer based social network service identification of the ingestion intelligence including information related to ingestion by the particular individual living being of at least one of the one or more ingestible products, such ingestion intelligence being captured via at least in part electronic speech recognition.

435. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a transmission keypad electrical circuitry arrangement operable for electronically directing control at least in part of transmission to one or more computer based social network services associated with the computer based social network service identification of the ingestion intelligence including information related to ingestion by the particular individual living being of at least one of the one or more ingestible products, such ingestion intelligence being captured via electronic keypad entry.

436. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a transmission input electrical circuitry arrangement operable for electronically directing control at least in part of transmission to one or more computer based social network services associated with the computer based social network service identification of the ingestion intelligence including information related to ingestion by the particular individual living being of at least one of the one or more ingestible products, such ingestion intelligence being captured via electronic input by the particular individual living being.

437. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a transmission restaurant electrical circuitry arrangement operable for electronically directing control at least in part of transmission to one or more computer based social network services associated with the computer based social network service identification of the ingestion intelligence including information related to ingestion by the particular individual living being of at least one of the one or more ingestible products, such ingestion intelligence being captured via electronic input by one or more restaurant staff.

438. The system of claim 293, wherein the controlling transmission electrical circuitry arrangement operable for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus comprises:
a transmission encrypted electrical circuitry arrangement operable for electronically directing control at least in part of transmission to one or more computer based social network services associated with the computer based social network service identification of the ingestion intelligence including information related to ingestion by the particular individual living being of at least one of the one or more ingestible products, such ingestion intelligence being captured via electronically encrypted input.

439. An article of manufacture comprising:
one or more non-transitory signal bearing storage medium bearing:
one or more receiving information instructions for electronically receiving user status information regarding a particular individual living being including computer based social network service identification associated with the particular individual living being and electronically receiving selection information of one or more computer based social network service options via electronically enabled input in response to electronically outputted one or more selection menus prior to dispensing of one or more ingestible products for ingestion by the particular individual living being to electronically direct control of collection of preparation information regarding at least partial preparation of the one or more ingestible products, the at least partial preparation of the one or more ingestible products occurring within a first vicinity of the electronically outputting of the electronically outputted one or more selection menus; and
one or more controlling transmission instructions for electronically directing control at least in part of transmission to one or more computer based social network services associated with the computer based social network service identification of the information collection regarding the at least partial preparation of the one or more ingestible products and ingestion intelligence including information related to ingestion by the particular individual living being of at least one of the one or more ingestible products, the ingestion by the particular individual living being within a second vicinity of the electronically outputting of the electronically outputted one or more selection menus.

440.-584. (canceled)
